(19) United States
(12) Patent Application Publication
(10) Pub. No.: US 2013/0030967 A1
(43) Pub. Date: Jan. 31, 2013

(54) MANAGING CONSISTENT INTERFACES FOR FOREIGN TRADE PRODUCT CLASSIFICATION, SUPPLIER INVOICE BUSINESS OBJECTS ACROSS HETEROGENEOUS SYSTEMS

(71) Applicants: Bharath Shiva Prasad, Bangalore (IN); Vidyashree Basavaraju, Tumkur (IN); Andre Wagner, Sinsheim (DE); Andreas Munk, Wiesloch (DE); Giovanni Deledda, Walldorf (DE); Hua Wang, Shanghai (CN); Paola Sala, Heidelberg (DE)

(72) Inventors: Bharath Shiva Prasad, Bangalore (IN); Vidyashree Basavaraju, Tumkur (IN); Andre Wagner, Sinsheim (DE); Andreas Munk, Wiesloch (DE); Giovanni Deledda, Walldorf (DE); Hua Wang, Shanghai (CN); Paola Sala, Heidelberg (DE)

(73) Assignee: SAP AG, Walldorf (DE)

(21) Appl. No.: 13/218,876

(22) Filed: Aug. 26, 2011

(30) Foreign Application Priority Data
Jul. 28, 2011 (CN) PCT/CN2011/001238

(51) Int. Cl. G06Q 30/04; G06Q 40/04

(52) U.S. Cl. 705/34; 705/37

(57) ABSTRACT

A business object model, which reflects data that is used during a given business transaction, is utilized to generate interfaces. This business object model facilitates commercial transactions by providing consistent interfaces that are suitable for use across industries, across businesses, and across different departments within a business during a business transaction. In some operations, software creates, updates, or otherwise processes information related to a foreign trade product classification business object and a supplier invoice business object.

### CLAIM OF PRIORITY

This application claims priority under 35 U.S.C. §119 to PCT/CN2011/001238, filed Jul. 28, 2011, the entire disclosure of which is incorporated herein by reference.

### CROSS-REFERENCE TO RELATED APPLICATIONS

Some details of the subject matter of this specification are described in previously-filed patent applications: U.S. patent application Ser. No. 12/815,911, entitled “Managing Consistent Interfaces for Foreign Trade Commodity Catalog and Foreign Trade Product Classification Business Objects across Heterogeneous Systems”, filed on Jun. 15, 2010; and U.S. patent application Ser. No. 11/803,178, entitled “Consistent Set of Interfaces Derived From a Business Object Model”, filed on May 11, 2007; and are hereby incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The subject matter described herein relates generally to the generation and use of consistent interfaces (or services) derived from a business object model. More particularly, the present disclosure relates to the generation and use of consistent interfaces or services that are suitable for use across industries, across businesses, and across different departments within a business.

### BACKGROUND

Transactions are common among businesses and between business departments within a particular business. During any given transaction, these business entities exchange information. For example, during a sales transaction, numerous business entities may be involved, such as a sales entity that sells merchandise to a customer, a financial institution that handles the financial transaction, and a warehouse that sends the merchandise to the customer. The end-to-end business transaction may require a significant amount of information to be exchanged between the various business entities involved. For example, the customer may send a request for the merchandise as well as some form of payment authorization for the merchandise to the sales entity, and the sales entity may send the financial institution a request for a transfer of funds from the customer's account to the sales entity's account.

Exchanging information between different business entities is not a simple task. This is particularly true because the information used by different business entities is usually tightly tied to the business entity itself. Each business entity may have its own program for handling its part of the transaction. These programs differ from each other because they typically are created for different purposes and because each business entity may use semantics that differ from the other business entities. For example, one program may relate to accounting, another program may relate to manufacturing, and a third program may relate to inventory control. Similarly, one program may identify merchandise using the name of the product while another program may identify the same merchandise using its model number. Further, one business entity may use U.S. dollars to represent its currency while another business entity may use Japanese Yen. A simple difference in formatting, e.g., the use of upper-case lettering rather than lower-case or title-case, makes the exchange of information between businesses a difficult task. Unless the individual businesses agree upon particular semantics, human interaction typically is required to facilitate transactions between these businesses. Because these “heterogeneous” programs are used by different companies or by different business areas within a given company, a need exists for a consistent way to exchange information and perform a business transaction between the different business entities.

Currently, many standards exist that offer a variety of interfaces used to exchange business information. Most of these interfaces, however, apply to only one specific industry and are not consistent between the different standards. Moreover, a number of these interfaces are not consistent within an individual standard.

### SUMMARY

In a first aspect, a tangible computer readable medium includes program code for providing a message-based interface for exchanging information for foreign trade product classifications. The medium comprises program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for providing a request to maintain a bundle of foreign trade product classifications that includes a first message package derived from the common business object model and hierarchically organized in memory as a foreign trade product classification bundle maintain request message entity and a foreign trade product classification package comprising at least one foreign trade product classification entity, where each foreign trade product classification entity includes a product key, a validity start date, and a customs commodity classification code.

The medium further comprises program code for processing the first message according to the hierarchical organization of the first message package, where processing the first message includes unpacking the first message package based on the common business object model.

The medium further comprises program code for sending a second message to the heterogeneous application responsive to the first message, where the second message includes a second message package derived from the common business object model to provide consistent semantics with the first message package.

Implementations can include the following. Each foreign trade product classification entity further includes at least one of the following: an action code, an object node sender technical identifier (ID), a change state ID, a universally unique identifier (UUID), a product quantity conversion quantity, and a product quantity conversion corresponding quantity.

In another aspect, a distributed system operates in a landscape of computer systems providing message-based services defined in a service registry. The system comprises a graphical user interface comprising computer readable instructions, embedded on tangible media, for providing a request to maintain a bundle of foreign trade product classifications using a request.

The system further comprises a first memory storing a user interface controller for processing the request and involving a message including a message package derived from a common business object model, where the common business object model includes business objects having relationships that enable derivation of message-based service interfaces and message packages, the message package hierarchically organized as a foreign trade product classification bundle maintain request message entity and a foreign trade product classification package comprising at least one foreign trade product classification entity, where each foreign trade product classification entity includes a product key, a validity start date, and a customs commodity classification code.

The system further comprises a second memory, remote from the graphical user interface, storing a plurality of message-based service interfaces derived from the common business object model to provide consistent semantics with messages derived from the common business object model, where one of the message-based service interfaces processes the message according to the hierarchical organization of the message package, where processing the message includes unpacking the first message package based on the common business object model.

Implementations can include the following. The first memory is remote from the graphical user interface. The first memory is remote from the second memory.

In another aspect, a tangible computer readable medium includes program code for providing a message-based interface for exchanging information for supplier invoices. The medium comprises program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for providing a request to check for issues that may occur during the creation of one or more supplier invoices by simulation their creation that includes a first message package derived from the common business object model and hierarchically organized in memory as a supplier invoice bundle check maintain request message entity and a supplier invoice package comprising at least one supplier invoice maintain bundle entity and a party package, where each supplier invoice maintain bundle entity includes a business transaction document type code and a document item gross amount indicator, and where the party package comprises a buyer party entity.

The medium further comprises program code for processing the first message according to the hierarchical organization of the first message package, where processing the first message includes unpacking the first message package based on the common business object model.

The medium further comprises program code for sending a second message to the heterogeneous application responsive to the first message, where the second message includes a second message package derived from the common business object model to provide consistent semantics with the first message package.

Implementations can include the following. The supplier invoice package further comprises at least one of the following: a business transaction document reference package, a location package, a cash discount terms package, a payment control package, an attachment folder package, a text collection package, and an item package. Each supplier invoice maintain bundle entity further includes at least one of the following: an action code, an item list complete transmission indicator, an object node sender technical identifier (ID), a change state ID, a medium name, a date, a receipt date, a transaction date, a gross amount, a tax amount, and a status.

In another aspect, a distributed system operates in a landscape of computer systems providing message-based services defined in a service registry. The system comprises a graphical user interface comprising computer readable instructions, embedded on tangible media, for providing a request to check for issues that may occur during the creation of one or more supplier invoices by simulation their creation using a request.

The system further comprises a first memory storing a user interface controller for processing the request and involving a message including a message package derived from a common business object model, where the common business object model includes business objects having relationships that enable derivation of message-based service interfaces and message packages, the message package hierarchically organized as a supplier invoice bundle check maintain request message entity and a supplier invoice package comprising at least one supplier invoice maintain bundle entity and a party package, where each supplier invoice maintain bundle entity includes a business transaction document type code and a document item gross amount indicator, and where the party package comprises a buyer party entity.

The system further comprises a second memory, remote from the graphical user interface, storing a plurality of message-based service interfaces derived from the common business object model to provide consistent semantics with messages derived from the common business object model, where one of the message-based service interfaces processes the message according to the hierarchical organization of the message package, where processing the message includes unpacking the first message package based on the common business object model.

Implementations can include the following. The first memory is remote from the graphical user interface. The first memory is remote from the second memory.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts a flow diagram of the overall steps performed by methods and systems consistent with the subject matter described herein.

FIG. 2 depicts a business document flow for an invoice request in accordance with methods and systems consistent with the subject matter described herein.

FIGS. 3A-B illustrate example environments implementing the transmission, receipt, and processing of data between heterogeneous applications in accordance with certain embodiments included in the present disclosure.

FIG. 4 illustrates an example application implementing certain techniques and components in accordance with one embodiment of the system of FIG. 1.

FIG. 5A depicts an example development environment in accordance with one embodiment of FIG. 1.

FIG. 5B depicts a simplified process for mapping a model representation to a runtime representation using the example development environment of FIG. 5A or some other development environment.

FIG. 6 depicts message categories in accordance with methods and systems consistent with the subject matter described herein.

FIG. 7 depicts an example of a package in accordance with methods and systems consistent with the subject matter described herein.

FIG. 8 depicts another example of a package in accordance with methods and systems consistent with the subject matter described herein.

FIG. 9 depicts a third example of a package in accordance with methods and systems consistent with the subject matter described herein.

FIG. 10 depicts a fourth example of a package in accordance with methods and systems consistent with the subject matter described herein.

FIG. 11 depicts the representation of a package in the XML schema in accordance with methods and systems consistent with the subject matter described herein.

FIG. 12 depicts a graphical representation of cardinalities between two entities in accordance with methods and systems consistent with the subject matter described herein.

FIG. 13 depicts an example of a composition in accordance with methods and systems consistent with the subject matter described herein.

FIG. 14 depicts an example of a hierarchical relationship in accordance with methods and systems consistent with the subject matter described herein.

FIG. 15 depicts an example of an aggregating relationship in accordance with methods and systems consistent with the subject matter described herein.

FIG. 16 depicts an example of an association in accordance with methods and systems consistent with the subject matter described herein.

FIG. 17 depicts an example of a specialization in accordance with methods and systems consistent with the subject matter described herein.

FIG. 18 depicts the categories of specializations in accordance with methods and systems consistent with the subject matter described herein.

FIG. 19 depicts an example of a hierarchy in accordance with methods and systems consistent with the subject matter described herein.

FIG. 20 depicts a graphical representation of a hierarchy in accordance with methods and systems consistent with the subject matter described herein.

FIGS. 21A-B depict a flow diagram of the steps performed to create a business object model in accordance with methods and systems consistent with the subject matter described herein.

FIGS. 22A-F depict a flow diagram of the steps performed to generate an interface from the business object model in accordance with methods and systems consistent with the subject matter described herein.

FIG. 23 depicts an example illustrating the transmittal of a business document in accordance with methods and systems consistent with the subject matter described herein.

FIG. 24 depicts an interface proxy in accordance with methods and systems consistent with the subject matter described herein.

FIG. 25 depicts an example illustrating the transmittal of a message using proxies in accordance with methods and systems consistent with the subject matter described herein.

FIG. 26A depicts components of a message in accordance with methods and systems consistent with the subject matter described herein.

FIG. 26B depicts IDs used in a message in accordance with methods and systems consistent with the subject matter described herein.

FIGS. 27A-E depict a hierarchization process in accordance with methods and systems consistent with the subject matter described herein.

FIG. 28 illustrates an example method for service enabling in accordance with one embodiment of the present disclosure.

FIG. 29 is a graphical illustration of an example business object and associated components as may be used in the enterprise service infrastructure system of the present disclosure.

FIG. 30 illustrates an example method for managing a process agent framework in accordance with one embodiment of the present disclosure.

FIG. 31 illustrates an example method for status and action management in accordance with one embodiment of the present disclosure.

FIG. 32 depicts an example ForeignTradeProductClassificationBundleMaintainConfirmation_sync Message Data Type.

FIGS. 33-1 through 33-3 collectively depict an example ForeignTradeProductClassificationBundleMaintainConfirmation_sync Element Structure.

FIG. 34 depicts an example ForeignTradeProductClassificationBundleMaintainRequest_sync Message Data Type.

FIGS. 35-1 through 35-3 collectively depict an example ForeignTradeProductClassificationBundleMaintainRequest_sync Element Structure.

FIGS. 36-1 through 36-6 collectively depict an example SupplierInvoiceBundleCheckMaintainRequest_sync Message Data Type.

FIGS. 37-1 through 37-83 collectively depict an example SupplierInvoiceBundleCheckMaintainRequest_sync Element Structure.

FIG. 38 depicts an example SupplierInvoiceBundleMaintainConfirmation_sync Message Data Type.

FIGS. 39-1 through 39-2 collectively depict an example SupplierInvoiceBundleMaintainConfirmation_sync Element Structure.

FIGS. 40-1 through 40-6 collectively depict an example SupplierInvoiceBundleMaintainRequest_sync Message Data Type.

FIGS. 41-1 through 41-83 collectively depict an example SupplierInvoiceBundleMaintainRequest_sync Element Structure.

FIG. 42 depicts an example Foreign Trade Product Classification Object Model.

FIGS. 43-1 through 43-12 collectively depict an example Supplier Invoice Object Model.

### DETAILED DESCRIPTION

### A. Overview

Methods and systems consistent with the subject matter described herein facilitate e-commerce by providing consistent interfaces that are suitable for use across industries, across businesses, and across different departments within a business during a business transaction. To generate consistent interfaces, methods and systems consistent with the subject matter described herein utilize a business object model, which reflects the data that will be used during a given business transaction. An example of a business transaction is the exchange of purchase orders and order confirmations between a buyer and a seller. The business object model is generated in a hierarchical manner to ensure that the same type of data is represented the same way throughout the business object model. This ensures the consistency of the information in the business object model. Consistency is also reflected in the semantic meaning of the various structural elements. That is, each structural element has a consistent business meaning. For example, the location entity, regardless of in which package it is located, refers to a location.

From this business object model, various interfaces are derived to accomplish the functionality of the business transaction. Interfaces provide an entry point for components to access the functionality of an application. For example, the interface for a Purchase Order Request provides an entry point for components to access the functionality of a Purchase Order, in particular, to transmit and/or receive a Purchase Order Request. One skilled in the art will recognize that each of these interfaces may be provided, sold, distributed, utilized, or marketed as a separate product or as a major component of a separate product. Alternatively, a group of related interfaces may be provided, sold, distributed, utilized, or marketed as a product or as a major component of a separate product. Because the interfaces are generated from the business object model, the information in the interfaces is consistent, and the interfaces are consistent among the business entities. Such consistency facilitates heterogeneous business entities in cooperating to accomplish the business transaction.

Generally, the business object is a representation of a type of a uniquely identifiable business entity (an object instance) described by a structural model. In the architecture, processes may typically operate on business objects. Business objects represent a specific view on some well-defined business content. In other words, business objects represent content, which a typical business user would expect and understand with little explanation. Business objects are further categorized as business process objects and master data objects. A master data object is an object that encapsulates master data (i.e., data that is valid for a period of time). A business process object, which is the kind of business object generally found in a process component, is an object that encapsulates transactional data (i.e., data that is valid for a point in time). The term business object will be used generically to refer to a business process object and a master data object, unless the context requires otherwise. Properly implemented, business objects are implemented free of redundancies.

The architectural elements also include the process component. The process component is a software package that realizes a business process and generally exposes its functionality as services. The functionality contains business transactions. In general, the process component contains one or more semantically related business objects. Often, a particular business object belongs to no more than one process component. Interactions between process component pairs involving their respective business objects, process agents, operations, interfaces, and messages are described as process component interactions, which generally determine the interactions of a pair of process components across a deployment unit boundary. Interactions between process components within a deployment unit are typically not constrained by the architectural design and can be implemented in any convenient fashion. Process components may be modular and context-independent. In other words, process components may not be specific to any particular application and as such, may be reusable. In some implementations, the process component is the smallest (most granular) element of reuse in the architecture. An external process component is generally used to represent the external system in describing interactions with the external system; however, this should be understood to require no more of the external system than that able to produce and receive messages as required by the process component that interacts with the external system. For example, process components may include multiple operations that may provide interaction with the external system. Each operation generally belongs to one type of process component in the architecture. Operations can be synchronous or asynchronous, corresponding to synchronous or asynchronous process agents, which will be described below. The operation is often the smallest, separately-callable function, described by a set of data types used as input, output, and fault parameters serving as a signature.

The architectural elements may also include the service interface, referred to simply as the interface. The interface is a named group of operations. The interface often belongs to one process component and process component might contain multiple interfaces. In one implementation, the service interface contains only inbound or outbound operations, but not a mixture of both. One interface can contain both synchronous and asynchronous operations. Normally, operations of the same type (either inbound or outbound) which belong to the same message choreography will belong to the same interface. Thus, generally, all outbound operations to the same other process component are in one interface.

The architectural elements also include the message. Operations transmit and receive messages. Any convenient messaging infrastructure can be used. A message is information conveyed from one process component instance to another, with the expectation that activity will ensue. Operation can use multiple message types for inbound, outbound, or error messages. When two process components are in different deployment units, invocation of an operation of one process component by the other process component is accomplished by the operation on the other process component sending a message to the first process component.

The architectural elements may also include the process agent. Process agents do business processing that involves the sending or receiving of messages. Each operation normally has at least one associated process agent. Each process agent can be associated with one or more operations. Process agents can be either inbound or outbound and either synchronous or asynchronous. Asynchronous outbound process agents are called after a business object changes such as after a “create”, “update”, or “delete” of a business object instance. Synchronous outbound process agents are generally triggered directly by business object. An outbound process agent will generally perform some processing of the data of the business object instance whose change triggered the event. The outbound agent triggers subsequent business process steps by sending messages using well-defined outbound services to another process component, which generally will be in another deployment unit, or to an external system. The outbound process agent is linked to the one business object that triggers the agent, but it is sent not to another business object but rather to another process component. Thus, the outbound process agent can be implemented without knowledge of the exact business object design of the recipient process component. Alternatively, the process agent may be inbound. For example, inbound process agents may be used for the inbound part of a message-based communication. Inbound process agents are called after a message has been received. The inbound process agent starts the execution of the business process step requested in a message by creating or updating one or multiple business object instances. Inbound process agent is not generally the agent of business object but of its process component. Inbound process agent can act on multiple business objects in a process component. Regardless of whether the process agent is inbound or outbound, an agent may be synchronous if used when a process component requires a more or less immediate response from another process component, and is waiting for that response to continue its work.

The architectural elements also include the deployment unit. Each deployment unit may include one or more process components that are generally deployed together on a single computer system platform. Conversely, separate deployment units can be deployed on separate physical computing systems. The process components of one deployment unit can interact with those of another deployment unit using messages passed through one or more data communication networks or other suitable communication channels. Thus, a deployment unit deployed on a platform belonging to one business can interact with a deployment unit software entity deployed on a separate platform belonging to a different and unrelated business, allowing for business-to-business communication. More than one instance of a given deployment unit can execute at the same time, on the same computing system or on separate physical computing systems. This arrangement allows the functionality offered by the deployment unit to be scaled to meet demand by creating as many instances as needed.

Since interaction between deployment units is through process component operations, one deployment unit can be replaced by other another deployment unit as long as the new deployment unit supports the operations depended upon by other deployment units as appropriate. Thus, while deployment units can depend on the external interfaces of process components in other deployment units, deployment units are not dependent on process component interaction within other deployment units. Similarly, process components that interact with other process components or external systems only through messages, e.g., as sent and received by operations, can also be replaced as long as the replacement generally supports the operations of the original.

Services (or interfaces) may be provided in a flexible architecture to support varying criteria between services and systems. The flexible architecture may generally be provided by a service delivery business object. The system may be able to schedule a service asynchronously as necessary, or on a regular basis. Services may be planned according to a schedule manually or automatically. For example, a follow-up service may be scheduled automatically upon completing an initial service. In addition, flexible execution periods may be possible (e.g. hourly, daily, every three months, etc.). Each customer may plan the services on demand or reschedule service execution upon request.

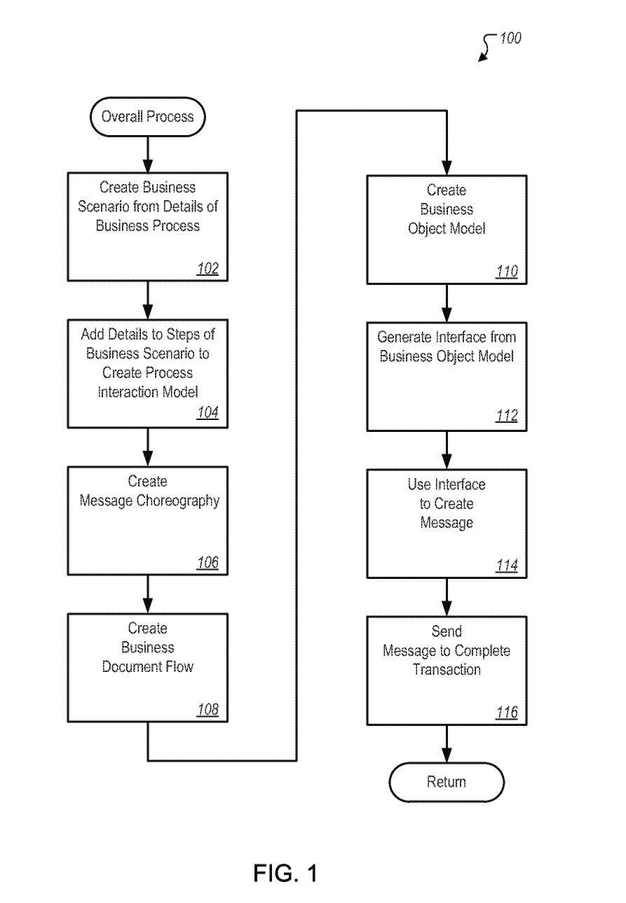

FIG. 1 depicts a flow diagram 100 showing an example technique, perhaps implemented by systems similar to those disclosed herein. Initially, to generate the business object model, design engineers study the details of a business process, and model the business process using a “business scenario” (step 102). The business scenario identifies the steps performed by the different business entities during a business process. Thus, the business scenario is a complete representation of a clearly defined business process.

After creating the business scenario, the developers add details to each step of the business scenario (step 104). In particular, for each step of the business scenario, the developers identify the complete process steps performed by each business entity. A discrete portion of the business scenario reflects a “business transaction,” and each business entity is referred to as a “component” of the business transaction. The developers also identify the messages that are transmitted between the components. A “process interaction model” represents the complete process steps between two components.

After creating the process interaction model, the developers create a “message choreography” (step 106), which depicts the messages transmitted between the two components in the process interaction model. The developers then represent the transmission of the messages between the components during a business process in a “business document flow” (step 108). Thus, the business document flow illustrates the flow of information between the business entities during a business process.

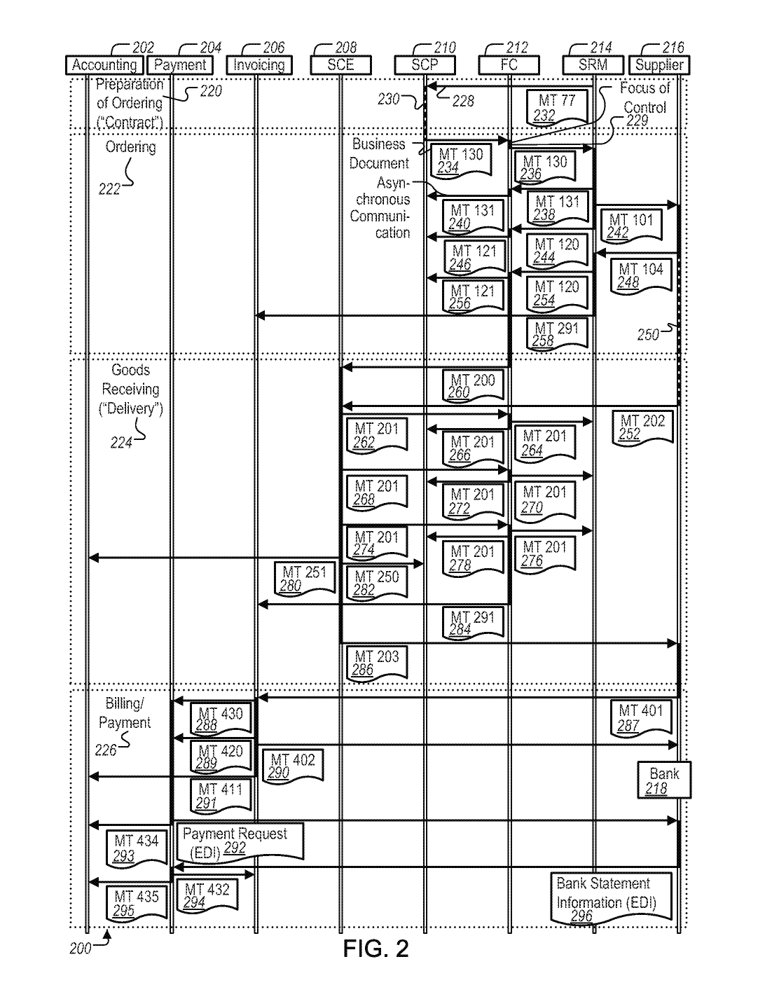

FIG. 2 depicts an example business document flow 200 for the process of purchasing a product or service. The business entities involved with the illustrative purchase process include Accounting 202, Payment 204, Invoicing 206, Supply Chain Execution (“SCE”) 208, Supply Chain Planning (“SCP”) 210, Fulfillment Coordination (“FC”) 212, Supply Relationship Management (“SRM”) 214, Supplier 216, and Bank 218. The business document flow 200 is divided into four different transactions: Preparation of Ordering (“Contract”) 220, Ordering 222, Goods Receiving (“Delivery”) 224, and Billing/Payment 226. In the business document flow, arrows 228 represent the transmittal of documents. Each document reflects a message transmitted between entities. One of ordinary skill in the art will appreciate that the messages transferred may be considered to be a communications protocol. The process flow follows the focus of control, which is depicted as a solid vertical line (e.g., 229) when the step is required, and a dotted vertical line (e.g., 230) when the step is optional.

During the Contract transaction 220, the SRM 214 sends a Source of Supply Notification 232 to the SCP 210. This step is optional, as illustrated by the optional control line 230 coupling this step to the remainder of the business document flow 200. During the Ordering transaction 222, the SCP 210 sends a Purchase Requirement Request 234 to the FC 212, which forwards a Purchase Requirement Request 236 to the SRM 214. The SRM 214 then sends a Purchase Requirement Confirmation 238 to the FC 212, and the FC 212 sends a Purchase Requirement Confirmation 240 to the SCP 210. The SRM 214 also sends a Purchase Order Request 242 to the Supplier 216, and sends Purchase Order Information 244 to the FC 212. The FC 212 then sends a Purchase Order Planning Notification 246 to the SCP 210. The Supplier 216, after receiving the Purchase Order Request 242, sends a Purchase Order Confirmation 248 to the SRM 214, which sends a Purchase Order Information confirmation message 254 to the FC 212, which sends a message 256 confirming the Purchase Order Planning Notification to the SCP 210. The SRM 214 then sends an Invoice Due Notification 258 to Invoicing 206.

During the Delivery transaction 224, the FC 212 sends a Delivery Execution Request 260 to the SCE 208. The Supplier 216 could optionally (illustrated at control line 250) send a Dispatched Delivery Notification 252 to the SCE 208. The SCE 208 then sends a message 262 to the FC 212 notifying the FC 212 that the request for the Delivery Information was created. The FC 212 then sends a message 264 notifying the SRM 214 that the request for the Delivery Information was created. The FC 212 also sends a message 266 notifying the SCP 210 that the request for the Delivery Information was created. The SCE 208 sends a message 268 to the FC 212 when the goods have been set aside for delivery. The FC 212 sends a message 270 to the SRM 214 when the goods have been set aside for delivery. The FC 212 also sends a message 272 to the SCP 210 when the goods have been set aside for delivery.

The SCE 208 sends a message 274 to the FC 212 when the goods have been delivered. The FC 212 then sends a message 276 to the SRM 214 indicating that the goods have been delivered, and sends a message 278 to the SCP 210 indicating that the goods have been delivered. The SCE 208 then sends an Inventory Change Accounting Notification 280 to Accounting 202, and an Inventory Change Notification 282 to the SCP 210. The FC 212 sends an Invoice Due Notification 284 to Invoicing 206, and SCE 208 sends a Received Delivery Notification 286 to the Supplier 216.

During the Billing/Payment transaction 226, the Supplier 216 sends an Invoice Request 287 to Invoicing 206. Invoicing 206 then sends a Payment Due Notification 288 to Payment 204, a Tax Due Notification 289 to Payment 204, an Invoice Confirmation 290 to the Supplier 216, and an Invoice Accounting Notification 291 to Accounting 202. Payment 204 sends a Payment Request 292 to the Bank 218, and a Payment Requested Accounting Notification 293 to Accounting 202. Bank 218 sends a Bank Statement Information 296 to Payment 204. Payment 204 then sends a Payment Done Information 294 to Invoicing 206 and a Payment Done Accounting Notification 295 to Accounting 202.

Within a business document flow, business documents having the same or similar structures are marked. For example, in the business document flow 200 depicted in FIG. 2, Purchase Requirement Requests 234, 236 and Purchase Requirement Confirmations 238, 240 have the same structures. Thus, each of these business documents is marked with an “O6.” Similarly, Purchase Order Request 242 and Purchase Order Confirmation 248 have the same structures. Thus, both documents are marked with an “O1.” Each business document or message is based on a message type.

From the business document flow, the developers identify the business documents having identical or similar structures, and use these business documents to create the business object model (step 110). The business object model includes the objects contained within the business documents. These objects are reflected as packages containing related information, and are arranged in a hierarchical structure within the business object model, as discussed below.

Methods and systems consistent with the subject matter described herein then generate interfaces from the business object model (step 112). The heterogeneous programs use instantiations of these interfaces (called “business document objects” below) to create messages (step 114), which are sent to complete the business transaction (step 116). Business entities use these messages to exchange information with other business entities during an end-to-end business transaction. Since the business object model is shared by heterogeneous programs, the interfaces are consistent among these programs. The heterogeneous programs use these consistent interfaces to communicate in a consistent manner, thus facilitating the business transactions.

Standardized Business-to-Business (“B2B”) messages are compliant with at least one of the e-business standards (i.e., they include the business-relevant fields of the standard). The e-business standards include, for example, RosettaNet for the high-tech industry, Chemical Industry Data Exchange (“CIDX”), Petroleum Industry Data Exchange (“PIDX”) for the oil industry, UCCnet for trade, PapiNet for the paper industry, Odette for the automotive industry, HR-XML for human resources, and XML Common Business Library (“xCBL”). Thus, B2B messages enable simple integration of components in heterogeneous system landscapes. Application-to-Application (“A2A”) messages often exceed the standards and thus may provide the benefit of the full functionality of application components. Although various steps of FIG. 1 were described as being performed manually, one skilled in the art will appreciate that such steps could be computer-assisted or performed entirely by a computer, including being performed by either hardware, software, or any other combination thereof.

### B. Implementation Details

As discussed above, methods and systems consistent with the subject matter described herein create consistent interfaces by generating the interfaces from a business object model. Details regarding the creation of the business object model, the generation of an interface from the business object model, and the use of an interface generated from the business object model are provided below.

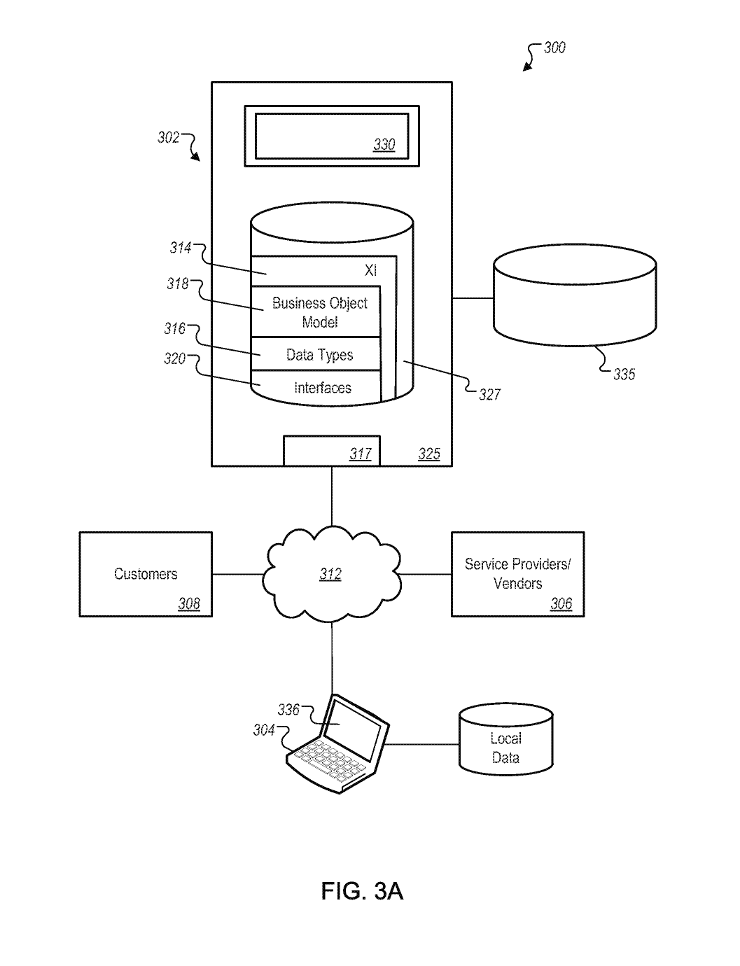

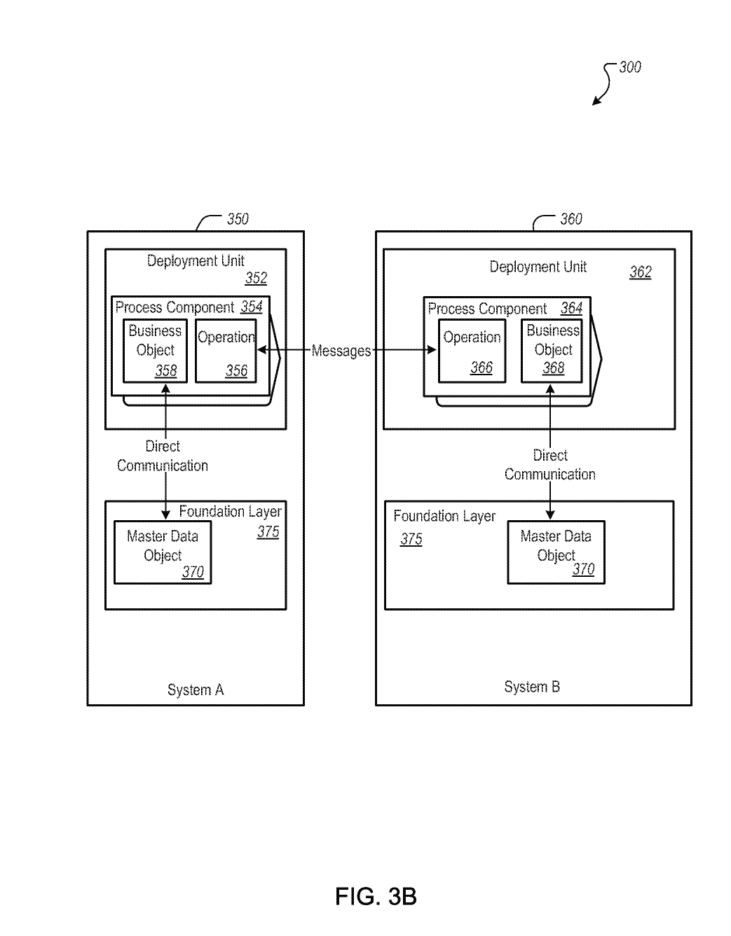

Turning to the illustrated embodiment in FIG. 3A, environment 300 includes or is communicably coupled (such as via a one-, bi- or multi-directional link or network) with server 302, one or more clients 304, one or more or vendors 306, one or more customers 308, at least some of which communicate across network 312. But, of course, this illustration is for example purposes only, and any distributed system or environment implementing one or more of the techniques described herein may be within the scope of this disclosure. Server 302 comprises an electronic computing device operable to receive, transmit, process and store data associated with environment 300. Generally, FIG. 3A provides merely one example of computers that may be used with the disclosure. Each computer is generally intended to encompass any suitable processing device. For example, although FIG. 3A illustrates one server 302 that may be used with the disclosure, environment 300 can be implemented using computers other than servers, as well as a server pool. Indeed, server 302 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Server 302 may be adapted to execute any operating system including Linux, UNIX, Windows Server, or any other suitable operating system. According to one embodiment, server 302 may also include or be communicably coupled with a web server and/or a mail server.

As illustrated (but not required), the server 302 is communicably coupled with a relatively remote repository 335 over a portion of the network 312. The repository 335 is any electronic storage facility, data processing center, or archive that may supplement or replace local memory (such as 327). The repository 335 may be a central database communicably coupled with the one or more servers 302 and the clients 304 via a virtual private network (VPN), SSH (Secure Shell) tunnel, or other secure network connection. The repository 335 may be physically or logically located at any appropriate location including in one of the example enterprises or off-shore, so long as it remains operable to store information associated with the environment 300 and communicate such data to the server 302 or at least a subset of plurality of the clients 304.

Illustrated server 302 includes local memory 327. Memory 327 may include any memory or database module and may take the form of volatile or non-volatile memory including, without limitation, magnetic media, optical media, random access memory (RAM), read-only memory (ROM), removable media, or any other suitable local or remote memory component. Illustrated memory 327 includes an exchange infrastructure (“XI”) 314, which is an infrastructure that supports the technical interaction of business processes across heterogeneous system environments. XI 314 centralizes the communication between components within a business entity and between different business entities. When appropriate, XI 314 carries out the mapping between the messages. XI 314 integrates different versions of systems implemented on different platforms (e.g., Java and ABAP). XI 314 is based on an open architecture, and makes use of open standards, such as eXtensible Markup Language (XML)TM and Java environments. XI 314 offers services that are useful in a heterogeneous and complex system landscape. In particular, XI 314 offers a runtime infrastructure for message exchange, configuration options for managing business processes and message flow, and options for transforming message contents between sender and receiver systems.

XI 314 stores data types 316, a business object model 318, and interfaces 320. The details regarding the business object model are described below. Data types 316 are the building blocks for the business object model 318. The business object model 318 is used to derive consistent interfaces 320. XI 314 allows for the exchange of information from a first company having one computer system to a second company having a second computer system over network 312 by using the standardized interfaces 320.

While not illustrated, memory 327 may also include business objects and any other appropriate data such as services, interfaces, VPN applications or services, firewall policies, a security or access log, print or other reporting files, HTML files or templates, data classes or object interfaces, child software applications or sub-systems, and others. This stored data may be stored in one or more logical or physical repositories. In some embodiments, the stored data (or pointers thereto) may be stored in one or more tables in a relational database described in terms of SQL statements or scripts. In the same or other embodiments, the stored data may also be formatted, stored, or defined as various data structures in text files, XML documents, Virtual Storage Access Method (VSAM) files, flat files, Btrieve files, comma-separated-value (CSV) files, internal variables, or one or more libraries. For example, a particular data service record may merely be a pointer to a particular piece of third party software stored remotely. In another example, a particular data service may be an internally stored software object usable by authenticated customers or internal development. In short, the stored data may comprise one table or file or a plurality of tables or files stored on one computer or across a plurality of computers in any appropriate format. Indeed, some or all of the stored data may be local or remote without departing from the scope of this disclosure and store any type of appropriate data.

Server 302 also includes processor 325. Processor 325 executes instructions and manipulates data to perform the operations of server 302 such as, for example, a central processing unit (CPU), a blade, an application specific integrated circuit (ASIC), or a field-programmable gate array (FPGA). Although FIG. 3A illustrates a single processor 325 in server 302, multiple processors 325 may be used according to particular needs and reference to processor 325 is meant to include multiple processors 325 where applicable. In the illustrated embodiment, processor 325 executes at least business application 330.

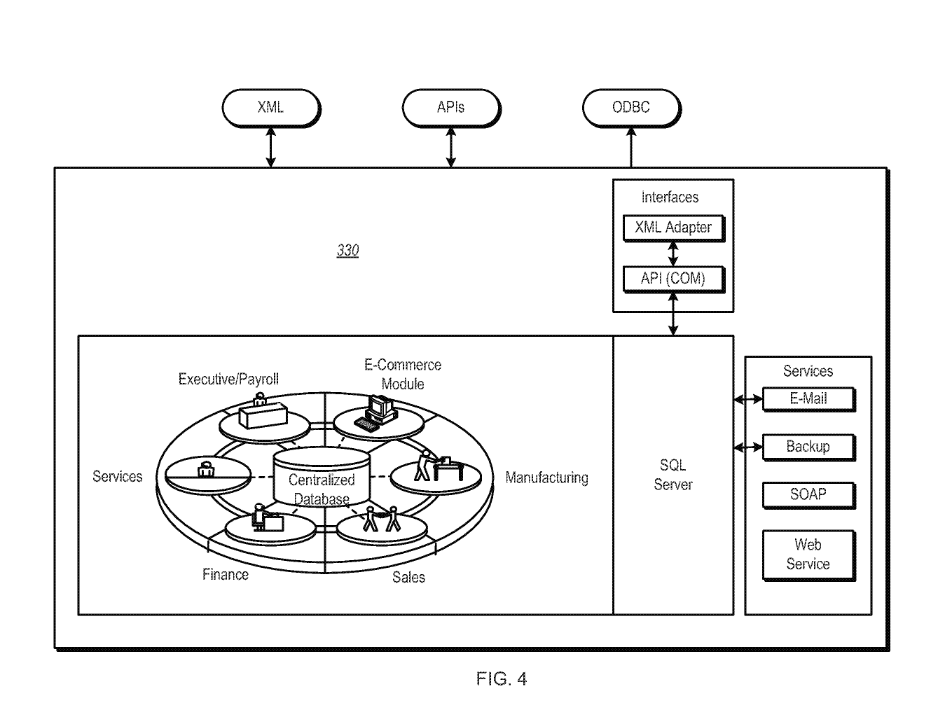

At a high level, business application 330 is any application, program, module, process, or other software that utilizes or facilitates the exchange of information via messages (or services) or the use of business objects. For example, application 330 may implement, utilize or otherwise leverage an enterprise service-oriented architecture (enterprise SOA), which may be considered a blueprint for an adaptable, flexible, and open IT architecture for developing services-based, enterprise-scale business solutions. This example enterprise service may be a series of web services combined with business logic that can be accessed and used repeatedly to support a particular business process. Aggregating web services into business-level enterprise services helps provide a more meaningful foundation for the task of automating enterprise-scale business scenarios Put simply, enterprise services help provide a holistic combination of actions that are semantically linked to complete the specific task, no matter how many cross-applications are involved. In certain cases, environment 300 may implement a composite application 330, as described below in FIG. 4. Regardless of the particular implementation, “software” may include software, firmware, wired or programmed hardware, or any combination thereof as appropriate. Indeed, application 330 may be written or described in any appropriate computer language including C, C++, Java, Visual Basic, assembler, Perl, any suitable version of 4GL, as well as others. For example, returning to the above mentioned composite application, the composite application portions may be implemented as Enterprise Java Beans (EJBs) or the design-time components may have the ability to generate run-time implementations into different platforms, such as J2EE (Java 2 Platform, Enterprise Edition), ABAP (Advanced Business Application Programming) objects, or Microsoft's .NET. It will be understood that while application 330 is illustrated in FIG. 4 as including various sub-modules, application 330 may include numerous other sub-modules or may instead be a single multi-tasked module that implements the various features and functionality through various objects, methods, or other processes. Further, while illustrated as internal to server 302, one or more processes associated with application 330 may be stored, referenced, or executed remotely. For example, a portion of application 330 may be a web service that is remotely called, while another portion of application 330 may be an interface object bundled for processing at remote client 304. Moreover, application 330 may be a child or sub-module of another software module or enterprise application (not illustrated) without departing from the scope of this disclosure. Indeed, application 330 may be a hosted solution that allows multiple related or third parties in different portions of the process to perform the respective processing.

More specifically, as illustrated in FIG. 4, application 330 may be a composite application, or an application built on other applications, that includes an object access layer (OAL) and a service layer. In this example, application 330 may execute or provide a number of application services, such as customer relationship management (CRM) systems, human resources management (HRM) systems, financial management (FM) systems, project management (PM) systems, knowledge management (KM) systems, and electronic file and mail systems. Such an object access layer is operable to exchange data with a plurality of enterprise base systems and to present the data to a composite application through a uniform interface. The example service layer is operable to provide services to the composite application. These layers may help the composite application to orchestrate a business process in synchronization with other existing processes (e.g., native processes of enterprise base systems) and leverage existing investments in the IT platform. Further, composite application 330 may run on a heterogeneous IT platform. In doing so, composite application may be cross-functional in that it may drive business processes across different applications, technologies, and organizations. Accordingly, composite application 330 may drive end-to-end business processes across heterogeneous systems or sub-systems. Application 330 may also include or be coupled with a persistence layer and one or more application system connectors. Such application system connectors enable data exchange and integration with enterprise sub-systems and may include an Enterprise Connector (EC) interface, an Internet Communication Manager/Internet Communication Framework (ICM/ICF) interface, an Encapsulated PostScript (EPS) interface, and/or other interfaces that provide Remote Function Call (RFC) capability. It will be understood that while this example describes a composite application 330, it may instead be a standalone or (relatively) simple software program. Regardless, application 330 may also perform processing automatically, which may indicate that the appropriate processing is substantially performed by at least one component of environment 300. It should be understood that automatically further contemplates any suitable administrator or other user interaction with application 330 or other components of environment 300 without departing from the scope of this disclosure.

Returning to FIG. 3A, illustrated server 302 may also include interface 317 for communicating with other computer systems, such as clients 304, over network 312 in a client-server or other distributed environment. In certain embodiments, server 302 receives data from internal or external senders through interface 317 for storage in memory 327, for storage in DB 335, and/or processing by processor 325. Generally, interface 317 comprises logic encoded in software and/or hardware in a suitable combination and operable to communicate with network 312. More specifically, interface 317 may comprise software supporting one or more communications protocols associated with communications network 312 or hardware operable to communicate physical signals.

Network 312 facilitates wireless or wireline communication between computer server 302 and any other local or remote computer, such as clients 304. Network 312 may be all or a portion of an enterprise or secured network. In another example, network 312 may be a VPN merely between server 302 and client 304 across wireline or wireless link. Such an example wireless link may be via 802.11a, 802.11b, 802.11g, 802.20, WiMax, and many others. While illustrated as a single or continuous network, network 312 may be logically divided into various sub-nets or virtual networks without departing from the scope of this disclosure, so long as at least portion of network 312 may facilitate communications between server 302 and at least one client 304. For example, server 302 may be communicably coupled to one or more “local” repositories through one sub-net while communicably coupled to a particular client 304 or “remote” repositories through another. In other words, network 312 encompasses any internal or external network, networks, sub-network, or combination thereof operable to facilitate communications between various computing components in environment 300. Network 312 may communicate, for example, Internet Protocol (IP) packets, Frame Relay frames, Asynchronous Transfer Mode (ATM) cells, voice, video, data, and other suitable information between network addresses. Network 312 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 312 may be a secure network associated with the enterprise and certain local or remote vendors 306 and customers 308. As used in this disclosure, customer 308 is any person, department, organization, small business, enterprise, or any other entity that may use or request others to use environment 300. As described above, vendors 306 also may be local or remote to customer 308. Indeed, a particular vendor 306 may provide some content to business application 330, while receiving or purchasing other content (at the same or different times) as customer 308. As illustrated, customer 308 and vendor 06 each typically perform some processing (such as uploading or purchasing content) using a computer, such as client 304.

Client 304 is any computing device operable to connect or communicate with server 302 or network 312 using any communication link. For example, client 304 is intended to encompass a personal computer, touch screen terminal, workstation, network computer, kiosk, wireless data port, smart phone, personal data assistant (PDA), one or more processors within these or other devices, or any other suitable processing device used by or for the benefit of business 308, vendor 306, or some other user or entity. At a high level, each client 304 includes or executes at least GUI 336 and comprises an electronic computing device operable to receive, transmit, process and store any appropriate data associated with environment 300. It will be understood that there may be any number of clients 304 communicably coupled to server 302. Further, “client 304,” “business,” “business analyst,” “end user,” and “user” may be used interchangeably as appropriate without departing from the scope of this disclosure. Moreover, for ease of illustration, each client 304 is described in terms of being used by one user. But this disclosure contemplates that many users may use one computer or that one user may use multiple computers. For example, client 304 may be a PDA operable to wirelessly connect with external or unsecured network. In another example, client 304 may comprise a laptop that includes an input device, such as a keypad, touch screen, mouse, or other device that can accept information, and an output device that conveys information associated with the operation of server 302 or clients 304, including digital data, visual information, or GUI 336. Both the input device and output device may include fixed or removable storage media such as a magnetic computer disk, CD-ROM, or other suitable media to both receive input from and provide output to users of clients 304 through the display, namely the client portion of GUI or application interface 336.

GUI 336 comprises a graphical user interface operable to allow the user of client 304 to interface with at least a portion of environment 300 for any suitable purpose, such as viewing application or other transaction data. Generally, GUI 336 provides the particular user with an efficient and user-friendly presentation of data provided by or communicated within environment 300. For example, GUI 336 may present the user with the components and information that is relevant to their task, increase reuse of such components, and facilitate a sizable developer community around those components. GUI 336 may comprise a plurality of customizable frames or views having interactive fields, pull-down lists, and buttons operated by the user. For example, GUI 336 is operable to display data involving business objects and interfaces in a user-friendly form based on the user context and the displayed data. In another example, GUI 336 is operable to display different levels and types of information involving business objects and interfaces based on the identified or supplied user role. GUI 336 may also present a plurality of portals or dashboards. For example, GUI 336 may display a portal that allows users to view, create, and manage historical and real-time reports including role-based reporting and such. Of course, such reports may be in any appropriate output format including PDF, HTML, and printable text. Real-time dashboards often provide table and graph information on the current state of the data, which may be supplemented by business objects and interfaces. It should be understood that the term graphical user interface may be used in the singular or in the plural to describe one or more graphical user interfaces and each of the displays of a particular graphical user interface. Indeed, reference to GUI 336 may indicate a reference to the front-end or a component of business application 330, as well as the particular interface accessible via client 304, as appropriate, without departing from the scope of this disclosure. Therefore, GUI 336 contemplates any graphical user interface, such as a generic web browser or touchscreen, that processes information in environment 300 and efficiently presents the results to the user. Server 302 can accept data from client 304 via the web browser (e.g., Microsoft Internet Explorer or Netscape Navigator) and return the appropriate HTML or XML responses to the browser using network 312.

More generally in environment 300 as depicted in FIG. 3B, a Foundation Layer 375 can be deployed on multiple separate and distinct hardware platforms, e.g., System A 350 and System B 360, to support application software deployed as two or more deployment units distributed on the platforms, including deployment unit 352 deployed on System A and deployment unit 362 deployed on System B. In this example, the foundation layer can be used to support application software deployed in an application layer. In particular, the foundation layer can be used in connection with application software implemented in accordance with a software architecture that provides a suite of enterprise service operations having various application functionality. In some implementations, the application software is implemented to be deployed on an application platform that includes a foundation layer that contains all fundamental entities that can used from multiple deployment units. These entities can be process components, business objects, and reuse service components. A reuse service component is a piece of software that is reused in different transactions. A reuse service component is used by its defined interfaces, which can be, e.g., local APIs or service interfaces. As explained above, process components in separate deployment units interact through service operations, as illustrated by messages passing between service operations 356 and 366, which are implemented in process components 354 and 364, respectively, which are included in deployment units 352 and 362, respectively. As also explained above, some form of direct communication is generally the form of interaction used between a business object, e.g., business object 358 and 368, of an application deployment unit and a business object, such as master data object 370, of the Foundation Layer 375.

Various components of the present disclosure may be modeled using a model-driven environment. For example, the model-driven framework or environment may allow the developer to use simple drag-and-drop techniques to develop pattern-based or freestyle user interfaces and define the flow of data between them. The result could be an efficient, customized, visually rich online experience. In some cases, this model-driven development may accelerate the application development process and foster business-user self-service. It further enables business analysts or IT developers to compose visually rich applications that use analytic services, enterprise services, remote function calls (RFCs), APIs, and stored procedures. In addition, it may allow them to reuse existing applications and create content using a modeling process and a visual user interface instead of manual coding.

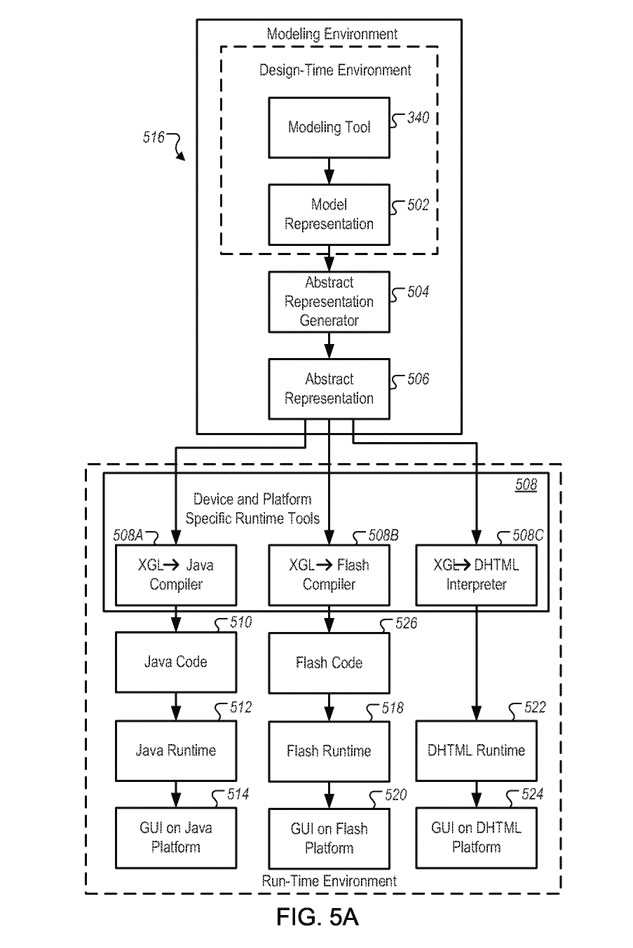

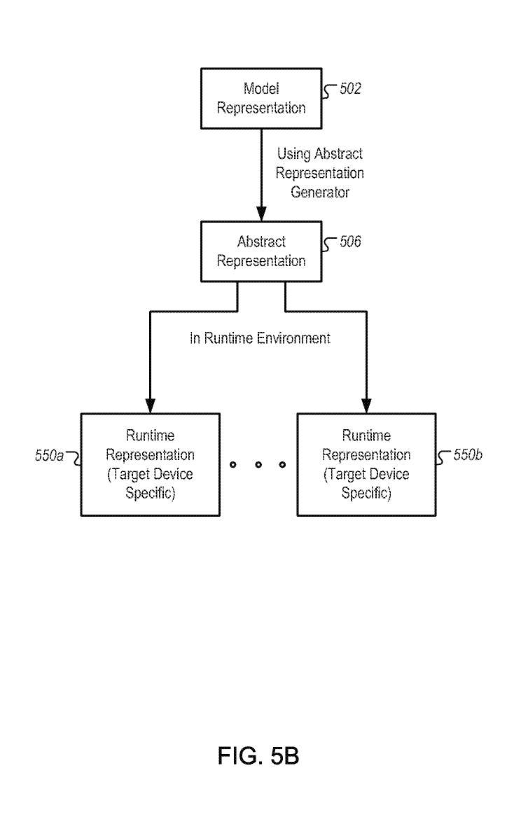

FIG. 5A depicts an example modeling environment 516, namely a modeling environment, in accordance with one embodiment of the present disclosure. Thus, as illustrated in FIG. 5A, such a modeling environment 516 may implement techniques for decoupling models created during design-time from the runtime environment. In other words, model representations for GUIs created in a design time environment are decoupled from the runtime environment in which the GUIs are executed. Often in these environments, a declarative and executable representation for GUIs for applications is provided that is independent of any particular runtime platform, GUI framework, device, or programming language.

According to some embodiments, a modeler (or other analyst) may use the model-driven modeling environment 516 to create pattern-based or freestyle user interfaces using simple drag-and-drop services. Because this development may be model-driven, the modeler can typically compose an application using models of business objects without having to write much, if any, code. In some cases, this example modeling environment 516 may provide a personalized, secure interface that helps unify enterprise applications, information, and processes into a coherent, role-based portal experience. Further, the modeling environment 516 may allow the developer to access and share information and applications in a collaborative environment. In this way, virtual collaboration rooms allow developers to work together efficiently, regardless of where they are located, and may enable powerful and immediate communication that crosses organizational boundaries while enforcing security requirements. Indeed, the modeling environment 516 may provide a shared set of services for finding, organizing, and accessing unstructured content stored in third-party repositories and content management systems across various networks 312. Classification tools may automate the organization of information, while subject-matter experts and content managers can publish information to distinct user audiences. Regardless of the particular implementation or architecture, this modeling environment 516 may allow the developer to easily model hosted business objects 140 using this model-driven approach.

In certain embodiments, the modeling environment 516 may implement or utilize a generic, declarative, and executable GUI language (generally described as XGL). This example XGL is generally independent of any particular GUI framework or runtime platform. Further, XGL is normally not dependent on characteristics of a target device on which the graphic user interface is to be displayed and may also be independent of any programming language. XGL is used to generate a generic representation (occasionally referred to as the XGL representation or XGL-compliant representation) for a design-time model representation. The XGL representation is thus typically a device-independent representation of a GUI. The XGL representation is declarative in that the representation does not depend on any particular GUI framework, runtime platform, device, or programming language. The XGL representation can be executable and therefore can unambiguously encapsulate execution semantics for the GUI described by a model representation. In short, models of different types can be transformed to XGL representations.

The XGL representation may be used for generating representations of various different GUIs and supports various GUI features including full windowing and componentization support, rich data visualizations and animations, rich modes of data entry and user interactions, and flexible connectivity to any complex application data services. While a specific embodiment of XGL is discussed, various other types of XGLs may also be used in alternative embodiments. In other words, it will be understood that XGL is used for example description only and may be read to include any abstract or modeling language that can be generic, declarative, and executable.

Turning to the illustrated embodiment in FIG. 5A, modeling tool 340 may be used by a GUI designer or business analyst during the application design phase to create a model representation 502 for a GUI application. It will be understood that modeling environment 516 may include or be compatible with various different modeling tools 340 used to generate model representation 502. This model representation 502 may be a machine-readable representation of an application or a domain specific model. Model representation 502 generally encapsulates various design parameters related to the GUI such as GUI components, dependencies between the GUI components, inputs and outputs, and the like. Put another way, model representation 502 provides a form in which the one or more models can be persisted and transported, and possibly handled by various tools such as code generators, runtime interpreters, analysis and validation tools, merge tools, and the like. In one embodiment, model representation 502 maybe a collection of XML documents with a well-formed syntax.

Illustrated modeling environment 516 also includes an abstract representation generator (or XGL generator) 504 operable to generate an abstract representation (for example, XGL representation or XGL-compliant representation) 506 based upon model representation 502. Abstract representation generator 504 takes model representation 502 as input and outputs abstract representation 506 for the model representation. Model representation 502 may include multiple instances of various forms or types depending on the tool/language used for the modeling. In certain cases, these various different model representations may each be mapped to one or more abstract representations 506. Different types of model representations may be transformed or mapped to XGL representations. For each type of model representation, mapping rules may be provided for mapping the model representation to the XGL representation 506. Different mapping rules may be provided for mapping a model representation to an XGL representation.

This XGL representation 506 that is created from a model representation may then be used for processing in the runtime environment. For example, the XGL representation 506 may be used to generate a machine-executable runtime GUI (or some other runtime representation) that may be executed by a target device. As part of the runtime processing, the XGL representation 506 may be transformed into one or more runtime representations, which may indicate source code in a particular programming language, machine-executable code for a specific runtime environment, executable GUI, and so forth, which may be generated for specific runtime environments and devices. Since the XGL representation 506, rather than the design-time model representation, is used by the runtime environment, the design-time model representation is decoupled from the runtime environment. The XGL representation 506 can thus serve as the common ground or interface between design-time user interface modeling tools and a plurality of user interface runtime frameworks. It provides a self-contained, closed, and deterministic definition of all aspects of a graphical user interface in a device-independent and programming-language independent manner. Accordingly, abstract representation 506 generated for a model representation 502 is generally declarative and executable in that it provides a representation of the GUI of model representation 502 that is not dependent on any device or runtime platform, is not dependent on any programming language, and unambiguously encapsulates execution semantics for the GUI. The execution semantics may include, for example, identification of various components of the GUI, interpretation of connections between the various GUI components, information identifying the order of sequencing of events, rules governing dynamic behavior of the GUI, rules governing handling of values by the GUI, and the like. The abstract representation 506 is also not GUI runtime-platform specific. The abstract representation 506 provides a self-contained, closed, and deterministic definition of all aspects of a graphical user interface that is device independent and language independent.

Abstract representation 506 is such that the appearance and execution semantics of a GUI generated from the XGL representation work consistently on different target devices irrespective of the GUI capabilities of the target device and the target device platform. For example, the same XGL representation may be mapped to appropriate GUIs on devices of differing levels of GUI complexity (i.e., the same abstract representation may be used to generate a GUI for devices that support simple GUIs and for devices that can support complex GUIs), the GUI generated by the devices are consistent with each other in their appearance and behavior.

Abstract representation generator 504 may be configured to generate abstract representation 506 for models of different types, which may be created using different modeling tools 340. It will be understood that modeling environment 516 may include some, none, or other sub-modules or components as those shown in this example illustration. In other words, modeling environment 516 encompasses the design-time environment (with or without the abstract generator or the various representations), a modeling toolkit (such as 340) linked with a developer's space, or any other appropriate software operable to decouple models created during design-time from the runtime environment. Abstract representation 506 provides an interface between the design time environment and the runtime environment. As shown, this abstract representation 506 may then be used by runtime processing.

As part of runtime processing, modeling environment 516 may include various runtime tools 508 and may generate different types of runtime representations based upon the abstract representation 506. Examples of runtime representations include device or language-dependent (or specific) source code, runtime platform-specific machine-readable code, GUIs for a particular target device, and the like. The runtime tools 508 may include compilers, interpreters, source code generators, and other such tools that are configured to generate runtime platform-specific or target device-specific runtime representations of abstract representation 506. The runtime tool 508 may generate the runtime representation from abstract representation 506 using specific rules that map abstract representation 506 to a particular type of runtime representation. These mapping rules may be dependent on the type of runtime tool, characteristics of the target device to be used for displaying the GUI, runtime platform, and/or other factors. Accordingly, mapping rules may be provided for transforming the abstract representation 506 to any number of target runtime representations directed to one or more target GUI runtime platforms. For example, XGL-compliant code generators may conform to semantics of XGL, as described below. XGL-compliant code generators may ensure that the appearance and behavior of the generated user interfaces is preserved across a plurality of target GUI frameworks, while accommodating the differences in the intrinsic characteristics of each and also accommodating the different levels of capability of target devices.

For example, as depicted in example FIG. 5A, an XGL-to-Java compiler 508A may take abstract representation 506 as input and generate Java code 510 for execution by a target device comprising a Java runtime 512. Java runtime 512 may execute Java code 510 to generate or display a GUI 514 on a Java-platform target device. As another example, an XGL-to-Flash compiler 508B may take abstract representation 506 as input and generate Flash code 526 for execution by a target device comprising a Flash runtime 518. Flash runtime 518 may execute Flash code 516 to generate or display a GUI 520 on a target device comprising a Flash platform. As another example, an XGL-to-DHTML (dynamic HTML) interpreter 508C may take abstract representation 506 as input and generate DHTML statements (instructions) on the fly which are then interpreted by a DHTML runtime 522 to generate or display a GUI 524 on a target device comprising a DHTML platform.

It should be apparent that abstract representation 506 may be used to generate GUIs for Extensible Application Markup Language (XAML) or various other runtime platforms and devices. The same abstract representation 506 may be mapped to various runtime representations and device-specific and runtime platform-specific GUIs. In general, in the runtime environment, machine executable instructions specific to a runtime environment may be generated based upon the abstract representation 506 and executed to generate a GUI in the runtime environment. The same XGL representation may be used to generate machine executable instructions specific to different runtime environments and target devices.

According to certain embodiments, the process of mapping a model representation 502 to an abstract representation 506 and mapping an abstract representation 506 to some runtime representation may be automated. For example, design tools may automatically generate an abstract representation for the model representation using XGL and then use the XGL abstract representation to generate GUIs that are customized for specific runtime environments and devices. As previously indicated, mapping rules may be provided for mapping model representations to an XGL representation. Mapping rules may also be provided for mapping an XGL representation to a runtime platform-specific representation.

Since the runtime environment uses abstract representation 506 rather than model representation 502 for runtime processing, the model representation 502 that is created during design-time is decoupled from the runtime environment. Abstract representation 506 thus provides an interface between the modeling environment and the runtime environment. As a result, changes may be made to the design time environment, including changes to model representation 502 or changes that affect model representation 502, generally to not substantially affect or impact the runtime environment or tools used by the runtime environment. Likewise, changes may be made to the runtime environment generally to not substantially affect or impact the design time environment. A designer or other developer can thus concentrate on the design aspects and make changes to the design without having to worry about the runtime dependencies such as the target device platform or programming language dependencies.

FIG. 5B depicts an example process for mapping a model representation 502 to a runtime representation using the example modeling environment 516 of FIG. 5A or some other modeling environment. Model representation 502 may comprise one or more model components and associated properties that describe a data object, such as hosted business objects and interfaces. As described above, at least one of these model components is based on or otherwise associated with these hosted business objects and interfaces. The abstract representation 506 is generated based upon model representation 502. Abstract representation 506 may be generated by the abstract representation generator 504. Abstract representation 506 comprises one or more abstract GUI components and properties associated with the abstract GUI components. As part of generation of abstract representation 506, the model GUI components and their associated properties from the model representation are mapped to abstract GUI components and properties associated with the abstract GUI components. Various mapping rules may be provided to facilitate the mapping. The abstract representation encapsulates both appearance and behavior of a GUI. Therefore, by mapping model components to abstract components, the abstract representation not only specifies the visual appearance of the GUI but also the behavior of the GUI, such as in response to events whether clicking/dragging or scrolling, interactions between GUI components and such.

One or more runtime representations 550a, including GUIs for specific runtime environment platforms, may be generated from abstract representation 506. A device-dependent runtime representation may be generated for a particular type of target device platform to be used for executing and displaying the GUI encapsulated by the abstract representation. The GUIs generated from abstract representation 506 may comprise various types of GUI elements such as buttons, windows, scrollbars, input boxes, etc. Rules may be provided for mapping an abstract representation to a particular runtime representation. Various mapping rules may be provided for different runtime environment platforms.

Methods and systems consistent with the subject matter described herein provide and use interfaces 320 derived from the business object model 318 suitable for use with more than one business area, for example different departments within a company such as finance, or marketing. Also, they are suitable across industries and across businesses. Interfaces 320 are used during an end-to-end business transaction to transfer business process information in an application-independent manner. For example the interfaces can be used for fulfilling a sales order.

1. Message Overview

To perform an end-to-end business transaction, consistent interfaces are used to create business documents that are sent within messages between heterogeneous programs or modules.

a) Message Categories

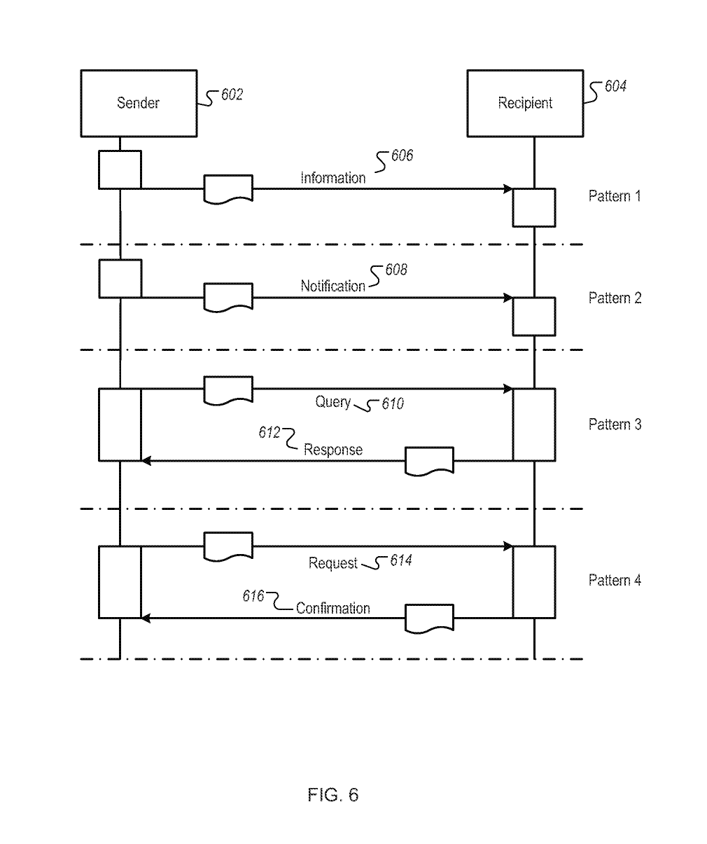

As depicted in FIG. 6, the communication between a sender 602 and a recipient 604 can be broken down into basic categories that describe the type of the information exchanged and simultaneously suggest the anticipated reaction of the recipient 604. A message category is a general business classification for the messages. Communication is sender-driven. In other words, the meaning of the message categories is established or formulated from the perspective of the sender 602. The message categories include information 606, notification 608, query 610, response 612, request 614, and confirmation 616.

(1) Information

Information 606 is a message sent from a sender 602 to a recipient 604 concerning a condition or a statement of affairs. No reply to information is expected. Information 606 is sent to make business partners or business applications aware of a situation. Information 606 is not compiled to be application-specific. Examples of “information” are an announcement, advertising, a report, planning information, and a message to the business warehouse.

(2) Notification

A notification 608 is a notice or message that is geared to a service. A sender 602 sends the notification 608 to a recipient 604. No reply is expected for a notification. For example, a billing notification relates to the preparation of an invoice while a dispatched delivery notification relates to preparation for receipt of goods.

(3) Query

A query 610 is a question from a sender 602 to a recipient 604 to which a response 612 is expected. A query 610 implies no assurance or obligation on the part of the sender 602. Examples of a query 610 are whether space is available on a specific flight or whether a specific product is available. These queries do not express the desire for reserving the flight or purchasing the product.

(4) Response

A response 612 is a reply to a query 610. The recipient 604 sends the response 612 to the sender 602. A response 612 generally implies no assurance or obligation on the part of the recipient 604. The sender 602 is not expected to reply. Instead, the process is concluded with the response 612. Depending on the business scenario, a response 612 also may include a commitment, i.e., an assurance or obligation on the part of the recipient 604. Examples of responses 612 are a response stating that space is available on a specific flight or that a specific product is available. With these responses, no reservation was made.

(5) Request

A request 614 is a binding requisition or requirement from a sender 602 to a recipient 604. Depending on the business scenario, the recipient 604 can respond to a request 614 with a confirmation 616. The request 614 is binding on the sender 602. In making the request 614, the sender 602 assumes, for example, an obligation to accept the services rendered in the request 614 under the reported conditions. Examples of a request 614 are a parking ticket, a purchase order, an order for delivery and a job application.

(6) Confirmation

A confirmation 616 is a binding reply that is generally made to a request 614. The recipient 604 sends the confirmation 616 to the sender 602. The information indicated in a confirmation 616, such as deadlines, products, quantities and prices, can deviate from the information of the preceding request 614. A request 614 and confirmation 616 may be used in negotiating processes. A negotiating process can consist of a series of several request 614 and confirmation 616 messages. The confirmation 616 is binding on the recipient 604. For example, 100 units of X may be ordered in a purchase order request; however, only the delivery of 80 units is confirmed in the associated purchase order confirmation.

b) Message Choreography

A message choreography is a template that specifies the sequence of messages between business entities during a given transaction. The sequence with the messages contained in it describes in general the message “lifecycle” as it proceeds between the business entities. If messages from a choreography are used in a business transaction, they appear in the transaction in the sequence determined by the choreography. This illustrates the template character of a choreography, i.e., during an actual transaction, it is not necessary for all messages of the choreography to appear. Those messages that are contained in the transaction, however, follow the sequence within the choreography. A business transaction is thus a derivation of a message choreography. The choreography makes it possible to determine the structure of the individual message types more precisely and distinguish them from one another.

2. Components of the Business Object Model The overall structure of the business object model ensures the consistency of the interfaces that are derived from the business object model. The derivation ensures that the same business-related subject matter or concept is represented and structured in the same way in all interfaces.

The business object model defines the business-related concepts at a central location for a number of business transactions. In other words, it reflects the decisions made about modeling the business entities of the real world acting in business transactions across industries and business areas. The business object model is defined by the business objects and their relationship to each other (the overall net structure).

Each business object is generally a capsule with an internal hierarchical structure, behavior offered by its operations, and integrity constraints. Business objects are semantically disjoint, i.e., the same business information is represented once. In the business object model, the business objects are arranged in an ordering framework. From left to right, they are arranged according to their existence dependency to each other. For example, the customizing elements may be arranged on the left side of the business object model, the strategic elements may be arranged in the center of the business object model, and the operative elements may be arranged on the right side of the business object model. Similarly, the business objects are arranged from the top to the bottom based on defined order of the business areas, e.g., finance could be arranged at the top of the business object model with CRM below finance and SRM below CRM.

To ensure the consistency of interfaces, the business object model may be built using standardized data types as well as packages to group related elements together, and package templates and entity templates to specify the arrangement of packages and entities within the structure.

a) Data Types

Data types are used to type object entities and interfaces with a structure. This typing can include business semantic. Such data types may include those generally described at pages 96 through 1642 (which are incorporated by reference herein) of U.S. patent application Ser. No. 11/803,178, filed on May 11, 2007 and entitled “Consistent Set Of Interfaces Derived From A Business Object Model”. For example, the data type BusinessTransactionDocumentID is a unique identifier for a document in a business transaction. Also, as an example, Data type BusinessTransactionDocumentParty contains the information that is exchanged in business documents about a party involved in a business transaction, and includes the party's identity, the party's address, the party's contact person and the contact person's address. BusinessTransactionDocumentParty also includes the role of the party, e.g., a buyer, seller, product recipient, or vendor.

The data types are based on Core Component Types (“CCTs”), which themselves are based on the World Wide Web Consortium (“W3C”) data types. “Global” data types represent a business situation that is described by a fixed structure. Global data types include both context-neutral generic data types (“GDTs”) and context-based context data types (“CDTs”). GDTs contain business semantics, but are application-neutral, i.e., without context. CDTs, on the other hand, are based on GDTs and form either a use-specific view of the GDTs, or a context-specific assembly of GDTs or CDTs. A message is typically constructed with reference to a use and is thus a use-specific assembly of GDTs and CDTs. The data types can be aggregated to complex data types.

To achieve a harmonization across business objects and interfaces, the same subject matter is typed with the same data type. For example, the data type “GeoCoordinates” is built using the data type “Measure” so that the measures in a GeoCoordinate (i.e., the latitude measure and the longitude measure) are represented the same as other “Measures” that appear in the business object model.

b) Entities

Entities are discrete business elements that are used during a business transaction. Entities are not to be confused with business entities or the components that interact to perform a transaction. Rather, “entities” are one of the layers of the business object model and the interfaces. For example, a Catalogue entity is used in a Catalogue Publication Request and a Purchase Order is used in a Purchase Order Request. These entities are created using the data types defined above to ensure the consistent representation of data throughout the entities.

c) Packages

Packages group the entities in the business object model and the resulting interfaces into groups of semantically associated information. Packages also may include “sub”-packages, i.e., the packages may be nested.

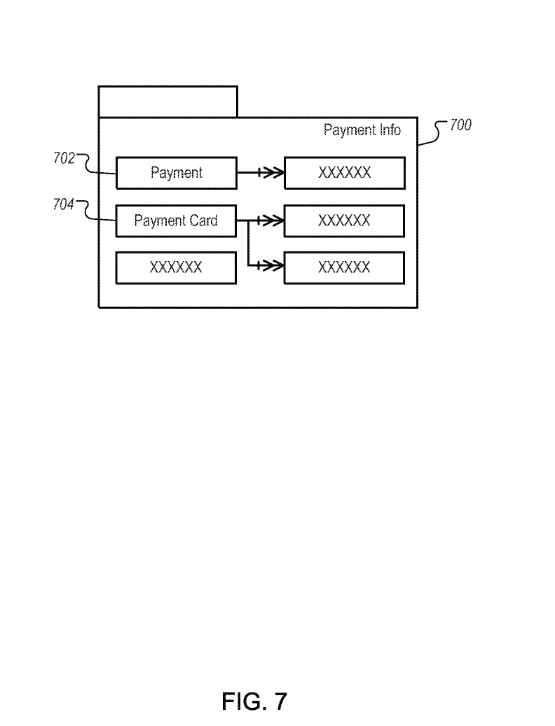

Packages may group elements together based on different factors, such as elements that occur together as a rule with regard to a business-related aspect. For example, as depicted in FIG. 7, in a Purchase Order, different information regarding the purchase order, such as the type of payment 702, and payment card 704, are grouped together via the PaymentInformation package 700.

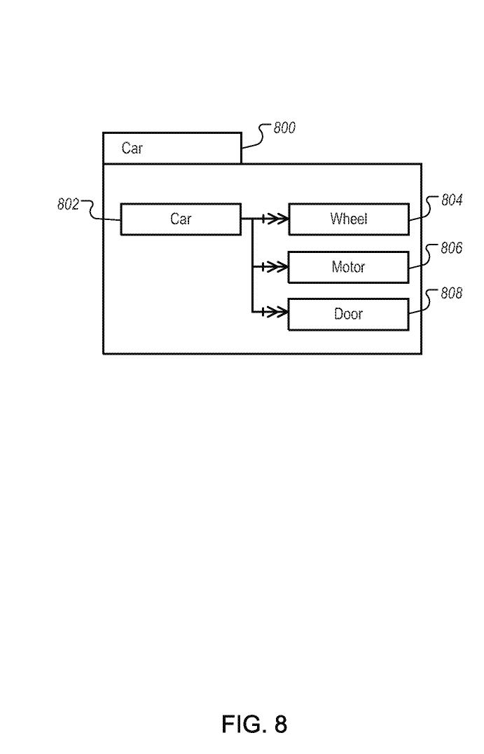

Packages also may combine different components that result in a new object. For example, as depicted in FIG. 8, the components wheels 804, motor 806, and doors 808 are combined to form a composition “Car” 802. The “Car” package 800 includes the wheels, motor and doors as well as the composition “Car.”

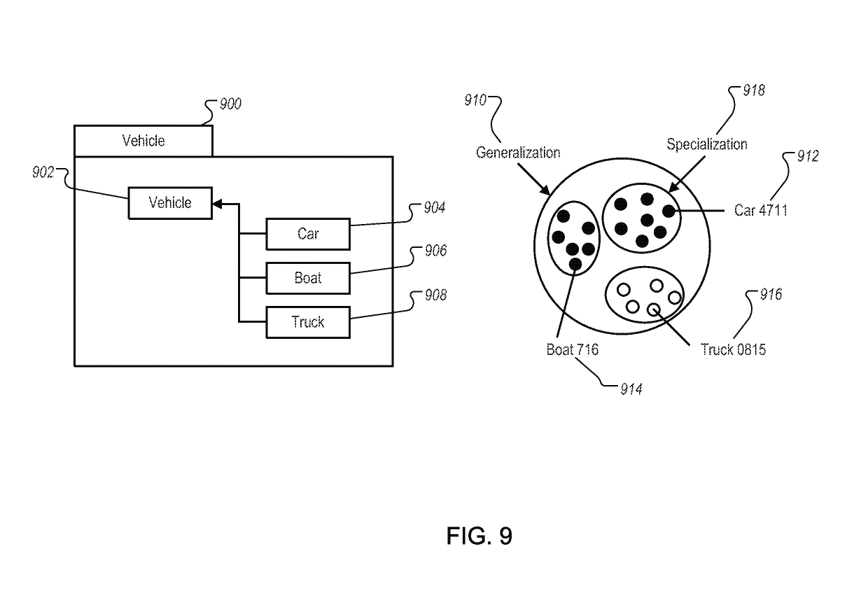

Another grouping within a package may be subtypes within a type. In these packages, the components are specialized forms of a generic package. For example, as depicted in FIG. 9, the components Car 904, Boat 906, and Truck 908 can be generalized by the generic term Vehicle 902 in Vehicle package 900. Vehicle in this case is the generic package 910, while Car 912, Boat 914, and Truck 916 are the specializations 918 of the generalized vehicle 910.

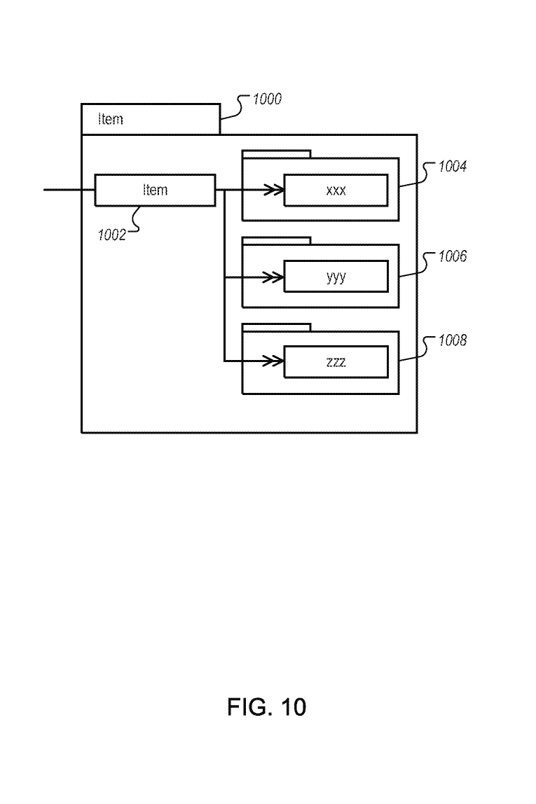

Packages also may be used to represent hierarchy levels. For example, as depicted in FIG. 10, the Item Package 1000 includes Item 1002 with subitem xxx 1004, subitem yyy 1006, and subitem zzz 1008.

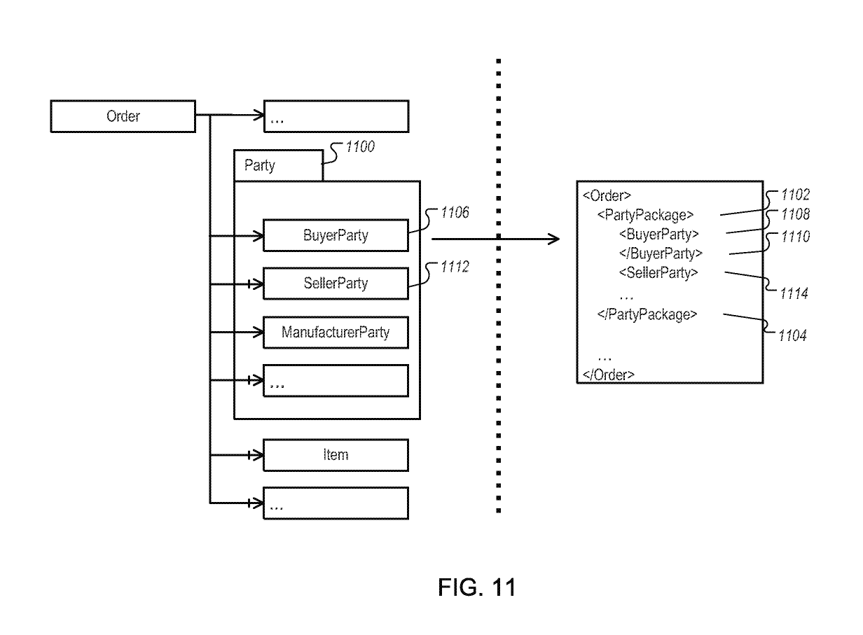

Packages can be represented in the XML schema as a comment. One advantage of this grouping is that the document structure is easier to read and is more understandable. The names of these packages are assigned by including the object name in brackets with the suffix “Package.” For example, as depicted in FIG. 11, Party package 1100 is enclosed by <PartyPackage> 1102 and </PartyPackage> 1104. Party package 1100 illustratively includes a Buyer Party 1106, identified by <BuyerParty> 1108 and </BuyerParty> 1110, and a Seller Party 1112, identified by <SellerParty> 1114 and </SellerParty>, etc.

d) Relationships

Relationships describe the interdependencies of the entities in the business object model, and are thus an integral part of the business object model.

(1) Cardinality of Relationships

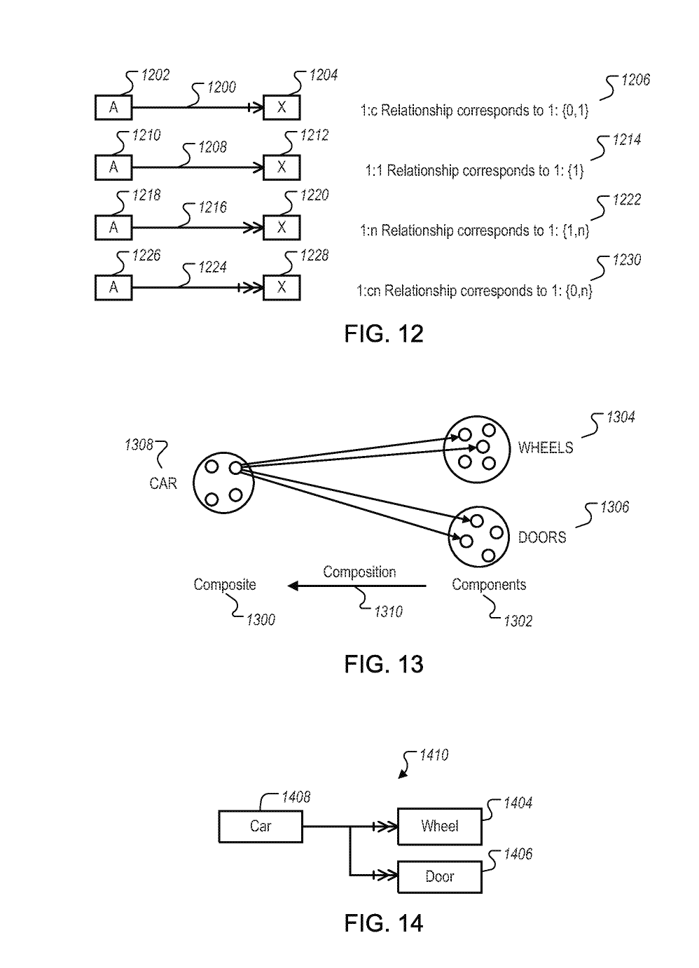

FIG. 12 depicts a graphical representation of the cardinalities between two entities. The cardinality between a first entity and a second entity identifies the number of second entities that could possibly exist for each first entity. Thus, a 1:c cardinality 1200 between entities A 1202 and X 1204 indicates that for each entity A 1202, there is either one or zero 1206 entity X 1204. A 1:1 cardinality 1208 between entities A 1210 and X 1212 indicates that for each entity A 1210, there is exactly one 1214 entity X 1212. A 1:n cardinality 1216 between entities A 1218 and X 1220 indicates that for each entity A 1218, there are one or more 1222 entity Xs 1220. A 1:cn cardinality 1224 between entities A 1226 and X 1228 indicates that for each entity A 1226, there are any number 1230 of entity Xs 1228 (i.e., 0 through n Xs for each A).

(2) Types of Relationships

(a) Composition

A composition or hierarchical relationship type is a strong whole-part relationship which is used to describe the structure within an object. The parts, or dependent entities, represent a semantic refinement or partition of the whole, or less dependent entity. For example, as depicted in FIG. 13, the components 1302, wheels 1304, and doors 1306 may be combined to form the composite 1300 “Car” 1308 using the composition 1310.

FIG. 14 depicts a graphical representation of the composition 1410 between composite Car 1408 and components wheel 1404 and door 1406.

(b) Aggregation

An aggregation or an aggregating relationship type is a weak whole-part relationship between two objects. The dependent object is created by the combination of one or several less dependent objects. For example, as depicted in FIG. 15, the properties of a competitor product 1500 are determined by a product 1502 and a competitor 1504. A hierarchical relationship 1506 exists between the product 1502 and the competitor product 1500 because the competitor product 1500 is a component of the product 1502. Therefore, the values of the attributes of the competitor product 1500 are determined by the product 1502. An aggregating relationship 1508 exists between the competitor 1504 and the competitor product 1500 because the competitor product 1500 is differentiated by the competitor 1504. Therefore the values of the attributes of the competitor product 1500 are determined by the competitor 1504.

(c) Association

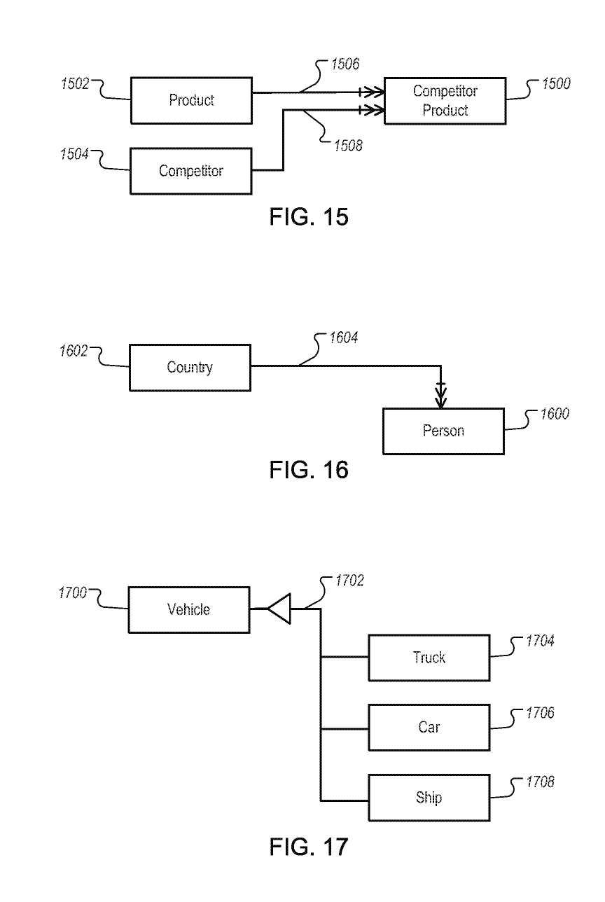

An association or a referential relationship type describes a relationship between two objects in which the dependent object refers to the less dependent object. For example, as depicted in FIG. 16, a person 1600 has a nationality, and thus, has a reference to its country 1602 of origin. There is an association 1604 between the country 1602 and the person 1600. The values of the attributes of the person 1600 are not determined by the country 1602.

(3) Specialization

Entity types may be divided into subtypes based on characteristics of the entity types. For example, FIG. 17 depicts an entity type “vehicle” 1700 specialized 1702 into subtypes “truck” 1704, “car” 1706, and “ship” 1708. These subtypes represent different aspects or the diversity of the entity type.

Subtypes may be defined based on related attributes. For example, although ships and cars are both vehicles, ships have an attribute, “draft,” that is not found in cars. Subtypes also may be defined based on certain methods that can be applied to entities of this subtype and that modify such entities. For example, “drop anchor” can be applied to ships. If outgoing relationships to a specific object are restricted to a subset, then a subtype can be defined which reflects this subset.

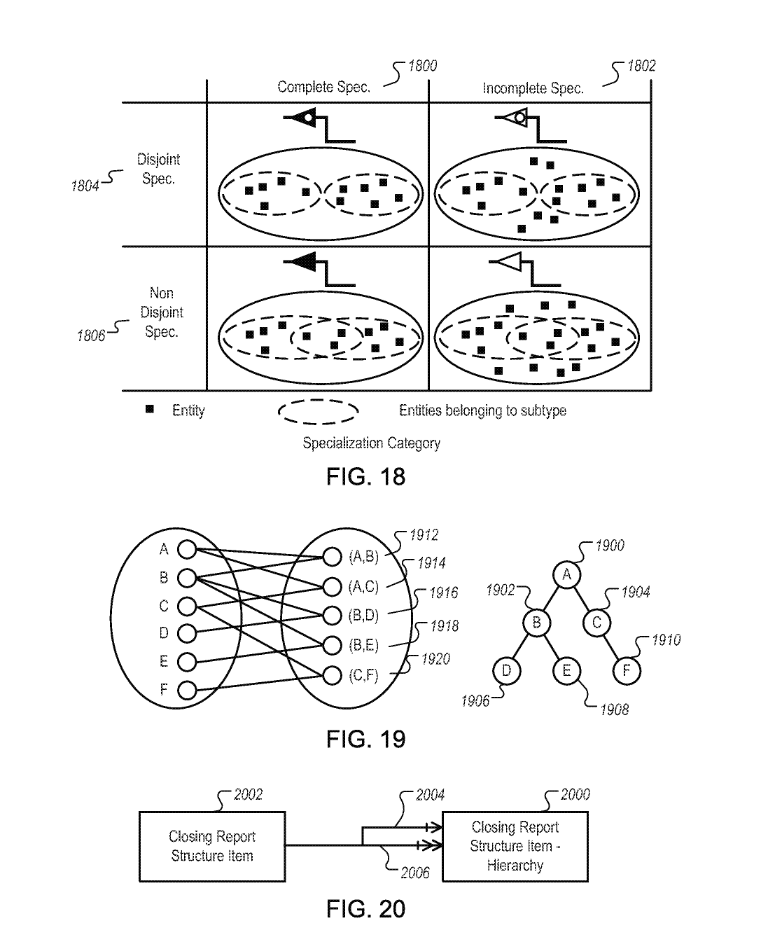

As depicted in FIG. 18, specializations may further be characterized as complete specializations 1800 or incomplete specializations 1802. There is a complete specialization 1800 where each entity of the generalized type belongs to at least one subtype. With an incomplete specialization 1802, there is at least one entity that does not belong to a subtype. Specializations also may be disjoint 1804 or nondisjoint 1806. In a disjoint specialization 1804, each entity of the generalized type belongs to a maximum of one subtype. With a nondisjoint specialization 1806, one entity may belong to more than one subtype. As depicted in FIG. 18, four specialization categories result from the combination of the specialization characteristics.

e) Structural Patterns

(1) Item

An item is an entity type which groups together features of another entity type. Thus, the features for the entity type chart of accounts are grouped together to form the entity type chart of accounts item. For example, a chart of accounts item is a category of values or value flows that can be recorded or represented in amounts of money in accounting, while a chart of accounts is a superordinate list of categories of values or value flows that is defined in accounting.

The cardinality between an entity type and its item is often either 1:n or 1:cn. For example, in the case of the entity type chart of accounts, there is a hierarchical relationship of the cardinality 1:n with the entity type chart of accounts item since a chart of accounts has at least one item in all cases.

(2) Hierarchy

A hierarchy describes the assignment of subordinate entities to superordinate entities and vice versa, where several entities of the same type are subordinate entities that have, at most, one directly superordinate entity. For example, in the hierarchy depicted in FIG. 19, entity B 1902 is subordinate to entity A 1900, resulting in the relationship (A,B) 1912. Similarly, entity C 1904 is subordinate to entity A 1900, resulting in the relationship (A,C) 1914. Entity D 1906 and entity E 1908 are subordinate to entity B 1902, resulting in the relationships (B,D) 1916 and (B,E) 1918, respectively. Entity F 1910 is subordinate to entity C 1904, resulting in the relationship (C,F) 1920.

Because each entity has at most one superordinate entity, the cardinality between a subordinate entity and its superordinate entity is 1:c. Similarly, each entity may have 0, 1 or many subordinate entities. Thus, the cardinality between a superordinate entity and its subordinate entity is 1:cn. FIG. 20 depicts a graphical representation of a Closing Report Structure Item hierarchy 2000 for a Closing Report Structure Item 2002. The hierarchy illustrates the 1:c cardinality 2004 between a subordinate entity and its superordinate entity, and the 1:cn cardinality 2006 between a superordinate entity and its subordinate entity.

3. Creation of the Business Object Model

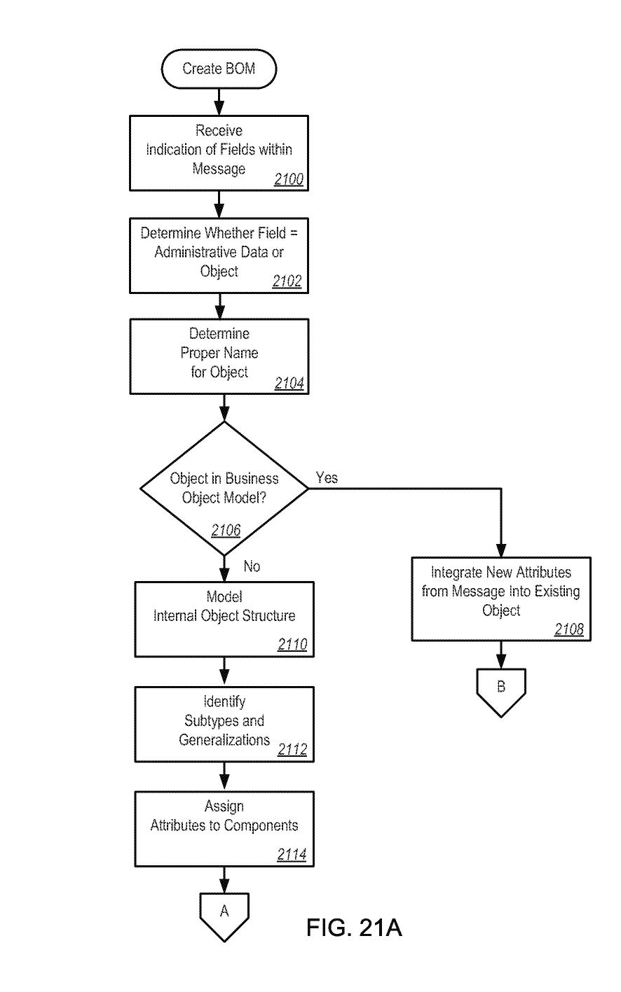

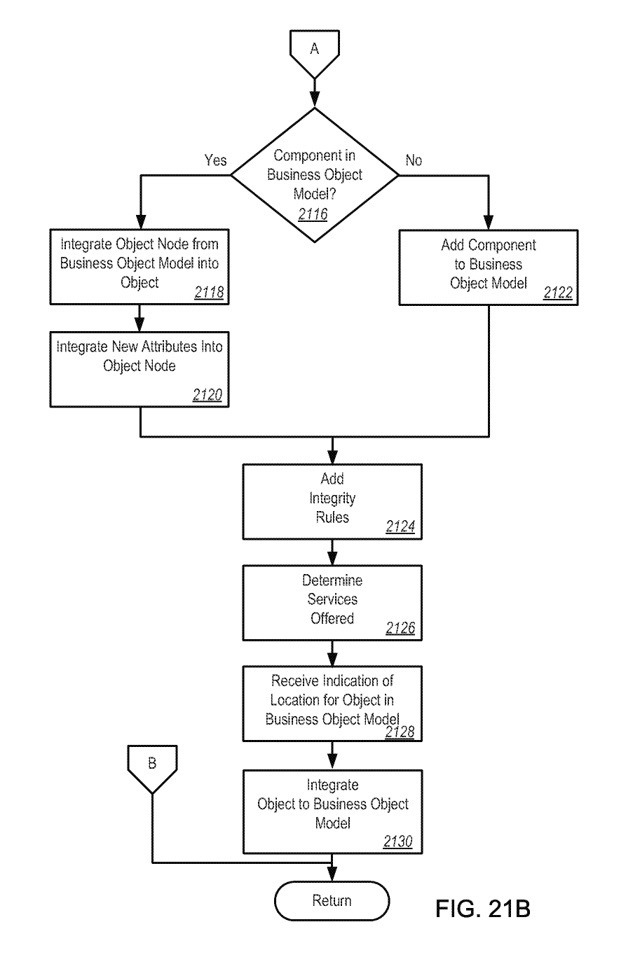

FIGS. 21A-B depict the steps performed using methods and systems consistent with the subject matter described herein to create a business object model. Although some steps are described as being performed by a computer, these steps may alternatively be performed manually, or computer-assisted, or any combination thereof. Likewise, although to some steps are described as being performed by a computer, these steps may also be computer-assisted, or performed manually, or any combination thereof.

As discussed above, the designers create message choreographies that specify the sequence of messages between business entities during a transaction. After identifying the messages, the developers identify the fields contained in one of the messages (step 2100, FIG. 21A). The designers then determine whether each field relates to administrative data or is part of the object (step 2102). Thus, the first eleven fields identified below in the left column are related to administrative data, while the remaining fields are part of the object.

| | |
|---|---|
| MessageID | Admin |
| ReferenceID | |
| CreationDate | |
| SenderID | |
| AdditionalSenderID | |
| ContactPersonID | |
| SenderAddress | |
| RecipientID | |
| AdditionalRecipientID | |
| ContactPersonID | |
| RecipientAddress | |
| ID | Main Object |
| AdditionalID | |
| PostingDate | |
| LastChangeDate | |
| AcceptanceStatus | |
| Note | |
| CompleteTransmission Indicator | |
| Buyer | |
| BuyerOrganisationName | |
| Person Name | |
| FunctionalTitle | |
| DepartmentName | |
| CountryCode | |
| StreetPostalCode | |
| POBox Postal Code | |
| Company Postal Code | |
| City Name | |
| DistrictName | |
| PO Box ID | |
| PO Box Indicator | |
| PO Box Country Code | |
| PO Box Region Code | |
| PO Box City Name | |
| Street Name | |
| House ID | |
| Building ID | |
| Floor ID | |
| Room ID | |
| Care Of Name | |
| AddressDescription | |
| Telefonnumber | |
| MobileNumber | |
| Facsimile | |
| Email | |
| Seller | |
| SellerAddress | |
| Location | |
| LocationType | |
| DeliveryItemGroupID | |
| DeliveryPriority | |
| DeliveryCondition | |
| TransferLocation | |
| NumberofPartialDelivery | |
| QuantityTolerance | |
| MaximumLeadTime | |
| TransportServiceLevel | |
| TranportCondition | |
| TransportDescription | |
| CashDiscountTerms | |
| PaymentForm | |
| PaymentCardID | |
| PaymentCardReferenceID | |
| SequenceID | |
| Holder | |
| ExpirationDate | |
| AttachmentID | |
| AttachmentFilename | |
| DescriptionofMessage | |
| ConfirmationDescriptionof Message | |
| FollowUpActivity | |
| ItemID | |
| ParentItemID | |
| HierarchyType | |
| ProductID | |
| ProductType | |
| ProductNote | |
| ProductCategoryID | |
| Amount | |
| BaseQuantity | |
| ConfirmedAmount | |
| ConfirmedBaseQuantity | |
| ItemBuyer | |
| ItemBuyerOrganisationName | |
| Person Name | |
| FunctionalTitle | |
| DepartmentName | |
| CountryCode | |
| StreetPostalCode | |
| POBox Postal Code | |
| Company Postal Code | |
| City Name | |
| DistrictName | |
| PO Box ID | |
| PO Box Indicator | |
| PO Box Country Code | |
| PO Box Region Code | |
| PO Box City Name | |
| Street Name | |
| House ID | |
| Building ID | |
| Floor ID | |
| Room ID | |
| Care Of Name | |
| AddressDescription | |
| Telefonnumber | |
| MobilNumber | |
| Facsimile | |
| Email | |
| ItemSeller | |
| ItemSellerAddress | |
| ItemLocation | |
| ItemLocationType | |
| ItemDeliveryItemGroupID | |
| ItemDeliveryPriority | |
| ItemDeliveryCondition | |
| ItemTransferLocation | |
| ItemNumberofPartialDelivery | |
| ItemQuantityTolerance | |
| ItemMaximumLeadTime | |
| ItemTransportServiceLevel | |
| ItemTranportCondition | |
| ItemTransportDescription | |
| ContractReference | |
| QuoteReference | |
| CatalogueReference | |
| ItemAttachmentID | |
| ItemAttachmentFilename | |
| ItemDescription | |
| ScheduleLineID | |
| DeliveryPeriod | |
| Quantity | |
| ConfirmedScheduleLineID | |
| ConfirmedDeliveryPeriod | |
| ConfirmedQuantity | |

Next, the designers determine the proper name for the object according to the ISO 11179 naming standards (step 2104). In the example above, the proper name for the “Main Object” is “Purchase Order.” After naming the object, the system that is creating the business object model determines whether the object already exists in the business object model (step 2106). If the object already exists, the system integrates new attributes from the message into the existing object (step 2108), and the process is complete.

If at step 2106 the system determines that the object does not exist in the business object model, the designers model the internal object structure (step 2110). To model the internal structure, the designers define the components. For the above example, the designers may define the components identified below.

| | | | |
|---|---|---|---|
| ID | Pur- | | |
| AdditionalID | chase | | |
| PostingDate | Order | | |
| LastChangeDate | | | |
| AcceptanceStatus | | | |
| Note | | | |
| CompleteTransmission | | | |
| Indicator | | | |
| Buyer | | Buyer | |
| BuyerOrganisationName | | | |
| Person Name | | | |
| FunctionalTitle | | | |
| DepartmentName | | | |
| CountryCode | | | |
| StreetPostalCode | | | |
| POBox Postal Code | | | |
| Company Postal Code | | | |
| City Name | | | |
| DistrictName | | | |
| PO Box ID | | | |
| PO Box Indicator | | | |
| PO Box Country Code | | | |
| PO Box Region Code | | | |
| PO Box City Name | | | |
| Street Name | | | |
| House ID | | | |
| Building ID | | | |
| Floor ID | | | |
| Room ID | | | |
| Care Of Name | | | |
| AddressDescription | | | |
| Telefonnumber | | | |
| MobileNumber | | | |
| Facsimile | | | |
| Email | | | |
| Seller | | Seller | |
| SellerAddress | | | |
| Location | | Location | |
| LocationType | | | |
| DeliveryItemGroupID | | DeliveryTerms | |
| DeliveryPriority | | | |
| DeliveryCondition | | | |
| TransferLocation | | | |
| NumberofPartialDelivery | | | |
| QuantityTolerance | | | |
| MaximumLeadTime | | | |
| TransportServiceLevel | | | |
| TranportCondition | | | |
| TransportDescription | | | |
| CashDiscountTerms | | | |
| PaymentForm | | Payment | |
| PaymentCardID | | | |
| PaymentCardReferenceID | | | |
| SequenceID | | | |
| Holder | | | |
| ExpirationDate | | | |
| AttachmentID | | | |
| AttachmentFilename | | | |
| DescriptionofMessage | | | |
| ConfirmationDescriptionof | | | |
| Message | | | |
| FollowUpActivity | | | |
| ItemID | | Purchase Order | |
| ParentItemID | | Item | |
| HierarchyType | | | |
| ProductID | | | Product |
| ProductType | | | |
| ProductNote | | | |
| ProductCategoryID | | | ProductCategory |
| Amount | | | |
| BaseQuantity | | | |
| ConfirmedAmount | | | |
| ConfirmedBaseQuantity | | | |
| ItemBuyer | | | Buyer |
| ItemBuyerOrganisation | | | |
| Name | | | |
| Person Name | | | |
| FunctionalTitle | | | |
| DepartmentName | | | |
| CountryCode | | | |
| StreetPostalCode | | | |
| POBox Postal Code | | | |
| Company Postal Code | | | |
| City Name | | | |
| DistrictName | | | |
| PO Box ID | | | |
| PO Box Indicator | | | |
| PO Box Country Code | | | |
| PO Box Region Code | | | |
| PO Box City Name | | | |
| Street Name | | | |
| House ID | | | |
| Building ID | | | |
| Floor ID | | | |
| Room ID | | | |
| Care Of Name | | | |
| AddressDescription | | | |
| Telefonnumber | | | |
| MobilNumber | | | |
| Facsimile | | | |
| Email | | | |
| ItemSeller | | | Seller |
| ItemSellerAddress | | | |
| ItemLocation | | | Location |
| ItemLocationType | | | |
| ItemDeliveryItemGroupID | | | |
| ItemDeliveryPriority | | | |
| ItemDeliveryCondition | | | |
| ItemTransferLocation | | | |
| ItemNumberofPartial | | | |
| Delivery | | | |
| ItemQuantityTolerance | | | |
| ItemMaximumLeadTime | | | |
| ItemTransportServiceLevel | | | |
| ItemTranportCondition | | | |
| ItemTransportDescription | | | |
| ContractReference | | | Contract |
| QuoteReference | | | Quote |
| CatalogueReference | | | Catalogue |
| ItemAttachmentID | | | |
| ItemAttachmentFilename | | | |
| ItemDescription | | | |
| ScheduleLineID | | | |
| DeliveryPeriod | | | |
| Quantity | | | |
| ConfirmedScheduleLineID | | | |
| ConfirmedDeliveryPeriod | | | |
| ConfirmedQuantity | | | |

During the step of modeling the internal structure, the designers also model the complete internal structure by identifying the compositions of the components and the corresponding cardinalities, as shown below.

| | | | | |
|---|---|---|---|---|
| PurchaseOrder | | | | 1 |
| | Buyer | | | 0 . . . 1 |
| | | Address | | 0 . . . 1 |
| | | ContactPerson | | 0 . . . 1 |
| | | | Address | 0 . . . 1 |
| | Seller | | | 0 . . . 1 |
| | Location | | | 0 . . . 1 |
| | | Address | | 0 . . . 1 |
| | DeliveryTerms | | | 0 . . . 1 |
| | | Incoterms | | 0 . . . 1 |
| | | PartialDelivery | | 0 . . . 1 |
| | | QuantityTolerance | | 0 . . . 1 |
| | | Transport | | 0 . . . 1 |
| | CashDiscount | | | 0 . . . 1 |
| | Terms | | | |
| | | MaximumCashDiscount | | 0 . . . 1 |
| | | NormalCashDiscount | | 0 . . . 1 |
| | PaymentForm | | | 0 . . . 1 |
| | | PaymentCard | | 0 . . . 1 |
| | Attachment | | | 0 . . . n |
| | Description | | | 0 . . . 1 |
| | Confirmation | | | 0 . . . 1 |
| | Description | | | |
| | Item | | | 0 . . . n |
| | | HierarchyRelationship | | 0 . . . 1 |
| | | Product | | 0 . . . 1 |
| | | ProductCategory | | 0 . . . 1 |
| | | Price | | 0 . . . 1 |
| | | | NetunitPrice | 0 . . . 1 |
| | | ConfirmedPrice | | 0 . . . 1 |
| | | | NetunitPrice | 0 . . . 1 |
| | | Buyer | | 0 . . . 1 |
| | | Seller | | 0 . . . 1 |
| | | Location | | 0 . . . 1 |
| | | DeliveryTerms | | 0 . . . 1 |
| | | Attachment | | 0 . . . n |
| | | Description | | 0 . . . 1 |
| | | ConfirmationDescription | | 0 . . . 1 |
| | | ScheduleLine | | 0 . . . n |
| | | | DeliveryPeriod | 1 |
| | | ConfirmedScheduleLine | | 0 . . . n |

After modeling the internal object structure, the developers identify the subtypes and generalizations for all objects and components (step 2112). For example, the Purchase Order may have subtypes Purchase Order Update, Purchase Order Cancellation and Purchase Order Information. Purchase Order Update may include Purchase Order Request, Purchase Order Change, and Purchase Order Confirmation. Moreover, Party may be identified as the generalization of Buyer and Seller. The subtypes and generalizations for the above example are shown below.

| | | | | | |
|---|---|---|---|---|---|
| Purchase | | | | | 1 |
| Order | | | | | |
| | PurchaseOrder | | | | |
| | Update | | | | |
| | | PurchaseOrder Request | | | |
| | | PurchaseOrder Change | | | |
| | | PurchaseOrder | | | |
| | | Confirmation | | | |
| | PurchaseOrder | | | | |
| | Cancellation | | | | |
| | PurchaseOrder | | | | |
| | Information | | | | |
| | Party | | | | |
| | | BuyerParty | | | 0 . . . 1 |
| | | | Address | | 0 . . . 1 |
| | | | ContactPerson | | 0 . . . 1 |
| | | | | Address | 0 . . . 1 |
| | | SellerParty | | | 0 . . . 1 |
| | Location | | | | |
| | | ShipToLocation | | | 0 . . . 1 |
| | | | Address | | 0 . . . 1 |
| | | ShipFromLocation | | | 0 . . . 1 |
| | | | Address | | 0 . . . 1 |
| | DeliveryTerms | | | | 0 . . . 1 |
| | | Incoterms | | | 0 . . . 1 |
| | | PartialDelivery | | | 0 . . . 1 |
| | | QuantityTolerance | | | 0 . . . 1 |
| | | Transport | | | 0 . . . 1 |
| | CashDiscount | | | | 0 . . . 1 |
| | Terms | | | | |
| | | MaximumCash Discount | | | 0 . . . 1 |
| | | NormalCashDiscount | | | 0 . . . 1 |
| | PaymentForm | | | | 0 . . . 1 |
| | | PaymentCard | | | 0 . . . 1 |
| | Attachment | | | | 0 . . . n |
| | Description | | | | 0 . . . 1 |
| | Confirmation | | | | 0 . . . 1 |
| | Description | | | | |
| | Item | | | | 0 . . . n |
| | | HierarchyRelationship | | | 0 . . . 1 |
| | | Product | | | 0 . . . 1 |
| | | ProductCategory | | | 0 . . . 1 |
| | | Price | | | 0 . . . 1 |
| | | | NetunitPrice | | 0 . . . 1 |
| | | ConfirmedPrice | | | 0 . . . 1 |
| | | | NetunitPrice | | 0 . . . 1 |
| | | Party | | | |
| | | | BuyerParty | | 0 . . . 1 |
| | | | SellerParty | | 0 . . . 1 |
| | | Location | | | |
| | | | ShipTo | | 0 . . . 1 |
| | | | Location | | |
| | | | ShipFrom | | 0 . . . 1 |
| | | | Location | | |
| | | DeliveryTerms | | | 0 . . . 1 |
| | | Attachment | | | 0 . . . n |
| | | Description | | | 0 . . . 1 |
| | | Confirmation | | | 0 . . . 1 |
| | | Description | | | |
| | | ScheduleLine | | | 0 . . . n |
| | | | Delivery | | 1 |
| | | | Period | | |
| | | ConfirmedScheduleLine | | | 0 . . . n |

After identifying the subtypes and generalizations, the developers assign the attributes to these components (step 2114). The attributes for a portion of the components are shown below.

| | | | | |
|---|---|---|---|---|
| Purchase | | | | 1 |
| Order | | | | |
| | ID | | | 1 |
| | SellerID | | | 0 . . . 1 |
| | BuyerPosting | | | 0 . . . 1 |
| | DateTime | | | |
| | BuyerLast | | | 0 . . . 1 |
| | ChangeDate | | | |
| | Time | | | |
| | SellerPosting | | | 0 . . . 1 |
| | DateTime | | | |
| | SellerLast | | | 0 . . . 1 |
| | ChangeDate | | | |
| | Time | | | |
| | Acceptance | | | 0 . . . 1 |
| | StatusCode | | | |
| | Note | | | 0 . . . 1 |
| | ItemList | | | 0 . . . 1 |
| | Complete | | | |
| | Transmission | | | |
| | Indicator | | | |
| | BuyerParty | | | 0 . . . 1 |
| | | StandardID | | 0 . . . n |
| | | BuyerID | | 0 . . . 1 |
| | | SellerID | | 0 . . . 1 |
| | | Address | | 0 . . . 1 |
| | | ContactPerson | | 0 . . . 1 |
| | | | BuyerID | 0 . . . 1 |
| | | | SellerID | 0 . . . 1 |
| | | | Address | 0 . . . 1 |
| | SellerParty | | | 0 . . . 1 |
| | Product | | | 0 . . . 1 |
| | RecipientParty | | | |
| | VendorParty | | | 0 . . . 1 |
| | Manufacturer | | | 0 . . . 1 |
| | Party | | | |
| | BillToParty | | | 0 . . . 1 |
| | PayerParty | | | 0 . . . 1 |
| | CarrierParty | | | 0 . . . 1 |
| | ShipTo | | | 0 . . . 1 |
| | Location | | | |
| | | StandardID | | 0 . . . n |
| | | BuyerID | | 0 . . . 1 |
| | | SellerID | | 0 . . . 1 |
| | | Address | | 0 . . . 1 |
| | ShipFrom | | | 0 . . . 1 |
| | Location | | | |

The system then determines whether the component is one of the object nodes in the business object model (step 2116, FIG. 21B). If the system determines that the component is one of the object nodes in the business object model, the system integrates a reference to the corresponding object node from the business object model into the object (step 2118). In the above example, the system integrates the reference to the Buyer party represented by an ID and the reference to the ShipToLocation represented by an into the object, as shown below. The attributes that were formerly located in the PurchaseOrder object are now assigned to the new found object party. Thus, the attributes are removed from the PurchaseOrder object.

| | | |
|---|---|---|
| PurchaseOrder | | |
| | ID | |
| | SellerID | |
| | BuyerPostingDateTime | |
| | BuyerLastChangeDateTime | |
| | SellerPostingDateTime | |
| | SellerLastChangeDateTime | |
| | AcceptanceStatusCode | |
| | Note | |
| | ItemListComplete | |
| | TransmissionIndicator | |
| | BuyerParty | |
| | | ID |
| | SellerParty | |
| | ProductRecipientParty | |
| | VendorParty | |
| | ManufacturerParty | |
| | BillToParty | |
| | PayerParty | |
| | CarrierParty | |
| | ShipToLocation | |
| | | ID |
| | ShipFromLocation | |

During the integration step, the designers classify the relationship (i.e., aggregation or association) between the object node and the object being integrated into the business object model. The system also integrates the new attributes into the object node (step 2120). If at step 2116, the system determines that the component is not in the business object model, the system adds the component to the business object model (step 2122).

Regardless of whether the component was in the business object model at step 2116, the next step in creating the business object model is to add the integrity rules (step 2124). There are several levels of integrity rules and constraints which should be described. These levels include consistency rules between attributes, consistency rules between components, and consistency rules to other objects. Next, the designers determine the services offered, which can be accessed via interfaces (step 2126). The services offered in the example above include PurchaseOrderCreateRequest, PurchaseOrderCancellationRequest, and PurchaseOrderReleaseRequest. The system then receives an indication of the location for the object in the business object model (step 2128). After receiving the indication of the location, the system integrates the object into the business object model (step 2130).

4. Structure of the Business Object Model

The business object model, which serves as the basis for the process of generating consistent interfaces, includes the elements contained within the interfaces. These elements are arranged in a hierarchical structure within the business object model.

5. Interfaces Derived from Business Object Model

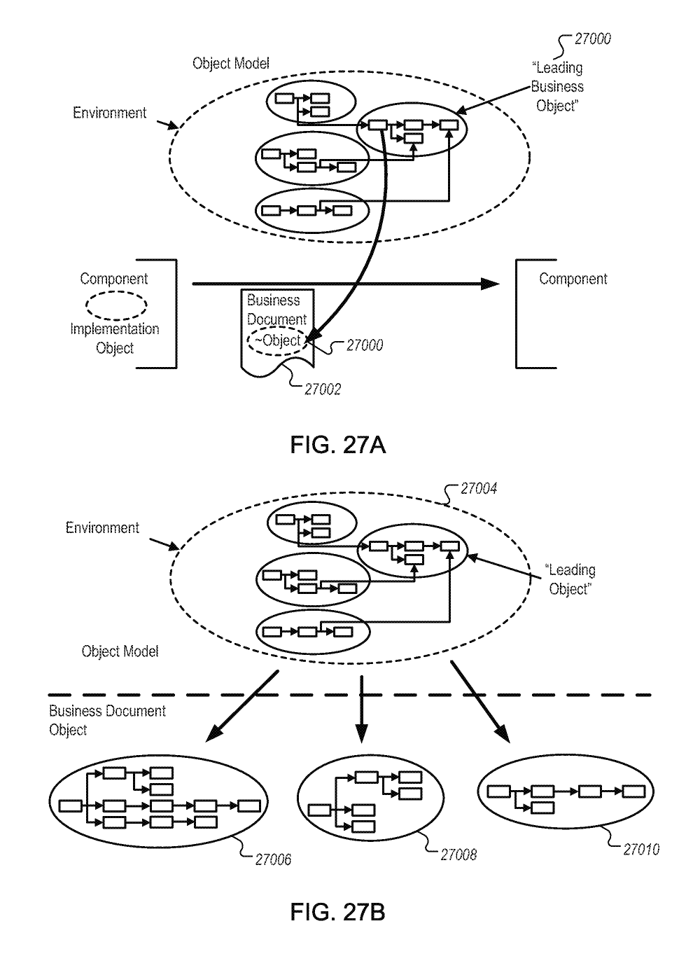

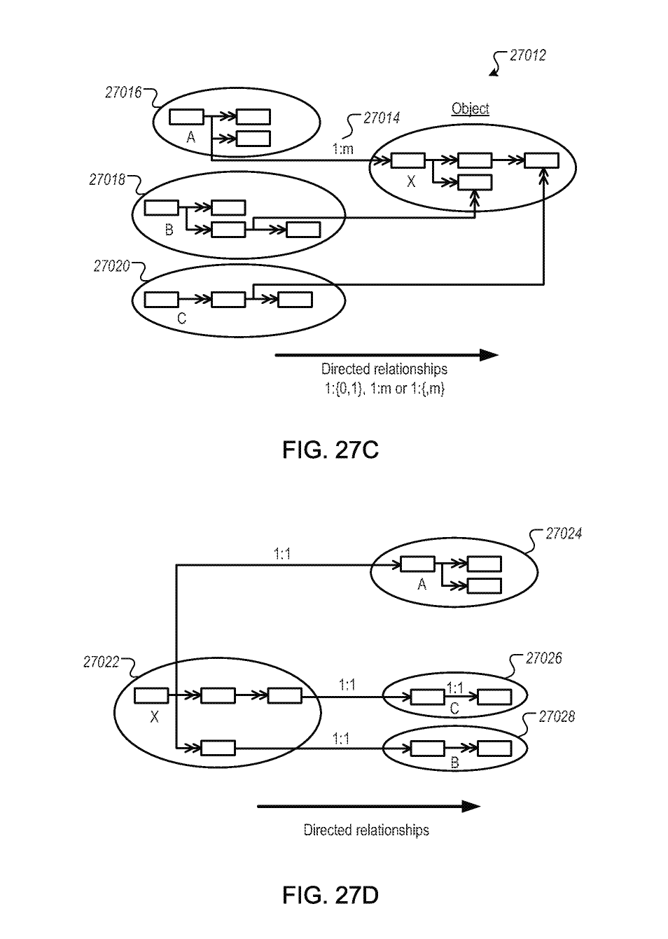

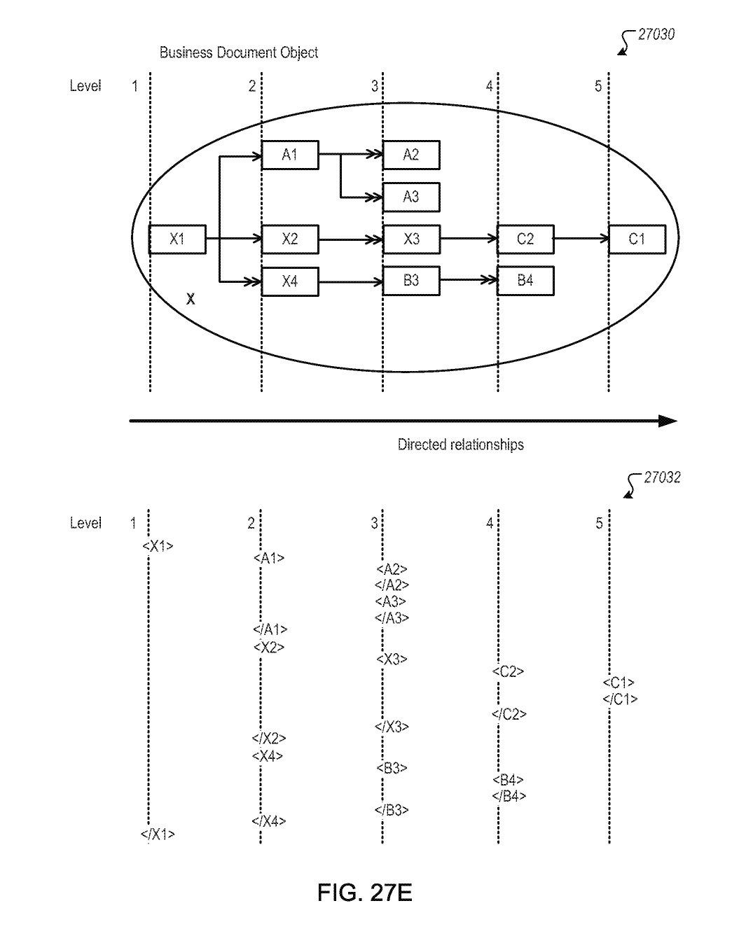

Interfaces are the starting point of the communication between two business entities. The structure of each interface determines how one business entity communicates with another business entity. The business entities may act as a unified whole when, based on the business scenario, the business entities know what an interface contains from a business perspective and how to fill the individual elements or fields of the interface. As illustrated in FIG. 27A, communication between components takes place via messages that contain business documents (e.g., business document 27002). The business document 27002 ensures a holistic business-related understanding for the recipient of the message. The business documents are created and accepted or consumed by interfaces, specifically by inbound and outbound interfaces. The interface structure and, hence, the structure of the business document are derived by a mapping rule. This mapping rule is known as “hierarchization.” An interface structure thus has a hierarchical structure created based on the leading business object 27000. The interface represents a usage-specific, hierarchical view of the underlying usage-neutral object model.

As illustrated in FIG. 27B, several business document objects 27006, 27008, and 27010 as overlapping views may be derived for a given leading object 27004. Each business document object results from the object model by hierarchization.

To illustrate the hierarchization process, FIG. 27C depicts an example of an object model 27012 (i.e., a portion of the business object model) that is used to derive a service operation signature (business document object structure). As depicted, leading object X 27014 in the object model 27012 is integrated in a net of object A 27016, object B 27018, and object C 27020. Initially, the parts of the leading object 27014 that are required for the business object document are adopted. In one variation, all parts required for a business document object are adopted from leading object 27014 (making such an operation a maximal service operation). Based on these parts, the relationships to the superordinate objects (i.e., objects A, B, and C from which object X depends) are inverted. In other words, these objects are adopted as dependent or subordinate objects in the new business document object.

For example, object A 27016, object B 27018, and object C 27020 have information that characterize object X. Because object A 27016, object B 27018, and object C 27020 are superordinate to leading object X 27014, the dependencies of these relationships change so that object A 27016, object B 27018, and object C 27020 become dependent and subordinate to leading object X 27014. This procedure is known as “derivation of the business document object by hierarchization.”

Business-related objects generally have an internal structure (parts). This structure can be complex and reflect the individual parts of an object and their mutual dependency. When creating the operation signature, the internal structure of an object is strictly hierarchized. Thus, dependent parts keep their dependency structure, and relationships between the parts within the object that do not represent the hierarchical structure are resolved by prioritizing one of the relationships.

Relationships of object X to external objects that are referenced and whose information characterizes object X are added to the operation signature. Such a structure can be quite complex (see, for example, FIG. 27D). The cardinality to these referenced objects is adopted as 1:1 or 1:C, respectively. By this, the direction of the dependency changes. The required parts of this referenced object are adopted identically, both in their cardinality and in their dependency arrangement.

The newly created business document object contains all required information, including the incorporated master data information of the referenced objects. As depicted in FIG. 27D, components Xi in leading object X 27022 are adopted directly. The relationship of object X 27022 to object A 27024, object B 27028, and object C 27026 are inverted, and the parts required by these objects are added as objects that depend from object X 27022. As depicted, all of object A 27024 is adopted. B3 and B4 are adopted from object B 27028, but B1 is not adopted. From object C 27026, C2 and C1 are adopted, but C3 is not adopted.

FIG. 27E depicts the business document object X 27030 created by this hierarchization process. As shown, the arrangement of the elements corresponds to their dependency levels, which directly leads to a corresponding representation as an XML structure 27032.

The following provides certain rules that can be adopted singly or in combination with regard to the hierarchization process. A business document object always refers to a leading business document object and is derived from this object. The name of the root entity in the business document entity is the name of the business object or the name of a specialization of the business object or the name of a service specific view onto the business object. The nodes and elements of the business object that are relevant (according to the semantics of the associated message type) are contained as entities and elements in the business document object.

The name of a business document entity is predefined by the name of the corresponding business object node. The name of the superordinate entity is not repeated in the name of the business document entity. The “full” semantic name results from the concatenation of the entity names along the hierarchical structure of the business document object.

The structure of the business document object is, except for deviations due to hierarchization, the same as the structure of the business object. The cardinalities of the business document object nodes and elements are adopted identically or more restrictively to the business document object. An object from which the leading business object is dependent can be adopted to the business document object. For this arrangement, the relationship is inverted, and the object (or its parts, respectively) are hierarchically subordinated in the business document object.

Nodes in the business object representing generalized business information can be adopted as explicit entities to the business document object (generally speaking, multiply TypeCodes out). When this adoption occurs, the entities are named according to their more specific semantic (name of TypeCode becomes prefix). Party nodes of the business object are modeled as explicit entities for each party role in the business document object. These nodes are given the name <Prefix><Party Role>Party, for example, BuyerParty, ItemBuyerParty. BTDReference nodes are modeled as separate entities for each reference type in the business document object. These nodes are given the name <Qualifier><BO><Node>Reference, for example SalesOrderReference, OriginSalesOrderReference, SalesOrderItemReference. A product node in the business object comprises all of the information on the Product, ProductCategory, and Batch. This information is modeled in the business document object as explicit entities for Product, ProductCategory, and Batch.

Entities which are connected by a 1:1 relationship as a result of hierarchization can be combined to a single entity, if they are semantically equivalent. Such a combination can often occurs if a node in the business document object that results from an assignment node is removed because it does not have any elements.

The message type structure is typed with data types. Elements are typed by GDTs according to their business objects. Aggregated levels are typed with message type specific data types (Intermediate Data Types), with their names being built according to the corresponding paths in the message type structure. The whole message type structured is typed by a message data type with its name being built according to the root entity with the suffix “Message”. For the message type, the message category (e.g., information, notification, query, response, request, confirmation, etc.) is specified according to the suited transaction communication pattern.

In one variation, the derivation by hierarchization can be initiated by specifying a leading business object and a desired view relevant for a selected service operation. This view determines the business document object. The leading business object can be the source object, the target object, or a third object. Thereafter, the parts of the business object required for the view are determined. The parts are connected to the root node via a valid path along the hierarchy. Thereafter, one or more independent objects (object parts, respectively) referenced by the leading object which are relevant for the service may be determined (provided that a relationship exists between the leading object and the one or more independent objects).

Once the selection is finalized, relevant nodes of the leading object node that are structurally identical to the message type structure can then be adopted. If nodes are adopted from independent objects or object parts, the relationships to such independent objects or object parts are inverted. Linearization can occur such that a business object node containing certain TypeCodes is represented in the message type structure by explicit entities (an entity for each value of the TypeCode). The structure can be reduced by checking all 1:1 cardinalities in the message type structure. Entities can be combined if they are semantically equivalent, one of the entities carries no elements, or an entity solely results from an n:m assignment in the business object.

After the hierarchization is completed, information regarding transmission of the business document object (e.g., CompleteTransmissionIndicator, ActionCodes, message category, etc.) can be added. A standardized message header can be added to the message type structure and the message structure can be typed. Additionally, the message category for the message type can be designated.

Invoice Request and Invoice Confirmation are examples of interfaces. These invoice interfaces are used to exchange invoices and invoice confirmations between an invoicing party and an invoice recipient (such as between a seller and a buyer) in a B2B process. Companies can create invoices in electronic as well as in paper form. Traditional methods of communication, such as mail or fax, for invoicing are cost intensive, prone to error, and relatively slow, since the data is recorded manually. Electronic communication eliminates such problems. The motivating business scenarios for the Invoice Request and Invoice Confirmation interfaces are the Procure to Stock (PTS) and Sell from Stock (SFS) scenarios. In the PTS scenario, the parties use invoice interfaces to purchase and settle goods. In the SFS scenario, the parties use invoice interfaces to sell and invoice goods. The invoice interfaces directly integrate the applications implementing them and also form the basis for mapping data to widely-used XML standard formats such as RosettaNet, PIDX, xCBL, and CIDX.

The invoicing party may use two different messages to map a B2B invoicing process: (1) the invoicing party sends the message type InvoiceRequest to the invoice recipient to start a new invoicing process; and (2) the invoice recipient sends the message type InvoiceConfirmation to the invoicing party to confirm or reject an entire invoice or to temporarily assign it the status “pending.”

An InvoiceRequest is a legally binding notification of claims or liabilities for delivered goods and rendered services—usually, a payment request for the particular goods and services. The message type InvoiceRequest is based on the message data type InvoiceMessage. The InvoiceRequest message (as defined) transfers invoices in the broader sense. This includes the specific invoice (request to settle a liability), the debit memo, and the credit memo.

InvoiceConfirmation is a response sent by the recipient to the invoicing party confirming or rejecting the entire invoice received or stating that it has been assigned temporarily the status “pending.” The message type InvoiceConfirmation is based on the message data type InvoiceMessage. An InvoiceConfirmation is not mandatory in a B2B invoicing process, however, it automates collaborative processes and dispute management.

Usually, the invoice is created after it has been confirmed that the goods were delivered or the service was provided. The invoicing party (such as the seller) starts the invoicing process by sending an InvoiceRequest message. Upon receiving the InvoiceRequest message, the invoice recipient (for instance, the buyer) can use the InvoiceConfirmation message to completely accept or reject the invoice received or to temporarily assign it the status “pending.” The InvoiceConfirmation is not a negotiation tool (as is the case in order management), since the options available are either to accept or reject the entire invoice. The invoice data in the InvoiceConfirmation message merely confirms that the invoice has been forwarded correctly and does not communicate any desired changes to the invoice. Therefore, the InvoiceConfirmation includes the precise invoice data that the invoice recipient received and checked. If the invoice recipient rejects an invoice, the invoicing party can send a new invoice after checking the reason for rejection (AcceptanceStatus and ConfirmationDescription at Invoice and InvoiceItem level). If the invoice recipient does not respond, the invoice is generally regarded as being accepted and the invoicing party can expect payment.

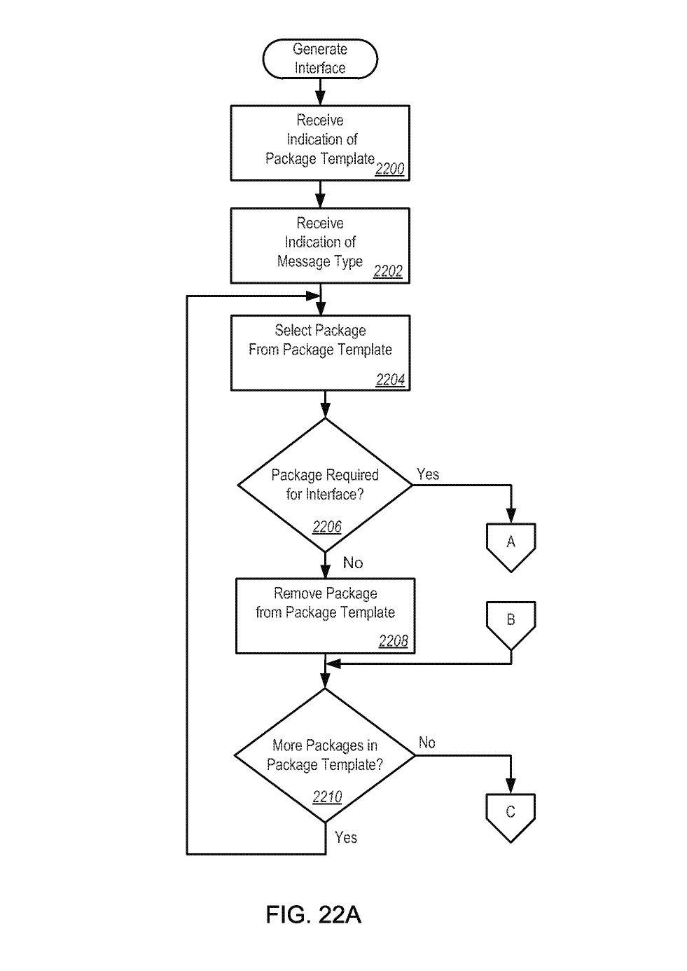

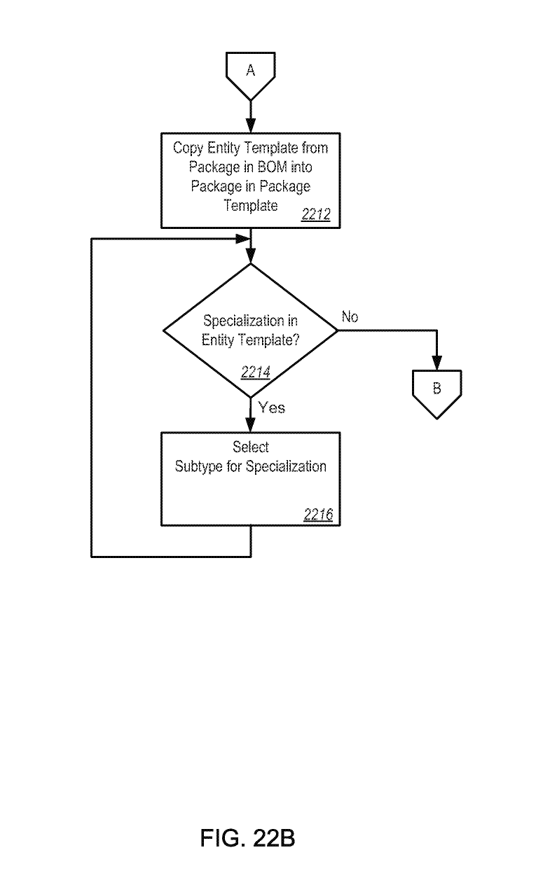

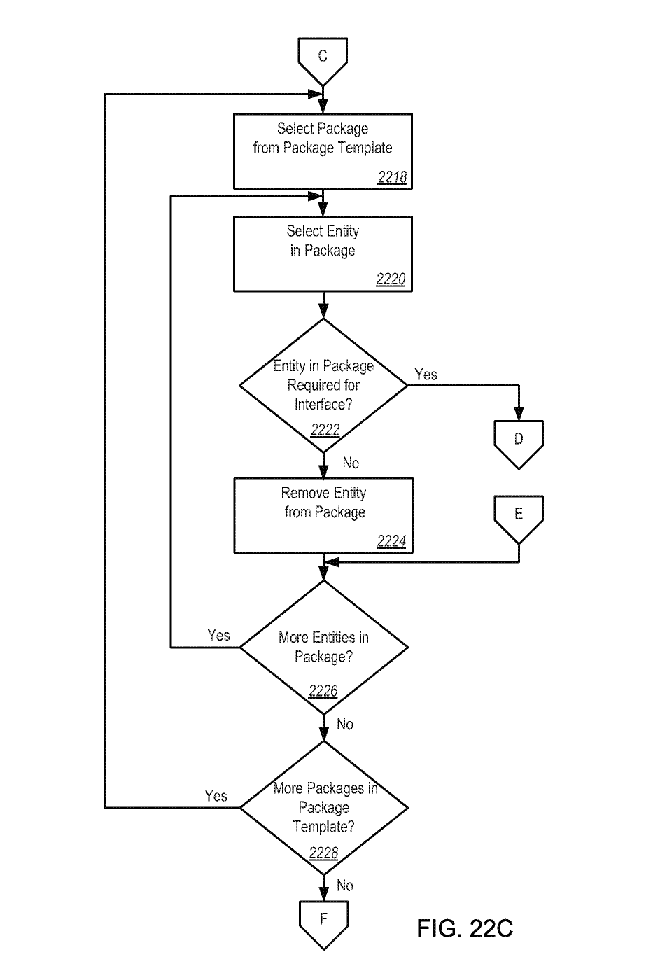

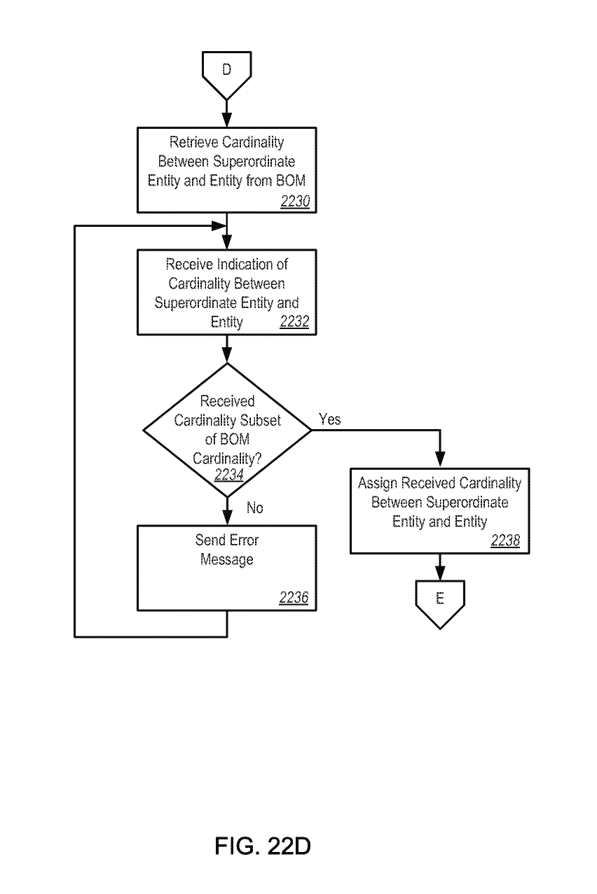

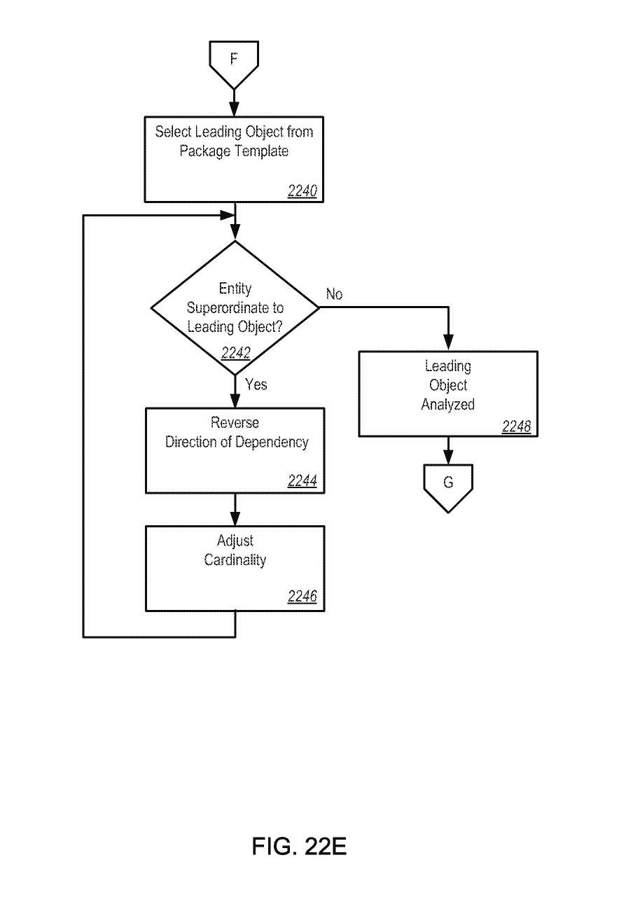

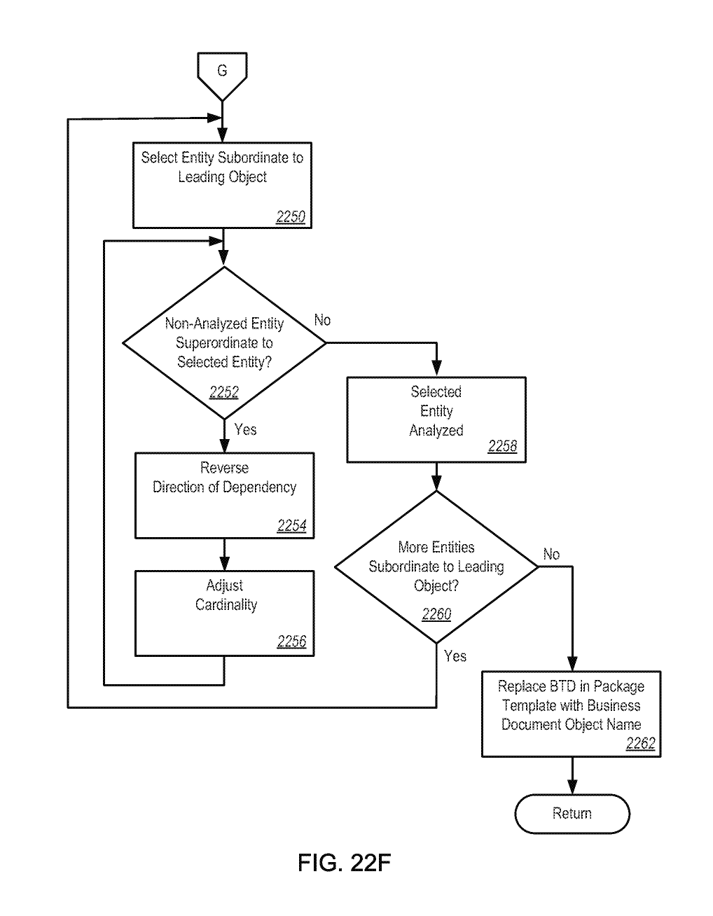

FIGS. 22A-F depict a flow diagram of the steps performed by methods and systems consistent with the subject matter described herein to generate an interface from the business object model. Although described as being performed by a computer, these steps may alternatively be performed manually, or using any combination thereof. The process begins when the system receives an indication of a package template from the designer, i.e., the designer provides a package template to the system (step 2200).

Package templates specify the arrangement of packages within a business transaction document. Package templates are used to define the overall structure of the messages sent between business entities. Methods and systems consistent with the subject matter described herein use package templates in conjunction with the business object model to derive the interfaces.

The system also receives an indication of the message type from the designer (step 2202). The system selects a package from the package template (step 2204), and receives an indication from the designer whether the package is required for the interface (step 2206). If the package is not required for the interface, the system removes the package from the package template (step 2208). The system then continues this analysis for the remaining packages within the package template (step 2210).

If, at step 2206, the package is required for the interface, the system copies the entity template from the package in the business object model into the package in the package template (step 2212, FIG. 22B). The system determines whether there is a specialization in the entity template (step 2214). If the system determines that there is a specialization in the entity template, the system selects a subtype for the specialization (step 2216). The system may either select the subtype for the specialization based on the message type, or it may receive this information from the designer. The system then determines whether there are any other specializations in the entity template (step 2214). When the system determines that there are no specializations in the entity template, the system continues this analysis for the remaining packages within the package template (step 2210, FIG. 22A).

At step 2210, after the system completes its analysis for the packages within the package template, the system selects one of the packages remaining in the package template (step 2218, FIG. 22C), and selects an entity from the package (step 2220). The system receives an indication from the designer whether the entity is required for the interface (step 2222). If the entity is not required for the interface, the system removes the entity from the package template (step 2224). The system then continues this analysis for the remaining entities within the package (step 2226), and for the remaining packages within the package template (step 2228).

If, at step 2222, the entity is required for the interface, the system retrieves the cardinality between a superordinate entity and the entity from the business object model (step 2230, FIG. 22D). The system also receives an indication of the cardinality between the superordinate entity and the entity from the designer (step 2232). The system then determines whether the received cardinality is a subset of the business object model cardinality (step 2234). If the received cardinality is not a subset of the business object model cardinality, the system sends an error message to the designer (step 2236). If the received cardinality is a subset of the business object model cardinality, the system assigns the received cardinality as the cardinality between the superordinate entity and the entity (step 2238). The system then continues this analysis for the remaining entities within the package (step 2226, FIG. 22C), and for the remaining packages within the package template (step 2228).

The system then selects a leading object from the package template (step 2240, FIG. 22E). The system determines whether there is an entity superordinate to the leading object (step 2242). If the system determines that there is an entity superordinate to the leading object, the system reverses the direction of the dependency (step 2244) and adjusts the cardinality between the leading object and the entity (step 2246). The system performs this analysis for entities that are superordinate to the leading object (step 2242). If the system determines that there are no entities superordinate to the leading object, the system identifies the leading object as analyzed (step 2248).

The system then selects an entity that is subordinate to the leading object (step 2250, FIG. 22F). The system determines whether any non-analyzed entities are superordinate to the selected entity (step 2252). If a non-analyzed entity is superordinate to the selected entity, the system reverses the direction of the dependency (step 2254) and adjusts the cardinality between the selected entity and the non-analyzed entity (step 2256). The system performs this analysis for non-analyzed entities that are superordinate to the selected entity (step 2252). If the system determines that there are no non-analyzed entities superordinate to the selected entity, the system identifies the selected entity as analyzed (step 2258), and continues this analysis for entities that are subordinate to the leading object (step 2260). After the packages have been analyzed, the system substitutes the BusinessTransactionDocument (“BTD”) in the package template with the name of the interface (step 2262). This includes the “BTD” in the BTDItem package and the “BTD” in the BTDItemScheduleLine package.

6. Use of an Interface

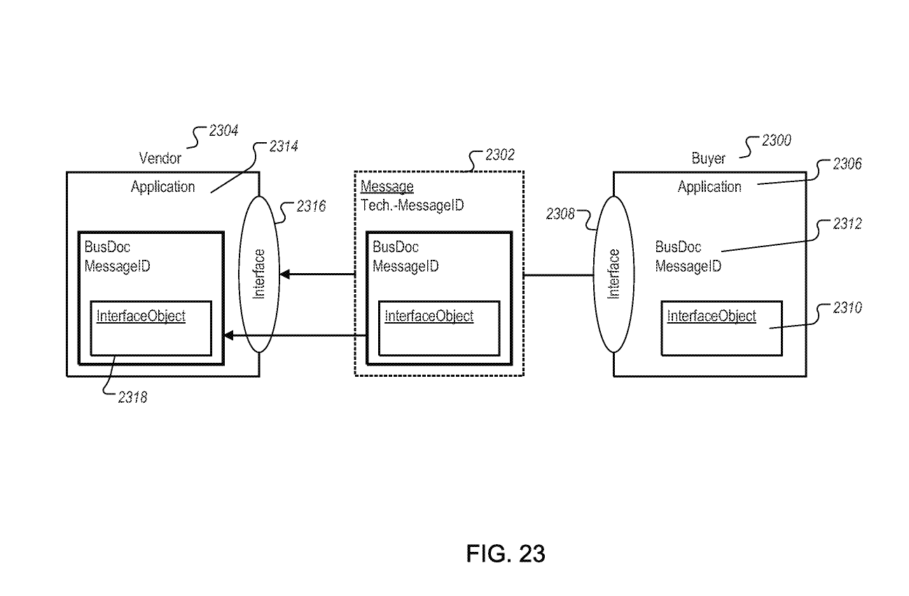

The XI stores the interfaces (as an interface type). At runtime, the sending party's program instantiates the interface to create a business document, and sends the business document in a message to the recipient. The messages are preferably defined using XML. In the example depicted in FIG. 23, the Buyer 2300 uses an application 2306 in its system to instantiate an interface 2308 and create an interface object or business document object 2310. The Buyer's application 2306 uses data that is in the sender's component-specific structure and fills the business document object 2310 with the data. The Buyer's application 2306 then adds message identification 2312 to the business document and places the business document into a message 2302. The Buyer's application 2306 sends the message 2302 to the Vendor 2304. The Vendor 2304 uses an application 2314 in its system to receive the message 2302 and store the business document into its own memory. The Vendor's application 2314 unpacks the message 2302 using the corresponding interface 2316 stored in its XI to obtain the relevant data from the interface object or business document object 2318.

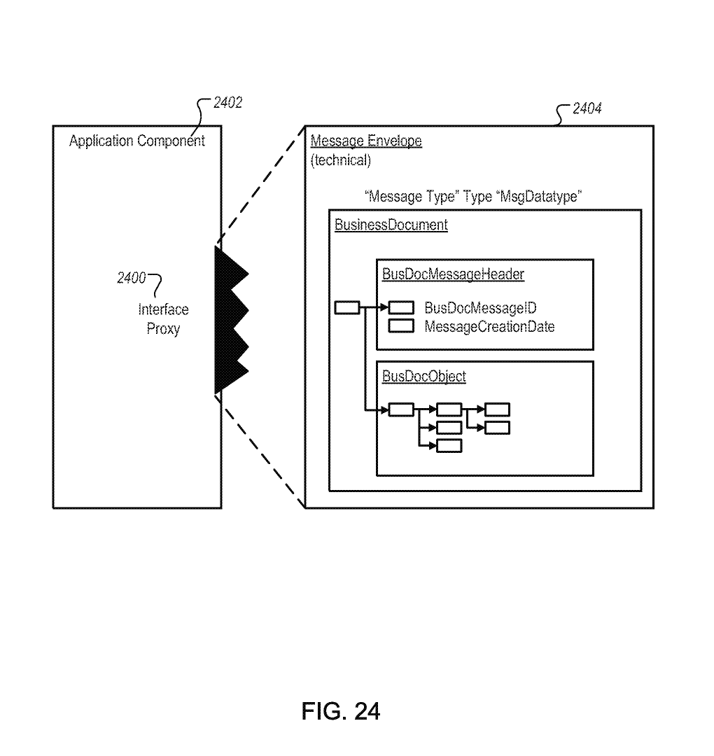

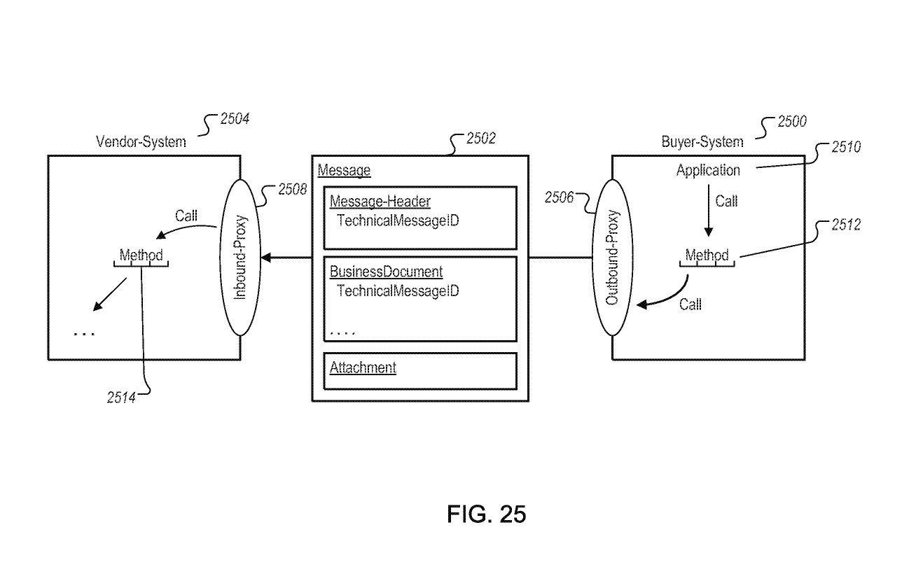

From the component's perspective, the interface is represented by an interface proxy 2400, as depicted in FIG. 24. The proxies 2400 shield the components 2402 of the sender and recipient from the technical details of sending messages 2404 via XI. In particular, as depicted in FIG. 25, at the sending end, the Buyer 2500 uses an application 2510 in its system to call an implemented method 2512, which generates the outbound proxy 2506. The outbound proxy 2506 parses the internal data structure of the components and converts them to the XML structure in accordance with the business document object. The outbound proxy 2506 packs the document into a message 2502. Transport, routing and mapping the XML message to the recipient 28304 is done by the routing system (XI, modeling environment 516, etc.).

When the message arrives, the recipient's inbound proxy 2508 calls its component-specific method 2514 for creating a document. The proxy 2508 at the receiving end downloads the data and converts the XML structure into the internal data structure of the recipient component 2504 for further processing.

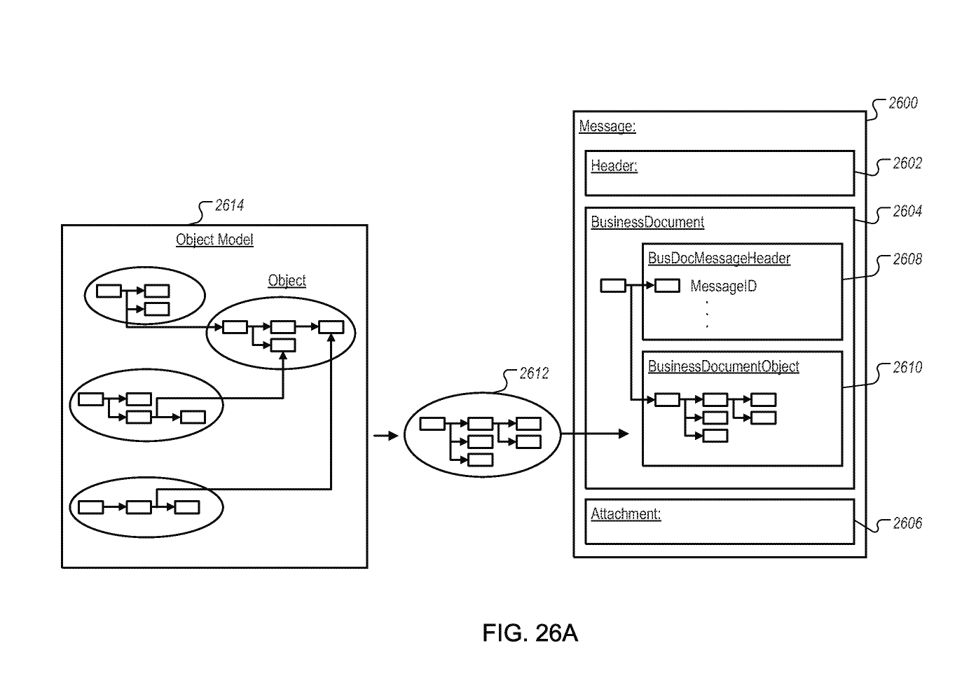

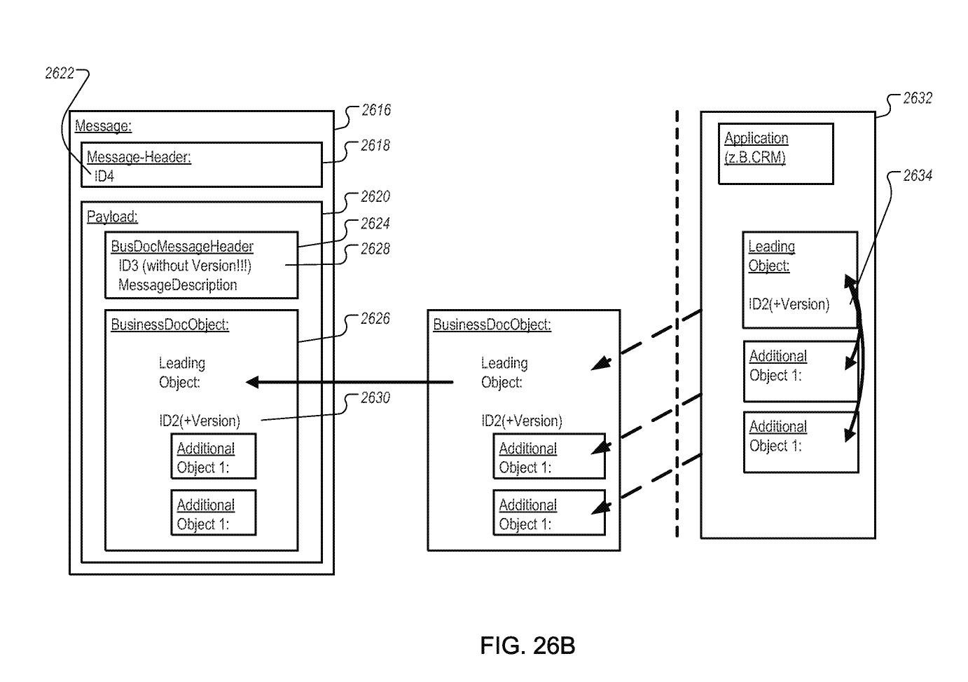

As depicted in FIG. 26A, a message 2600 includes a message header 2602 and a business document 2604. The message 2600 also may include an attachment 2606. For example, the sender may attach technical drawings, detailed specifications or pictures of a product to a purchase order for the product. The business document 2604 includes a business document message header 2608 and the business document object 2610. The business document message header 2608 includes administrative data, such as the message ID and a message description. As discussed above, the structure 2612 of the business document object 2610 is derived from the business object model 2614. Thus, there is a strong correlation between the structure of the business document object and the structure of the business object model. The business document object 2610 forms the core of the message 2600.

In collaborative processes as well as Q&A processes, messages should refer to documents from previous messages. A simple business document object ID or object ID is insufficient to identify individual messages uniquely because several versions of the same business document object can be sent during a transaction. A business document object ID with a version number also is insufficient because the same version of a business document object can be sent several times. Thus, messages require several identifiers during the course of a transaction.

As depicted in FIG. 26B, the message header 2618 in message 2616 includes a technical ID (“ID4”) 2622 that identifies the address for a computer to route the message. The sender's system manages the technical ID 2622.

The administrative information in the business document message header 2624 of the payload or business document 2620 includes a BusinessDocumentMessageID (“ID3”) 2628.

The business entity or component 2632 of the business entity manages and sets the BusinessDocumentMessageID 2628. The business entity or component 2632 also can refer to other business documents using the BusinessDocumentMessageID 2628. The receiving component 2632 requires no knowledge regarding the structure of this ID. The BusinessDocumentMessageID 2628 is, as an ID, unique. Creation of a message refers to a point in time. No versioning is typically expressed by the ID. Besides the BusinessDocumentMessageID 2628, there also is a business document object ID 2630, which may include versions.

The component 2632 also adds its own component object ID 2634 when the business document object is stored in the component. The component object ID 2634 identifies the business document object when it is stored within the component. However, not all communication partners may be aware of the internal structure of the component object ID 2634. Some components also may include a versioning in their ID 2634.

7. Use of Interfaces Across Industries

Methods and systems consistent with the subject matter described herein provide interfaces that may be used across different business areas for different industries. Indeed, the interfaces derived using methods and systems consistent with the subject matter described herein may be mapped onto the interfaces of different industry standards. Unlike the interfaces provided by any given standard that do not include the interfaces required by other standards, methods and systems consistent with the subject matter described herein provide a set of consistent interfaces that correspond to the interfaces provided by different industry standards. Due to the different fields provided by each standard, the interface from one standard does not easily map onto another standard. By comparison, to map onto the different industry standards, the interfaces derived using methods and systems consistent with the subject matter described herein include most of the fields provided by the interfaces of different industry standards. Missing fields may easily be included into the business object model. Thus, by derivation, the interfaces can be extended consistently by these fields. Thus, methods and systems consistent with the subject matter described herein provide consistent interfaces or services that can be used across different industry standards.

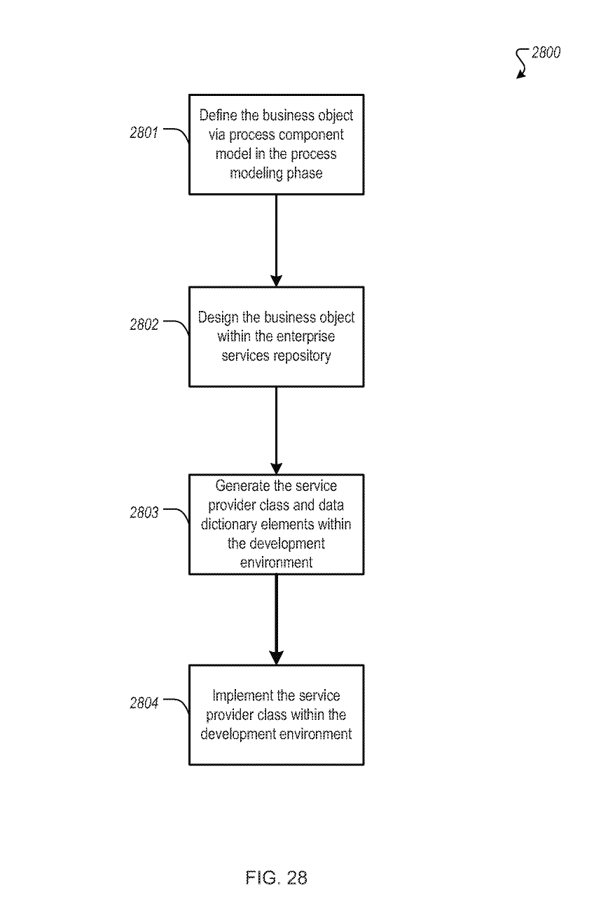

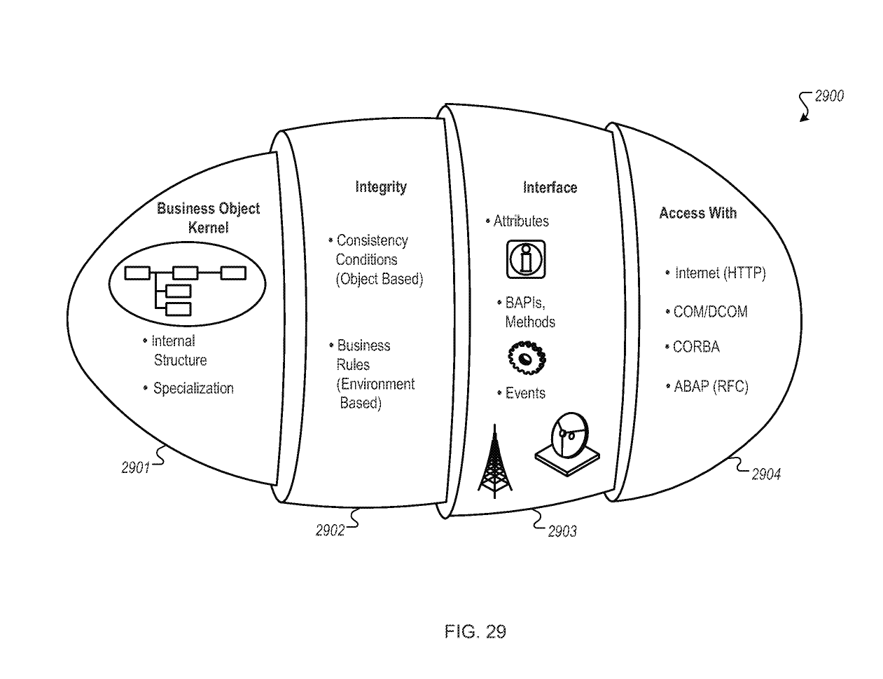

For example, FIG. 28 illustrates an example method 2800 for service enabling. In this example, the enterprise services infrastructure may offer one common and standard-based service infrastructure. Further, one central enterprise services repository may support uniform service definition, implementation and usage of services for user interface, and cross-application communication. In step 2801, a business object is defined via a process component model in a process modeling phase. Next, in step 2802, the business object is designed within an enterprise services repository. For example, FIG. 29 provides a graphical representation of one of the business objects 2900. As shown, an innermost layer or kernel 2901 of the business object may represent the business object's inherent data. Inherent data may include, for example, an employee's name, age, status, position, address, etc. A second layer 2902 may be considered the business object's logic. Thus, the layer 2902 includes the rules for consistently embedding the business object in a system environment as well as constraints defining values and domains applicable to the business object. For example, one such constraint may limit sale of an item only to a customer with whom a company has a business relationship. A third layer 2903 includes validation options for accessing the business object. For example, the third layer 2903 defines the business object's interface that may be interfaced by other business objects or applications. A fourth layer 2904 is the access layer that defines technologies that may externally access the business object.

Accordingly, the third layer 2903 separates the inherent data of the first layer 2901 and the technologies used to access the inherent data. As a result of the described structure, the business object reveals only an interface that includes a set of clearly defined methods. Thus, applications access the business object via those defined methods. An application wanting access to the business object and the data associated therewith usually includes the information or data to execute the clearly defined methods of the business object's interface. Such clearly defined methods of the business object's interface represent the business object's behavior. That is, when the methods are executed, the methods may change the business object's data. Therefore, an application may utilize any business object by providing the information or data without having any concern for the details related to the internal operation of the business object. Returning to method 2800, a service provider class and data dictionary elements are generated within a development environment at step 2803. In step 2804, the service provider class is implemented within the development environment.

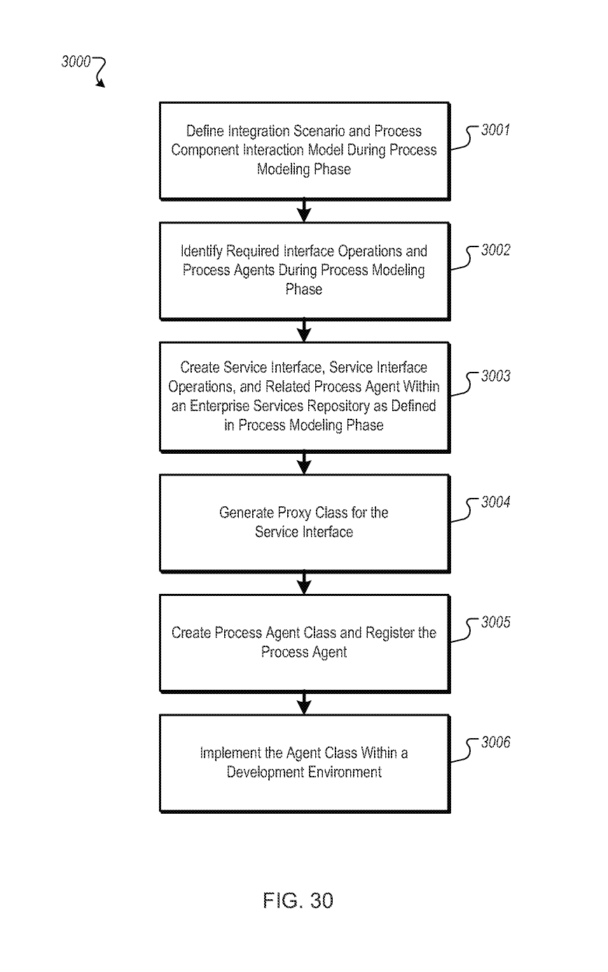

FIG. 30 illustrates an example method 3000 for a process agent framework. For example, the process agent framework may be the basic infrastructure to integrate business processes located in different deployment units. It may support a loose coupling of these processes by message based integration. A process agent may encapsulate the process integration logic and separate it from business logic of business objects. As shown in FIG. 30, an integration scenario and a process component interaction model are defined during a process modeling phase in step 3001. In step 3002, required interface operations and process agents are identified during the process modeling phase also. Next, in step 3003, a service interface, service interface operations, and the related process agent are created within an enterprise services repository as defined in the process modeling phase. In step 3004, a proxy class for the service interface is generated. Next, in step 3005, a process agent class is created and the process agent is registered. In step 3006, the agent class is implemented within a development environment.

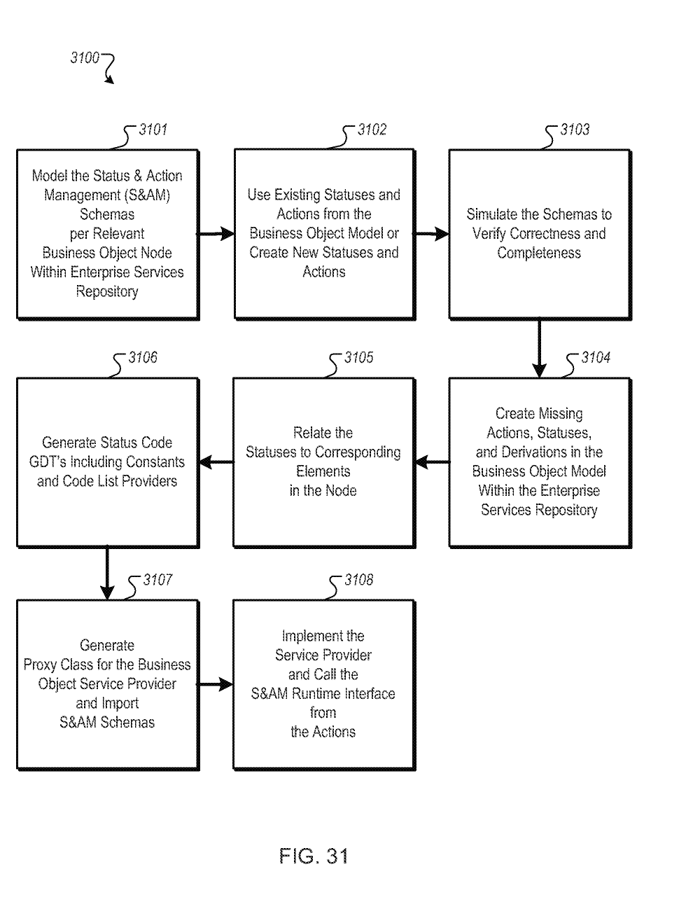

FIG. 31 illustrates an example method 3100 for status and action management (S&AM). For example, status and action management may describe the life cycle of a business object (node) by defining actions and statuses (as their result) of the business object (node), as well as, the constraints that the statuses put on the actions. In step 3101, the status and action management schemas are modeled per a relevant business object node within an enterprise services repository. In step 3102, existing statuses and actions from the business object model are used or new statuses and actions are created. Next, in step 3103, the schemas are simulated to verify correctness and completeness. In step 3104, missing actions, statuses, and derivations are created in the business object model with the enterprise services repository. Continuing with method 3100, the statuses are related to corresponding elements in the node in step 3105. In step 3106, status code GDT's are generated, including constants and code list providers. Next, in step 3107, a proxy class for a business object service provider is generated and the proxy class S&AM schemas are imported. In step 3108, the service provider is implemented and the status and action management runtime interface is called from the actions.

Regardless of the particular hardware or software architecture used, the disclosed systems or software are generally capable of implementing business objects and deriving (or otherwise utilizing) consistent interfaces that are suitable for use across industries, across businesses, and across different departments within a business in accordance with some or all of the following description. In short, system 100 contemplates using any appropriate combination and arrangement of logical elements to implement some or all of the described functionality.

Moreover, the preceding flowcharts and accompanying description illustrate example methods. The present services environment contemplates using or implementing any suitable technique for performing these and other tasks. It will be understood that these methods are for illustration purposes only and that the described or similar techniques may be performed at any appropriate time, including concurrently, individually, or in combination. In addition, many of the steps in these flowcharts may take place simultaneously and/or in different orders than as shown. Moreover, the services environment may use methods with additional steps, fewer steps, and/or different steps, so long as the methods remain appropriate.

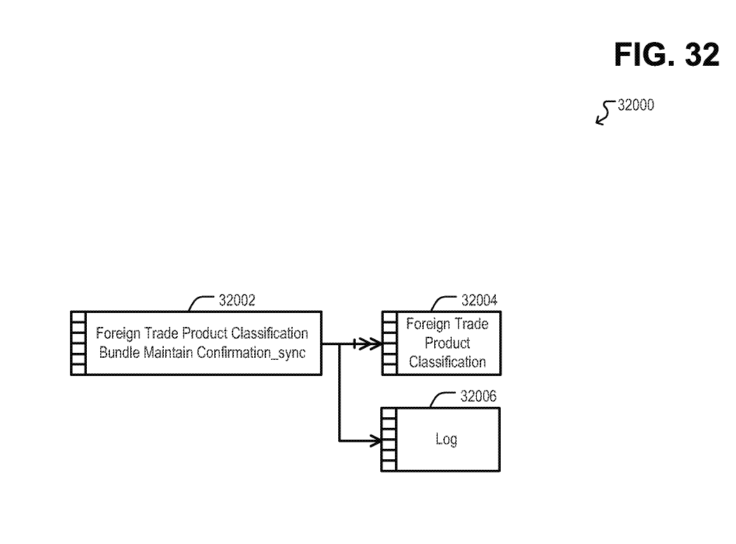

FIG. 32 illustrates one example logical configuration of a Foreign Trade Product Classification Bundle Maintain Confirmation_sync message 32000. Specifically, this figure depicts the arrangement and hierarchy of various components such as one or more levels of packages, entities, and datatypes, shown here as 32002 through 32006. As described above, packages may be used to represent hierarchy levels. Entities are discrete business elements that are used during a business transaction. Data types are used to type object entities and interfaces with a structure. For example, the Foreign Trade Product Classification Bundle Maintain Confirmation_sync message 32000 includes, among other things, Foreign Trade Product Classification entity 32004. Accordingly, heterogeneous applications may communicate using this consistent message configured as such.

The message type Foreign Trade Product Classification Bundle Maintain Confirmation_sync is derived from the business object Foreign Trade Product Classification as a leading object together with its operation signature. The message type Foreign Trade Product Classification Bundle Maintain Confirmation_sync is a positive or negative reply to a request to maintain a bundle of foreign trade product classifications. The structure of the message type Foreign Trade Product Classification Bundle Maintain Confirmation_sync is determined by the message data type Foreign Trade Product Classification Bundle Maintain Confirmation. The message data type Foreign Trade Product Classification Bundle Maintain Confirmation_sync includes the packages: ForeignTradeProductClassification and Log.

The package ForeignTradeProductClassification includes the entity ForeignTradeProductClassification. ForeignTradeProductClassification includes the following non-node elements: ReferenceObjectNodeSenderTechnicalID, ChangeStateID, UUID, ProductKey, ValidityStartDate, CustomsCommodityClassificationCode, ProductQuantityConversionQuantity, and ProductQuantityConversionCorrespondingQuantity. ReferenceObjectNodeSenderTechnicalID may have a multiplicity of 1 and may be based on BGDT:ObjectNodePartyTechnicalID. ChangeStateID may have a multiplicity of 1 and may be based on datatype BGDT:ChangeStateID. UUID may have a multiplicity of 0 . . . 1 and may be based on datatype BGDT:UUID. ProductKey may have a multiplicity of 0 . . . 1 and may be based on datatype KDT: ProductKey. ValidityStartDate may have a multiplicity of 0 . . . 1 and may be based on datatype CDT:Date. CustomsCommodityClassificationCode may have a multiplicity of 0 . . . 1 and may be based on datatype BGDT:CustomsCommodityClassificationCode. ProductQuantityConversionQuantity may have a multiplicity of 0 . . . 1 and may be based on datatype CDT:Quantity. ProductQuantityConversionCorrespondingQuantity may have a multiplicity of 0 . . . 1 and may be based on datatype CDT:Quantity. The package Log includes the entity Log, which is typed by datatype Log.

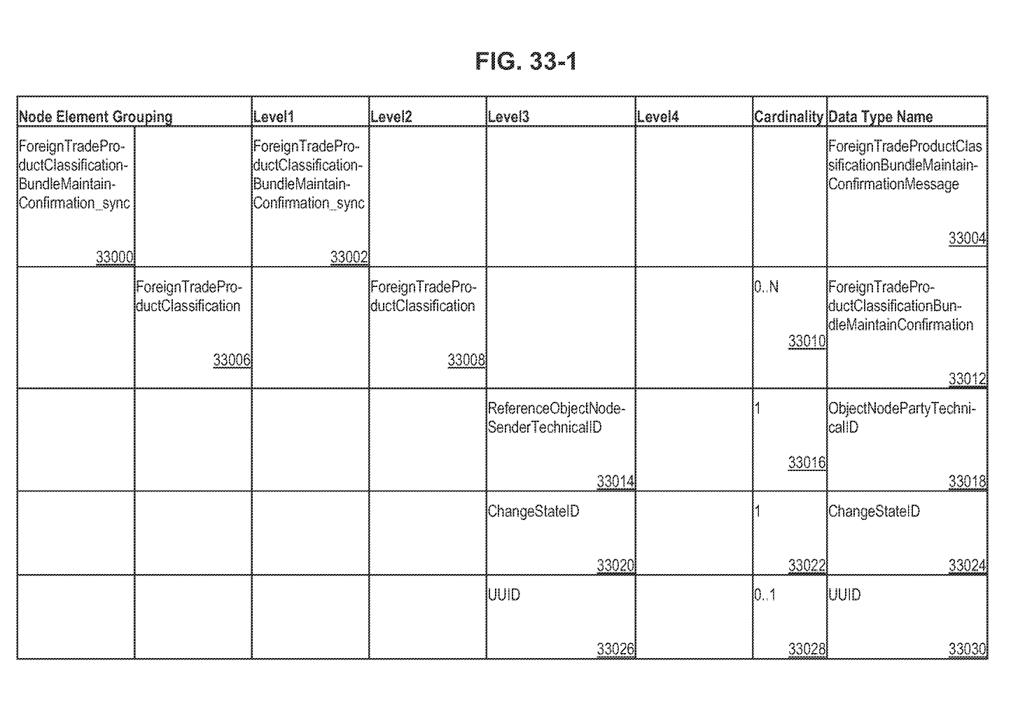

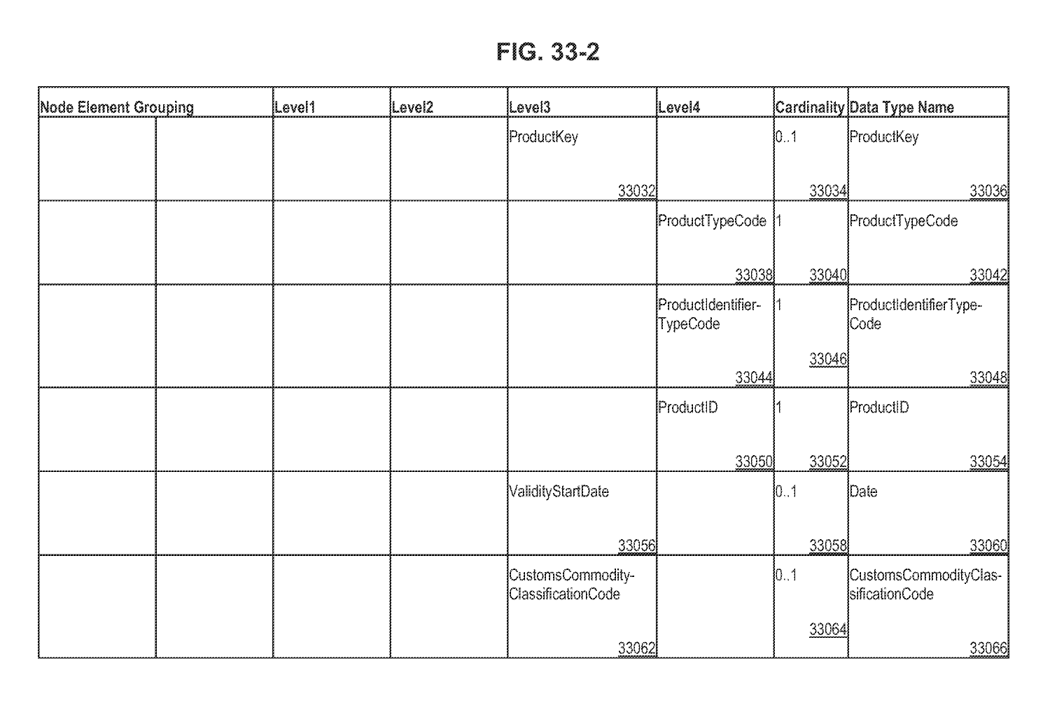

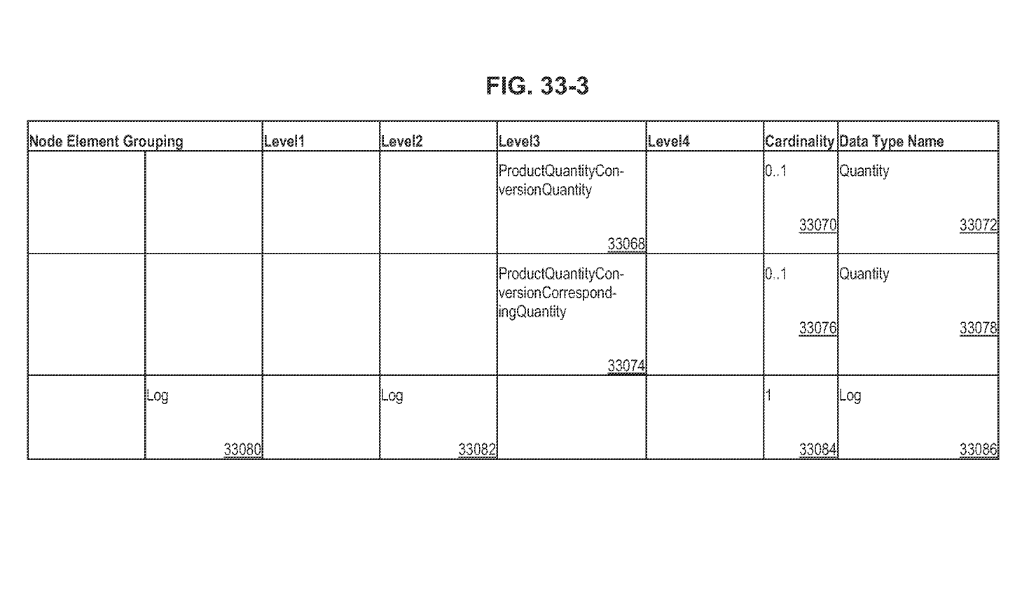

FIGS. 33-1 through 33-3 show an example configuration of an Element Structure that includes a ForeignTradeProductClassificationBundleMaintainConfirmation_sync 33000 node element grouping. Specifically, these figures depict the arrangement and hierarchy of various components such as one or more levels of node element groupings, entities, and datatypes, shown here as 33000 through 33086. As described above, node element groupings may be used to represent hierarchy levels. Entities are discrete business elements that are used during a business transaction. Data types are used to type object entities and interfaces with a structure. For example, the ForeignTradeProductClassificationBundleMaintainConfirmation_sync 33000 includes, among other things, a ForeignTradeProductClassificationBundleMaintainConfirmation_sync 33002. Accordingly, heterogeneous applications may communicate using this consistent message configured as such.

The ForeignTradeProductClassificationBundleMaintainConfirmation_sync 33000 node element grouping is a ForeignTradeProductClassificationBundleMaintainConfirmationMessage 33004 data type. The ForeignTradeProductClassificationBundleMaintainConfirmation_sync 33000 node element grouping includes a ForeignTradeProductClassificationBundleMaintainConfirmation_sync 33002 entity. The ForeignTradeProductClassificationBundleMaintainConfirmation_sync 33000 node element grouping includes various node element groupings, namely a ForeignTradeProductClassification 33006 and a Log 33080. The ForeignTradeProductClassification 33006 node element grouping is a ForeignTradeProductClassificationBundleMaintainConfirmation 33012 data type. The ForeignTradeProductClassification 33006 node element grouping includes a ForeignTradeProductClassification 33008 entity.

The ForeignTradeProductClassification 33008 entity has a cardinality of 0 . . . N 33010 meaning that for each instance of the ForeignTradeProductClassification 33006 node element grouping there may be one or more ForeignTradeProductClassification 33008 entities. The ForeignTradeProductClassification 33008 entity includes various attributes, namely a ReferenceObjectNodeSenderTechnicalID 33014, a ChangeStateID 33020, an UUID 33026, a ValidityStartDate 33056, a CustomsCommodityClassificationCode 33062, a ProductQuantityConversionQuantity 33068 and a ProductQuantityConversionCorrespondingQuantity 33074. The ForeignTradeProductClassification 33008 entity includes a ProductKey 33032 subordinate entity.

The ReferenceObjectNodeSenderTechnicalID 33014 attribute is an ObjectNodePartyTechnicalID 33018 data type. The ReferenceObjectNodeSenderTechnicalID 33014 attribute has a cardinality of 1 33016 meaning that for each instance of the ForeignTradeProductClassification 33008 entity there is one ReferenceObjectNodeSenderTechnicalID 33014 attribute.

The ChangeStateID 33020 attribute is a ChangeStateID 33024 data type. The ChangeStateID 33020 attribute has a cardinality of 1 33022 meaning that for each instance of the ForeignTradeProductClassification 33008 entity there is one ChangeStateID 33020 attribute.

The UUID 33026 attribute is an UUID 33030 data type. The UUID 33026 attribute has a cardinality of 0 . . . 1 33028 meaning that for each instance of the ForeignTradeProductClassification 33008 entity there may be one UUID 33026 attribute.

The ValidityStartDate 33056 attribute is a Date 33060 data type. The ValidityStartDate 33056 attribute has a cardinality of 0 . . . 1 33058 meaning that for each instance of the ForeignTradeProductClassification 33008 entity there may be one ValidityStartDate 33056 attribute.

The CustomsCommodityClassificationCode 33062 attribute is a CustomsCommodityClassificationCode 33066 data type. The CustomsCommodityClassificationCode 33062 attribute has a cardinality of 0 . . . 1 33064 meaning that for each instance of the ForeignTradeProductClassification 33008 entity there may be one CustomsCommodityClassificationCode 33062 attribute.

The ProductQuantityConversionQuantity 33068 attribute is a Quantity 33072 data type. The ProductQuantityConversionQuantity 33068 attribute has a cardinality of 0 . . . 1 33070 meaning that for each instance of the ForeignTradeProductClassification 33008 entity there may be one ProductQuantityConversionQuantity 33068 attribute.

The ProductQuantityConversionCorrespondingQuantity 33074 attribute is a Quantity 33078 data type. The ProductQuantityConversionCorrespondingQuantity 33074 attribute has a cardinality of 0 . . . 1 33076 meaning that for each instance of the ForeignTradeProductClassification 33008 entity there may be one ProductQuantityConversionCorrespondingQuantity 33074 attribute.

The ProductKey 33032 entity has a cardinality of 0 . . . 1 33034 meaning that for each instance of the ForeignTradeProductClassification 33008 entity there may be one ProductKey 33032 entity. The ProductKey 33032 entity includes various attributes, namely a ProductTypeCode 33038, a ProductIdentifierTypeCode 33044 and a ProductID 33050.

The ProductTypeCode 33038 attribute is a ProductTypeCode 33042 data type. The ProductTypeCode 33038 attribute has a cardinality of 1 33040 meaning that for each instance of the ProductKey 33032 entity there is one ProductTypeCode 33038 attribute.

The ProductIdentifierTypeCode 33044 attribute is a ProductIdentifierTypeCode 33048 data type. The ProductIdentifierTypeCode 33044 attribute has a cardinality of 1 33046 meaning that for each instance of the ProductKey 33032 entity there is one ProductIdentifierTypeCode 33044 attribute.

The ProductID 33050 attribute is a ProductID 33054 data type. The ProductID 33050 attribute has a cardinality of 1 33052 meaning that for each instance of the ProductKey 33032 entity there is one ProductID 33050 attribute.

The Log 33080 node element grouping is a Log 33086 data type. The Log 33080 node element grouping includes a Log 33082 entity.

The Log 33082 entity has a cardinality of 1 33084 meaning that for each instance of the Log 33080 node element grouping there is one Log 33082 entity.

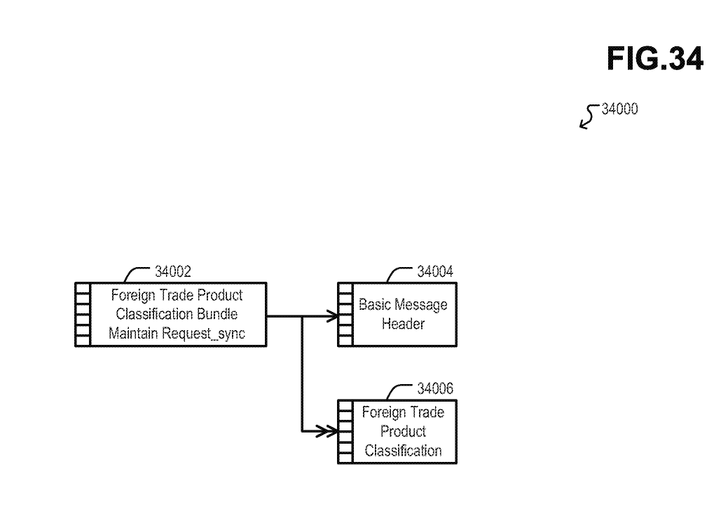

FIG. 34 illustrates one example logical configuration of a Foreign Trade Product Classification Bundle Maintain Request_sync message 34000. Specifically, this figure depicts the arrangement and hierarchy of various components such as one or more levels of packages, entities, and datatypes, shown here as 34002 through 34006. As described above, packages may be used to represent hierarchy levels. Entities are discrete business elements that are used during a business transaction. Data types are used to type object entities and interfaces with a structure. For example, the Foreign Trade Product Classification Bundle Maintain Request_sync message 34000 includes, among other things, Foreign Trade Product Classification entity 34006. Accordingly, heterogeneous applications may communicate using this consistent message configured as such.

The message type Foreign Trade Product Classification Bundle Maintain Request_sync is derived from the business object Foreign Trade Product Classification as a leading object together with its operation signature. The message type Foreign Trade Product Classification Bundle Maintain Request_sync is a request to maintain a bundle of foreign trade product classifications. The structure of the message type Foreign Trade Product Classification Bundle Maintain Request_sync is determined by the message data type Foreign Trade Product Classification Bundle Maintain Request Message. Foreign Trade Product Classification Bundle Maintain Request is a message data type for Foreign Trade Product Classification Bundle Maintain Request. The message data type includes the packages MessageHeader and ForeignTradeProductClassification.

The package MessageHeader includes the entity BasicMessageHeader. BasicMessageHeader is typed by BusinessDocumentBasicMessageHeader. The package ForeignTradeProductClassification includes the entity ForeignTradeProductClassification.

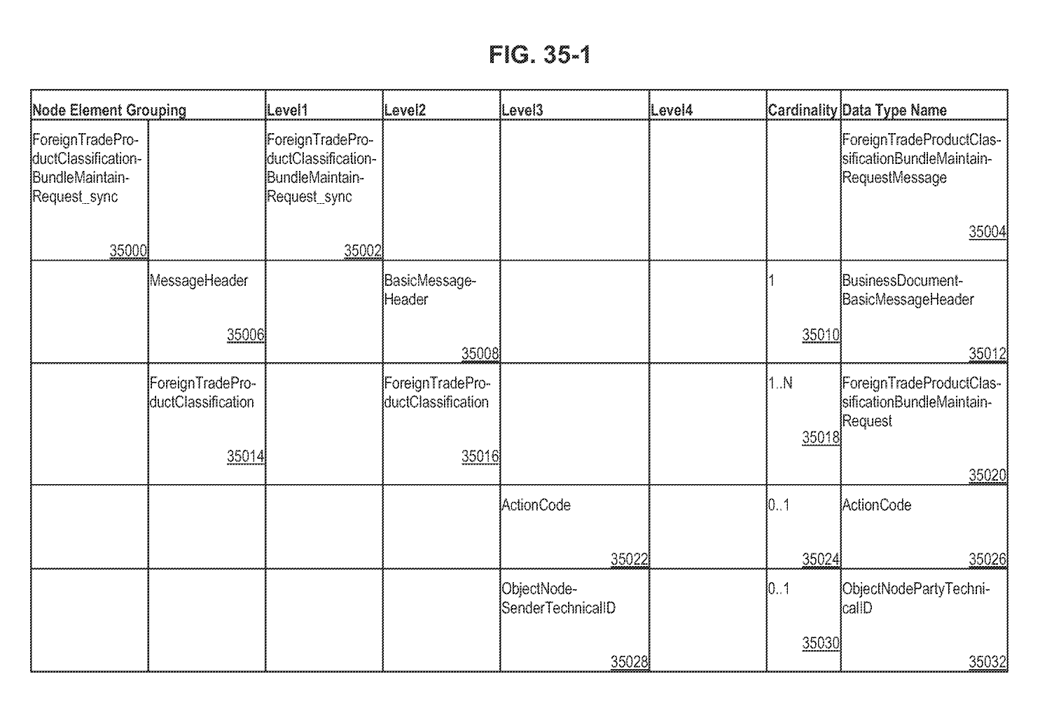

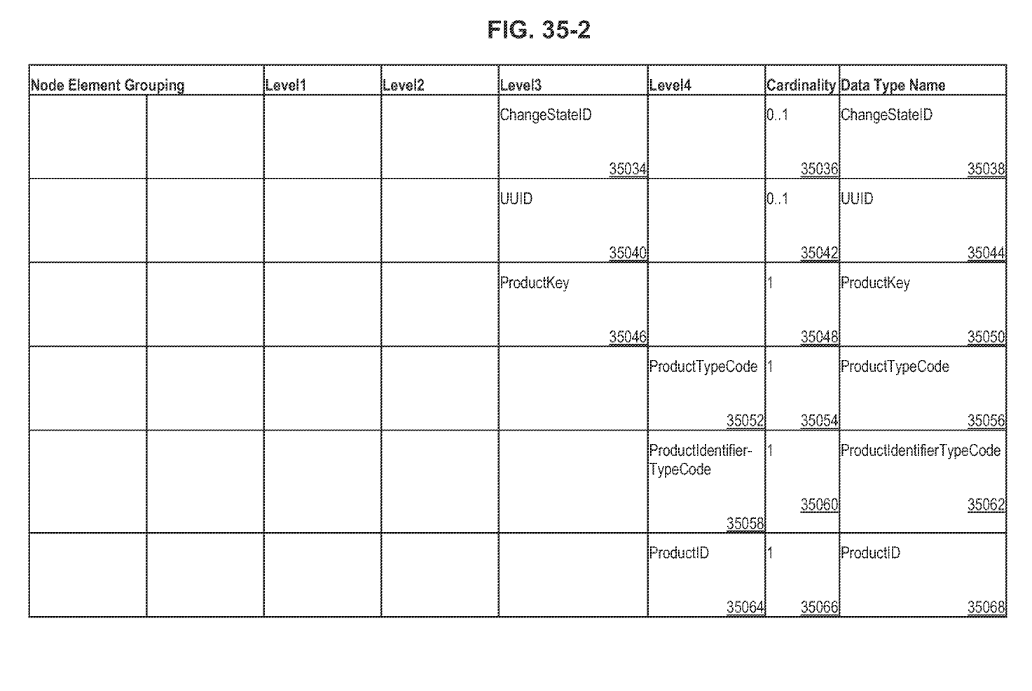

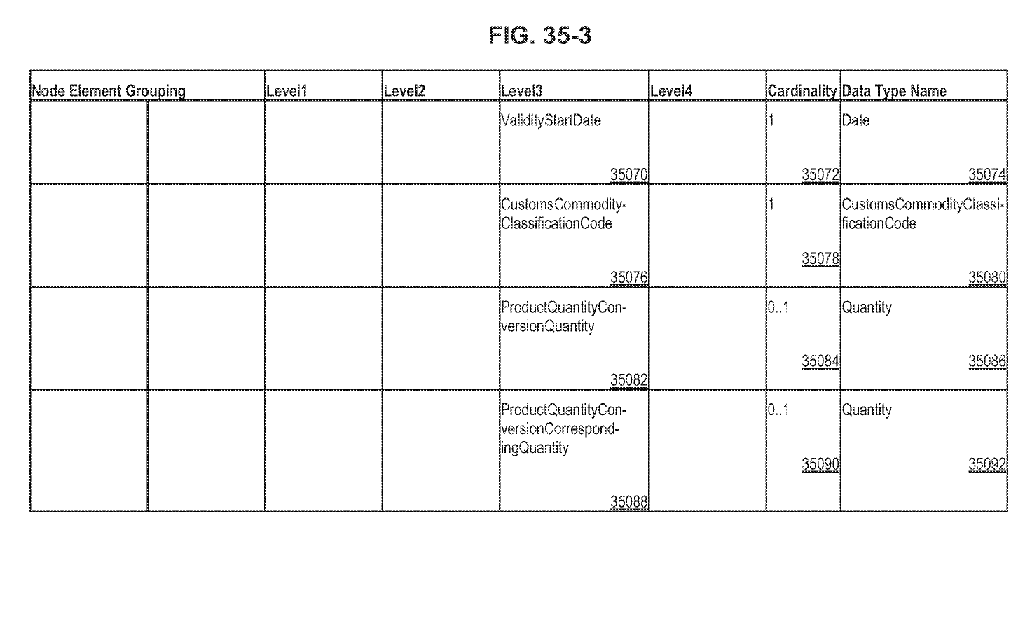

ForeignTradeProductClassification includes the ActionCode attribute. ActionCode may have a multiplicity of 0 . . . 1 and may be based on datatype BGDT:ActionCode. ForeignTradeProductClassification includes the non-node elements: ObjectNodeSenderTechnicalID, ChangeStateID, UUID, ProductKey, ValidityStartDate, CustomsCommodityClassificationCode, ProductQuantityConversionQuantity, and ProductQuantityConversionCorrespondingQuantity. ObjectNodeSenderTechnicalID may have a multiplicity of 0 . . . 1 and may be based on datatype BGDT:ObjectNodePartyTechnicalID. ChangeStateID may have a multiplicity of 0 . . . 1 and may be based on datatype BGDT:ChangeStateID. UUID may have a multiplicity of 0 . . . 1 and may be based on datatype BGDT:UUID. ProductKey may have a multiplicity of 1 and may be based on datatype KDT:ProductKey. ValidityStartDate may have a multiplicity of 1 and may be based on datatype CDT:Date. CustomsCommodityClassificationCode may have a multiplicity of 1 and may be based on datatype BGDT:CustomsCommodityClassificationCode. ProductQuantityConversionQuantity may have a multiplicity of 0 . . . 1 and may be based on datatype CDT:Quantity. ProductQuantityConversionCorrespondingQuantity may have a multiplicity of 0 . . . 1 and may be based on datatype CDT:Quantity. FIGS. 35-1 through 35-3 show an example configuration of an Element Structure that includes a ForeignTradeProductClassificationBundleMaintainRequest_sync 35000 node element grouping. Specifically, these figures depict the arrangement and hierarchy of various components such as one or more levels of node element groupings, entities, and datatypes, shown here as 35000 through 35092. As described above, node element groupings may be used to represent hierarchy levels. Entities are discrete business elements that are used during a business transaction. Data types are used to type object entities and interfaces with a structure. For example, the ForeignTradeProductClassificationBundleMaintainRequest_sync 35000 includes, among other things, a ForeignTradeProductClassificationBundleMaintainRequest_sync 35002. Accordingly, heterogeneous applications may communicate using this consistent message configured as such.

The table shown in the figures presents a hierarchical representation of elements that are included in the message represented by the ForeignTradeProductClassificationBundleMaintainRequest_sync 350000 node element grouping. The structure of the table is similar to the table structure described above with reference to FIGS. 33-1 through 33-3. The full details of the example configuration of the Element Structure found in FIGS. 35-1 through 35-3 can be derived from a review of the corresponding figures. For example, first-level packages (in the second “Node Element Grouping” column) include packages 350006 through 350014. Level 1 components include the entity 350002. Level 2 components include elements and attributes 350008 through 350016. Level 3 components include elements and attributes 350022 through 350088. Level 4 components include elements and attributes 350052 through 350064. Cardinality components include cardinalities 350010 through 350090. Data Type Name components include data types 350004 through 350092.

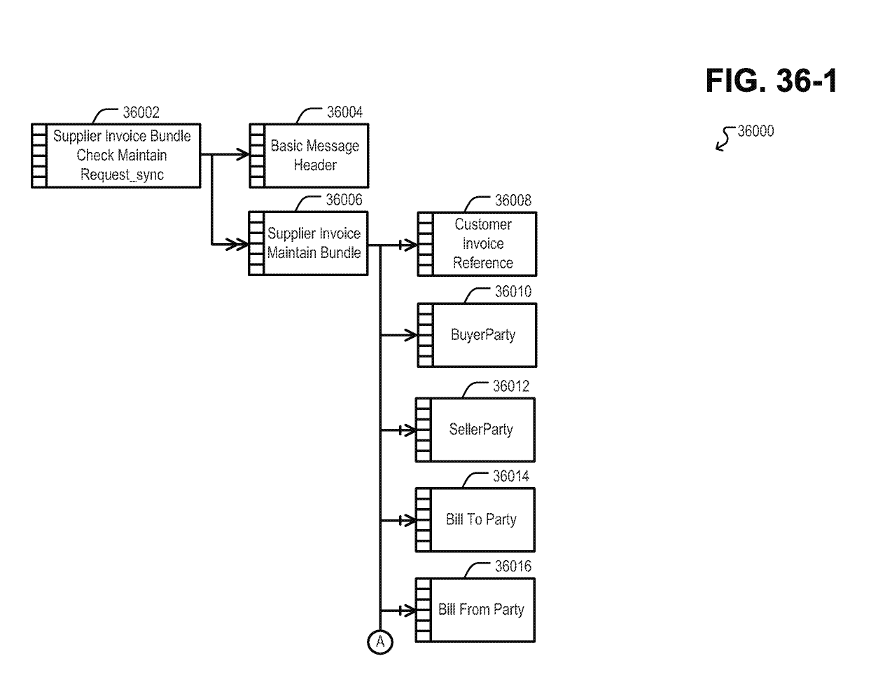

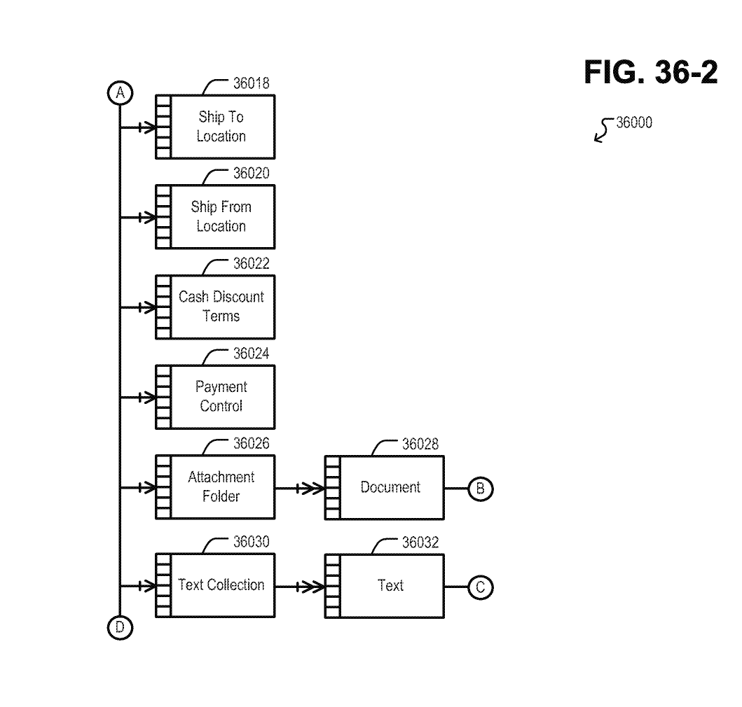

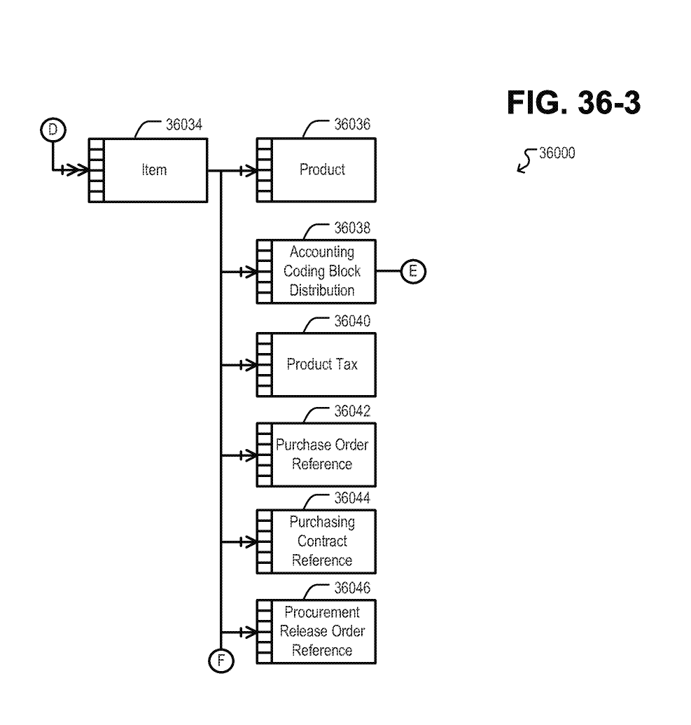

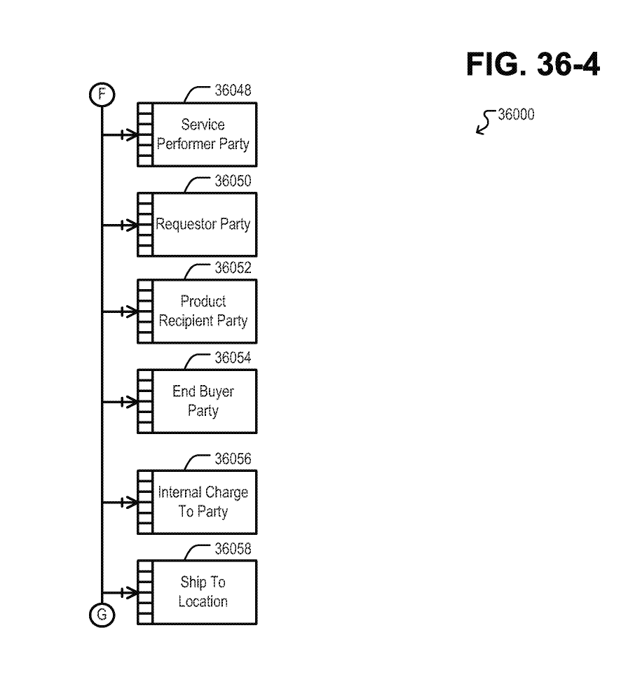

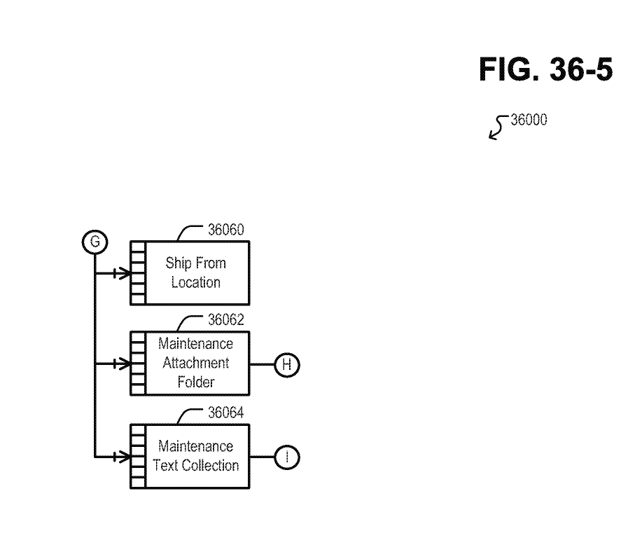

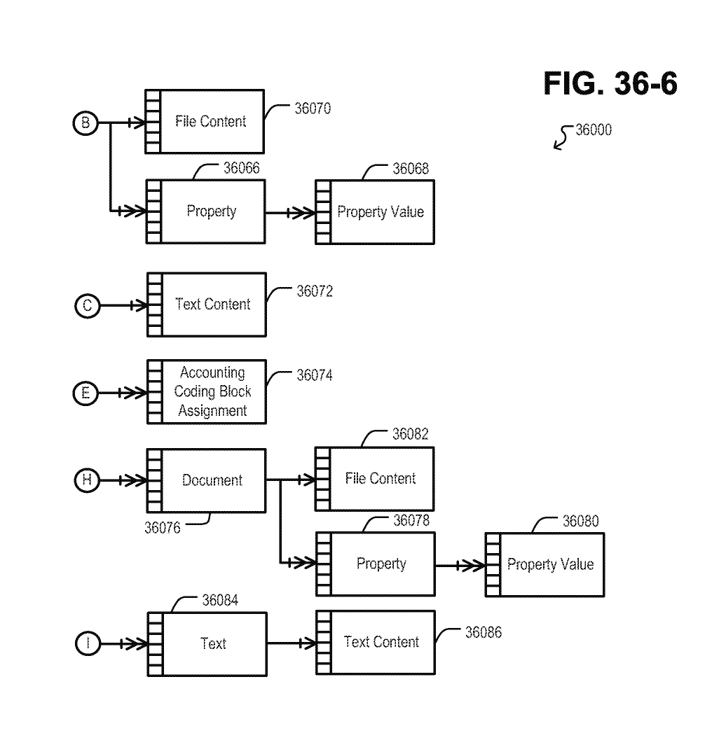

FIGS. 36-1 to 36-6 collectively illustrate one example logical configuration of a Supplier Invoice Bundle Check Maintain Request_sync message 36000. Specifically, these figures depict the arrangement and hierarchy of various components such as one or more levels of packages, entities, and datatypes, shown here as 36002 through 36086. As described above, packages may be used to represent hierarchy levels. Entities are discrete business elements that are used during a business transaction. Data types are used to type object entities and interfaces with a structure. For example, the Supplier Invoice Bundle Check Maintain Request_sync message 36000 includes, among other things, Supplier Invoice Maintain Bundle 36006. Accordingly, heterogeneous applications may communicate using this consistent message configured as such.

The message type SupplierInvoiceBundleCheckMaintainRequest_sync is derived from the business object Supplier Invoice as a leading object together with its operation signature. The message type SupplierInvoiceBundleCheckMaintainRequest_sync is a request to check for issues that may occur during the creation of one or more supplier invoices by simulating their creation. The structure of the message type SupplierInvoiceBundleCheckMaintainRequest_sync is determined by the message data type SupplierInvoiceBundleMaintainRequestMessage_sync.

The message data type SupplierInvoiceBundleMaintainRequestMessage_sync includes the MessageHeader package and the SupplierInvoice package. The package MessageHeader includes the entity BasicMessageHeader. BasicMessageHeader is typed by BusinessDocumentBasicMessageHeader. The package SupplierInvoice includes the sub-packages BusinessTransactionDocumentReference, Party, Location, CashDiscountTerms, PaymentControl, AttachmentFolder, TextCollection, and Item, and the entity SupplierInvoiceMaintainBundle.

SupplierInvoiceMaintainBundle includes the following attributes: actionCode and itemListCompleteTransmissionIndicator. The actionCode attribute may have a multiplicity of 0 . . . 1 and may be based on datatype BGDT:ActionCode. The itemListCompleteTransmissionIndicator attribute may have a multiplicity of 0 . . . 1 and may be based on datatype CDT:Indicator. SupplierInvoiceMaintainBundle includes the following non-node elements: ObjectNodeSenderTechnicalID, ChangeStateID, BusinessTransactionDocumentTypeCode, MEDIUM_Name, Date, ReceiptDate, TransactionDate, DocumentItemGrossAmountIndicator, GrossAmount, TaxAmount, and Status. Status may include DataEntryProcessingStatusCode. ObjectNodeSenderTechnicalID may have a multiplicity of 0 . . . 1 and may be based on datatype BGDT:ObjectNodePartyTechnicalID. ChangeStateID may have a multiplicity of 0 . . . 1 and may be based on datatype BGDT:ChangeStateID. BusinessTransactionDocumentTypeCode may have a multiplicity of 1 and may be based on datatype BGDT:BusinessTransactionDocumentTypeCode. MEDIUM_Name may have a multiplicity of 0 . . . 1 and may be based on datatype CDT:MEDIUM_Name. Date may have a multiplicity of 0 . . . 1 and may be based on datatype CDT:Date. ReceiptDate may have a multiplicity of 0 . . . 1 and may be based on datatype CDT:Date. TransactionDate may have a multiplicity of 0 . . . 1 and may be based on datatype CDT:Date. DocumentItemGrossAmountIndicator may have a multiplicity of 1 and may be based on datatype CDT:Indicator. GrossAmount may have a multiplicity of 0 . . . 1 and may be based on datatype CDT:Amount. TaxAmount may have a multiplicity of 0 . . . 1 and may be based on datatype CDT:Amount. Status may have a multiplicity of 0 . . . 1 and may be based on datatype MIDT:SupplierInvoiceMaintainRequestBundleStatus. DataEntryProcessingStatusCode may have a multiplicity of 0 . . . 1 and may be based on datatype BGDT:INPROCESSFINISHED_ProcessingStatusCode.

SupplierInvoiceMaintainBundle includes the following node elements: CustomerinvoiceReference, in a 1:C cardinality relationship; BuyerParty, in a 1:1 cardinality relationship; SellerParty, in a 1:C cardinality relationship; BillToParty, in a 1:C cardinality relationship; BillFromParty, in a 1:C cardinality relationship; ShipToLocation, in a 1:C cardinality relationship; ShipFromLocation, in a 1:C cardinality relationship; CashDiscountTerms, in a 1:C cardinality relationship; PaymentControl, in a 1:C cardinality relationship; AttachmentFolder, in a 1:C cardinality relationship; TextCollection, in a 1:C cardinality relationship; and Item, in a 1:CN cardinality relationship.

The package SupplierInvoiceBusinessTransactionDocumentReference includes the entity CustomerinvoiceReference. CustomerinvoiceReference includes the actionCode attribute, which may have a multiplicity of 0 . . . 1 and may be based on datatype BGDT:ActionCode. SupplierInvoiceBusinessTransactionDocumentReference includes the following non-node elements: ObjectNodePartyTechnicalID and BusinessTransactionDocumentReference. ObjectNodePartyTechnicalID may have a multiplicity of 0 . . . 1 and may be based on datatype BGDT:ObjectNodePartyTechnicalID. BusinessTransactionDocumentReference may have a multiplicity of 0 . . . 1 and may be based on datatype AGDT:BusinessTransactionDocumentReference.

The package SupplierInvoiceParty includes the entities BuyerParty, SellerParty, BillToParty, and BillFromParty. BuyerParty includes the actionCode attribute, which may have a multiplicity of 0 . . . 1 and may be based on datatype BGDT:ActionCode. BuyerParty includes the following non-node elements: ObjectNodePartyTechnicalID and PartyKey. ObjectNodePartyTechnicalID may have a multiplicity of 0 . . . 1 and may be based on datatype BGDT:ObjectNodePartyTechnicalID. PartyKey may have a multiplicity of 0 . . . 1 and may be based on datatype KDT:PartyKey.

SellerParty includes the actionCode attribute, which may have a multiplicity of 0 . . . 1 and may be based on datatype BGDT:ActionCode. SellerParty includes the following non-node elements: ObjectNodePartyTechnicalID and PartyKey. ObjectNodePartyTechnicalID may have a multiplicity of 0 . . . 1 and may be based on datatype BGDT:ObjectNodePartyTechnicalID. PartyKey may have a multiplicity of 0 . . . 1 and may be based on datatype KDT:PartyKey.

BillToParty includes the actionCode attribute, which may have a multiplicity of 0 . . . 1 and may be based on datatype BGDT:ActionCode. BillToParty includes the following non-node elements: ObjectNodePartyTechnicalID and PartyKey. ObjectNodePartyTechnicalID may have a multiplicity of 0 . . . 1 and may be based on datatype BGDT:ObjectNodePartyTechnicalID. PartyKey may have a multiplicity of 0 . . . 1 and may be based on datatype KDT:PartyKey.

BillFromParty includes the actionCode attribute, which may have a multiplicity of 0 . . . 1 and may be based on datatype BGDT:ActionCode. BillFromParty includes the following non-node elements: ObjectNodePartyTechnicalID and PartyKey. ObjectNodePartyTechnicalID may have a multiplicity of 0 . . . 1 and may be based on datatype BGDT:ObjectNodePartyTechnicalID. PartyKey may have a multiplicity of 0 . . . 1 and may be based on datatype KDT:PartyKey.

The package SupplierInvoiceLocation includes the entities ShipToLocation and ShipFromLocation. ShipToLocation includes the actionCode attribute, which may have a multiplicity of 0 . . . 1 and may be based on datatype BGDT:ActionCode. ShipToLocation includes the following non-node elements: ObjectNodePartyTechnicalID and LocationID. ObjectNodePartyTechnicalID may have a multiplicity of 0 . . . 1 and may be based on datatype BGDT:ObjectNodePartyTechnicalID. LocationID may have a multiplicity of 0 . . . 1 and may be based on datatype BGDT:LocationID.

ShipFromLocation includes the actionCode attribute, which may have a multiplicity of 0 . . . 1 and may be based on datatype BGDT:ActionCode. ShipFromLocation includes the following non-node elements: ObjectNodePartyTechnicalID and LocationID. ObjectNodePartyTechnicalID may have a multiplicity of 0 . . . 1 and may be based on datatype BGDT:ObjectNodePartyTechnicalID. LocationID may have a multiplicity of 0 . . . 1 and may be based on datatype BGDT:LocationID.

The package SupplierInvoiceCashDiscountTerms includes the entity CashDiscountTerms. CashDiscountTerms includes the ActionCode attribute, which may have a multiplicity of 0 . . . 1 and may be based on datatype BGDT:ActionCode. CashDiscountTerms includes the following non-node elements: UUID, Code, and PaymentBaselineDate. UUID may have a multiplicity of 0 . . . 1 and may be based on datatype BGDT:UUID. Code may have a multiplicity of 0 . . . 1 and may be based on datatype BGDT:CashDiscountTermsCode. PaymentBaselineDate may have a multiplicity of 0 . . . 1 and may be based on datatype CDT:Date.

The package SupplierInvoicePaymentControl includes the entity PaymentControl. PaymentControl includes the following attributes: BankTransferListCompleteTransmissionIndicator, BillOfExchangePayablePaymentListCompleteTransmissionIndicator, BillOfExchangeReceivablePaymentListCompleteTransmissionIndicator, CreditCardPaymentListCompleteTransmissionIndicator, ChequePaymentListCompleteTransmissionIndicator, and ActionCode. BankTransferListCompleteTransmissionIndicator may have a multiplicity of 0 . . . 1 and may be based on datatype CDT:Indicator. BillOfExchangePayablePaymentListCompleteTransmissionIndicator may have a multiplicity of 0 . . . 1 and may be based on datatype CDT:Indicator. BillOfExchangeReceivablePaymentListCompleteTransmissionIndicator may have a multiplicity of 0 . . . 1 and may be based on datatype CDT:Indicator. CreditCardPaymentListCompleteTransmissionIndicator may have a multiplicity of 0 . . . 1 and may be based on datatype CDT:Indicator. ChequePaymentListCompleteTransmissionIndicator may have a multiplicity of 0 . . . 1 and may be based on datatype CDT:Indicator. ActionCode may have a multiplicity of 0 . . . 1 and may be based on datatype BGDT:ActionCode.

PaymentControl includes the following non-node elements: UUID, PaymentProcessingCompanyUUID, PaymentProcessingCompanyID, PaymentProcessingBusinessPartnerUUID, PaymentProcessingBusinessPartnerID, ResponsibleEmployeeUUID, ResponsibleEmployeeID, PropertyMovementDirectionCode, PaymentFormCode, PaymentAmount, ExchangeRate, ExchangeRateUnitCurrencyName, ExchangeRateQuotedCurrencyName, PaymentBlock, PaymentBlockPaymentBlockingReasonName, FirstPaymentInstructionTypeCode, SecondPaymentInstructionTypeCode, ThirdPaymentInstructionTypeCode, FourthPaymentInstructionTypeCode, BankChargeBearerCode, PaymentPriorityCode, SinglePaymentIndicator, DebitValueDate, CreditValueDate, PaymentReceivablesPayablesGroupID, PaymentReferenceID, PaymentReferenceTypeCode, Note, BankTransfer, BillOfExchangePayablePayment, BillOfExchangeReceivablePayment, CashPayment, CreditCardPayment, and ChequePayment. BankTransfer may include ActionCode, UUID, HouseBankAccountUUID, HouseBankAccountKey, HouseBankUUID, HouseBankInternalID, BankDirectoryEntryUUID, BankInternalID, BankAccountID, BankAccountID, CheckDigitValue, BankAccountTypeCode, BankAccountHolderName, BankAccountStandardID, BusinessPartnerBankDetailsKey, and Amount. BillOfExchangePayablePayment may include ActionCode, UUID, BillOfExchangePayableDrawerID, DrawerPartyRoleCategoryCode, HouseBankUUID, HouseBankAccountUUID, HouseBankAccountKey, BusinessPartnerBankDetailsKey, Amount, IssueDate, DueDate, and DocumentDate. BillOfExchangeReceivablePayment may include ActionCode, UUID, BillOfExchangeReceivableDrawerID, DrawerPartyRoleCategoryCode, PlannedBillOfExchangeUsageCode, Amount, IssueDate, DueDate, DocumentDate, RiskPeriodEndDate, and BusinessPartnerBankDetailsKey. CashPayment may include ActionCode, UUID, CashStorageUUID, and CashStorageKey. CreditCardPayment may include CreditCardPaymentAuthorisationListCompleteTransmissionIndicator, ActionCode, UUID, PaymentCardUUID, PaymentCardKey, BusinessPartnerPaymentCardDetailsKey, PaymentCardDataOriginTypeCode, PaymentCardAutomaticallyGeneratedIndicator, DeviceID, LocationInternalID, ClearingHouseAccountUUID, ClearingHouseAccountKey, PaymentCardVerificationValueText, PaymentCardVerificationValueAvailabilityCode, PaymentCardVerificationValueCheckRequiredIndicator, AuthorisationRequiredIndicator, AuthorisationLimitAmount, AuthorisationValueUnlimitedIndicator, Amount, PaymentAuthorisedAmount, and CreditCardPaymentAuthorisation. CreditCardPaymentAuthorisation may include ActionCode, UUID, ID, ClearingHouseID, ProviderID, PaymentCardHolderAuthenticationID, PaymentCardHolderAuthenticationResultCode, PaymentCardHolderAuthenticationTokenText, DateTime, PaymentCardTransactionTypeCode, PreAuthorisationIndicator, Amount, ExpirationDateTime, ActiveIndicator, AppliedIndicator, ResultCode, PaymentCardAddressVerificationResultCode, ProductRecipientPartyPaymentCardAddressVerificationResultCode, PaymentCardVerificationResultCode, PaymentCardVerificationValueVerificationResultCode, and ResultDescription. ChequePayment may include ActionCode, UUID, HouseBankAccountKey, HouseBankInternalID, and Amount. UUID may have a multiplicity of 0 . . . 1 and may be based on datatype BGDT:UUID. PaymentProcessingCompanyUUID may have a multiplicity of 0 . . . 1 and may be based on datatype BGDT:UUID. PaymentProcessingCompanyID may have a multiplicity of 0 . . . 1 and may be based on datatype BGDT:OrganisationalCentreID. PaymentProcessingBusinessPartnerUUID may have a multiplicity of 0 . . . 1 and may be based on datatype BGDT:UUID. PaymentProcessingBusinessPartnerID may have a multiplicity of 0 . . . 1 and may be based on datatype BGDT:BusinessPartnerInternalID. ResponsibleEmployeeUUID may have a multiplicity of 0 . . . 1 and may be based on datatype BGDT:UUID. ResponsibleEmployeeID may have a multiplicity of 0 . . . 1 and may be based on datatype BGDT:BusinessPartnerinternalID. PropertyMovementDirectionCode may have a multiplicity of 0 . . . 1 and may be based on datatype BGDT:PropertyMovementDirectionCode. PaymentFormCode may have a multiplicity of 0 . . . 1 and may be based on datatype BGDT:PaymentFormCode. PaymentAmount may have a multiplicity of 0 . . . 1 and may be based on datatype CDT:Amount. ExchangeRate may have a multiplicity of 0 . . . 1 and may be based on datatype AGDT:ExchangeRate. ExchangeRateUnitCurrencyName may have a multiplicity of 0 . . . 1 and may be based on datatype CDT:LANGUAGEINDEPENDENT_LONG_Name. ExchangeRateQuotedCurrencyName may have a multiplicity of 0 . . . 1 and may be based on datatype CDT:LANGUAGEINDEPENDENT_LONG_Name. PaymentBlock may have a multiplicity of 0 . . . 1 and may be based on datatype AGDT:PaymentBlock. PaymentBlockPaymentBlockingReasonName may have a multiplicity of 0 . . . 1 and may be based on datatype CDT:LANGUAGEINDEPENDENT_LONG_Name. FirstPaymentInstructionTypeCode may have a multiplicity of 0 . . . 1 and may be based on datatype BGDT:PaymentInstructionTypeCode. SecondPaymentInstructionTypeCode may have a multiplicity of 0 . . . 1 and may be based on datatype BGDT:PaymentInstructionTypeCode. ThirdPaymentInstructionTypeCode may have a multiplicity of 0 . . . 1 and may be based on datatype BGDT:PaymentInstructionTypeCode. FourthPaymentInstructionTypeCode may have a multiplicity of 0 . . . 1 and may be based on datatype BGDT:PaymentInstructionTypeCode. BankChargeBearerCode may have a multiplicity of 0 . . . 1 and may be based on datatype BGDT:BankChargeBearerCode. PaymentPriorityCode may have a multiplicity of 0 . . . 1 and may be based on datatype BGDT:PriorityCode. SinglePaymentIndicator may have a multiplicity of 0 . . . 1 and may be based on datatype CDT:Indicator. DebitValueDate may have a multiplicity of 0 . . . 1 and may be based on datatype CDT:Date. CreditValueDate may have a multiplicity of 0 . . . 1 and may be based on datatype CDT:Date. PaymentReceivablesPayablesGroupID may have a multiplicity of 0 . . . 1 and may be based on datatype BGDT:BusinessTransactionDocumentGroupID. PaymentReferenceID may have a multiplicity of 0 . . . 1 and may be based on datatype BGDT:PaymentReferenceID. PaymentReferenceTypeCode may have a multiplicity of 0 . . . 1 and may be based on datatype BGDT:PaymentReferenceTypeCode. Note may have a multiplicity of 0 . . . 1 and may be based on datatype BGDT:MEDIUM_Note. BankTransfer may have a multiplicity of 0 . . . * and may be based on datatype MIDT:MaintenancePaymentControlBankTransfer. ActionCode may have a multiplicity of 0 . . . 1 and may be based on datatype BGDT:ActionCode. UUID may have a multiplicity of 0 . . . 1 and may be based on datatype BGDT:UUID. HouseBankAccountUUID may have a multiplicity of 0 . . . 1 and may be based on datatype BGDT:UUID. HouseBankAccountKey may have a multiplicity of 0 . . . 1 and may be based on datatype KDT:MaintenancePaymentControlBankTransferHouseBankAccountKey. HouseBankUUID may have a multiplicity of 0 . . . 1 and may be based on datatype BGDT:UUID. HouseBankInternalID may have a multiplicity of 0 . . . 1 and may be based on datatype BGDT:BusinessPartnerInternalID. BankDirectoryEntryUUID may have a multiplicity of 0 . . . 1 and may be based on datatype BGDT:UUID. BankInternalID may have a multiplicity of 0 . . . 1 and may be based on datatype BGDT:BankInternalID. BankAccountID may have a multiplicity of 0 . . . 1 and may be based on datatype BGDT:BankAccountID. BankAccountIDCheckDigitValue may have a multiplicity of 0 . . . 1 and may be based on datatype BGDT:BankAccountIDCheckDigitValue. BankAccountTypeCode may have a multiplicity of 0 . . . 1 and may be based on datatype BGDT:BankAccountTypeCode. BankAccountHolderName may have a multiplicity of 0 . . . 1 and may be based on datatype BGDT:BankAccountHolderName_V1. BankAccountStandardID may have a multiplicity of 0 . . . 1 and may be based on datatype BGDT:BankAccountStandardID. BusinessPartnerBankDetailsKey may have a multiplicity of 0 . . . 1 and may be based on datatype KDT:MaintenancePaymentControlBankTransferBusinessPartnerBankDetailsKey.

Amount may have a multiplicity of 0 . . . 1 and may be based on datatype CDT:Amount. BillOfExchangePayablePayment may have a multiplicity of 0 . . . * and may be based on datatype MIDT:MaintenancePaymentControlBillOfExchangePayablePayment. ActionCode may have a multiplicity of 0 . . . 1 and may be based on datatype BGDT:ActionCode. UUID may have a multiplicity of 0 . . . 1 and may be based on datatype BGDT:UUID. BillOfExchangePayableDrawerID may have a multiplicity of 0 . . . 1 and may be based on datatype BGDT:BusinessTransactionDocumentID. DrawerPartyRoleCategoryCode may have a multiplicity of 0 . . . 1 and may be based on datatype BGDT:PartyRoleCategoryCode. HouseBankUUID may have a multiplicity of 0 . . . 1 and may be based on datatype BGDT:UUID. HouseBankAccountUUID may have a multiplicity of 0 . . . 1 and may be based on datatype BGDT:UUID. HouseBankAccountKey may have a multiplicity of 0 . . . 1 and may be based on datatype KDT:MaintenancePaymentControlBillOfExchangePayablePaymentHouseBankAccountKey. BusinessPartnerBankDetailsKey may have a multiplicity of 0 . . . 1 and may be based on datatype KDT:MaintenancePaymentControlBillOfExchangePayablePaymentBusinessPartnerBankDetailsKey. Amount may have a multiplicity of 0 . . . 1 and may be based on datatype CDT:Amount. IssueDate may have a multiplicity of 0 . . . 1 and may be based on datatype CDT:Date. DueDate may have a multiplicity of 0 . . . 1 and may be based on datatype CDT:Date. DocumentDate may have a multiplicity of 0 . . . 1 and may be based on datatype CDT:Date. BillOfExchangeReceivablePayment may have a multiplicity of 0 . . . * and may be based on datatype MIDT:MaintenancePaymentControlBillOfExchangeReceivablePayment. ActionCode may have a multiplicity of 0 . . . 1 and may be based on datatype BGDT:ActionCode. UUID may have a multiplicity of 0 . . . 1 and may be based on datatype BGDT:UUID. BillOfExchangeReceivableDrawerID may have a multiplicity of 0 . . . 1 and may be based on datatype BGDT:BusinessTransactionDocumentID. DrawerPartyRoleCategoryCode may have a multiplicity of 0 . . . 1 and may be based on datatype BGDT:PartyRoleCategoryCode. PlannedBillOfExchangeUsageCode may have a multiplicity of 0 . . . 1 and may be based on datatype BGDT:BillOfExchangeUsageCode. Amount may have a multiplicity of 0 . . . 1 and may be based on datatype CDT:Amount. IssueDate may have a multiplicity of 0 . . . 1 and may be based on datatype CDT:Date. DueDate may have a multiplicity of 0 . . . 1 and may be based on datatype CDT:Date. DocumentDate may have a multiplicity of 0 . . . 1 and may be based on datatype CDT:Date. RiskPeriodEndDate may have a multiplicity of 0 . . . 1 and may be based on datatype CDT:Date.

BusinessPartnerBankDetailsKey may have a multiplicity of 0 . . . 1 and may be based on datatype KDT:MaintenancePaymentControlBillOfExchangeReceivablePaymentBusinessPartnerBank DetailsKey. CashPayment may have a multiplicity of 0 . . . 1 and may be based on datatype MIDT:MaintenancePaymentControlCashPayment. ActionCode may have a multiplicity of 0 . . . 1 and may be based on datatype BGDT:ActionCode. UUID may have a multiplicity of 0 . . . 1 and may be based on datatype BGDT:UUID. CashStorageUUID may have a multiplicity of 0 . . . 1 and may be based on datatype BGDT:UUID. CashStorageKey may have a multiplicity of 0 . . . 1 and may be based on datatype KDT:MaintenancePaymentControlCashPaymentCashStorageKey. CreditCardPayment may have a multiplicity of 0 . . . * and may be based on datatype MIDT:MaintenancePaymentControlCreditCardPayment. CreditCardPaymentAuthorisationListCompleteTransmissionIndicator may have a multiplicity of 0 . . . 1 and may be based on datatype CDT:Indicator. ActionCode may have a multiplicity of 0 . . . 1 and may be based on datatype BGDT:ActionCode. UUID may have a multiplicity of 0 . . . 1 and may be based on datatype BGDT:UUID. PaymentCardUUID may have a multiplicity of 0 . . . 1 and may be based on datatype BGDT:UUID. PaymentCardKey may have a multiplicity of 0 . . . 1 and may be based on datatype KDT:MaintenancePaymentControlCreditCardPaymentPaymentCardKey. BusinessPartnerPaymentCardDetailsKey may have a multiplicity of 0 . . . 1 and may be based on datatype KDT:MaintenancePaymentControlCreditCardPaymentBusinessPartnerPaymentCardDetailsKey. PaymentCardDataOriginTypeCode may have a multiplicity of 0 . . . 1 and may be based on datatype BGDT:DataOriginTypeCode. PaymentCardAutomaticallyGeneratedIndicator may have a multiplicity of 0 . . . 1 and may be based on datatype CDT:Indicator. DeviceID may have a multiplicity of 0 . . . 1 and may be based on datatype BGDT:DeviceID. LocationInternalID may have a multiplicity of 0 . . . 1 and may be based on datatype BGDT:LocationInternalID. ClearingHouseAccountUUID may have a multiplicity of 0 . . . 1 and may be based on datatype BGDT:UUID. ClearingHouseAccountKey may have a multiplicity of 0 . . . 1 and may be based on datatype KDT:MaintenancePaymentControlCreditCardPaymentClearingHouseAccountKey. PaymentCardVerificationValueText may have a multiplicity of 0 . . . 1 and may be based on datatype BGDT:PaymentCardVerificationValueText. PaymentCardVerificationValueAvailabilityCode may have a multiplicity of 0 . . . 1 and may be based on datatype BGDT:PaymentCardVerificationValueAvailabilityCode. PaymentCardVerificationValueCheckRequiredIndicator may have a multiplicity of 0 . . . 1 and may be based on datatype CDT:Indicator. AuthorisationRequiredIndicator may have a multiplicity of 0 . . . 1 and may be based on datatype CDT:Indicator. AuthorisationLimitAmount may have a multiplicity of 0 . . . 1 and may be based on datatype CDT:Amount. AuthorisationValueUnlimitedIndicator may have a multiplicity of 0 . . . 1 and may be based on datatype CDT:Indicator. Amount may have a multiplicity of 0 . . . 1 and may be based on datatype CDT:Amount. PaymentAuthorisedAmount may have a multiplicity of 0 . . . 1 and may be based on datatype CDT:Amount. CreditCardPaymentAuthorisation may have a multiplicity of 0 . . . * and may be based on datatype MIDT:MaintenancePaymentControlCreditCardPaymentCreditCardPaymentAuthorisation. ActionCode may have a multiplicity of 0 . . . 1 and may be based on datatype BGDT:ActionCode. UUID may have a multiplicity of 0 . . . 1 and may be based on datatype BGDT:UUID. ID may have a multiplicity of 0 . . . 1 and may be based on datatype BGDT:PaymentCardPaymentAuthorisationPartyID_V1. ClearingHouseID may have a multiplicity of 0 . . . 1 and may be based on datatype BGDT:PaymentCardPaymentAuthorisationPartyID_V1. ProviderID may have a multiplicity of 0 . . . 1 and may be based on datatype BGDT:PaymentCardPaymentAuthorisationPartyID_V1. PaymentCardHolderAuthenticationID may have a multiplicity of 0 . . . 1 and may be based on datatype BGDT:PaymentCardHolderAuthenticationID. PaymentCardHolderAuthenticationResultCode may have a multiplicity of 0 . . . 1 and may be based on datatype BGDT:PaymentCardHolderAuthenticationResultCode. PaymentCardHolderAuthenticationTokenText may have a multiplicity of 0 . . . 1 and may be based on datatype BGDT: PaymentCardHolderAuthenticationTokenText. DateTime may have a multiplicity of 0 . . . 1 and may be based on datatype CDT:GLOBAL_DateTime. PaymentCardTransactionTypeCode may have a multiplicity of 0 . . . 1 and may be based on datatype BGDT:PaymentCardTransactionTypeCode. PreAuthorisationIndicator may have a multiplicity of 0 . . . 1 and may be based on datatype CDT:Indicator. Amount may have a multiplicity of 0 . . . 1 and may be based on datatype CDT:Amount. ExpirationDateTime may have a multiplicity of 0 . . . 1 and may be based on datatype CDT:GLOBAL_DateTime. ActiveIndicator may have a multiplicity of 0 . . . 1 and may be based on datatype CDT:Indicator. AppliedIndicator may have a multiplicity of 0 . . . 1 and may be based on datatype CDT:Indicator. ResultCode may have a multiplicity of 0 . . . 1 and may be based on datatype BGDT:AuthorisationResultCode. PaymentCardAddressVerificationResultCode may have a multiplicity of 0 . . . 1 and may be based on datatype BGDT:PaymentCardAddressVerificationResultCode. ProductRecipientPartyPaymentCardAddressVerificationResultCode may have a multiplicity of 0 . . . 1 and may be based on datatype BGDT:PaymentCardAddressVerificationResultCode. PaymentCardVerificationResultCode may have a multiplicity of 0 . . . 1 and may be based on datatype BGDT:PaymentCardVerificationResultCode. PaymentCardVerificationValueVerificationResultCode may have a multiplicity of 0 . . . 1 and may be based on datatype BGDT:PaymentCardVerificationValueVerificationResultCode. ResultDescription may have a multiplicity of 0 . . . 1 and may be based on datatype BGDT:SHORT_Description. ChequePayment may have a multiplicity of 0 . . . * and may be based on datatype MIDT:MaintenancePaymentControlChequePayment. ActionCode may have a multiplicity of 0 . . . 1 and may be based on datatype BGDT:ActionCode. UUID may have a multiplicity of 0 . . . 1 and may be based on datatype BGDT:UUID. HouseBankAccountKey may have a multiplicity of 0 . . . 1 and may be based on datatype KDT:MaintenancePaymentControlChequePaymentHouseBankAccountKey. HouseBankInternalID may have a multiplicity of 0 . . . 1 and may be based on datatype BGDT:BusinessPartnerInternalID. Amount may have a multiplicity of 0 . . . 1 and may be based on datatype CDT:Amount.

The package SupplierInvoiceAttachmentFolder includes the entity AttachmentFolder. AttachmentFolder includes the following attributes: DocumentListCompleteTransmissionIndicator and ActionCode. DocumentListCompleteTransmissionIndicator may have a multiplicity of 0 . . . 1 and may be based on datatype CDT:Indicator. ActionCode may have a multiplicity of 0 . . . 1 and may be based on datatype BGDT:ActionCode. AttachmentFolder includes the UUID non-node element, which may have a multiplicity of 0 . . . 1 and may be based on datatype BGDT:UUID. AttachmentFolder includes the node element Document in a 1:CN cardinality relationship.

The package SupplierInvoiceAttachmentFolder includes the entity Document. Document includes the following attributes: PropertyListCompleteTransmissionIndicator and ActionCode. PropertyListCompleteTransmissionIndicator may have a multiplicity of 0 . . . 1 and may be based on datatype CDT:Indicator. ActionCode may have a multiplicity of 0 . . . 1 and may be based on datatype BGDT:ActionCode. Document includes the following non-node elements: UUID, LinkInternalIndicator, VisibleIndicator, CategoryCode, TypeCode, MIMECode, Name, AlternativeName, InternalLinkUUID, ExternalLinkWebURI, and Description. UUID may have a multiplicity of 0 . . . 1 and may be based on datatype BGDT:UUID. LinkInternalIndicator may have a multiplicity of 0 . . . 1 and may be based on datatype CDT:Indicator. VisibleIndicator may have a multiplicity of 0 . . . 1 and may be based on datatype CDT:Indicator. CategoryCode may have a multiplicity of 0 . . . 1 and may be based on datatype BGDT:DocumentCategoryCode. TypeCode may have a multiplicity of 0 . . . 1 and may be based on datatype BGDT:DocumentTypeCode. MIMECode may have a multiplicity of 0 . . . 1 and may be based on datatype BGDT:MIMECode. Name may have a multiplicity of 0 . . . 1 and may be based on datatype CDT:LANGUAGEINDEPENDENT_Name. AlternativeName may have a multiplicity of 0 . . . 1 and may be based on datatype CDT:LANGUAGEINDEPENDENT_Name. InternalLinkUUID may have a multiplicity of 0 . . . 1 and may be based on datatype BGDT:UUID. ExternalLinkWebURI may have a multiplicity of 0 . . . 1 and may be based on datatype BGDT:WebURI. Description may have a multiplicity of 0 . . . 1 and may be based on datatype BGDT:Description.

Document includes the node element FileContent in a 1:C cardinality relationship and the node element Property in a 1:CN cardinality relationship. FileContent includes the ActionCode attribute, which may have a multiplicity of 0 . . . 1 and may be based on datatype BGDT:ActionCode. FileContent includes the following non-node elements: TechnicalID and BinaryObject. TechnicalID may have a multiplicity of 0 . . . 1 and may be based on datatype BGDT:ObjectNodeTechnicalID. BinaryObject may have a multiplicity of 0 . . . 1 and may be based on datatype CDT:BinaryObject.

Property includes the following attributes: PropertyValueListCompleteTransmissionIndicator and ActionCode. PropertyValueListCompleteTransmissionIndicator may have a multiplicity of 0 . . . 1 and may be based on datatype CDT:Indicator. ActionCode may have a multiplicity of 0 . . . 1 and may be based on datatype BGDT:ActionCode. Property includes the following non-node elements: TechnicalID, Name, DataTypeFormatCode, VisibleIndicator, ChangeAllowedIndicator, MultipleValueIndicator, NamespaceURI, and Description.

TechnicalID may have a multiplicity of 0 . . . 1 and may be based on datatype BGDT:ObjectNodeTechnicalID. Name may have a multiplicity of 0 . . . 1 and may be based on datatype CDT:LANGUAGEINDEPENDENT_Name. DataTypeFormatCode may have a multiplicity of 0 . . . 1 and may be based on datatype BGDT:PropertyDataTypeFormatCode. VisibleIndicator may have a multiplicity of 0 . . . 1 and may be based on datatype CDT:Indicator. ChangeAllowedIndicator may have a multiplicity of 0 . . . 1 and may be based on datatype CDT:Indicator. MultipleValueIndicator may have a multiplicity of 0 . . . 1 and may be based on datatype CDT:Indicator. NamespaceURI may have a multiplicity of 0 . . . 1 and may be based on datatype BGDT:NamespaceURI. Description may have a multiplicity of 0 . . . 1 and may be based on datatype BGDT:Description.

Property includes the node element PropertyValue in a 1:CN cardinality relationship. PropertyValue includes the ActionCode attribute, which may have a multiplicity of 0 . . . 1 and may be based on datatype BGDT:ActionCode. PropertyValue includes the following non-node elements: TechnicalID, Text, Indicator, DateTime, and IntegerValue. TechnicalID may have a multiplicity of 0 . . . 1 and may be based on datatype BGDT:ObjectNodeTechnicalID. Text may have a multiplicity of 0 . . . 1 and may be based on datatype CDT:LANGUAGEINDEPENDENT_Text. Indicator may have a multiplicity of 0 . . . 1 and may be based on datatype CDT:Indicator. DateTime may have a multiplicity of 0 . . . 1 and may be based on datatype CDT:GLOBAL_DateTime. IntegerValue may have a multiplicity of 0 . . . 1 and may be based on datatype BGDT:IntegerValue.

The package SupplierInvoiceTextCollection includes the entity TextCollection. TextCollection includes the following attributes: TextListCompleteTransmissionIndicator and ActionCode. TextListCompleteTransmissionIndicator may have a multiplicity of 0 . . . 1 and may be based on datatype CDT:Indicator. ActionCode may have a multiplicity of 0 . . . 1 and may be based on datatype BGDT:ActionCode. TextCollection includes the UUID non-node element, which may have a multiplicity of 0 . . . 1 and may be based on datatype BGDT:UUID. TextCollection includes the Text node element in a 1:CN cardinality relationship.

The package SupplierInvoiceTextCollection includes the entity Text. Text includes the ActionCode attribute, which may have a multiplicity of 0 . . . 1 and may be based on datatype BGDT:ActionCode. Text includes the following non-node elements: TechnicalID, TypeCode, and CreationDateTime. TechnicalID may have a multiplicity of 0 . . . 1 and may be based on datatype BGDT:ObjectNodeTechnicalID. TypeCode may have a multiplicity of 0 . . . 1 and may be based on datatype BGDT:TextCollectionTextTypeCode. CreationDateTime may have a multiplicity of 0 . . . 1 and may be based on datatype CDT:GLOBAL_DateTime. Text includes the node element TextContent in a 1:C cardinality relationship.

TextContent includes the ActionCode attribute, which may have a multiplicity of 0 . . . 1 and may be based on datatype BGDT:ActionCode. TextContent includes the following non-node elements: TechnicalID and Text. TechnicalID may have a multiplicity of 0 . . . 1 and may be based on datatype BGDT:ObjectNodeTechnicalID. Text may have a multiplicity of 0 . . . 1 and may be based on datatype CDT:Text.

The package SupplierInvoiceItem includes the sub-packages ProductInformation, AccountingCodingBlockDistribution, Tax, BusinessTransactionDocumentReference, Party, Location, AttachmentFolder, and TextCollection, and the entity Item. Item includes the actionCode attribute, which may have a multiplicity of 0 . . . 1 and may be based on datatype BGDT:ActionCode. Item includes the following non-node elements: ObjectNodeSenderTechnicalID, BusinessTransactionDocumentItemTypeCode, Quantity, QuantityTypeCode, SHORT_Description, NetAmount, NetUnitPrice, GrossAmount, GrossUnitPrice, and CostDistributionIndicator. ObjectNodeSenderTechnicalID may have a multiplicity of 0 . . . 1 and may be based on datatype BGDT:ObjectNodePartyTechnicalID. BusinessTransactionDocumentItemTypeCode may have a multiplicity of 1 and may be based on datatype BGDT:BusinessTransactionDocumentItemTypeCode. Quantity may have a multiplicity of 0 . . . 1 and may be based on datatype CDT:Quantity. QuantityTypeCode may have a multiplicity of 0 . . . 1 and may be based on datatype BGDT:QuantityTypeCode. SHORT_Description may have a multiplicity of 0 . . . 1 and may be based on datatype BGDT:SHORT_Description. NetAmount may have a multiplicity of 0 . . . 1 and may be based on datatype CDT:Amount. NetUnitPrice may have a multiplicity of 0 . . . 1 and may be based on datatype AGDT:Price. GrossAmount may have a multiplicity of 0 . . . 1 and may be based on datatype CDT:Amount. GrossUnitPrice may have a multiplicity of 0 . . . 1 and may be based on datatype AGDT:Price. CostDistributionIndicator may have a multiplicity of 0 . . . 1 and may be based on datatype CDT:Indicator. Item includes the following node elements: Product, in a 1:C cardinality relationship; AccountingCodingBlockDistribution, in a 1:C cardinality relationship; ProductTax, in a 1:C cardinality relationship; PurchaseOrderReference, in a 1:C cardinality relationship; PurchasingContractReference, in a 1:C cardinality relationship; ProcurementReleaseOrderReference, in a 1:C cardinality relationship; ServicePerformerParty, in a 1:C cardinality relationship; RequestorParty in a 1:C cardinality relationship; ProductRecipientParty, in a 1:C cardinality relationship; EndBuyerParty, in a 1:C cardinality relationship; InternalChargeToParty, in a 1:C cardinality relationship; ShipToLocation, in a 1:C cardinality relationship; ShipFromLocation, in a 1:C cardinality relationship; MaintenanceAttachmentFolder, in a 1:C cardinality relationship; and MaintenanceTextCollection, in a 1:C cardinality relationship.

The package SupplierInvoiceItemProductInformation includes the entity Product. Product includes the actionCode attribute, which may have a multiplicity of 0 . . . 1 and may be based on datatype BGDT:ActionCode. Product includes the following non-node elements: ObjectNodePartyTechnicalID, ProductStandardID, ProductCategoryStandardID, CashDiscountDeductibleIndicator, ProductCategoryIDKey, and ProductKey. ObjectNodePartyTechnicalID may have a multiplicity of 0 . . . 1 and may be based on datatype BGDT:ObjectNodePartyTechnicalID. ProductStandardID may have a multiplicity of 0 . . . 1 and may be based on datatype BGDT:ProductStandardID. ProductCategoryStandardID may have a multiplicity of 0 . . . 1 and may be based on datatype BGDT:ProductCategoryStandardID. CashDiscountDeductibleIndicator may have a multiplicity of 1 and may be based on datatype CDT:Indicator. ProductCategoryIDKey may have a multiplicity of 0 . . . 1 and may be based on datatype KDT:ProductCategoryHierarchyProductCategoryIDKey. ProductKey may have a multiplicity of 0 . . . 1 and may be based on datatype KDT:ProductKey.

The package SupplierInvoiceItemAccountingCodingBlockDistribution includes the entity AccountingCodingBlockDistribution. AccountingCodingBlockDistribution includes the following attributes: AccountingCodingBlockAssignmentListCompleteTransmissionIndicator and ActionCode. AccountingCodingBlockAssignmentListCompleteTransmissionIndicator may have a multiplicity of 0 . . . 1 and may be based on datatype CDT:Indicator. ActionCode may have a multiplicity of 0 . . . 1 and may be based on datatype BGDT:ActionCode. AccountingCodingBlockDistribution includes the following non-node elements: UUID, ValidityDate, CompanyID, IdentityID, LanguageCode, TemplateIndicator, GeneralLedgerAccountAliasCode, GeneralLedgerAccountAliasContextCodeElements, GeneralLedgerAccountAliasContextCodeElementsUsageName, HostObjectTypeCode, TotalAmount, and TotalQuantity. UUID may have a multiplicity of 0 . . . 1 and may be based on datatype BGDT:UUID. ValidityDate may have a multiplicity of 0 . . . 1 and may be based on datatype CDT:Date. CompanyID may have a multiplicity of 0 . . . 1 and may be based on datatype BGDT:OrganisationalCentreID. IdentityID may have a multiplicity of 0 . . . 1 and may be based on datatype BGDT:IdentityID. LanguageCode may have a multiplicity of 0 . . . 1 and may be based on datatype BGDT:LanguageCode. TemplateIndicator may have a multiplicity of 0 . . . 1 and may be based on datatype CDT:Indicator. GeneralLedgerAccountAliasCode may have a multiplicity of 0 . . . 1 and may be based on datatype BGDT:GeneralLedgerAccountAliasCode. GeneralLedgerAccountAliasContextCodeElements may have a multiplicity of 0 . . . 1 and may be based on datatype GDT:GeneralLedgerAccountAliasCodeContextElements. GeneralLedgerAccountAliasContextCodeElementsUsageName may have a multiplicity of 0 . . . 1 and may be based on datatype CDT:LANGUAGEINDEPENDENT_LONG_Name. HostObjectTypeCode may have a multiplicity of 0 . . . 1 and may be based on datatype BGDT:ObjectTypeCode. TotalAmount may have a multiplicity of 0 . . . 1 and may be based on datatype CDT:Amount. TotalQuantity may have a multiplicity of 0 . . . 1 and may be based on datatype CDT:Quantity. AccountingCodingBlockDistribution includes the node element AccountingCodingBlockAssignment in a 1:CN cardinality relationship.

The package SupplierInvoiceItemAccountingCodingBlockDistribution includes the entity AccountingCodingBlockAssignment. AccountingCodingBlockAssignment includes the ActionCode attribute, which may have a multiplicity of 0 . . . 1 and may be based on datatype BGDT:ActionCode. AccountingCodingBlockAssignment includes the following non-node elements: TechnicalID, Percent, Amount, Quantity, AccountingCodingBlockTypeCode, AccountDeterminationExpenseGroupCode, GeneralLedgerAccountAliasCode, ProfitCentreID, ProfitCentreUUID, CostCentreID, CostCentreUUID, IndividualMaterialKey, IndividualMaterialUUID, ProjectTaskKey, ProjectReference, ProjectReferenceProjectElementTypeName, SalesOrderReference, SalesOrderReferenceTypeName, SalesOrderReferenceItemTypeName, SalesOrderName, SalesOrderhemDescription, ServiceOrderReference, ServiceOrderReferenceTypeName, ServiceOrderReferenceItemTypeName, ServiceOrderName, and ServiceOrderItemDescription. TechnicalID may have a multiplicity of 0 . . . 1 and may be based on datatype BGDT:ObjectNodeTechnicalID. Percent may have a multiplicity of 0 . . . 1 and may be based on datatype CDT:Percent. Amount may have a multiplicity of 0 . . . 1 and may be based on datatype CDT:Amount. Quantity may have a multiplicity of 0 . . . 1 and may be based on datatype CDT:Quantity. AccountingCodingBlockTypeCode may have a multiplicity of 0 . . . 1 and may be based on datatype BGDT:AccountingCodingBlockTypeCode. AccountDeterminationExpenseGroupCode may have a multiplicity of 0 . . . 1 and may be based on datatype BGDT:AccountDeterminationExpenseGroupCode. GeneralLedgerAccountAliasCode may have a multiplicity of 0 . . . 1 and may be based on datatype BGDT:GeneralLedgerAccountAliasCode. ProfitCentreID may have a multiplicity of 0 . . . 1 and may be based on datatype BGDT:OrganisationalCentreID. ProfitCentreUUID may have a multiplicity of 0 . . . 1 and may be based on datatype BGDT:UUID. CostCentreID may have a multiplicity of 0 . . . 1 and may be based on datatype BGDT:OrganisationalCentreID. CostCentreUUID may have a multiplicity of 0 . . . 1 and may be based on datatype BGDT:UUID. IndividualMaterialKey may have a multiplicity of 0 . . . 1 and may be based on datatype KDT:MaintenanceAccountingCodingBlockDistributionAccountingCodingBlockAssignmentIndividualMaterialKey. IndividualMaterialUUID may have a multiplicity of 0 . . . 1 and may be based on datatype BGDT:UUID. ProjectTaskKey may have a multiplicity of 0 . . . 1 and may be based on datatype KDT:MaintenanceAccountingCodingBlockDistributionAccountingCodingBlockAssignment ProjectTaskKey. ProjectReference may have a multiplicity of 0 . . . 1 and may be based on datatype AGDT:ProjectReference. ProjectReferenceProjectElementTypeName may have a multiplicity of 0 . . . 1 and may be based on datatype CDT:LANGUAGEINDEPENDENT_LONG_Name. SalesOrderReference may have a multiplicity of 0 . . . 1 and may be based on datatype AGDT:BusinessTransactionDocumentReference. SalesOrderReferenceTypeName may have a multiplicity of 0 . . . 1 and may be based on datatype CDT:LANGUAGEINDEPENDENT_LONG_Name. SalesOrderReferenceItemTypeName may have a multiplicity of 0 . . . 1 and may be based on datatype CDT:LANGUAGEINDEPENDENT_LONG_Name. SalesOrderName may have a multiplicity of 0 . . . 1 and may be based on datatype CDT:EXTENDED_Name. SalesOrderItemDescription may have a multiplicity of 0 . . . 1 and may be based on datatype BGDT:SHORT_Description. ServiceOrderReference may have a multiplicity of 0 . . . 1 and may be based on datatype AGDT:BusinessTransactionDocumentReference. ServiceOrderReferenceTypeName may have a multiplicity of 0 . . . 1 and may be based on datatype CDT:LANGUAGEINDEPENDENT_LONG_Name. ServiceOrderReferenceItemTypeName may have a multiplicity of 0 . . . 1 and may be based on datatype CDT:LANGUAGEINDEPENDENT_LONG_Name. ServiceOrderName may have a multiplicity of 0 . . . 1 and may be based on datatype CDT:EXTENDED_Name. ServiceOrderItemDescription may have a multiplicity of 0 . . . 1 and may be based on datatype BGDT: SHORT_Description.

The package SupplierInvoiceItemTax includes the entity ProductTax. ProductTax includes the actionCode attribute, which may have a multiplicity of 0 . . . 1 and may be based on datatype BGDT:ActionCode. ProductTax includes the following non-node elements: ObjectNodePartyTechnicalID, ProductTaxationCharacteristicsCode, WithholdingTaxationCharacteristicsCode, and CountryCode. ObjectNodePartyTechnicalID may have a multiplicity of 0 . . . 1 and may be based on datatype BGDT:ObjectNodePartyTechnicalID. ProductTaxationCharacteristicsCode may have a multiplicity of 0 . . . 1 and may be based on datatype BGDT:ProductTaxationCharacteristicsCode. WithholdingTaxationCharacteristicsCode may have a multiplicity of 0 . . . 1 and may be based on datatype BGDT:WithholdingTaxationCharacteristicsCode. CountryCode may have a multiplicity of 0 . . . 1 and may be based on datatype BGDT:CountryCode.

The package SupplierInvoiceItemBusinessTransactionDocumentReference includes the entities PurchaseOrderReference, PurchasingContractReference, and ProcurementReleaseOrderReference. PurchaseOrderReference includes the actionCode attribute, which may have a multiplicity of 0 . . . 1 and may be based on datatype BGDT:ActionCode. PurchaseOrderReference includes the following non-node elements: ObjectNodePartyTechnicalID and BusinessTransactionDocumentReference. ObjectNodePartyTechnicalID may have a multiplicity of 0 . . . 1 and may be based on datatype BGDT:ObjectNodePartyTechnicalID. BusinessTransactionDocumentReference may have a multiplicity of 0 . . . 1 and may be based on datatype AGDT:BusinessTransactionDocumentReference.

PurchasingContractReference includes the actionCode attribute, which may have a multiplicity of 0 . . . 1 and may be based on datatype BGDT:ActionCode.

PurchasingContractReference includes the following non-node elements: ObjectNodePartyTechnicalID and BusinessTransactionDocumentReference. ObjectNodePartyTechnicalID may have a multiplicity of 0 . . . 1 and may be based on datatype BGDT:ObjectNodePartyTechnicalID. BusinessTransactionDocumentReference may have a multiplicity of 0 . . . 1 and may be based on datatype AGDT:BusinessTransactionDocumentReference. ProcurementReleaseOrderReference includes the actionCode attribute, which may have a multiplicity of 0 . . . 1 and may be based on datatype BGDT:ActionCode. ProcurementReleaseOrderReference includes the following non-node elements: ObjectNodePartyTechnicalID and BusinessTransactionDocumentReference. ObjectNodePartyTechnicalID may have a multiplicity of 0 . . . 1 and may be based on datatype BGDT:ObjectNodePartyTechnicalID. BusinessTransactionDocumentReference may have a multiplicity of 0 . . . 1 and may be based on datatype AGDT:BusinessTransactionDocumentReference.

The package SupplierInvoiceItemParty includes the entities ServicePerformerParty, RequestorParty, ProductRecipientParty, EndBuyerParty, and InternalChargeToParty. ServicePerformerParty includes the actionCode attribute, which may have a multiplicity of 0 . . . 1 and may be based on datatype BGDT:ActionCode. SupplierInvoiceItemParty includes the following non-node elements: ObjectNodePartyTechnicalID and PartyKey. ObjectNodePartyTechnicalID may have a multiplicity of 0 . . . 1 and may be based on datatype BGDT:ObjectNodePartyTechnicalID. PartyKey may have a multiplicity of 0 . . . 1 and may be based on datatype KDT:PartyKey.

RequestorParty includes the actionCode attribute, which may have a multiplicity of 0 . . . 1 and may be based on datatype BGDT:ActionCode. RequestorParty includes the following non-node elements: ObjectNodePartyTechnicalID and PartyKey. ObjectNodePartyTechnicalID may have a multiplicity of 0 . . . 1 and may be based on datatype BGDT:ObjectNodePartyTechnicalID. PartyKey may have a multiplicity of 0 . . . 1 and may be based on datatype KDT:PartyKey.

ProductRecipientParty includes the actionCode attribute, which may have a multiplicity of 0 . . . 1 and may be based on datatype BGDT:ActionCode. ProductRecipientParty includes the following non-node elements: ObjectNodePartyTechnicalID and PartyKey. ObjectNodePartyTechnicalID may have a multiplicity of 0 . . . 1 and may be based on datatype BGDT:ObjectNodePartyTechnicalID. PartyKey may have a multiplicity of 0 . . . 1 and may be based on datatype KDT:PartyKey.

EndBuyerParty includes the actionCode attribute, which may have a multiplicity of 0 . . . 1 and may be based on datatype BGDT:ActionCode. EndBuyerParty includes the following non-node elements: ObjectNodePartyTechnicalID and PartyKey. ObjectNodePartyTechnicalID may have a multiplicity of 0 . . . 1 and may be based on datatype BGDT:ObjectNodePartyTechnicalID. PartyKey may have a multiplicity of 0 . . . 1 and may be based on datatype KDT:PartyKey. InternalChargeToParty includes the actionCode attribute, which may have a multiplicity of 0 . . . 1 and may be based on datatype BGDT:ActionCode. InternalChargeToParty includes the following non-node elements: ObjectNodePartyTechnicalID and PartyKey. ObjectNodePartyTechnicalID may have a multiplicity of 0 . . . 1 and may be based on datatype BGDT:ObjectNodePartyTechnicalID. PartyKey may have a multiplicity of 0 . . . 1 and may be based on datatype KDT:PartyKey.

The package SupplierInvoiceItemLocation includes the entities ShipToLocation and ShipFromLocation. ShipToLocation includes the actionCode attribute, which may have a multiplicity of 0 . . . 1 and may be based on datatype BGDT:ActionCode. ShipToLocation includes the following non-node elements: ObjectNodePartyTechnicalID and LocationID. ObjectNodePartyTechnicalID may have a multiplicity of 0 . . . 1 and may be based on datatype BGDT:ObjectNodePartyTechnicalID. LocationID may have a multiplicity of 0 . . . 1 and may be based on datatype BGDT:LocationID.

ShipFromLocation includes the actionCode attribute, which may have a multiplicity of 0 . . . 1 and may be based on datatype BGDT:ActionCode. ShipFromLocation includes the following non-node elements: ObjectNodePartyTechnicalID and LocationID. ObjectNodePartyTechnicalID may have a multiplicity of 0 . . . 1 and may be based on datatype BGDT:ObjectNodePartyTechnicalID. LocationID may have a multiplicity of 0 . . . 1 and may be based on datatype BGDT:LocationID.

The package SupplierInvoiceItemAttachmentFolder includes the entity MaintenanceAttachmentFolder. MaintenanceAttachmentFolder includes the following attributes: DocumentListCompleteTransmissionIndicator and ActionCode. DocumentListCompleteTransmissionIndicator may have a multiplicity of 0 . . . 1 and may be based on datatype CDT:Indicator. ActionCode may have a multiplicity of 0 . . . 1 and may be based on datatype BGDT:ActionCode. MaintenanceAttachmentFolder includes the UUID non-node element, which may have a multiplicity of 0 . . . 1 and may be based on datatype BGDT:UUID. MaintenanceAttachmentFolder includes the node element Document in a 1:CN cardinality relationship.

The package SupplierInvoiceItemAttachmentFolder includes the entity Document. Document includes the following attributes: PropertyListCompleteTransmissionIndicator and ActionCode. PropertyListCompleteTransmissionIndicator may have a multiplicity of 0 . . . 1 and may be based on datatype CDT:Indicator. ActionCode may have a multiplicity of 0 . . . 1 and may be based on datatype BGDT:ActionCode. Document includes the following non-node elements: UUID, LinkInternalIndicator, VisibleIndicator, CategoryCode, TypeCode, MIMECode, Name, AlternativeName, InternalLinkUUID, ExternalLinkWebURI, and Description. UUID may have a multiplicity of 0 . . . 1 and may be based on datatype BGDT:UUID. LinkInternalIndicator may have a multiplicity of 0 . . . 1 and may be based on datatype CDT:Indicator. VisibleIndicator may have a multiplicity of 0 . . . 1 and may be based on datatype CDT:Indicator. CategoryCode may have a multiplicity of 0 . . . 1 and may be based on datatype BGDT:DocumentCategoryCode. TypeCode may have a multiplicity of 0 . . . 1 and may be based on datatype BGDT:DocumentTypeCode. MIMECode may have a multiplicity of 0 . . . 1 and may be based on datatype BGDT:MIMECode. Name may have a multiplicity of 0 . . . 1 and may be based on datatype CDT:LANGUAGEINDEPENDENT_Name. AlternativeName may have a multiplicity of 0 . . . 1 and may be based on datatype CDT:LANGUAGEINDEPENDENT_Name. InternalLinkUUID may have a multiplicity of 0 . . . 1 and may be based on datatype BGDT:UUID. ExternalLinkWebURI may have a multiplicity of 0 . . . 1 and may be based on datatype BGDT:WebURI. Description may have a multiplicity of 0 . . . 1 and may be based on datatype BGDT:Description.

Document includes the node element FileContent in a 1:C cardinality relationship and the node element Property, in a 1:CN cardinality relationship. FileContent includes the ActionCode attribute, which may have a multiplicity of 0 . . . 1 and may be based on datatype BGDT:ActionCode. FileContent includes the following non-node elements: TechnicalID and BinaryObject. TechnicalID may have a multiplicity of 0 . . . 1 and may be based on datatype BGDT:ObjectNodeTechnicalID. BinaryObject may have a multiplicity of 0 . . . 1 and may be based on datatype CDT:BinaryObject.

Property includes the following attributes: PropertyValueListCompleteTransmissionIndicator and ActionCode. PropertyValueListCompleteTransmissionIndicator may have a multiplicity of 0 . . . 1 and may be based on datatype CDT:Indicator. ActionCode may have a multiplicity of 0 . . . 1 and may be based on datatype BGDT:ActionCode. Property includes the following non-node elements: TechnicalID, Name, DataTypeFormatCode, VisibleIndicator, ChangeAllowedIndicator, MultipleValueIndicator, NamespaceURI, and Description. TechnicalID may have a multiplicity of 0 . . . 1 and may be based on datatype BGDT:ObjectNodeTechnicalID. Name may have a multiplicity of 0 . . . 1 and may be based on datatype CDT:LANGUAGEINDEPENDENT_Name. DataTypeFormatCode may have a multiplicity of 0 . . . 1 and may be based on datatype BGDT:PropertyDataTypeFormatCode. VisibleIndicator may have a multiplicity of 0 . . . 1 and may be based on datatype CDT:Indicator. ChangeAllowedIndicator may have a multiplicity of 0 . . . 1 and may be based on datatype CDT:Indicator. MultipleValueIndicator may have a multiplicity of 0 . . . 1 and may be based on datatype CDT:Indicator. NamespaceURI may have a multiplicity of 0 . . . 1 and may be based on datatype BGDT:NamespaceURI. Description may have a multiplicity of 0 . . . 1 and may be based on datatype BGDT:Description.

Property includes the node element PropertyValue in a 1:CN cardinality relationship. PropertyValue includes the ActionCode attribute, which may have a multiplicity of 0 . . . 1 and may be based on datatype BGDT:ActionCode. PropertyValue includes the following non-node elements: TechnicalID, Text, Indicator, DateTime, and IntegerValue. TechnicalID may have a multiplicity of 0 . . . 1 and may be based on datatype BGDT:ObjectNodeTechnicalID. Text may have a multiplicity of 0 . . . 1 and may be based on datatype CDT:LANGUAGEINDEPENDENT_Text. Indicator may have a multiplicity of 0 . . . 1 and may be based on datatype CDT:Indicator. DateTime may have a multiplicity of 0 . . . 1 and may be based on datatype CDT:GLOBAL_DateTime. IntegerValue may have a multiplicity of 0 . . . 1 and may be based on datatype BGDT:IntegerValue.

The package SupplierInvoiceItemTextCollection includes the entity MaintenanceTextCollection. MaintenanceTextCollection includes the following attributes: TextListCompleteTransmissionIndicator and ActionCode. TextListCompleteTransmissionIndicator may have a multiplicity of 0 . . . 1 and may be based on datatype CDT:Indicator. ActionCode may have a multiplicity of 0 . . . 1 and may be based on datatype BGDT:ActionCode. MaintenanceTextCollection includes the UUID non-node element, which may have a multiplicity of 0 . . . 1 and may be based on datatype BGDT:UUID.

MaintenanceTextCollection includes the node element Text in a 1:CN cardinality relationship. The package SupplierInvoiceItemTextCollection includes the entity Text. Text includes the ActionCode attribute, which may have a multiplicity of 0 . . . 1 and may be based on datatype BGDT:ActionCode. Text includes the following non-node elements: TechnicalID, TypeCode, and CreationDateTime. TechnicalID may have a multiplicity of 0 . . . 1 and may be based on datatype BGDT:ObjectNodeTechnicalID. TypeCode may have a multiplicity of 0 . . . 1 and may be based on datatype BGDT:TextCollectionTextTypeCode. CreationDateTime may have a multiplicity of 0 . . . 1 and may be based on datatype CDT:GLOBAL_DateTime.

Text includes the node element TextContent in a 1:C cardinality relationship. TextContent includes the ActionCode attribute, which may have a multiplicity of 0 . . . 1 and may be based on datatype BGDT:ActionCode. TextContent includes the following non-node elements: TechnicalID and Text. TechnicalID may have a multiplicity of 0 . . . 1 and may be based on datatype BGDT:ObjectNodeTechnicalID. Text may have a multiplicity of 0 . . . 1 and may be based on datatype CDT:Text.

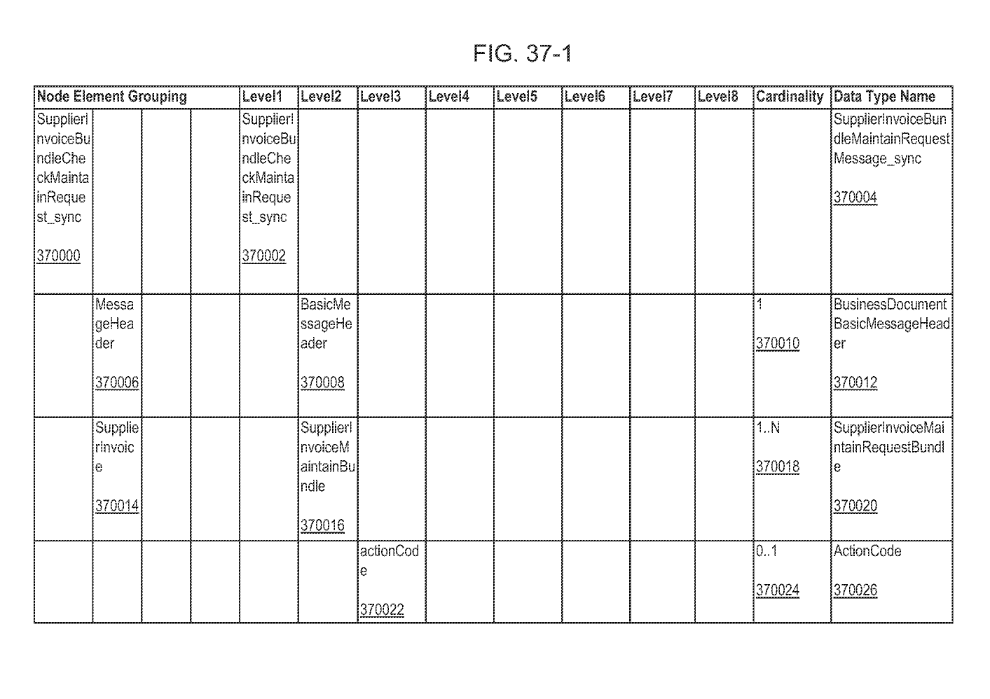

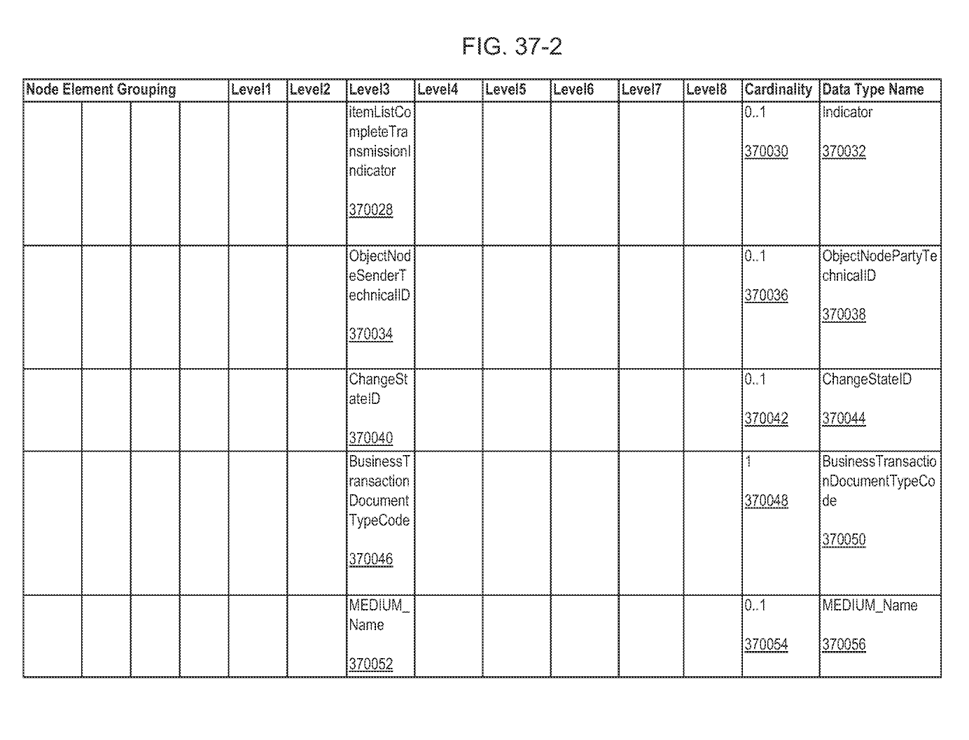

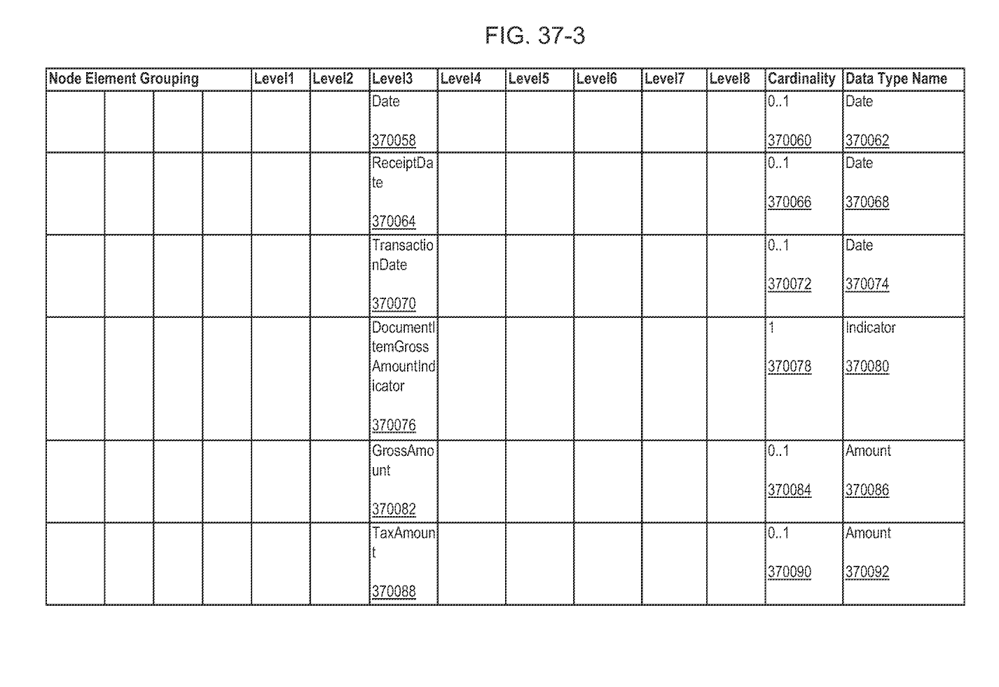

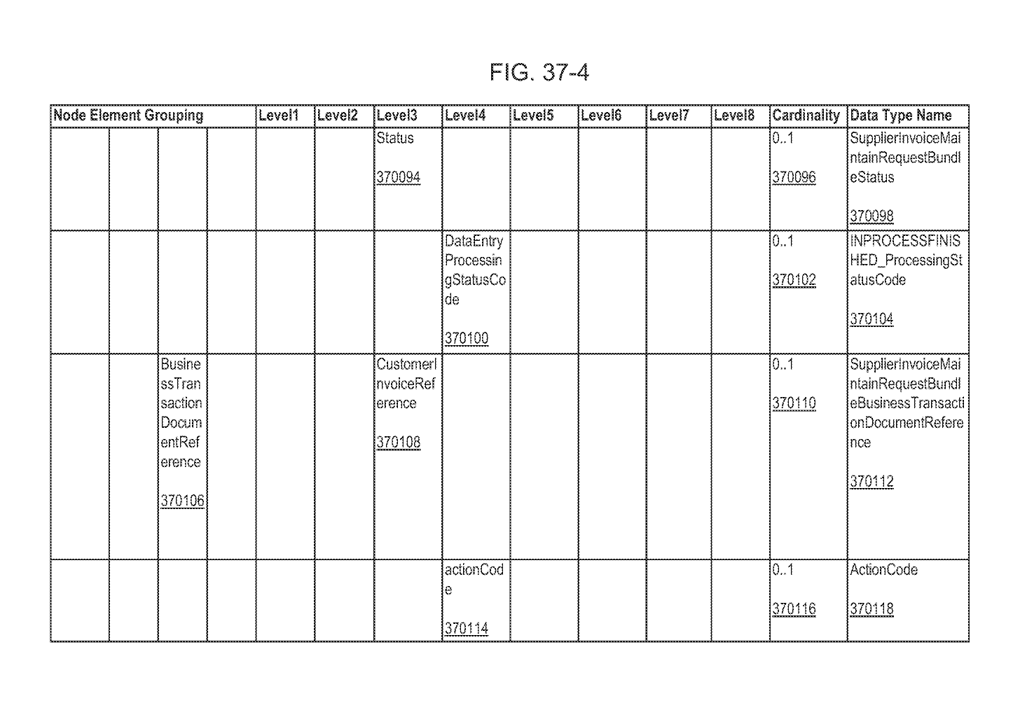

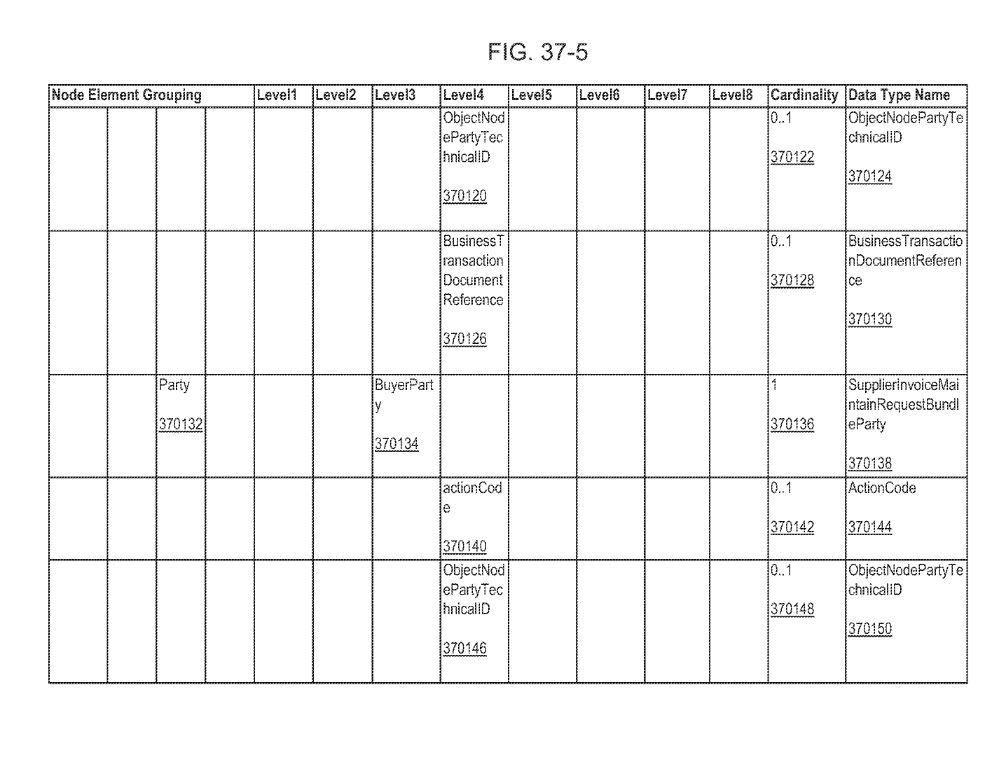

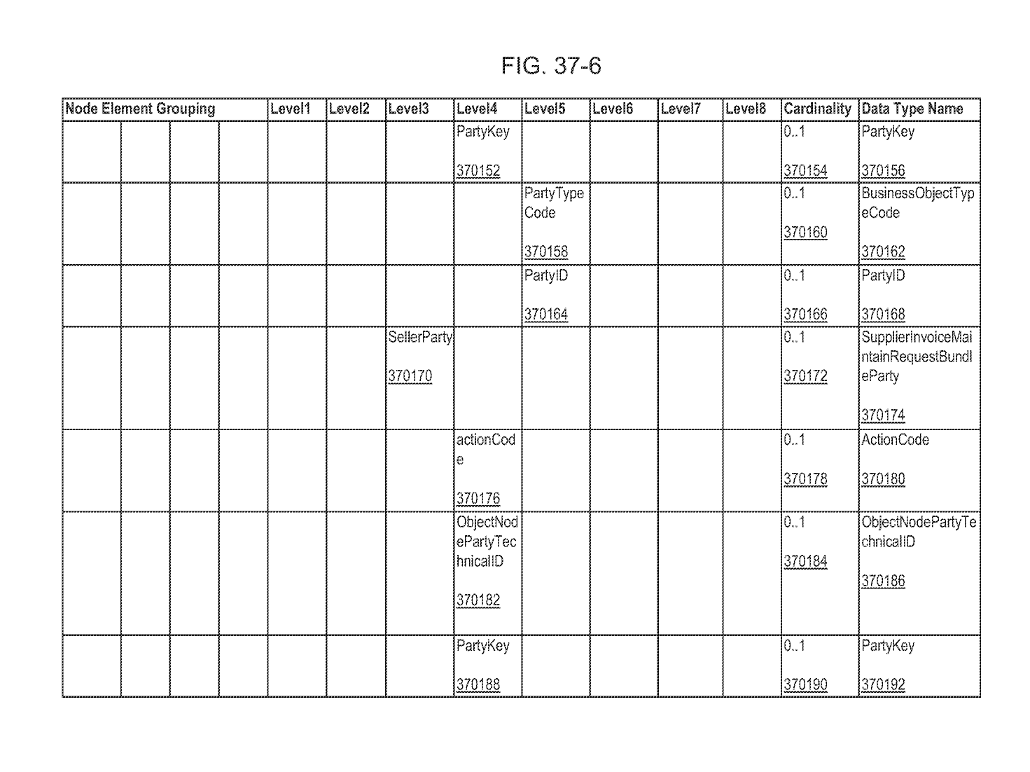

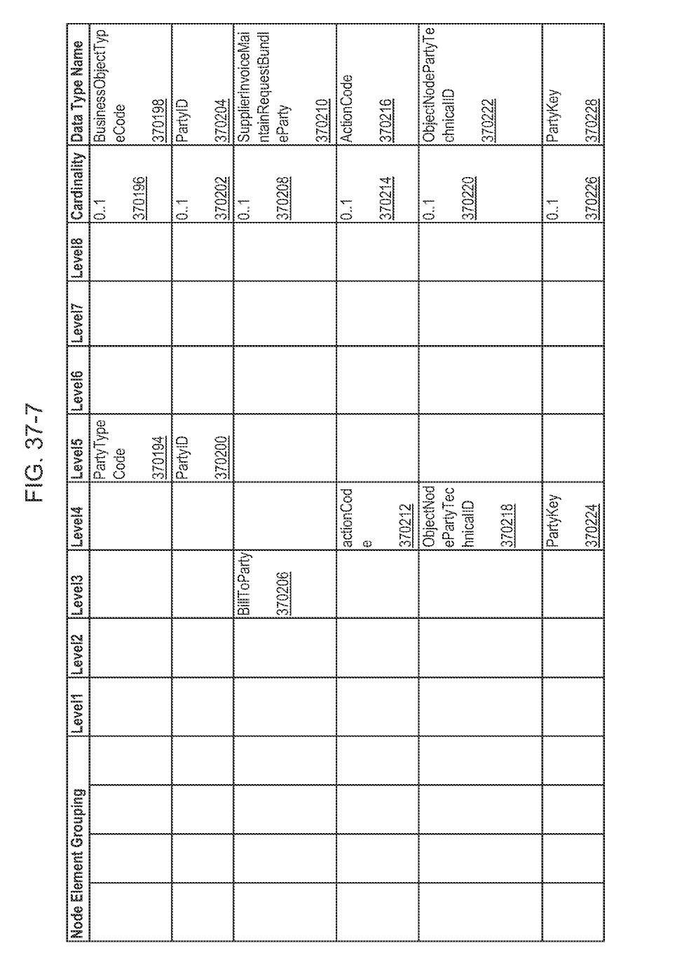

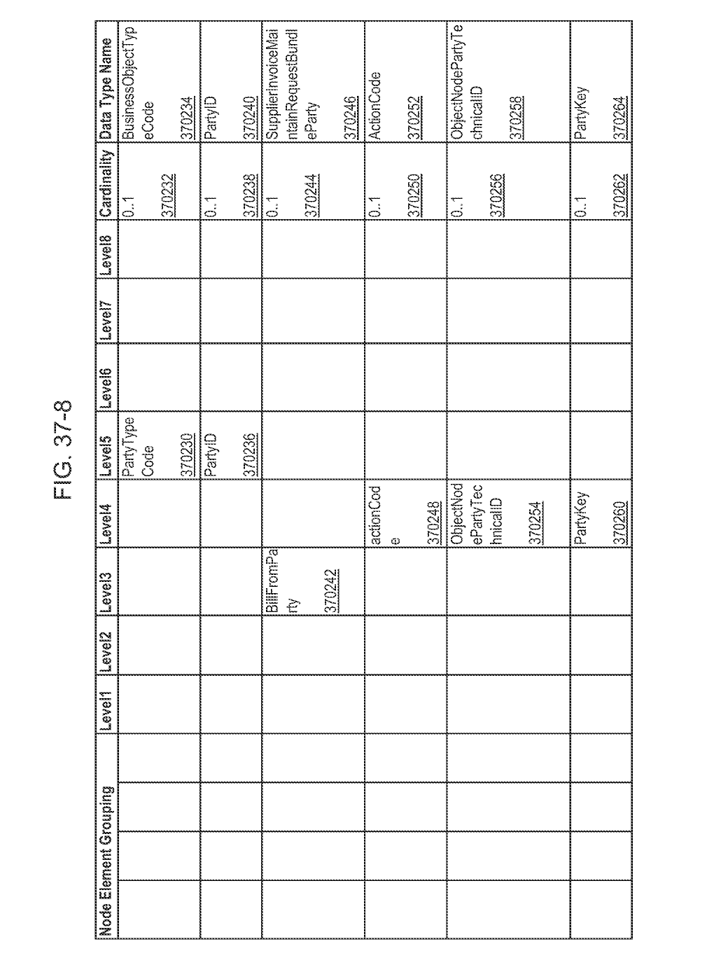

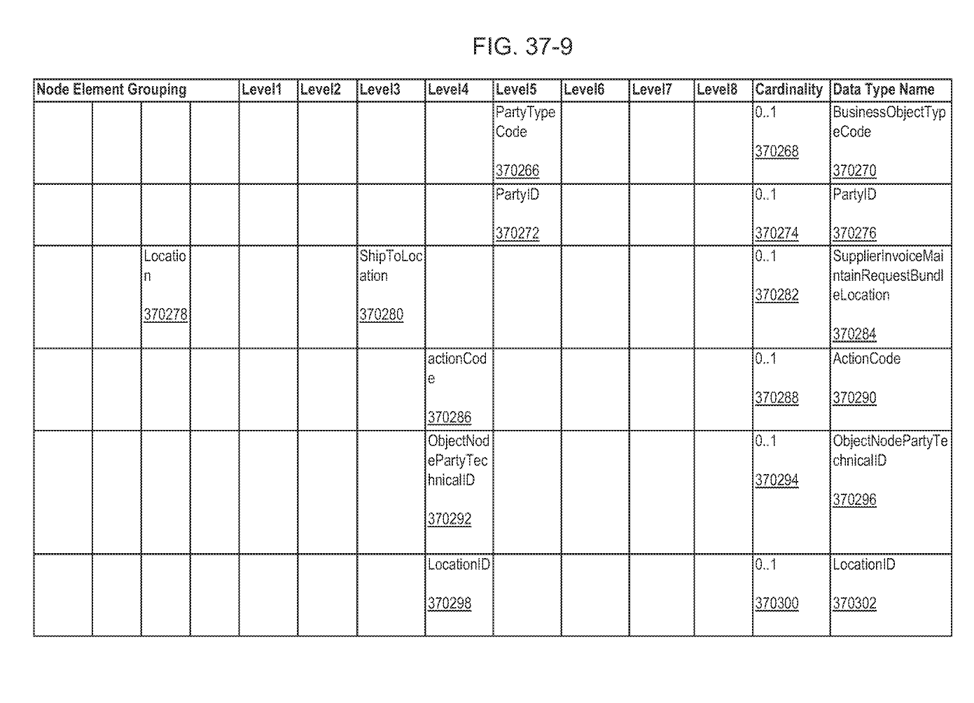

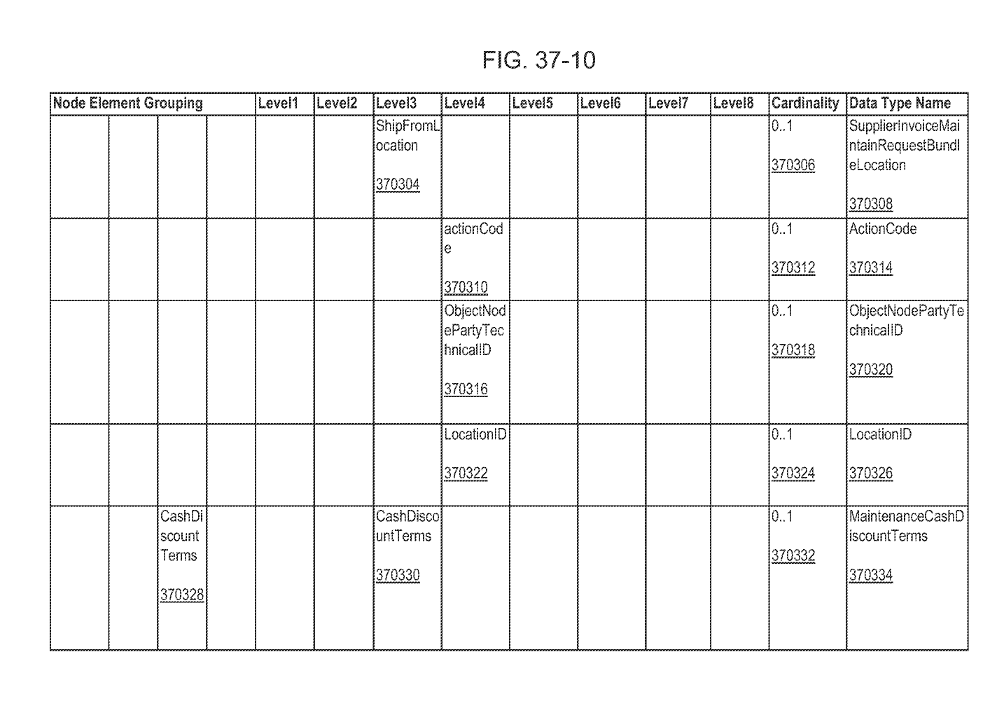

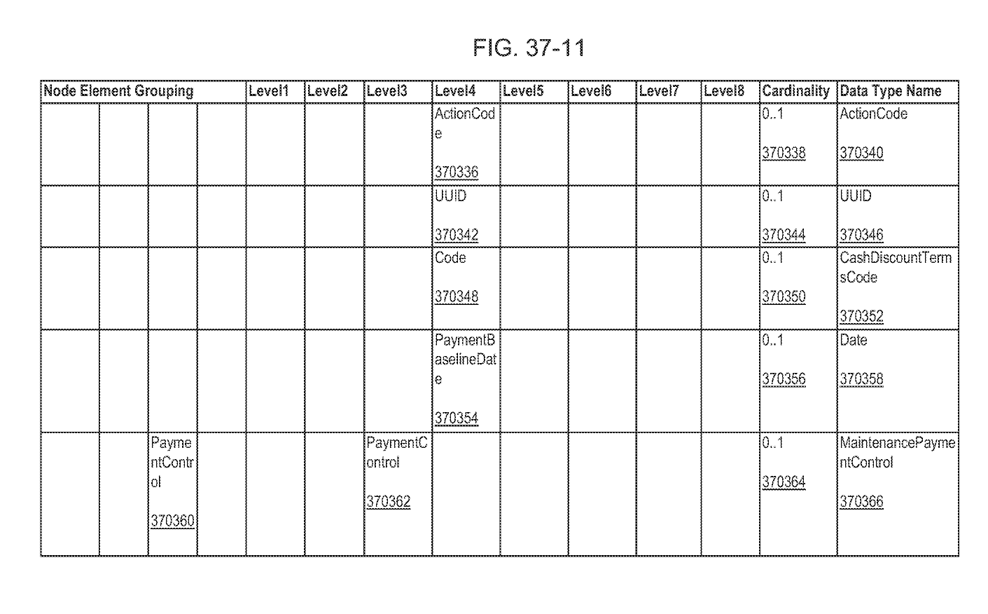

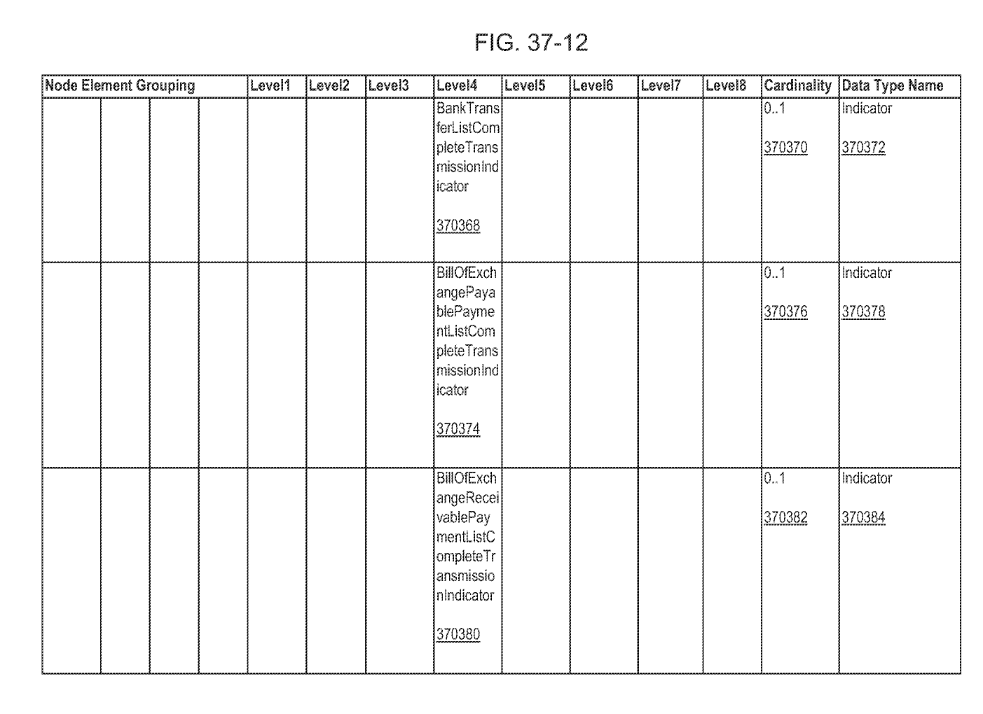

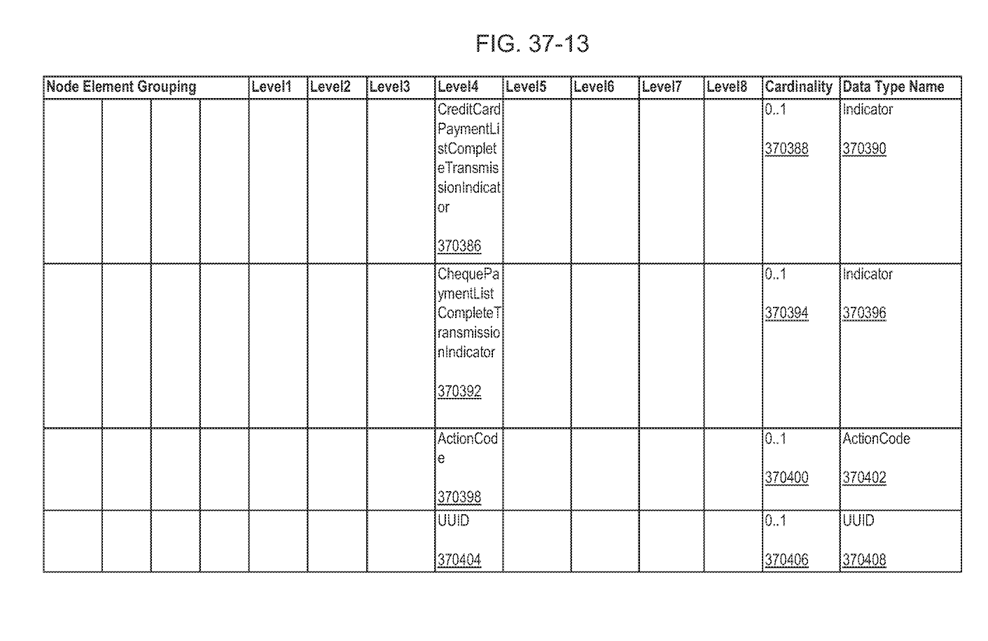

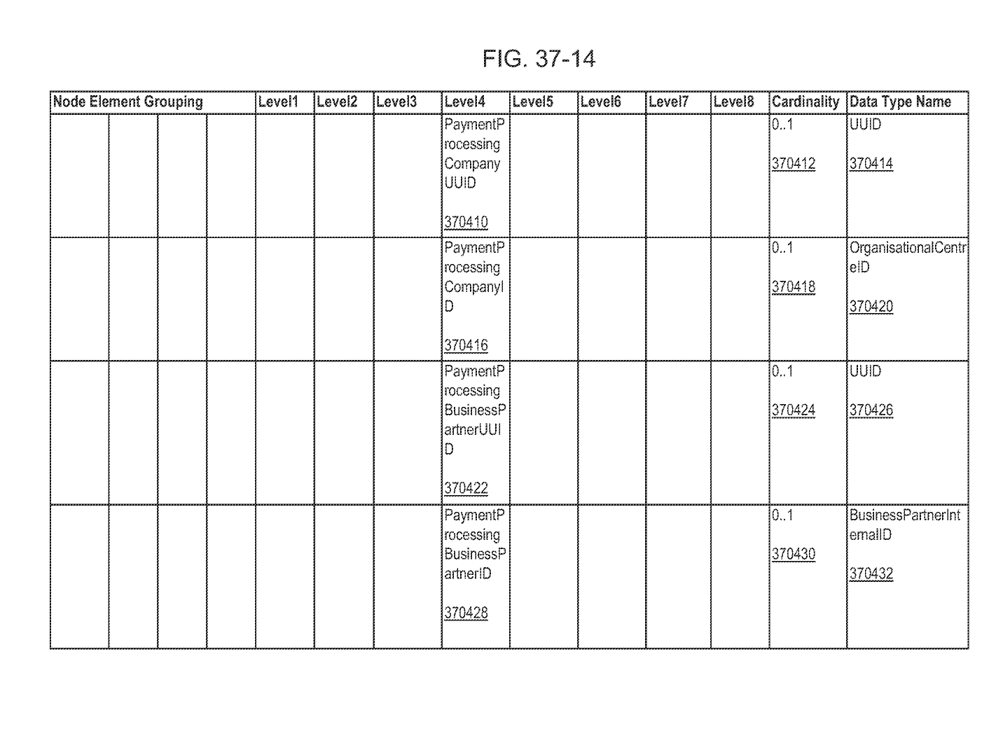

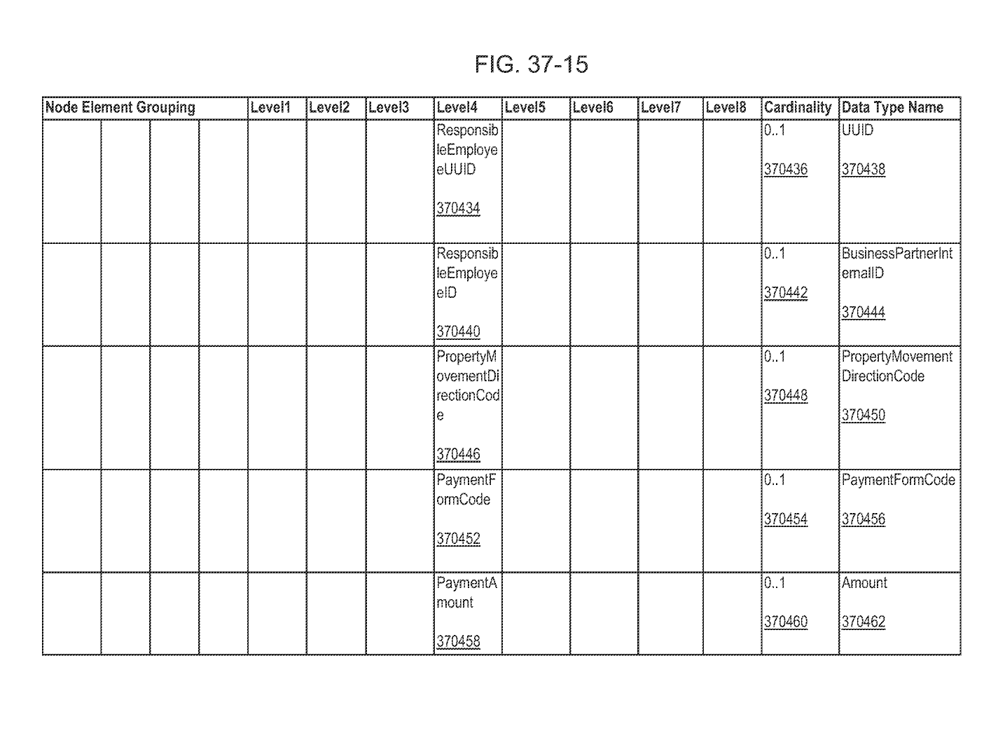

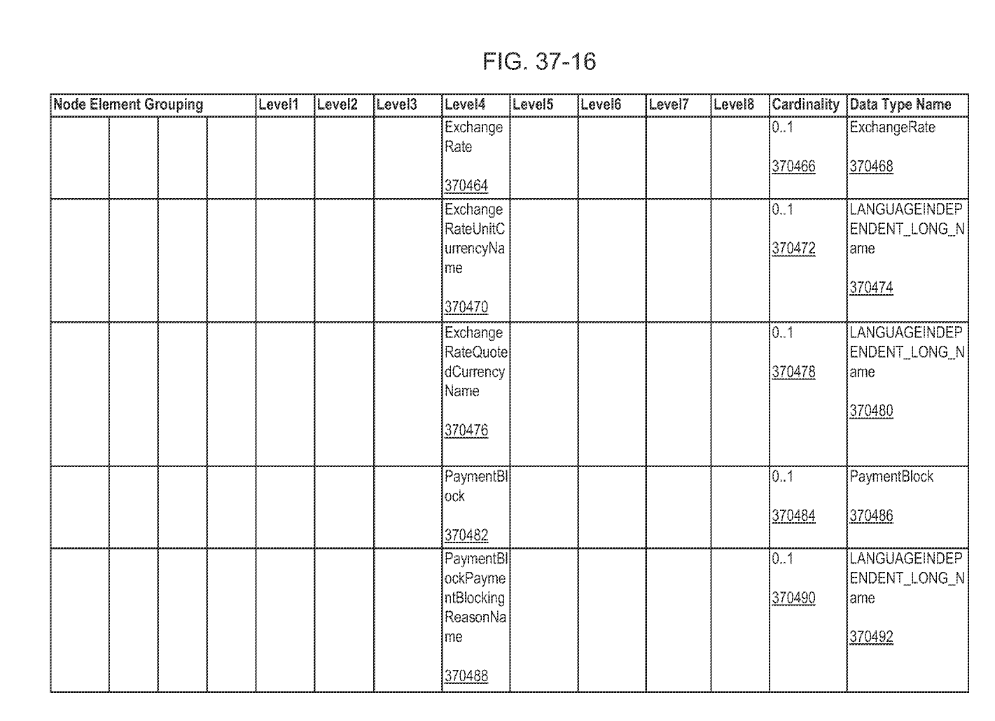

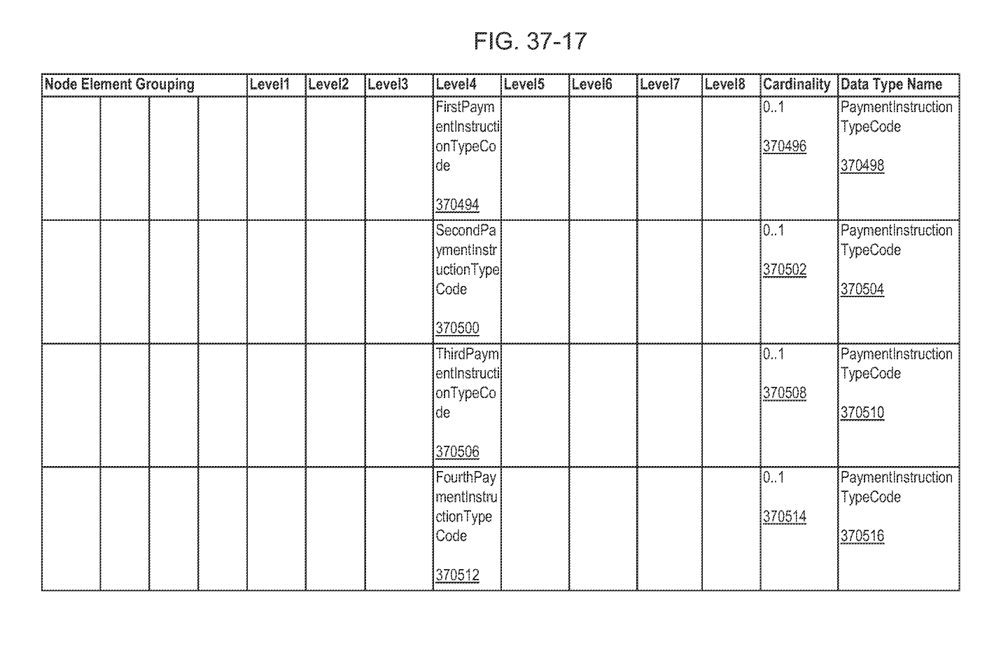

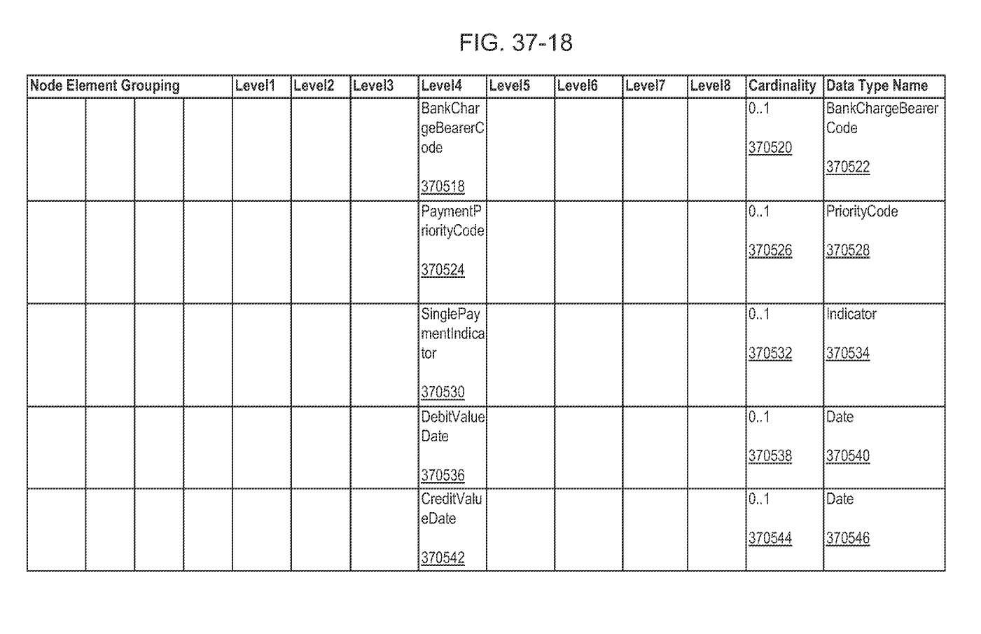

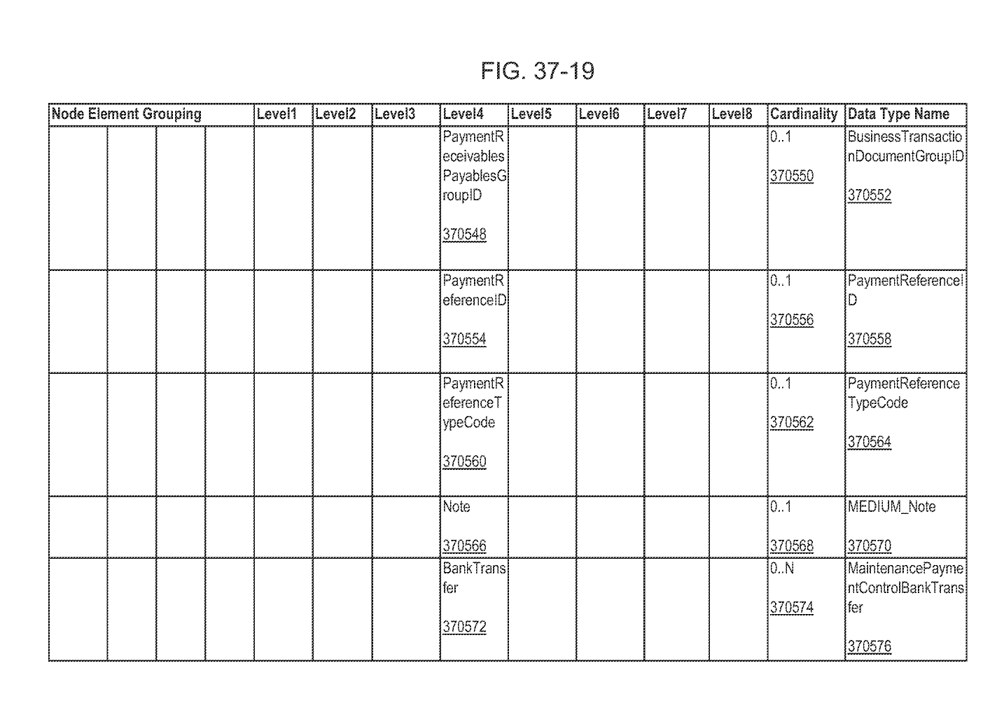

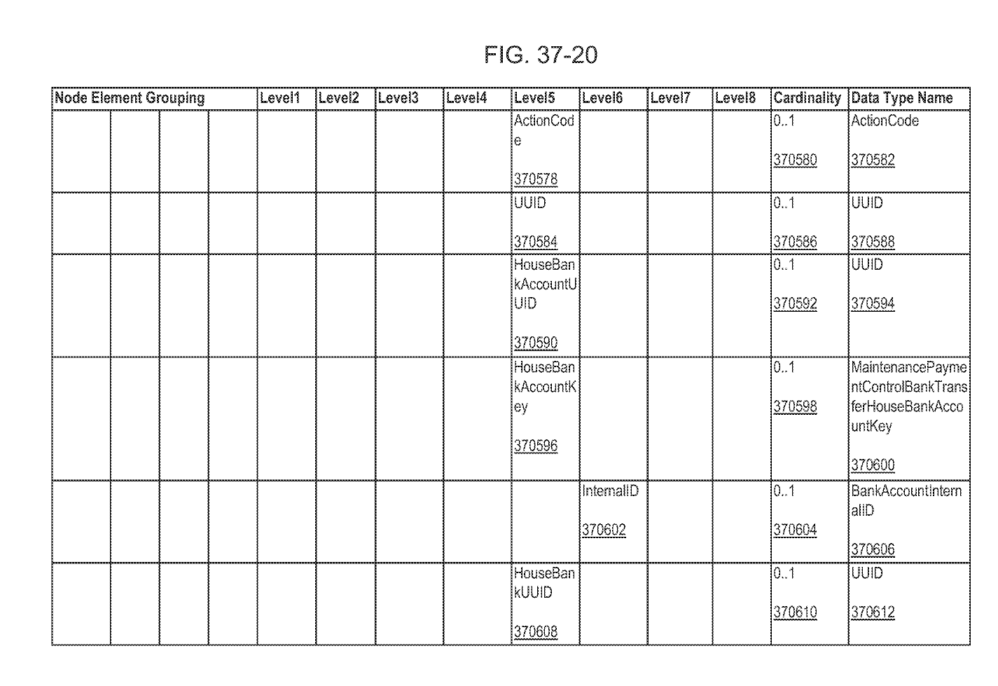

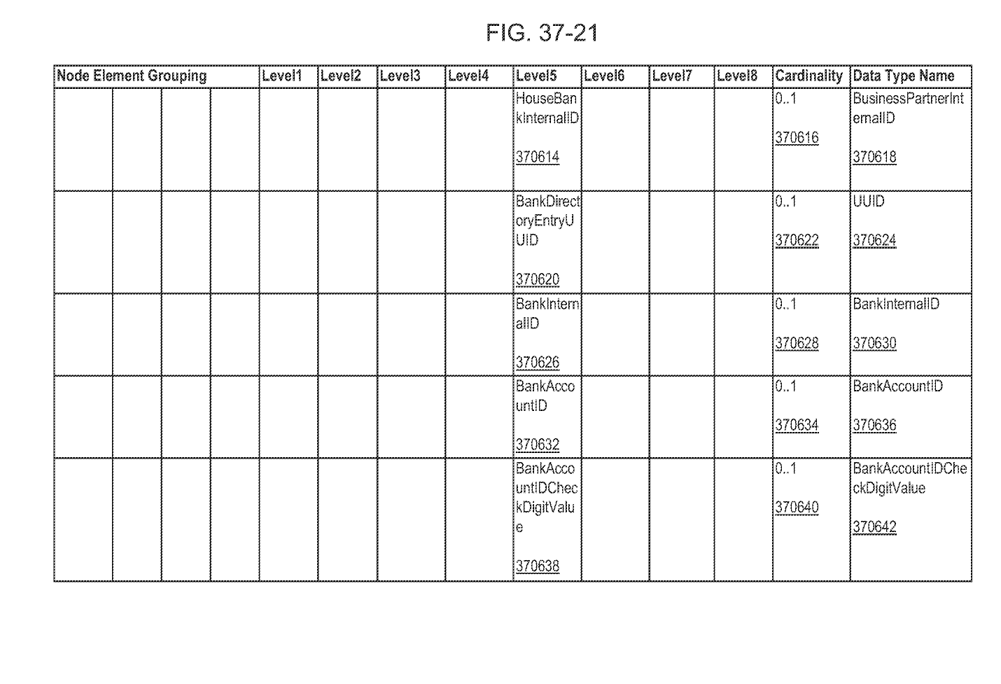

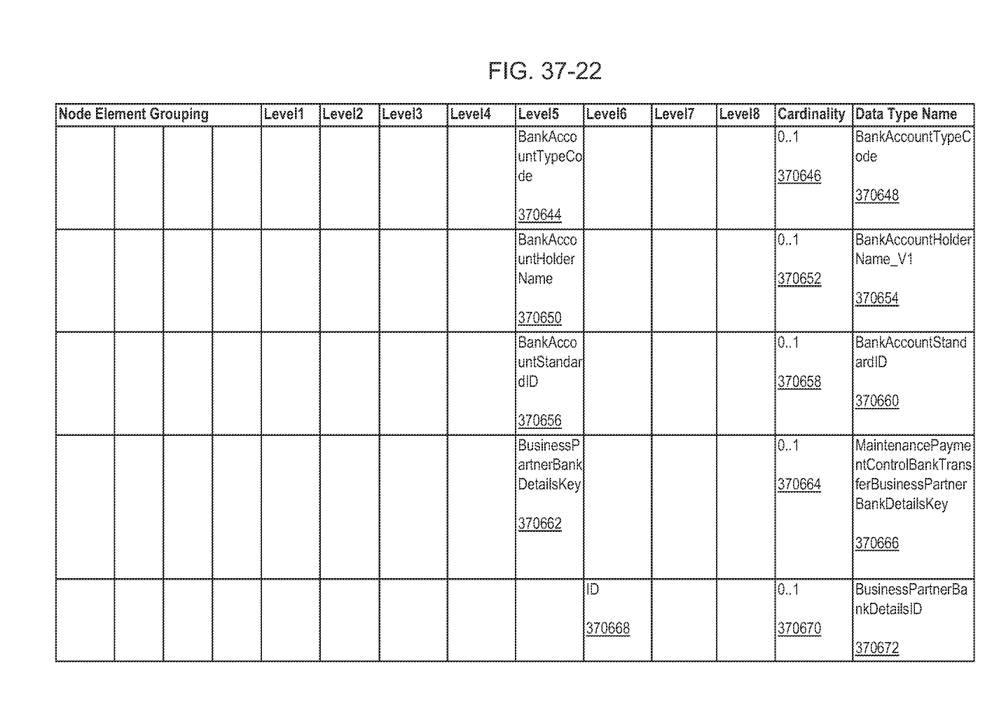

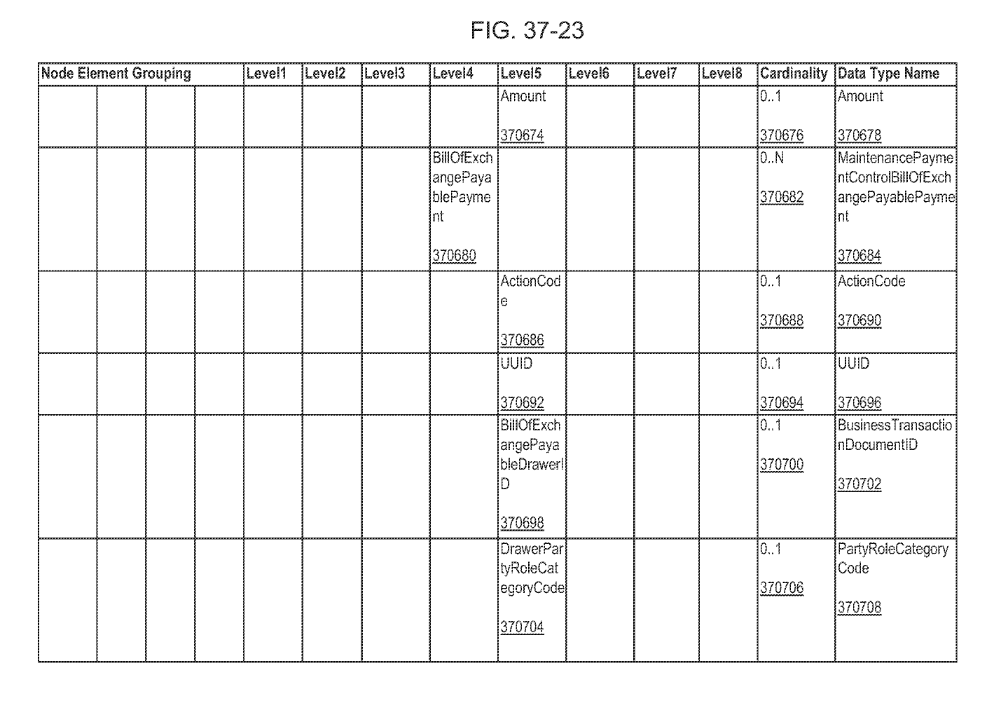

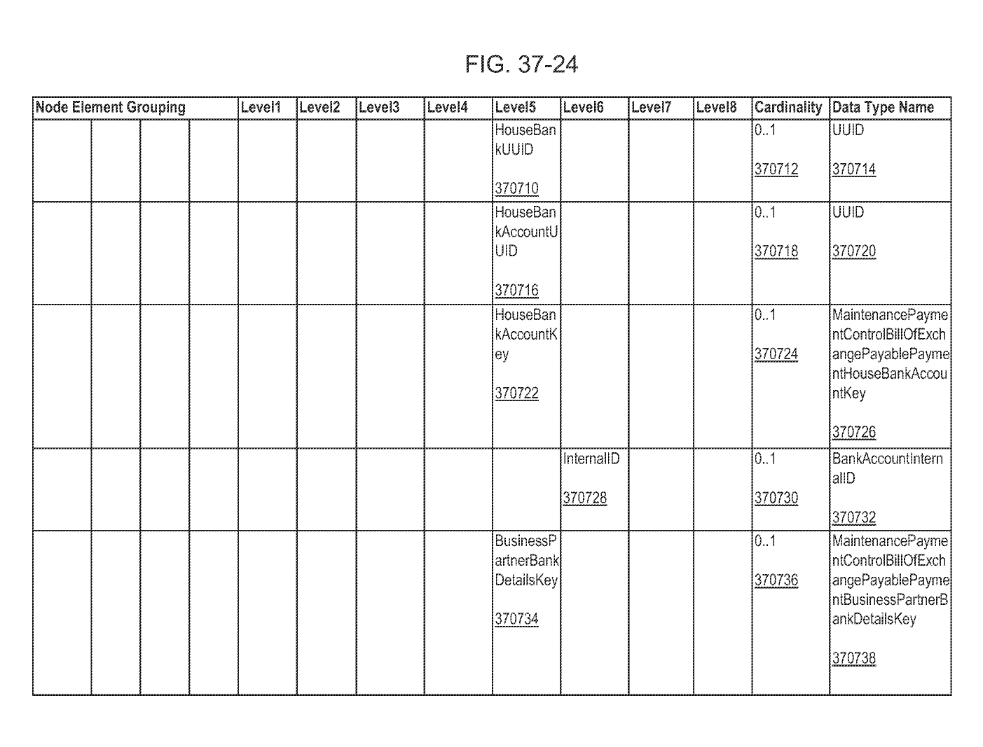

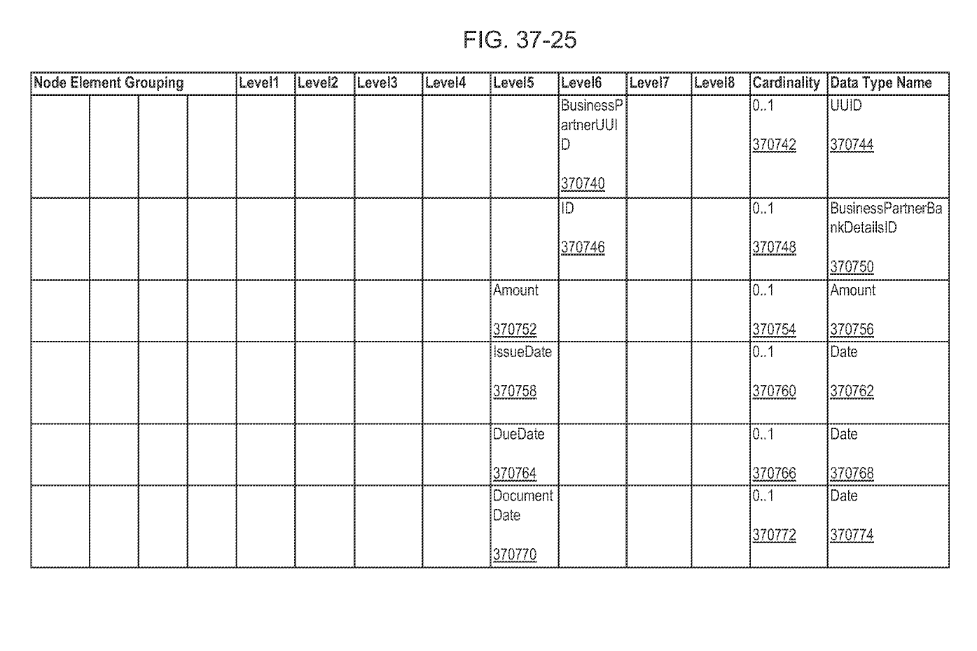

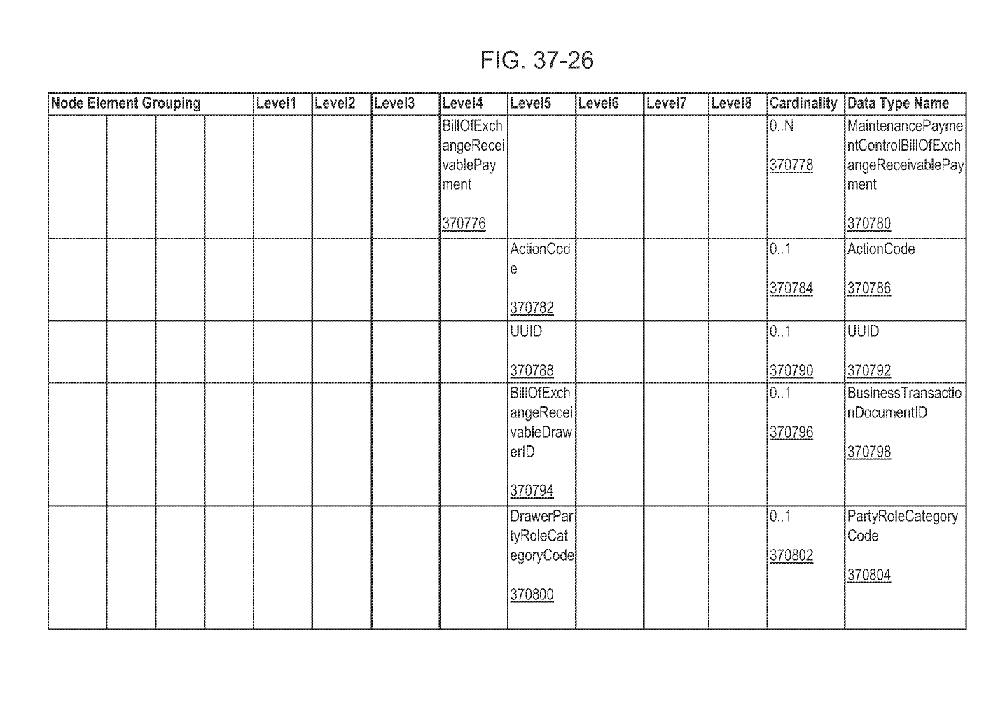

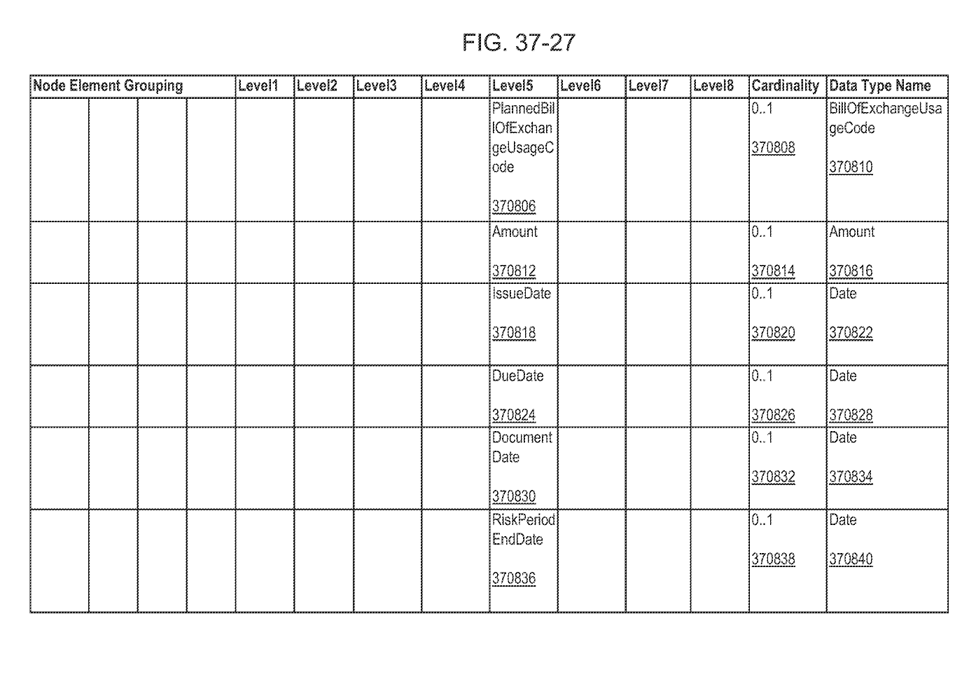

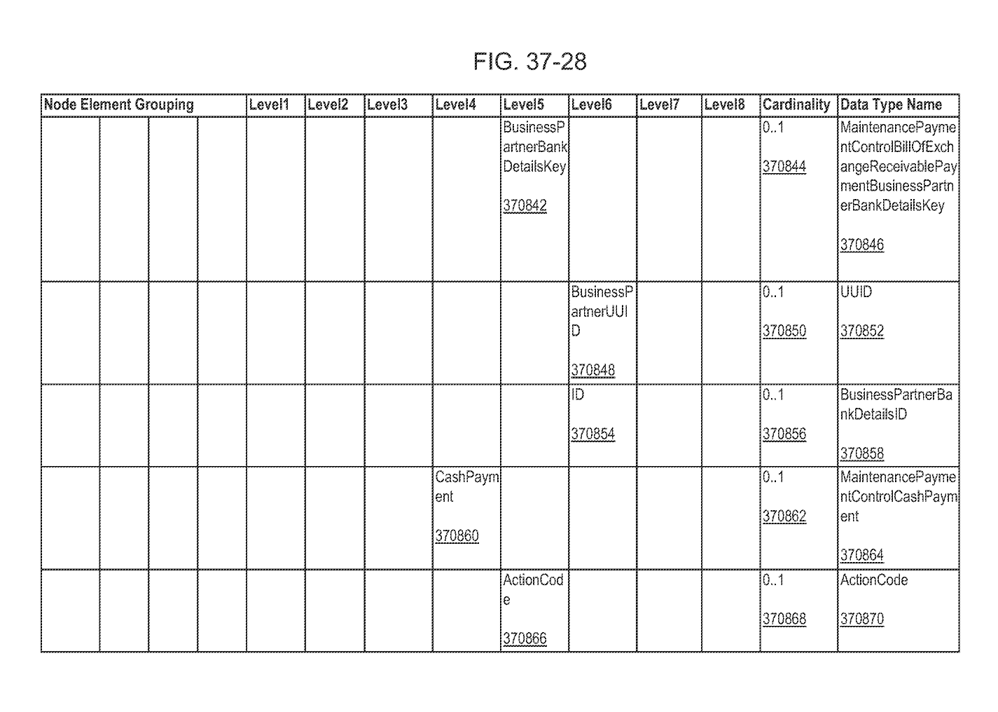

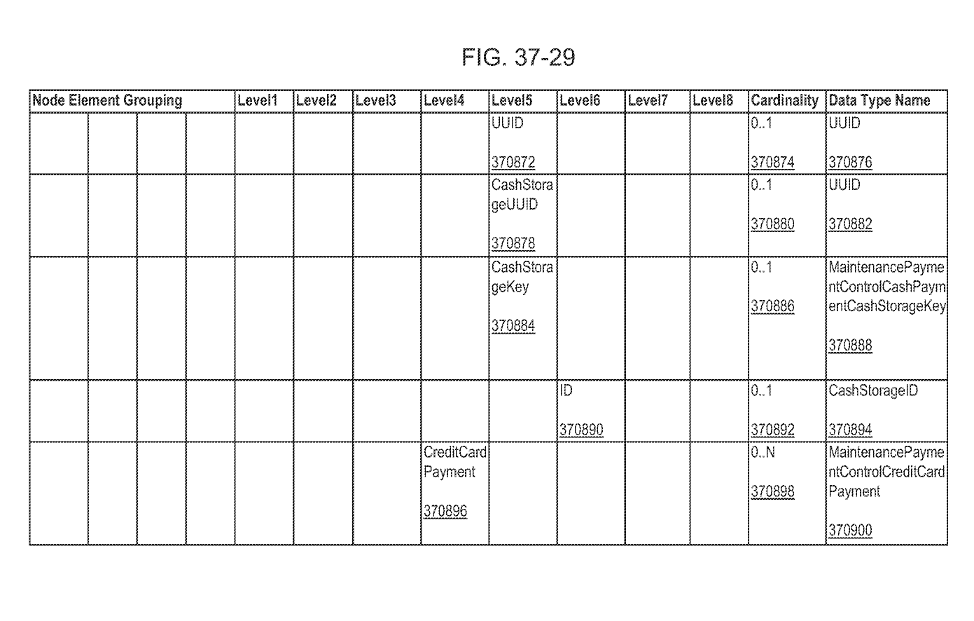

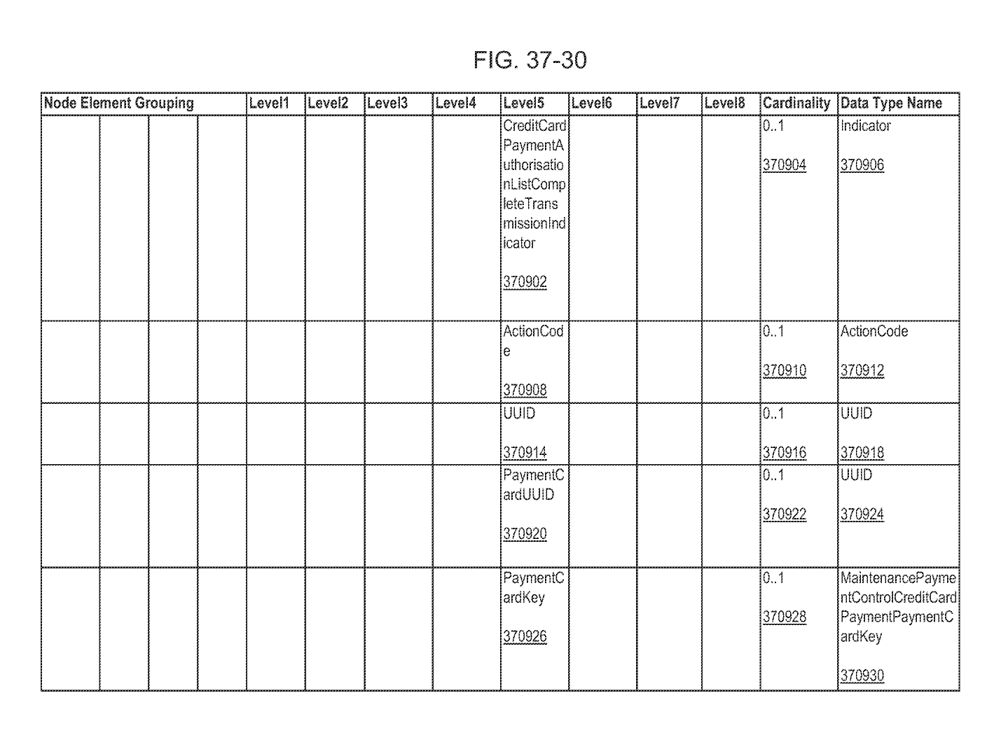

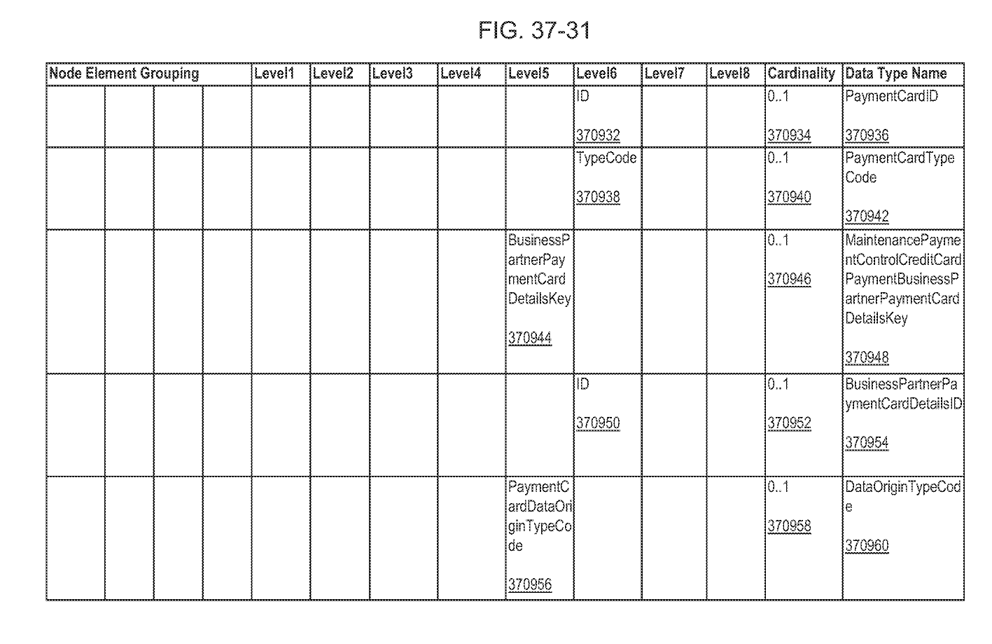

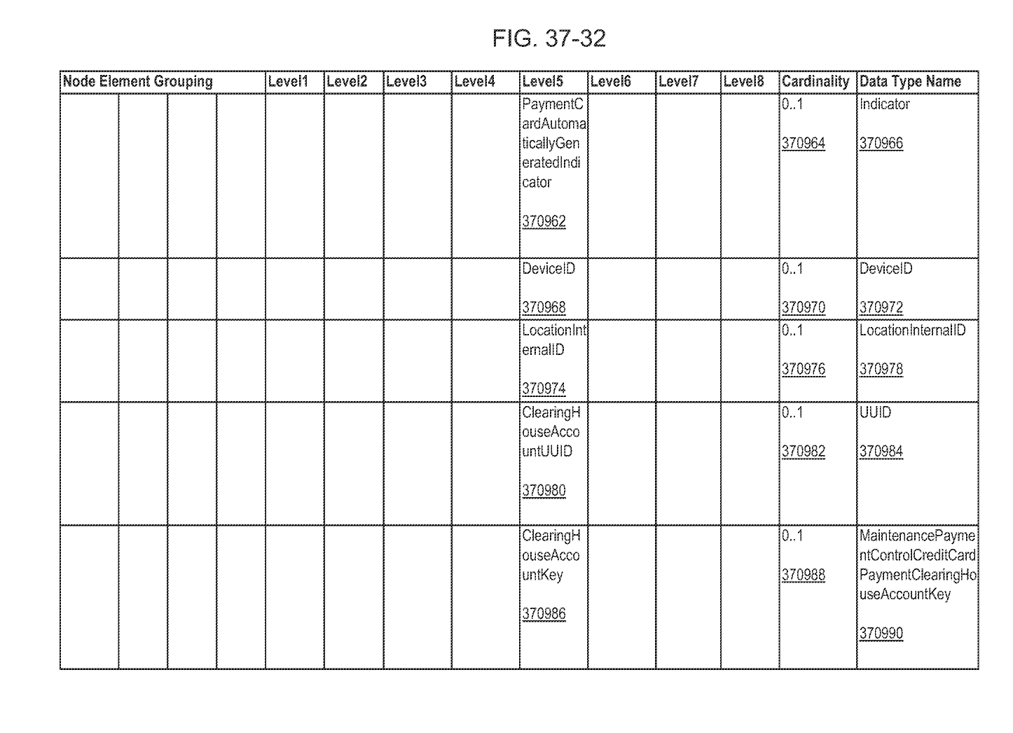

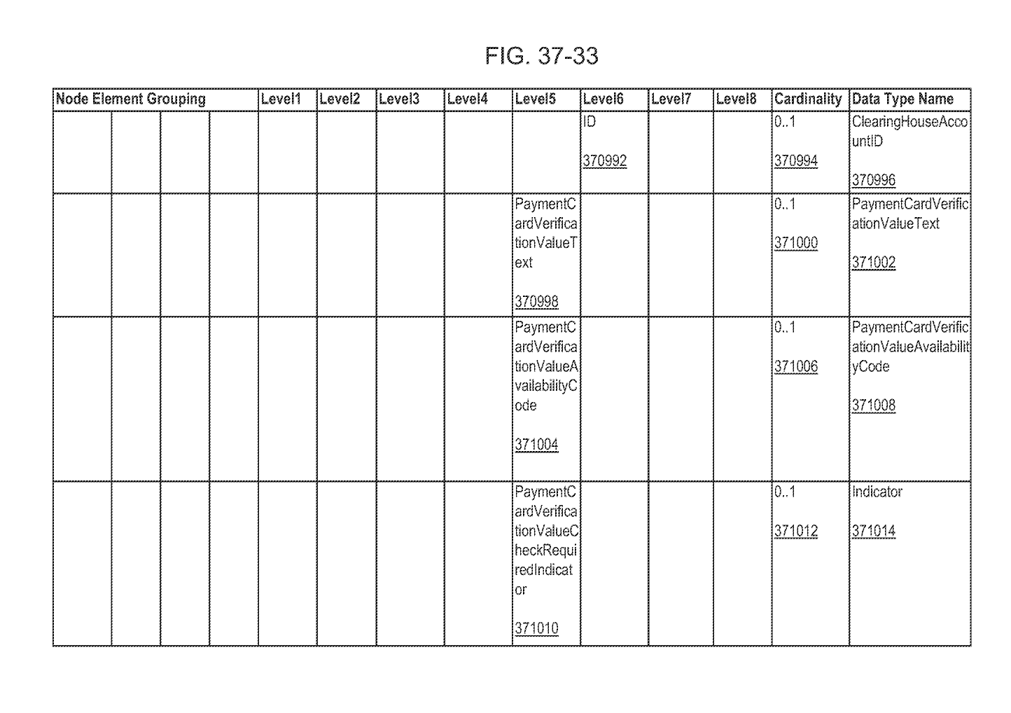

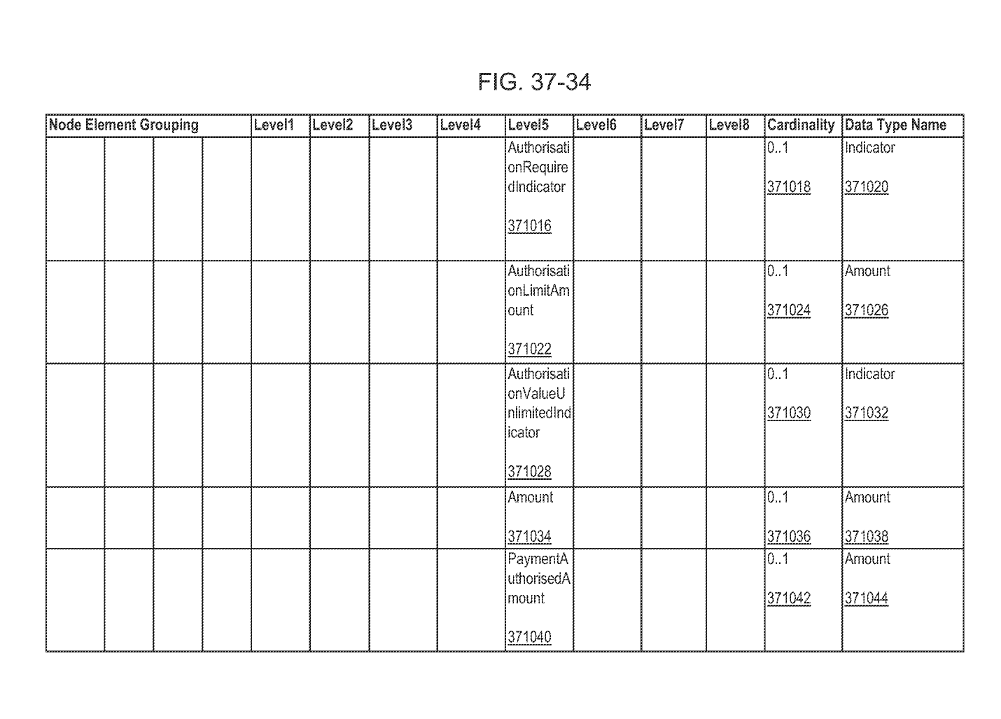

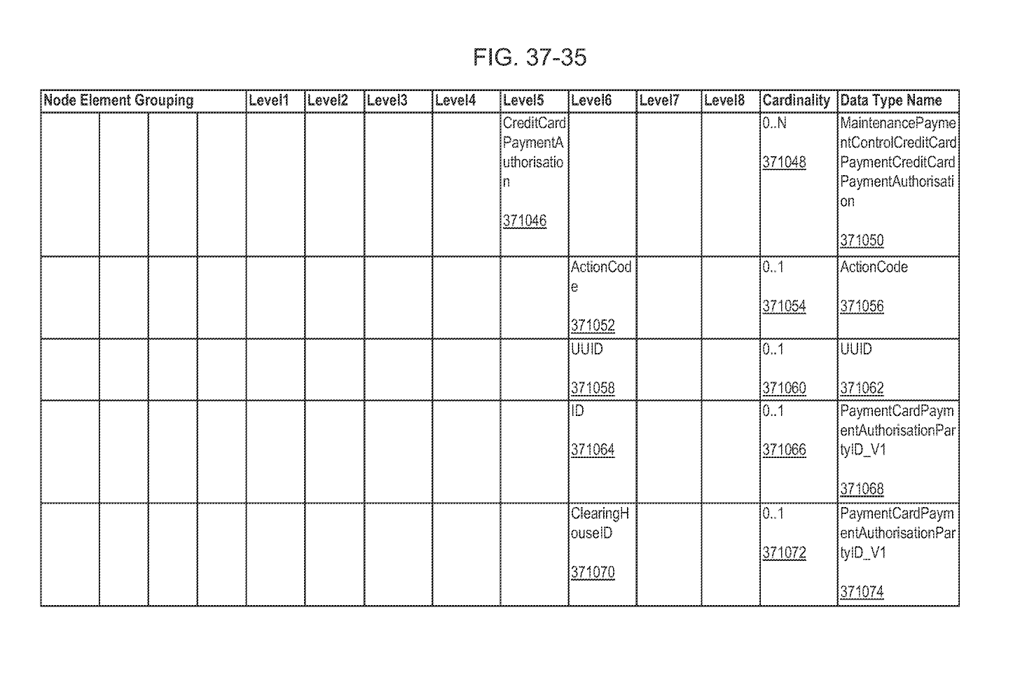

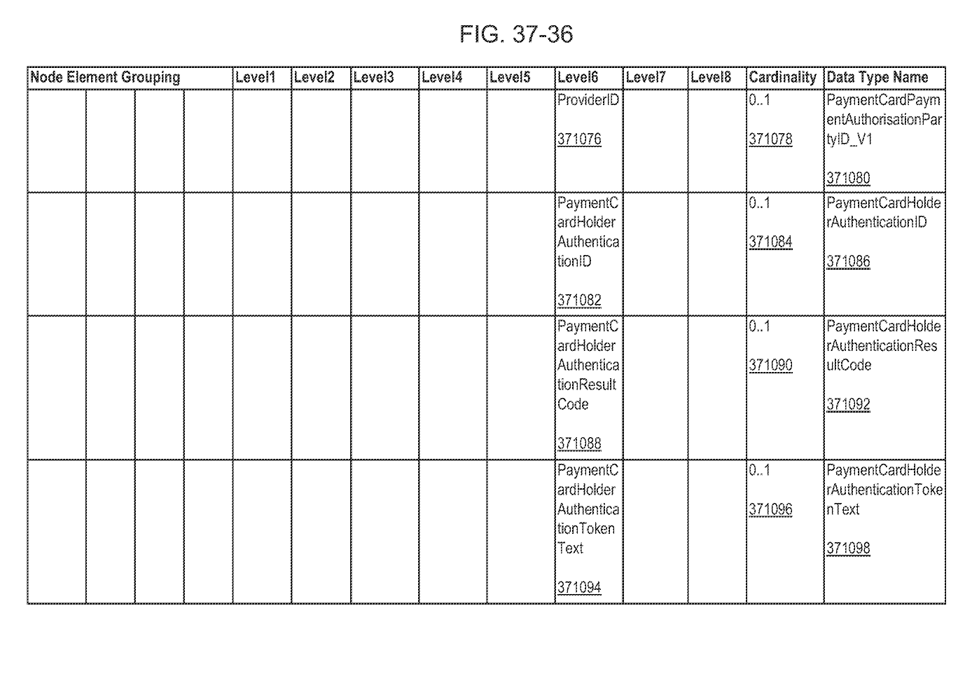

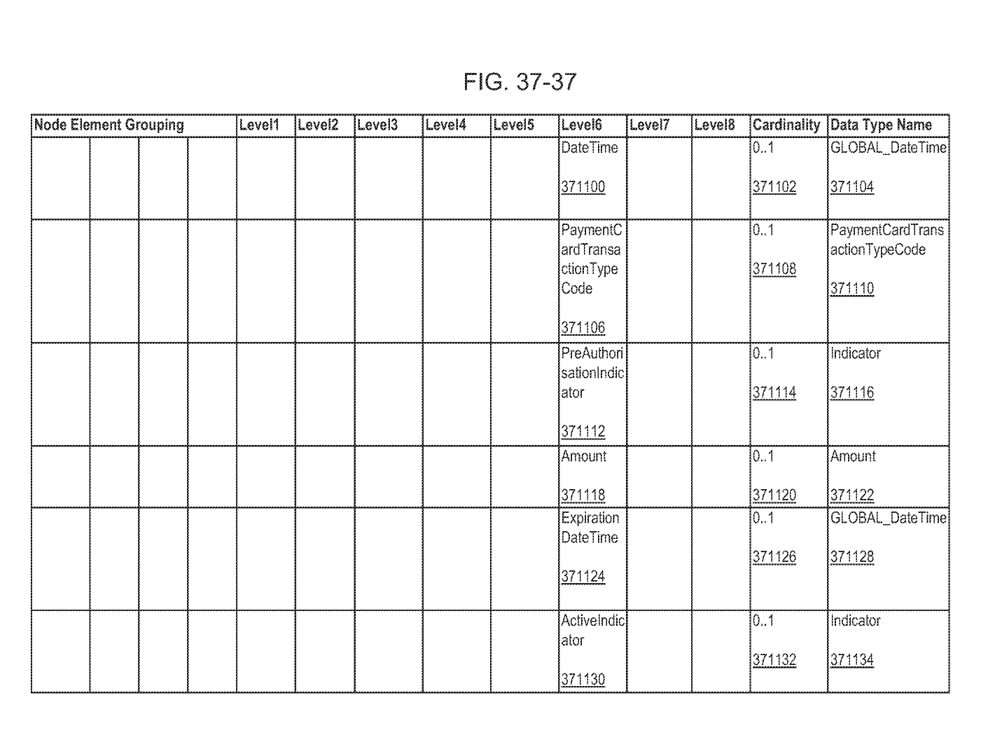

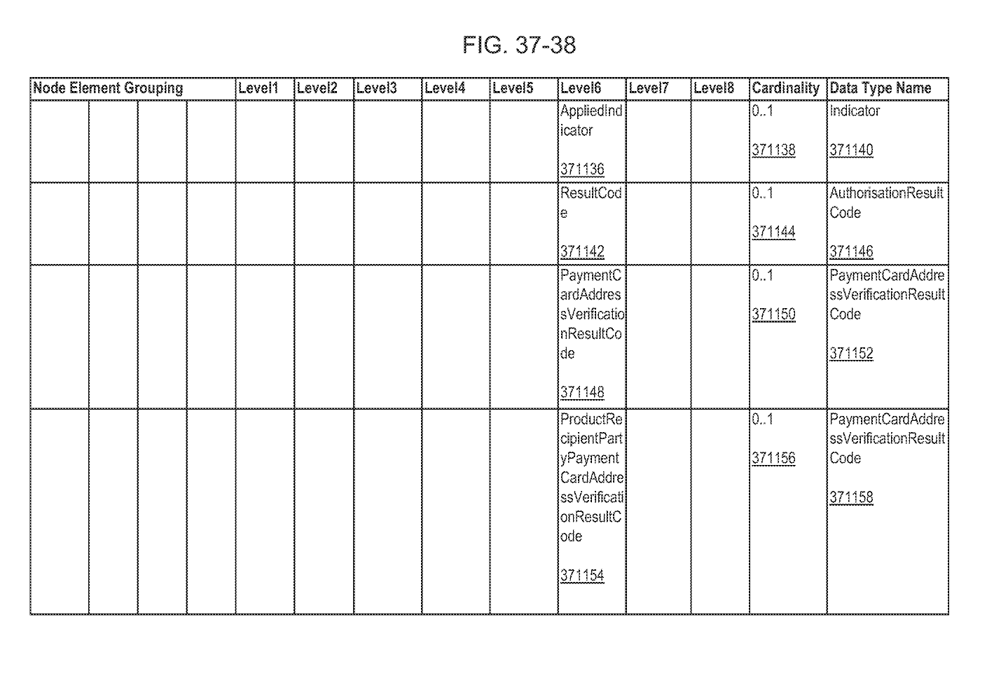

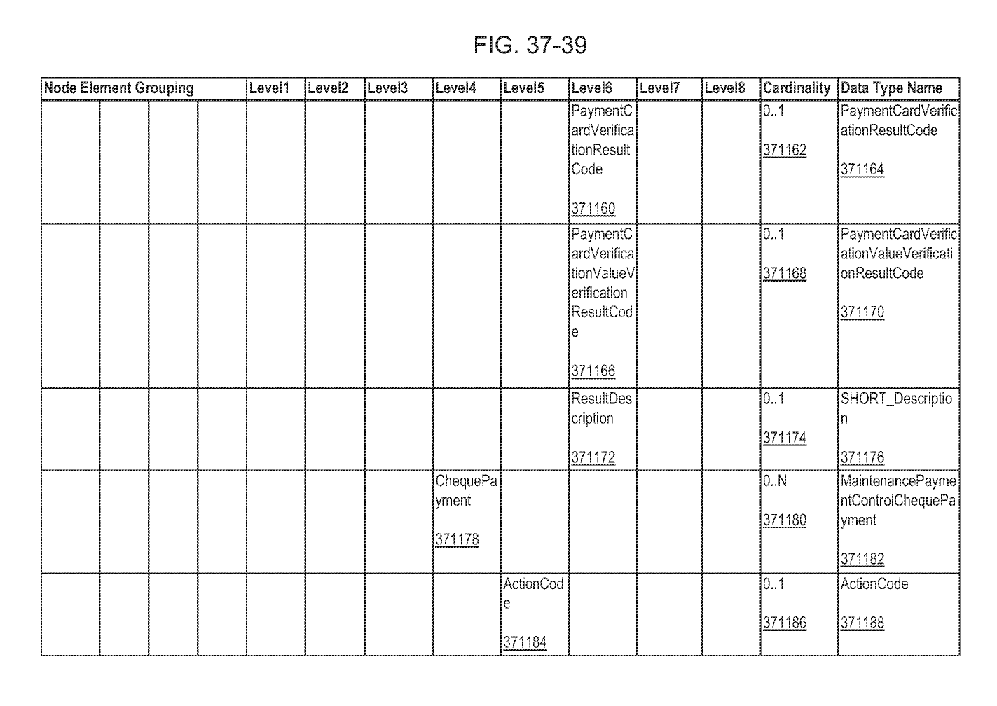

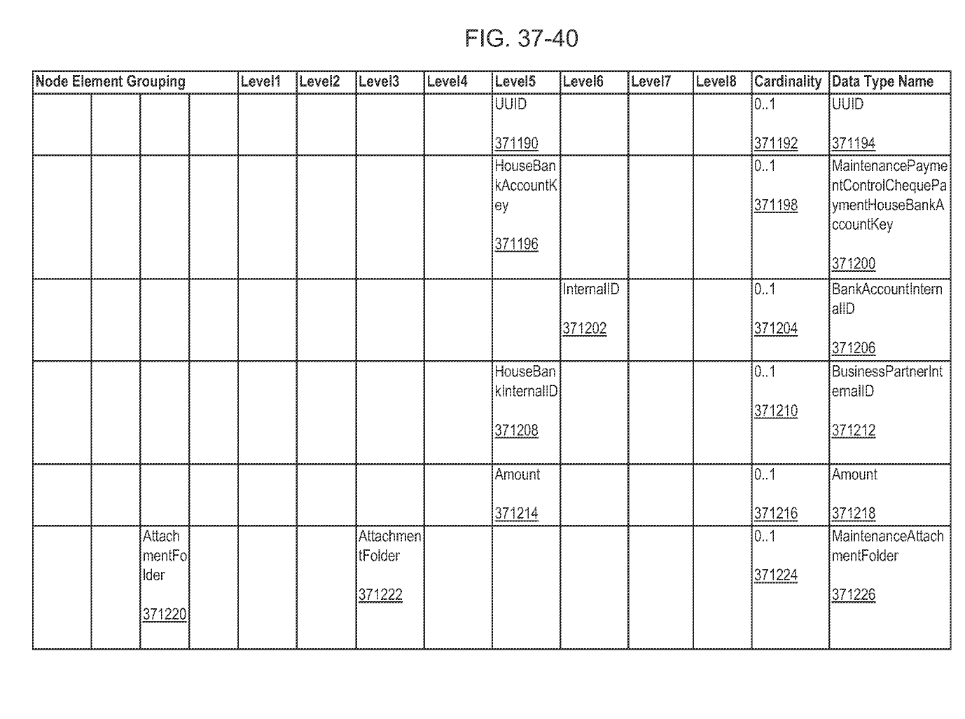

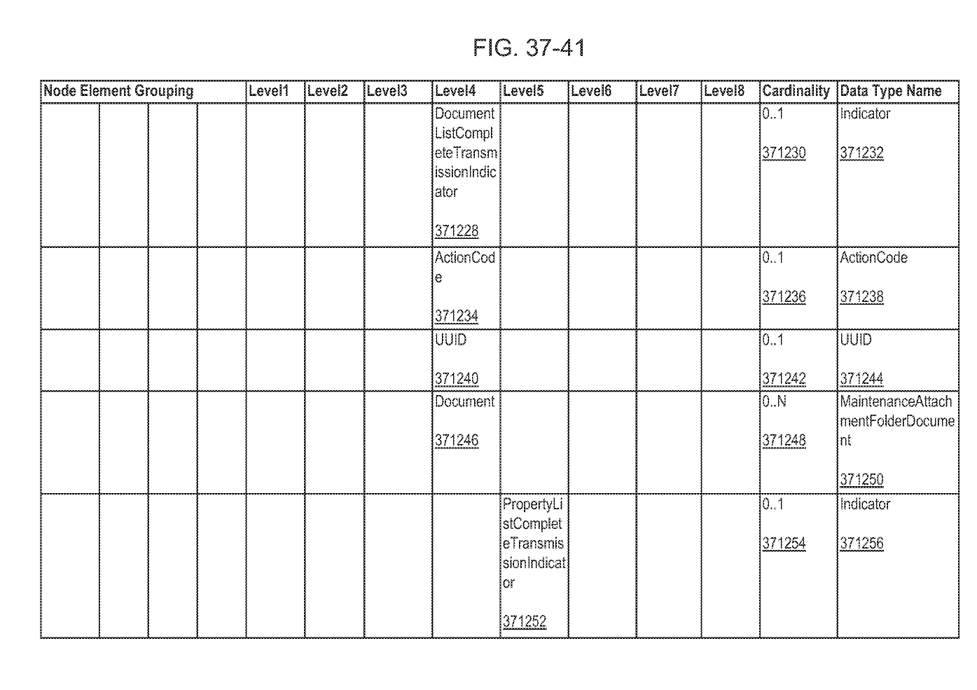

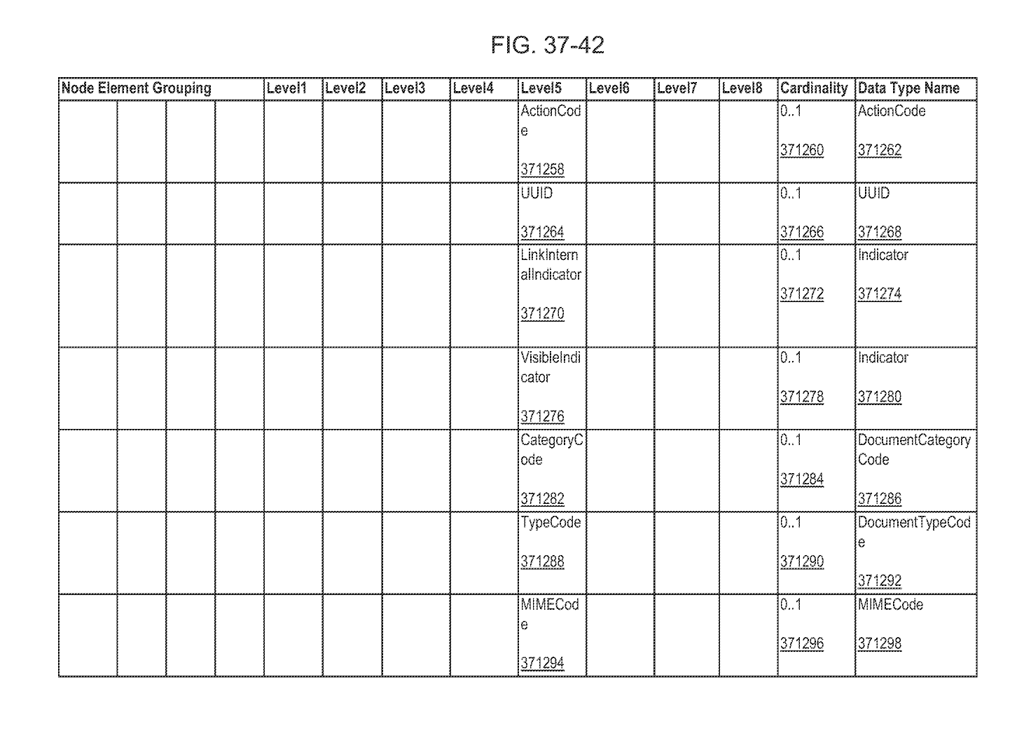

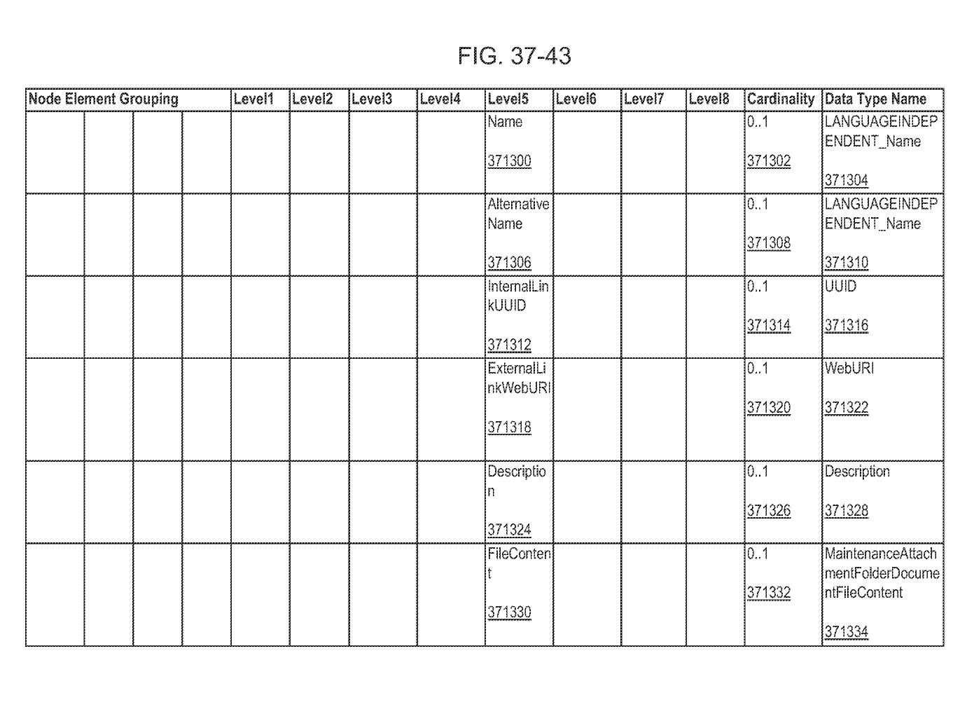

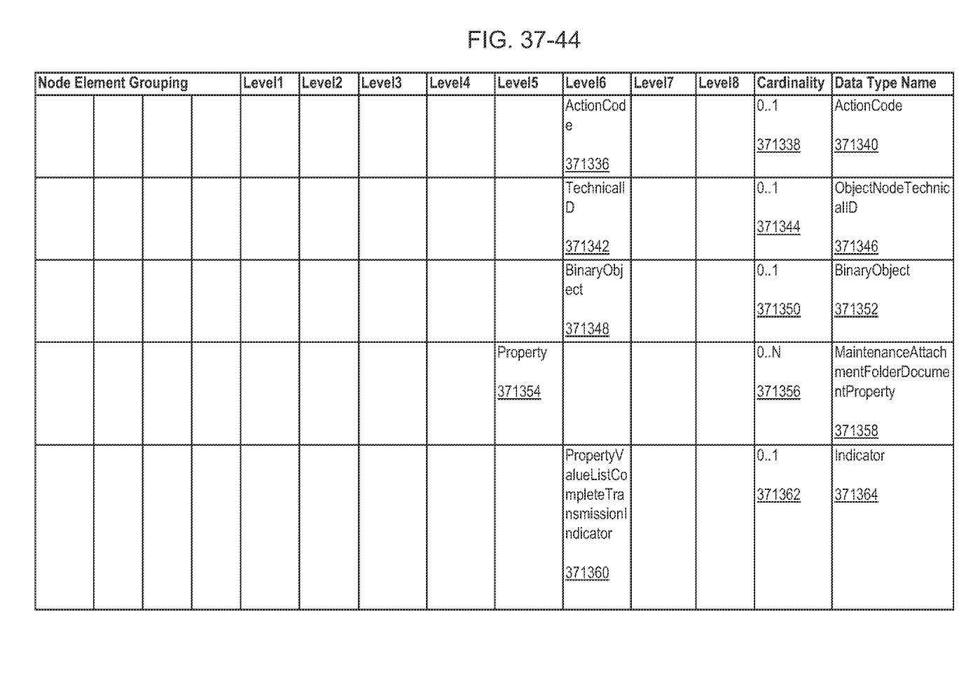

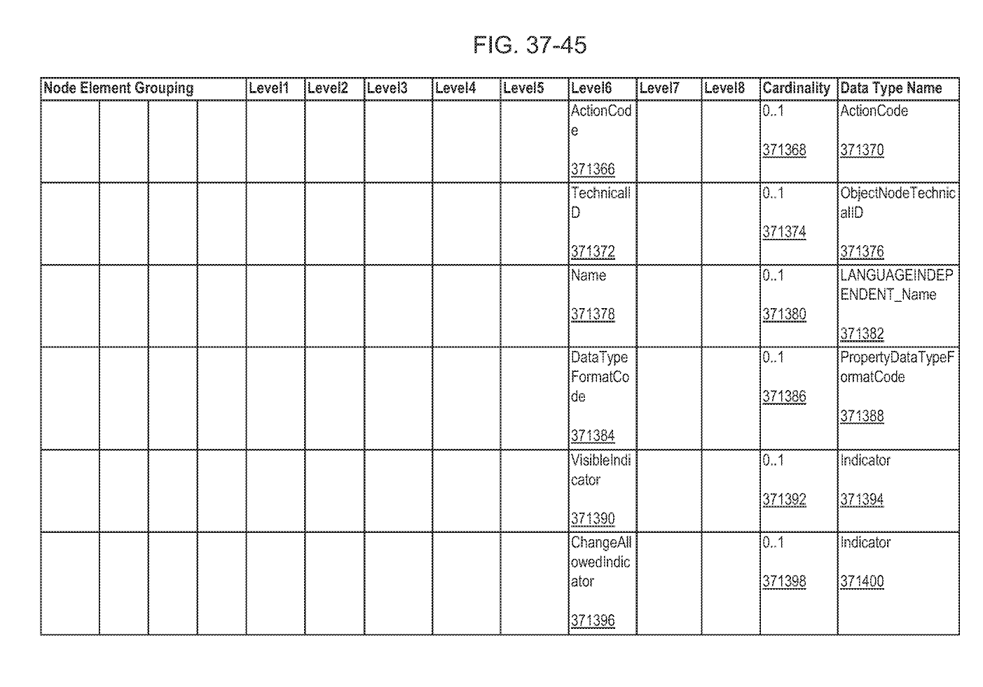

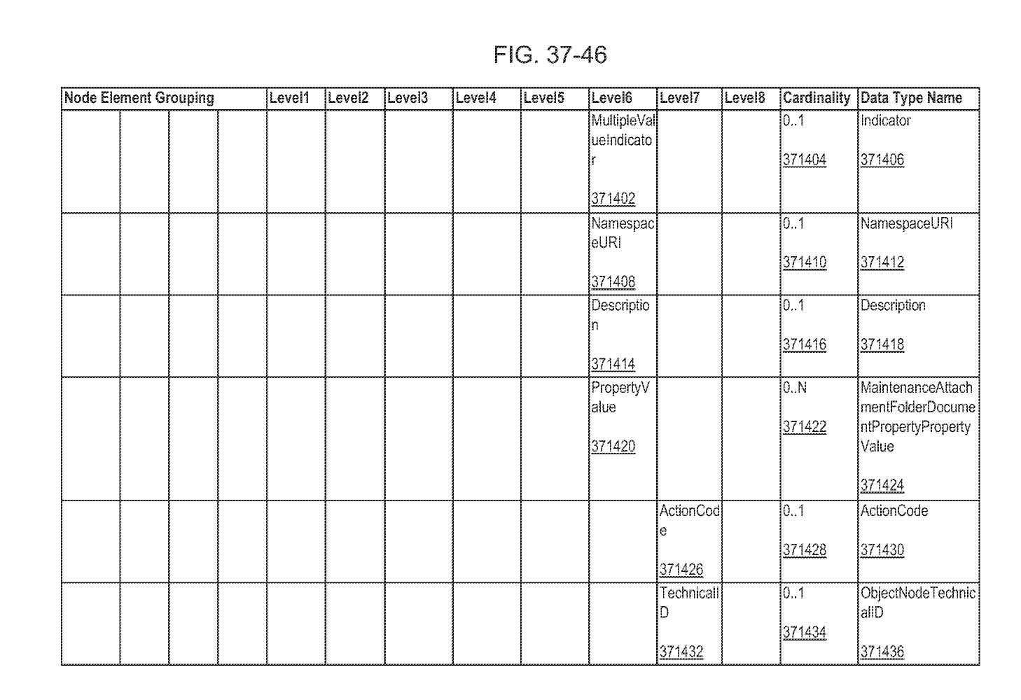

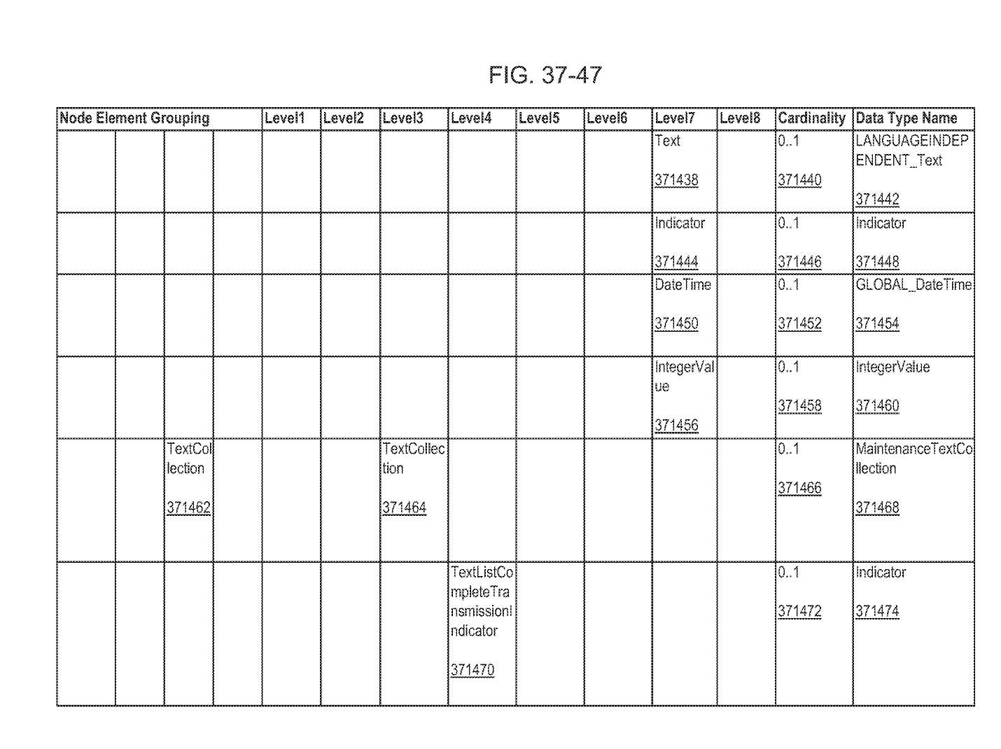

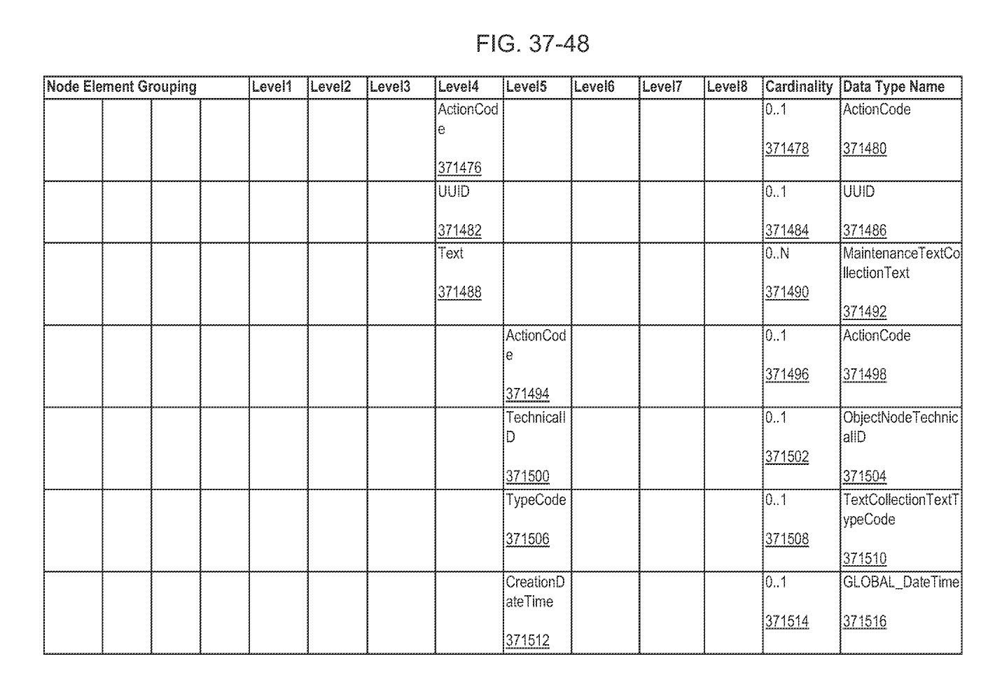

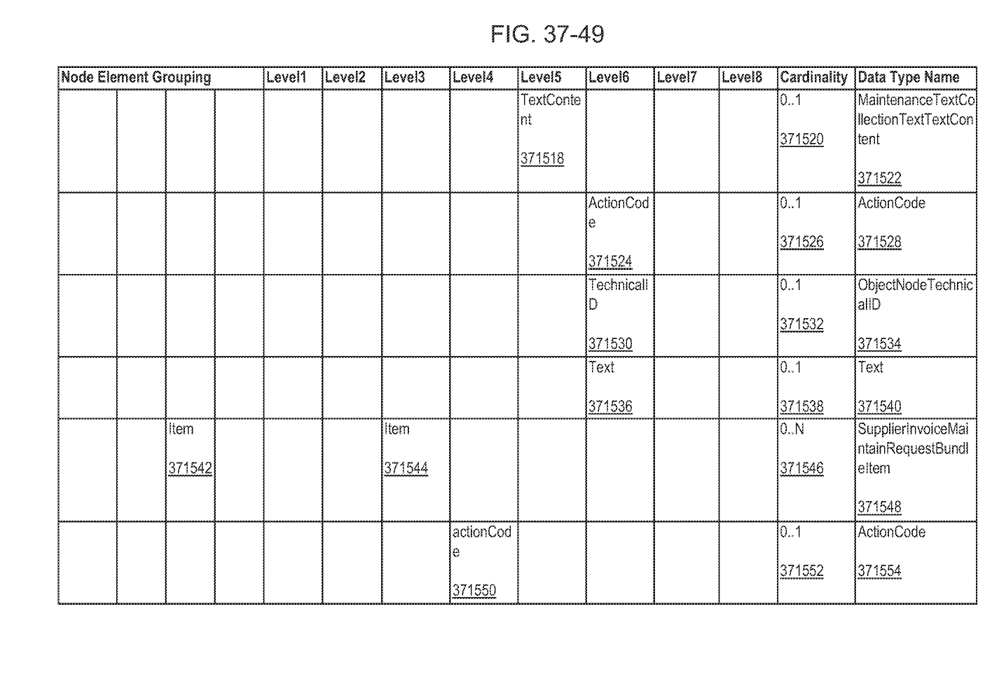

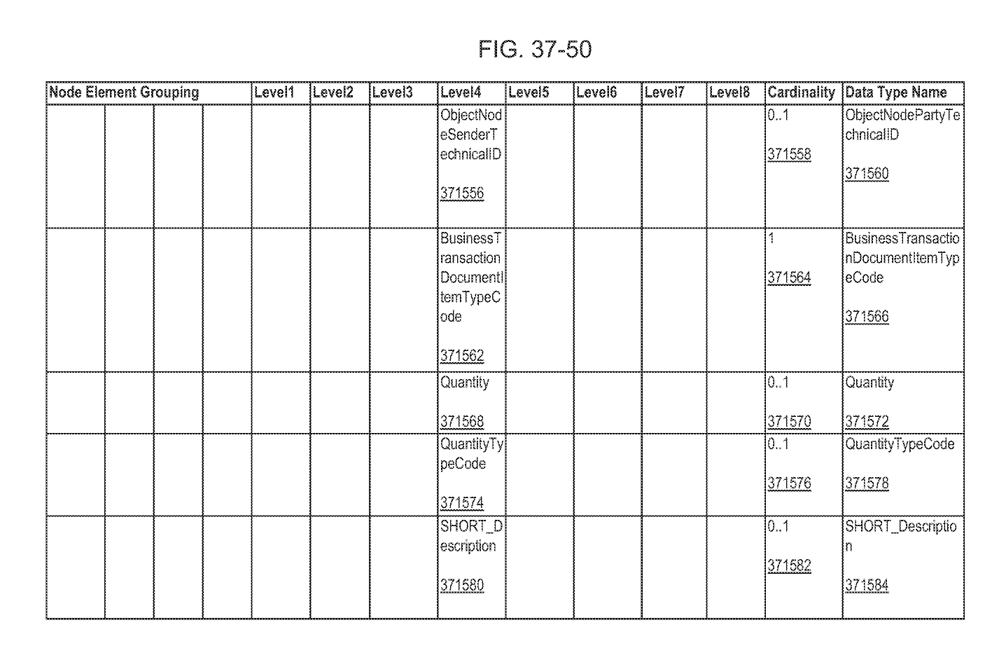

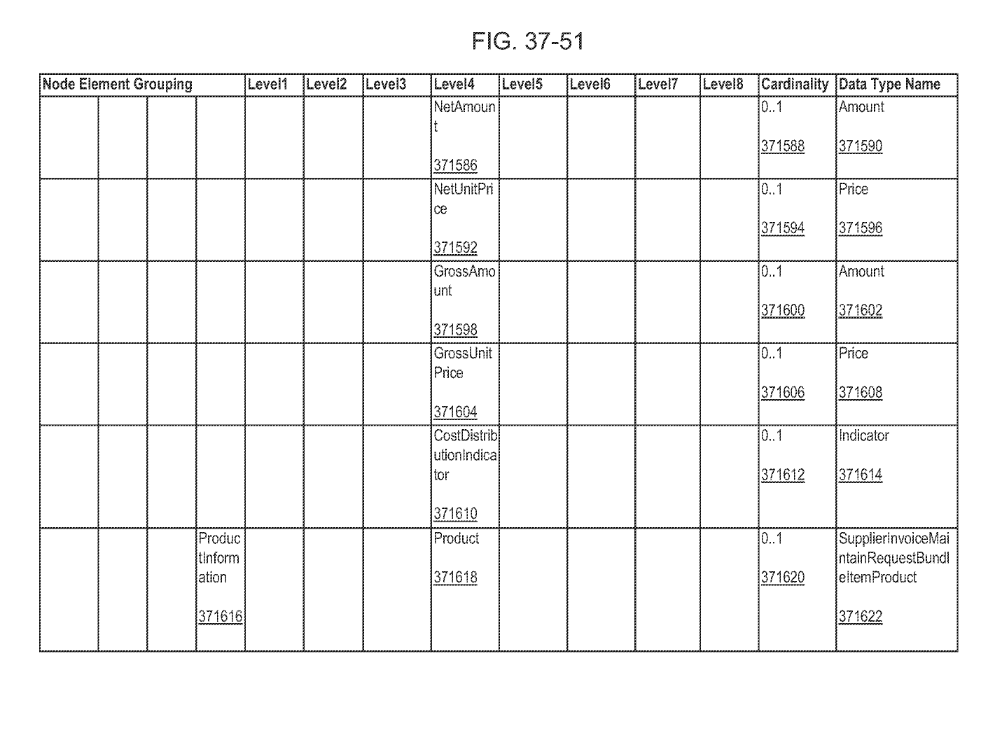

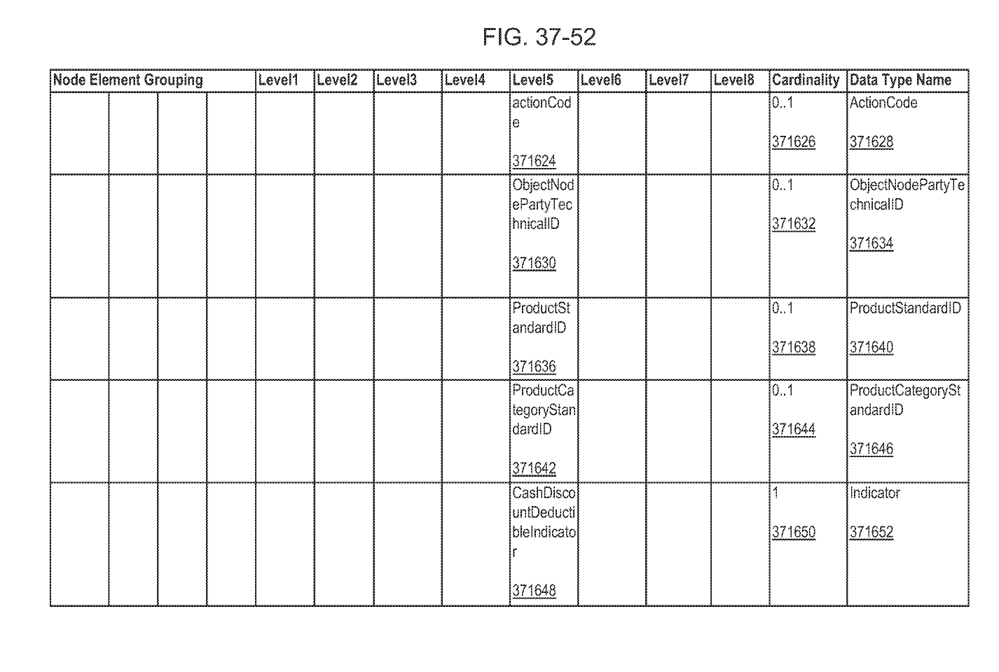

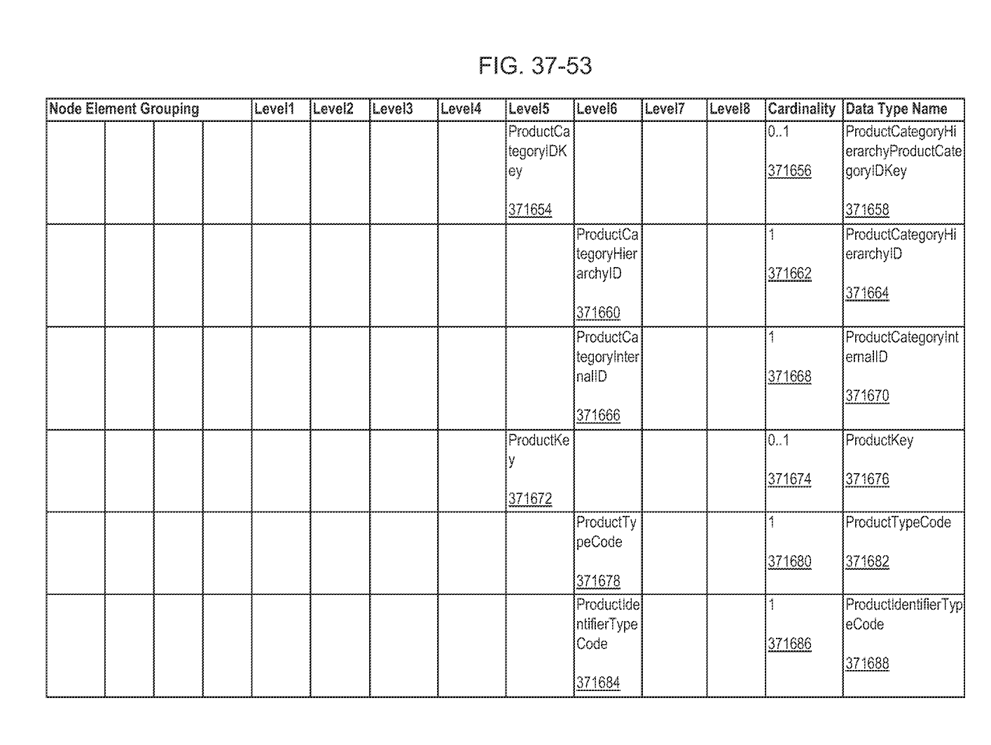

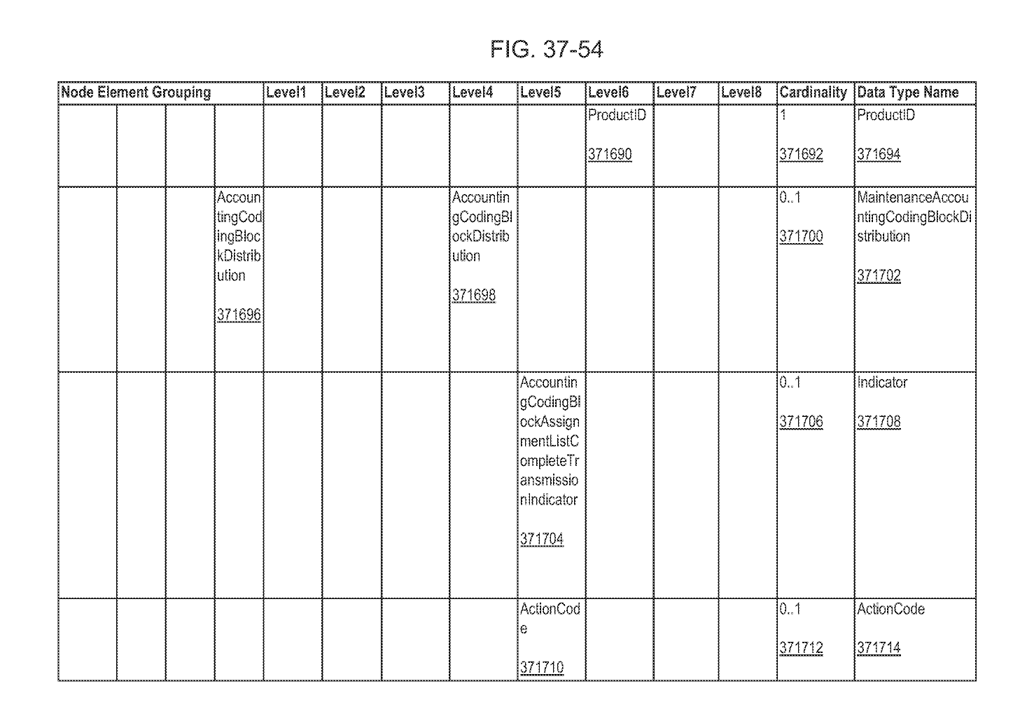

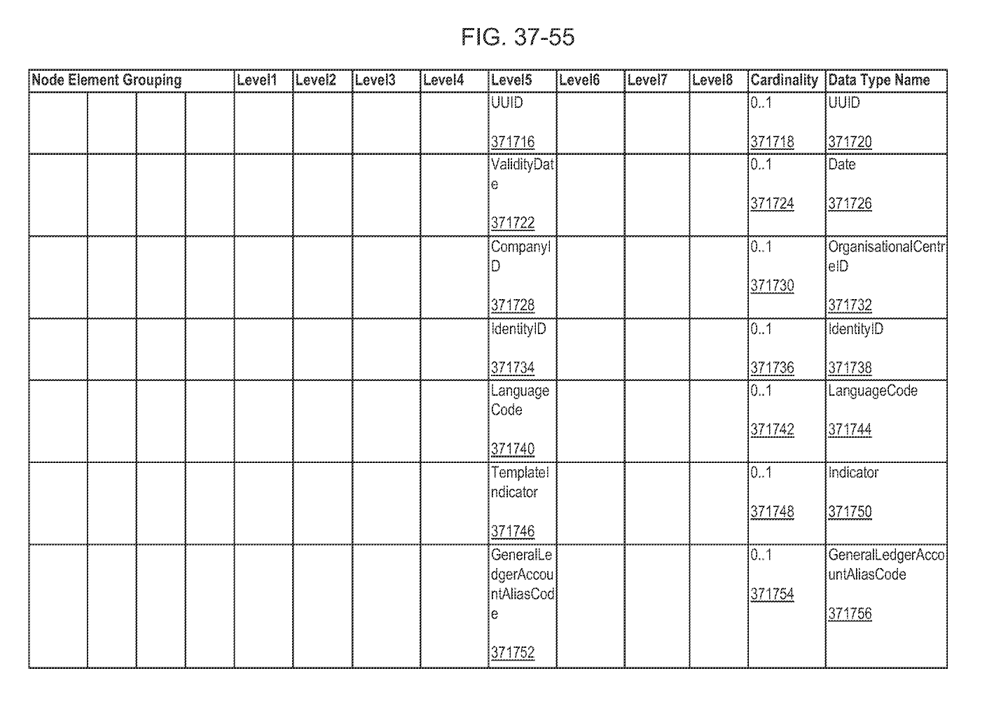

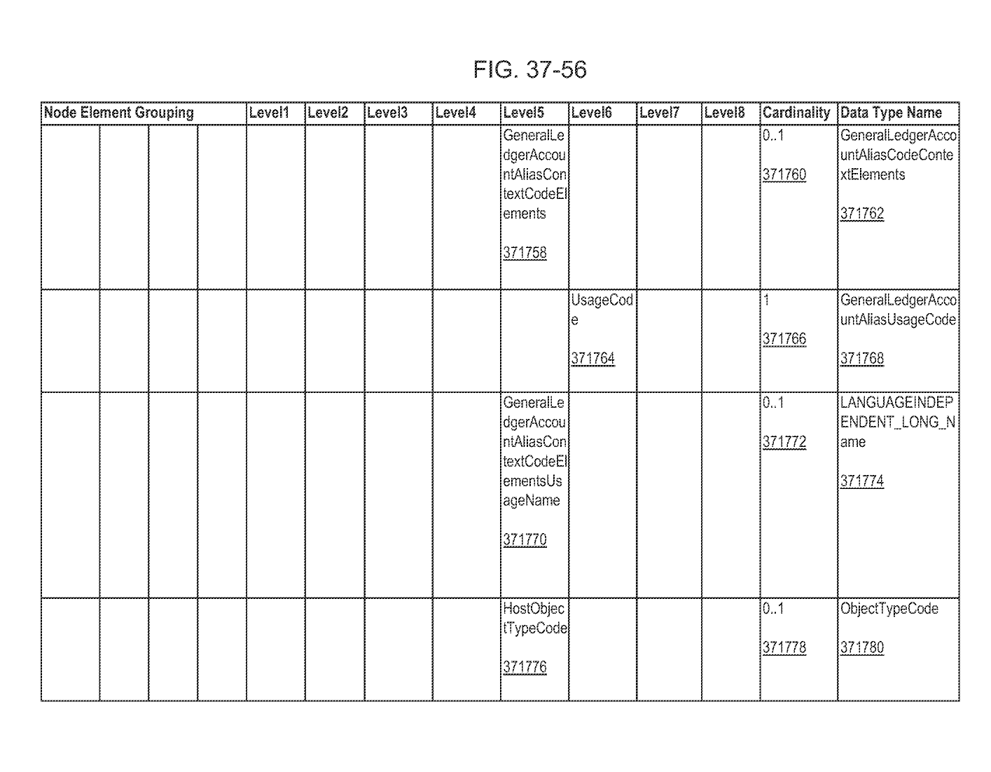

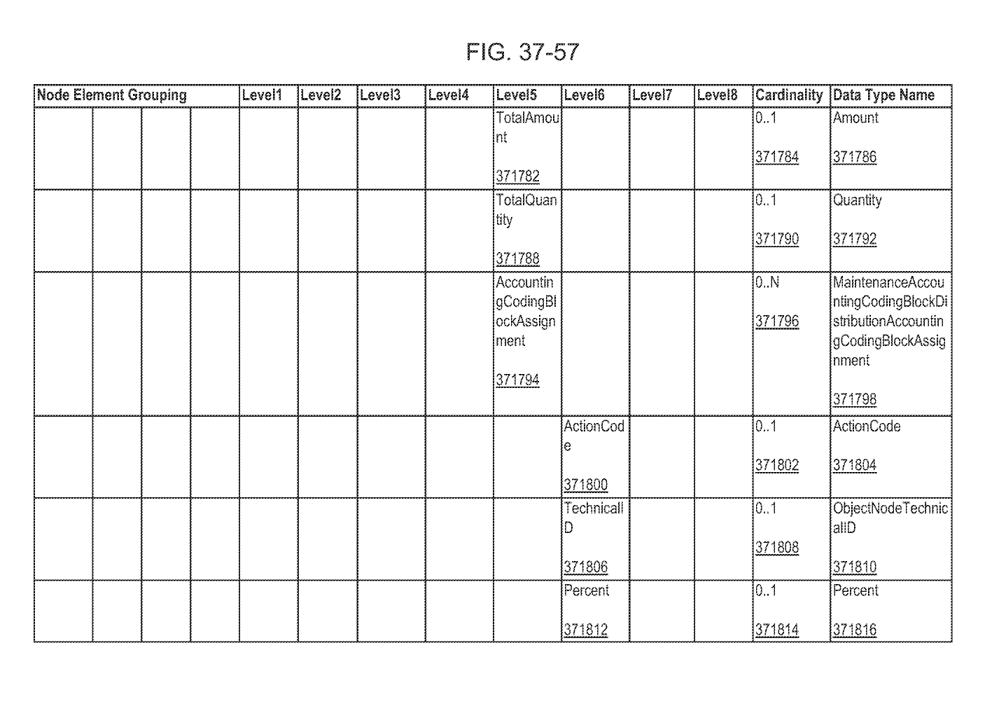

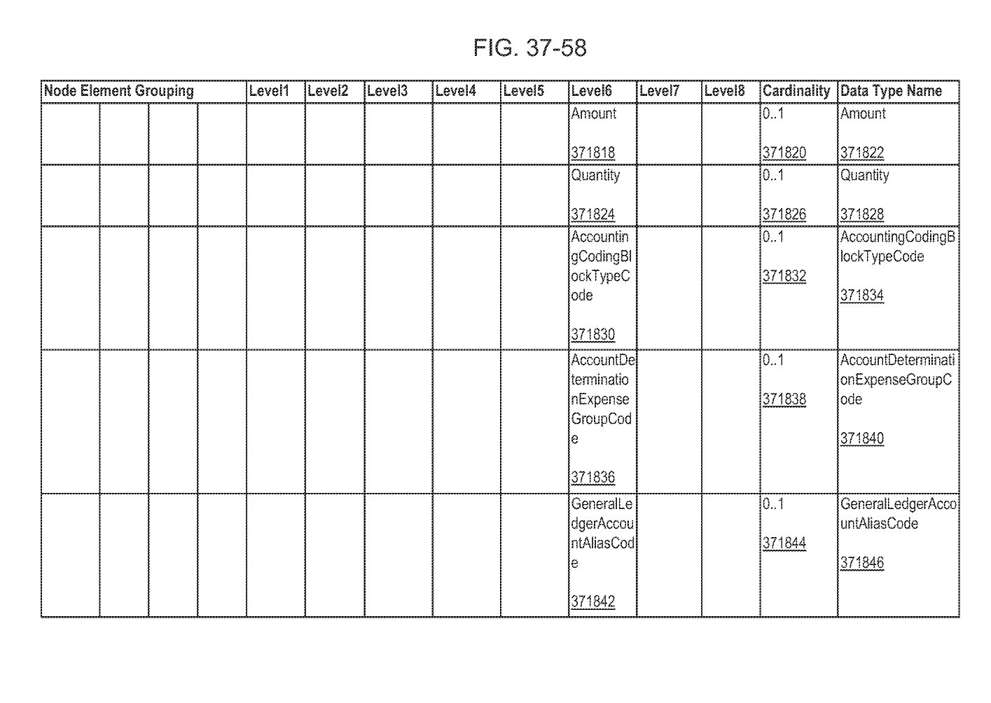

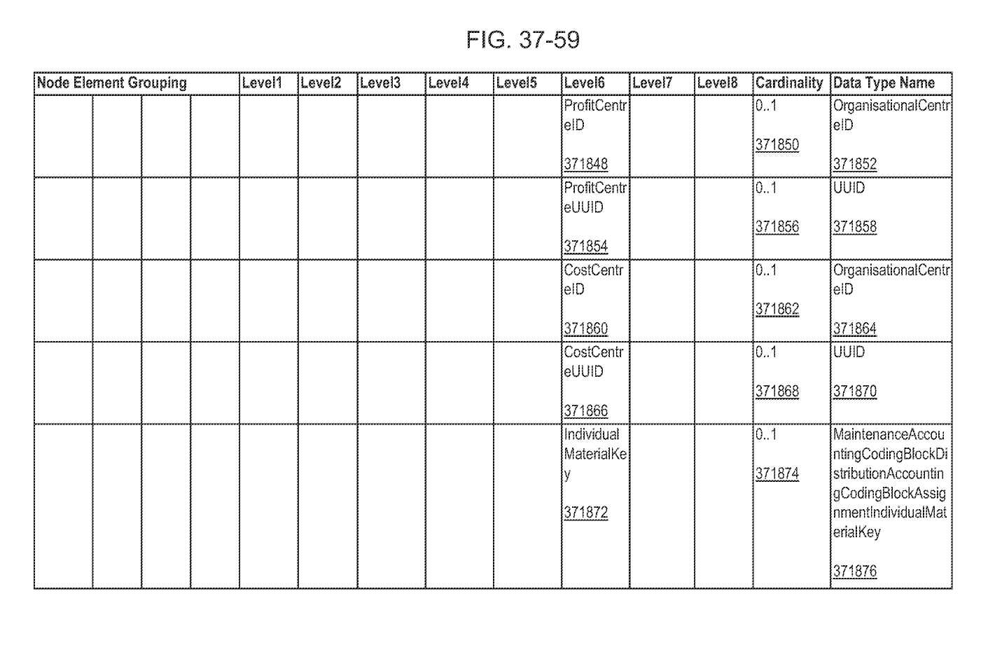

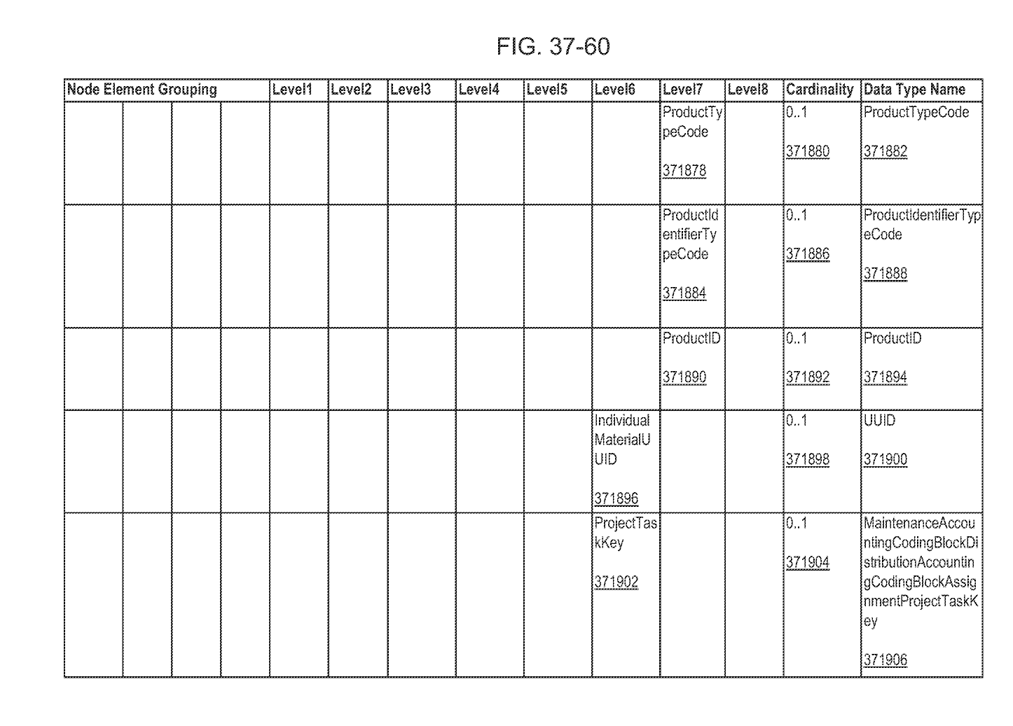

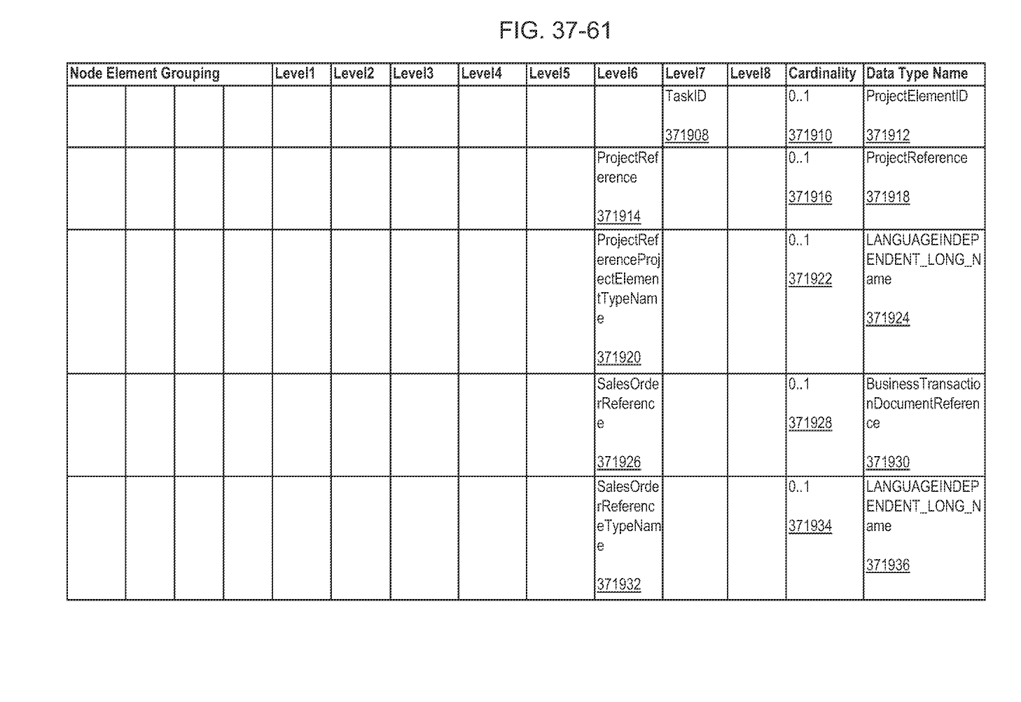

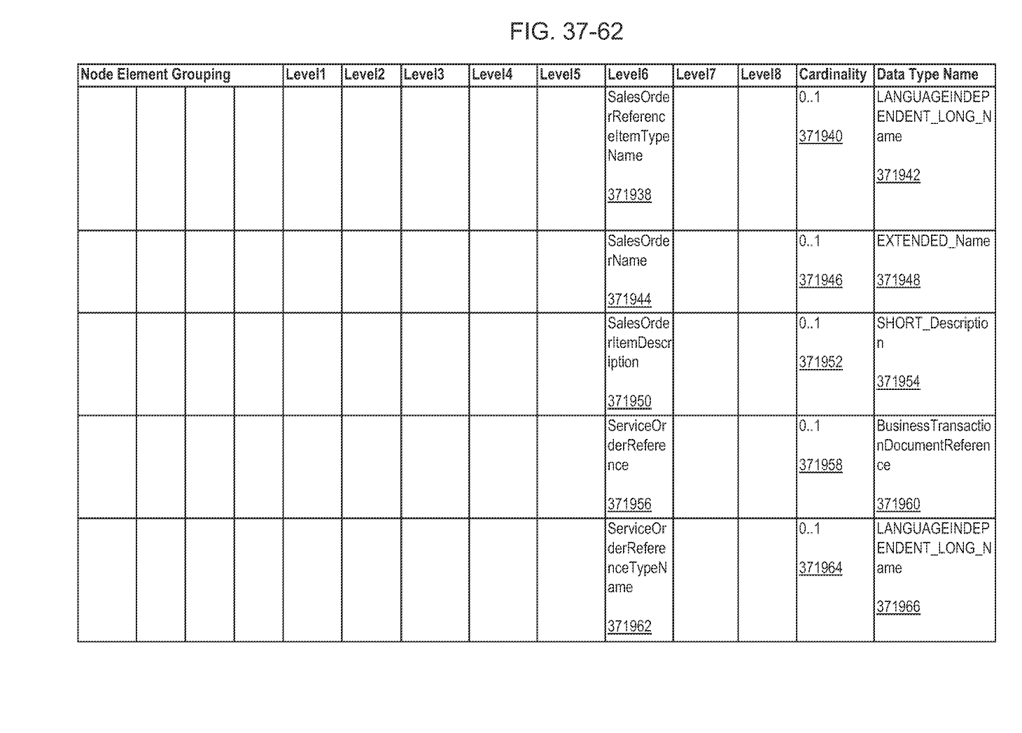

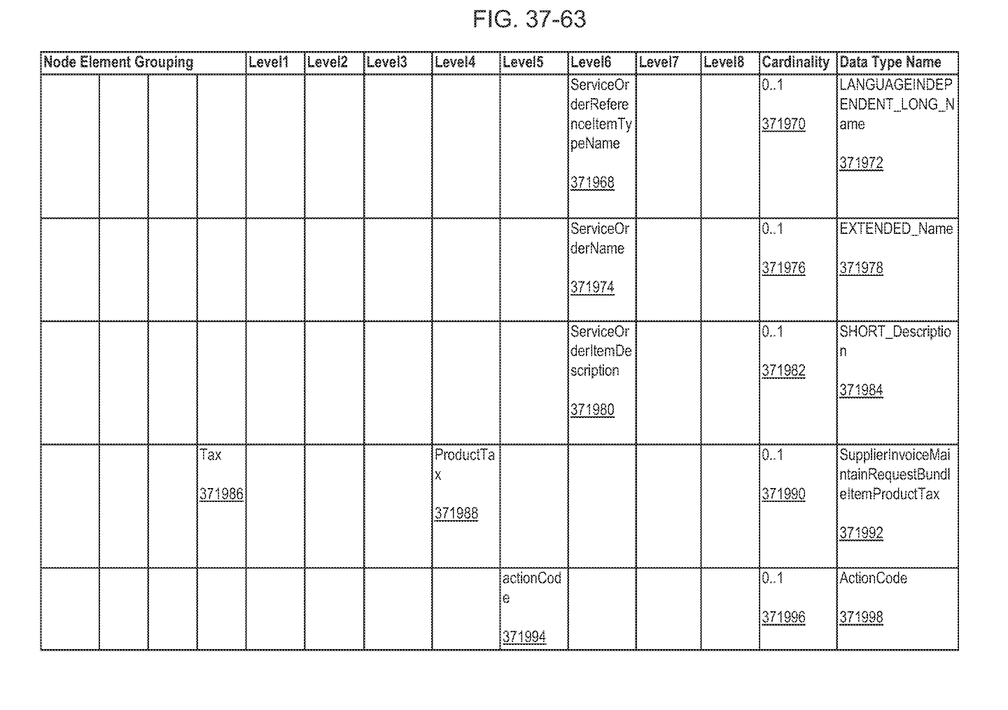

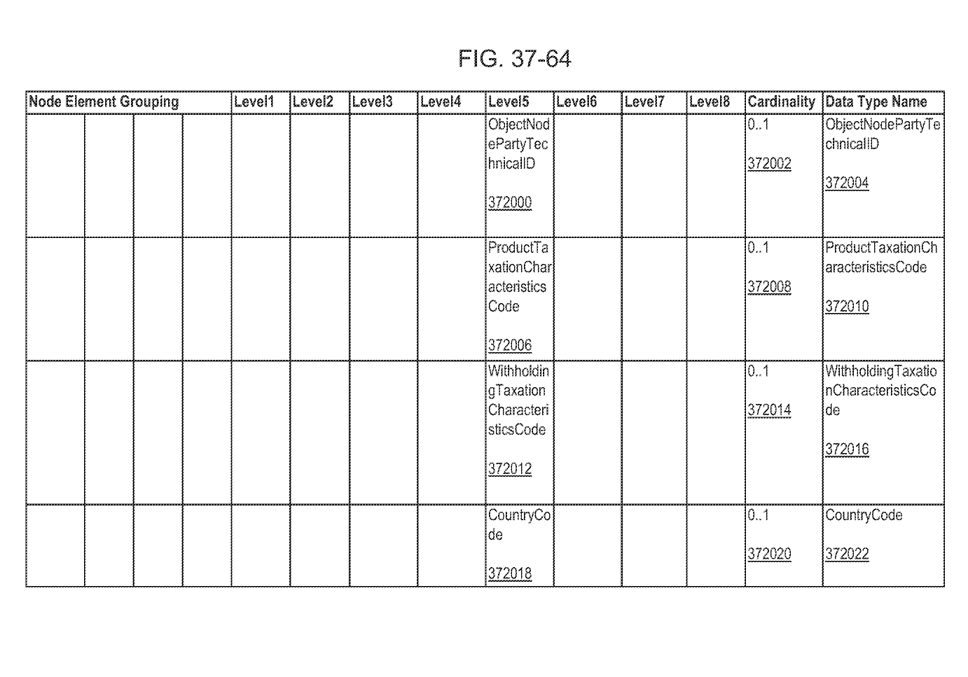

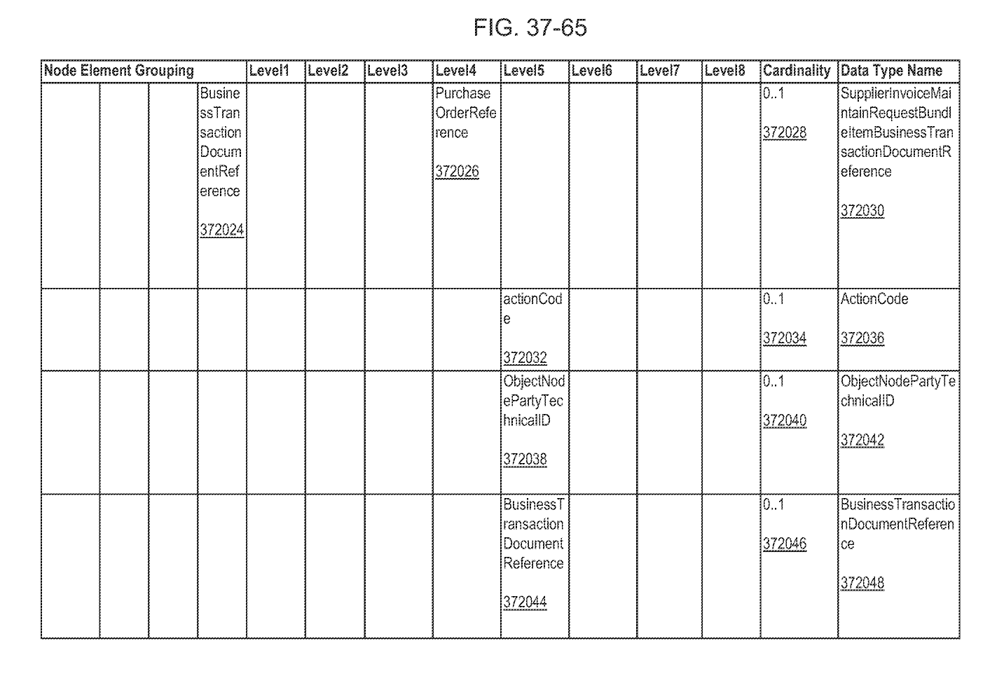

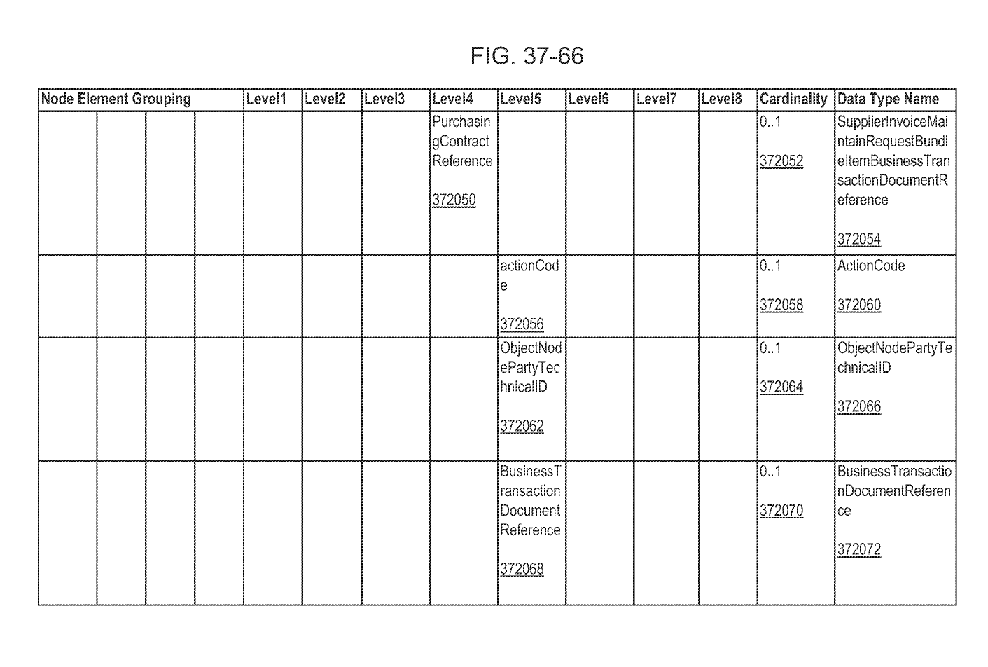

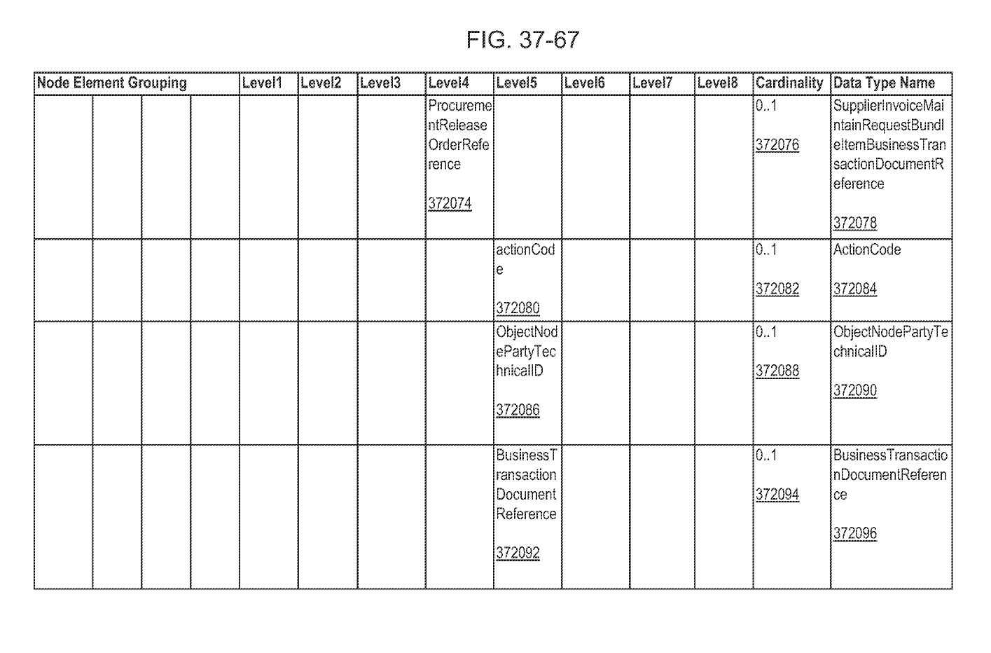

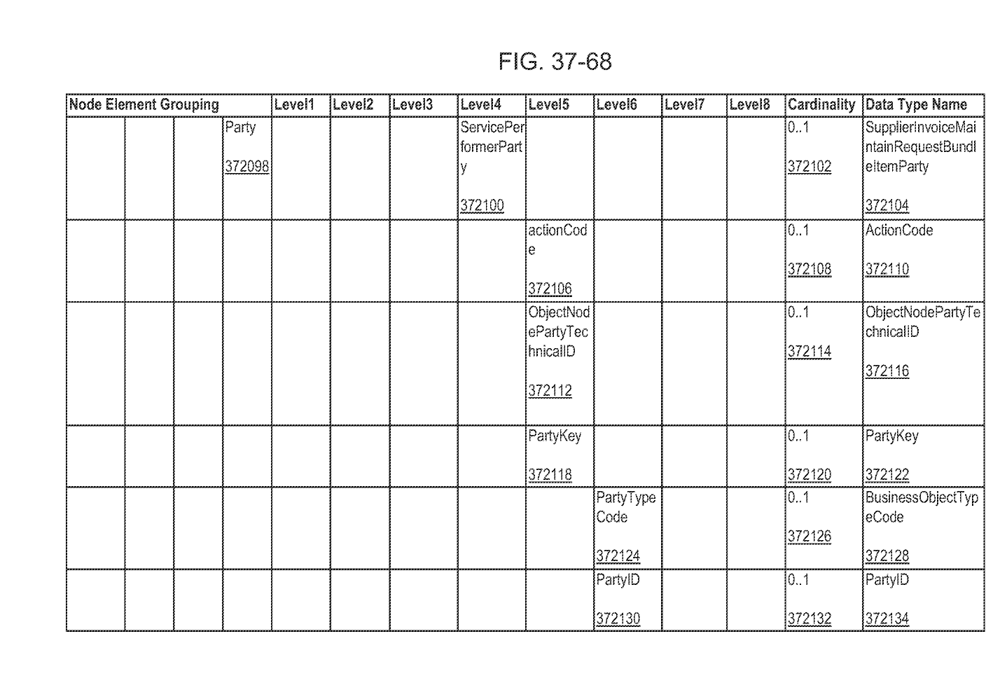

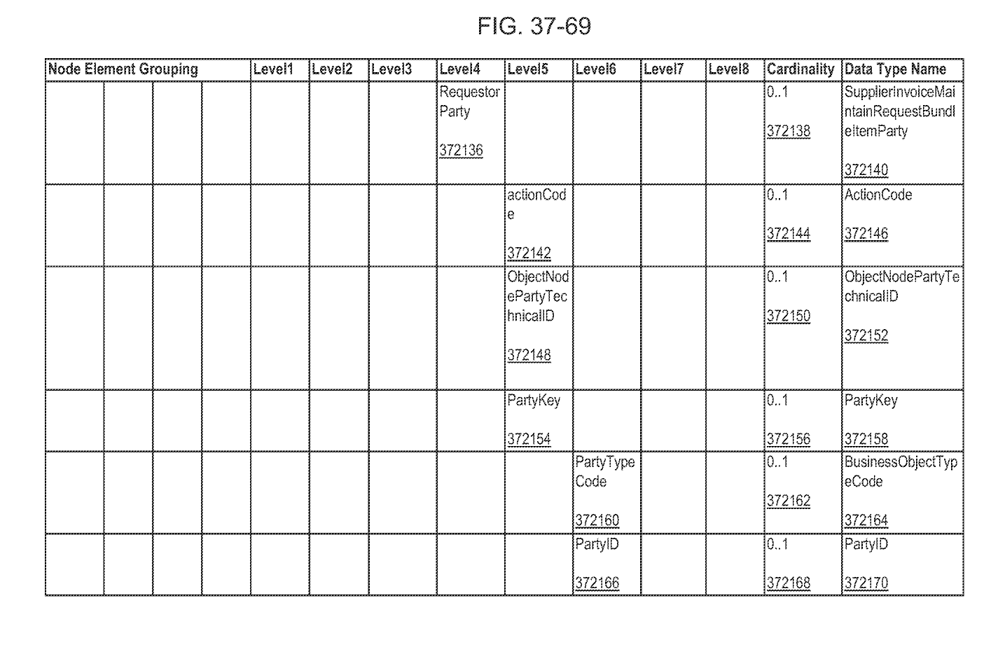

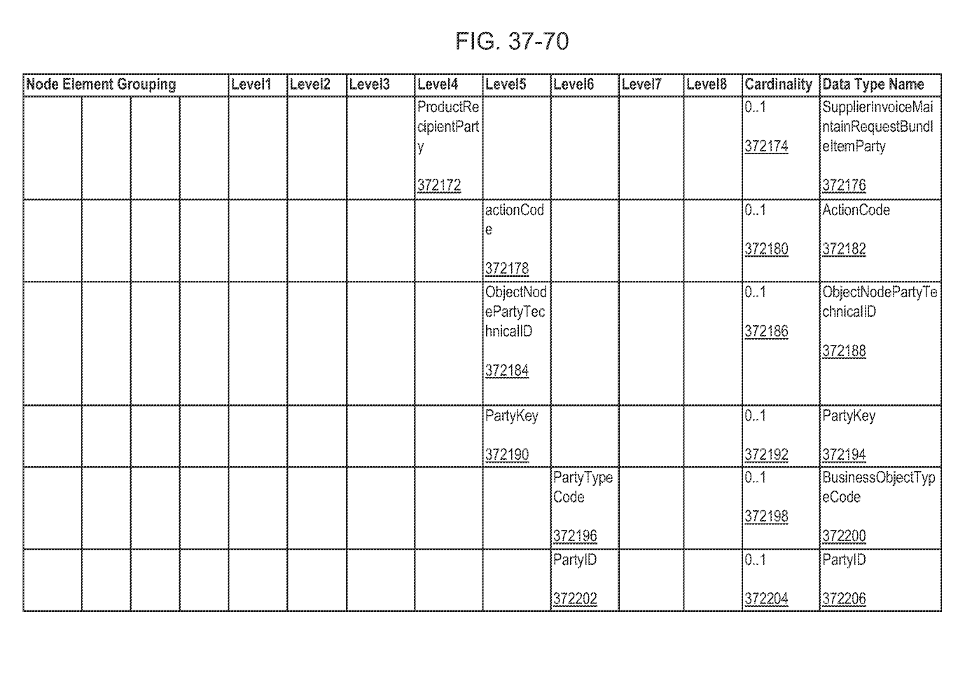

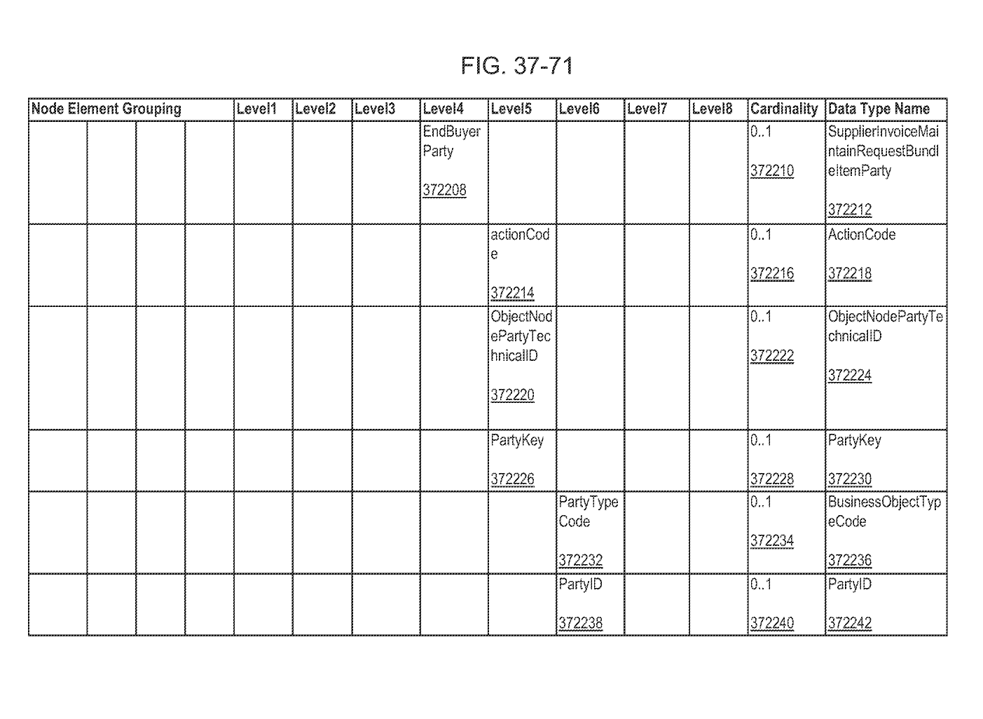

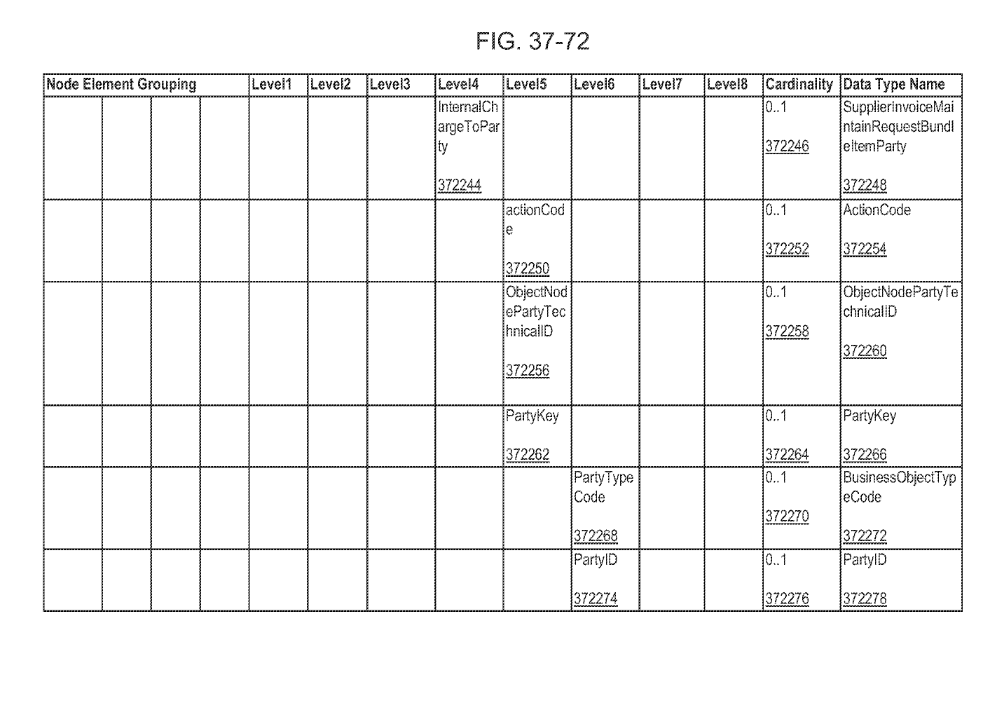

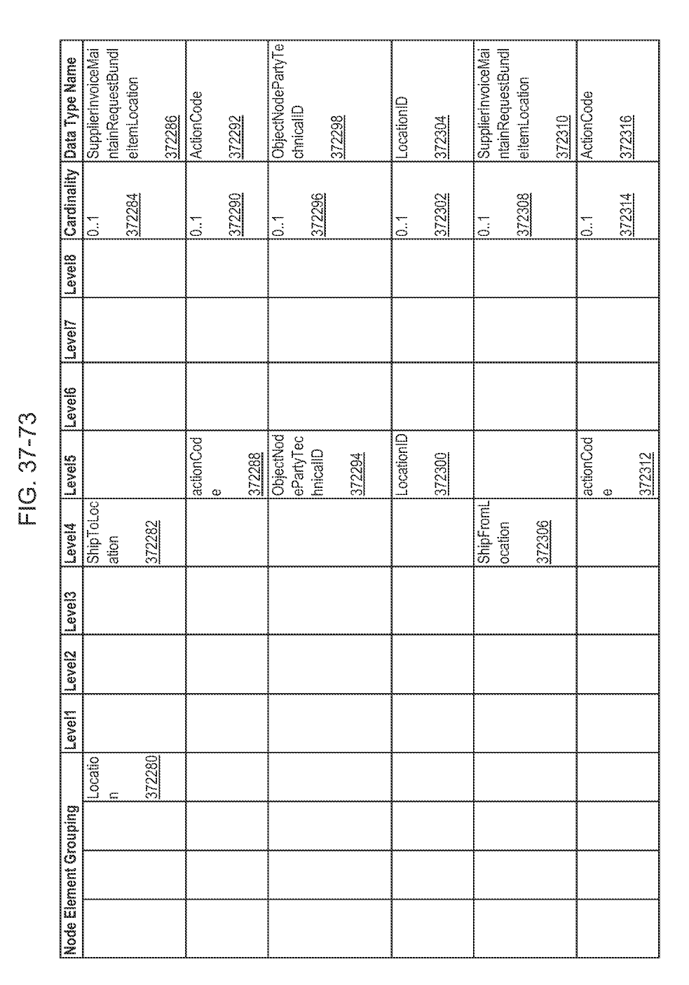

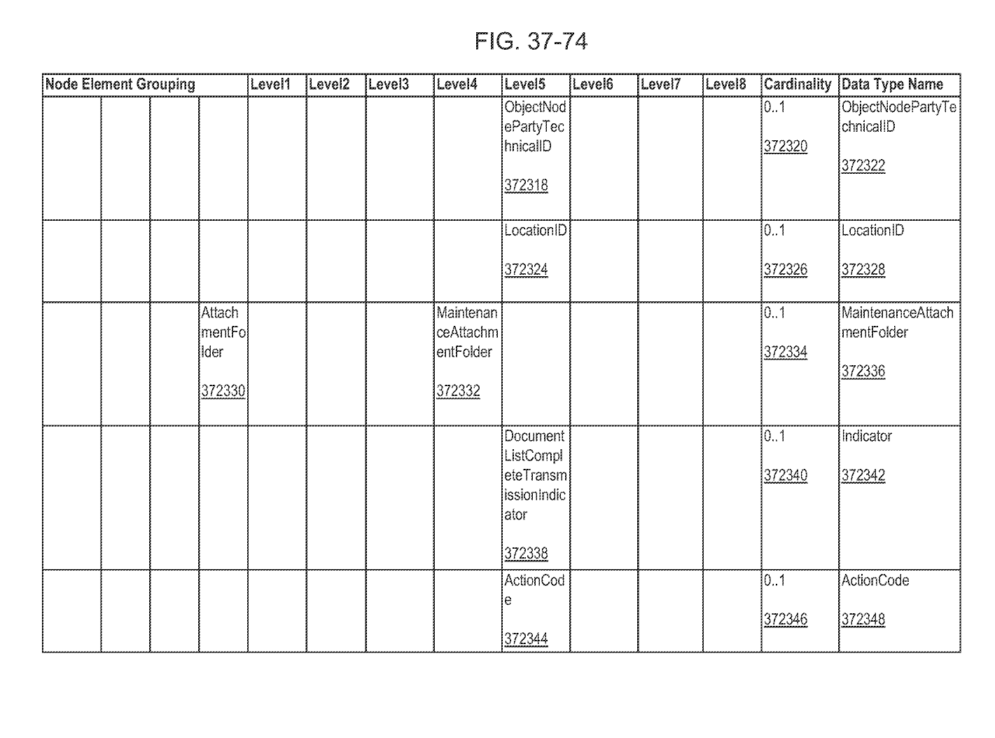

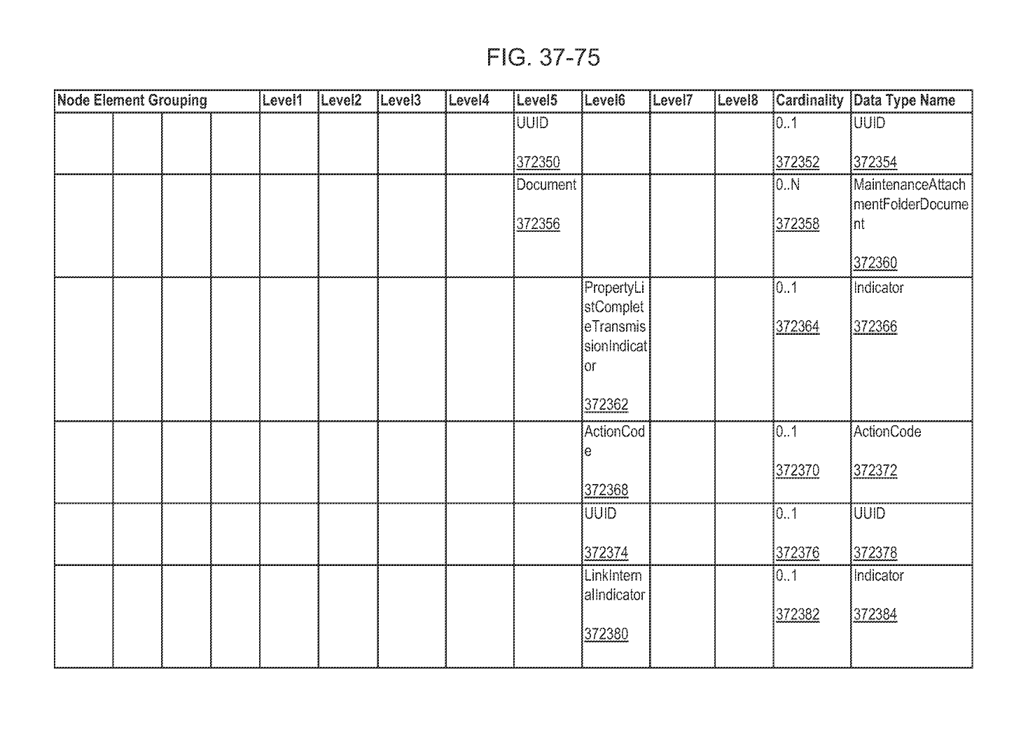

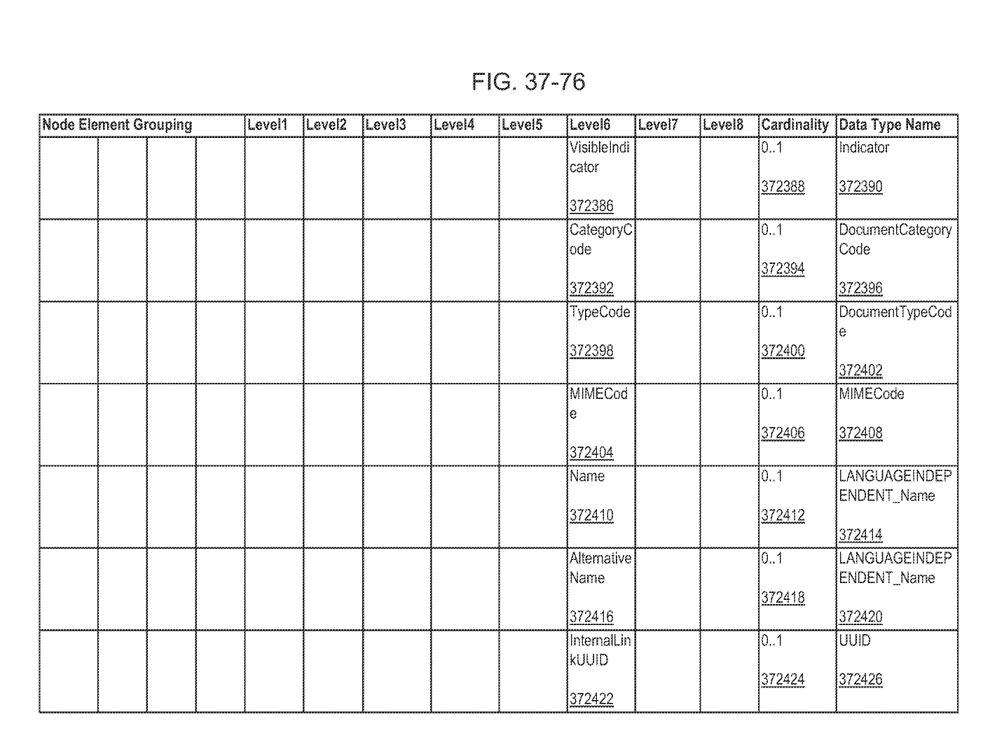

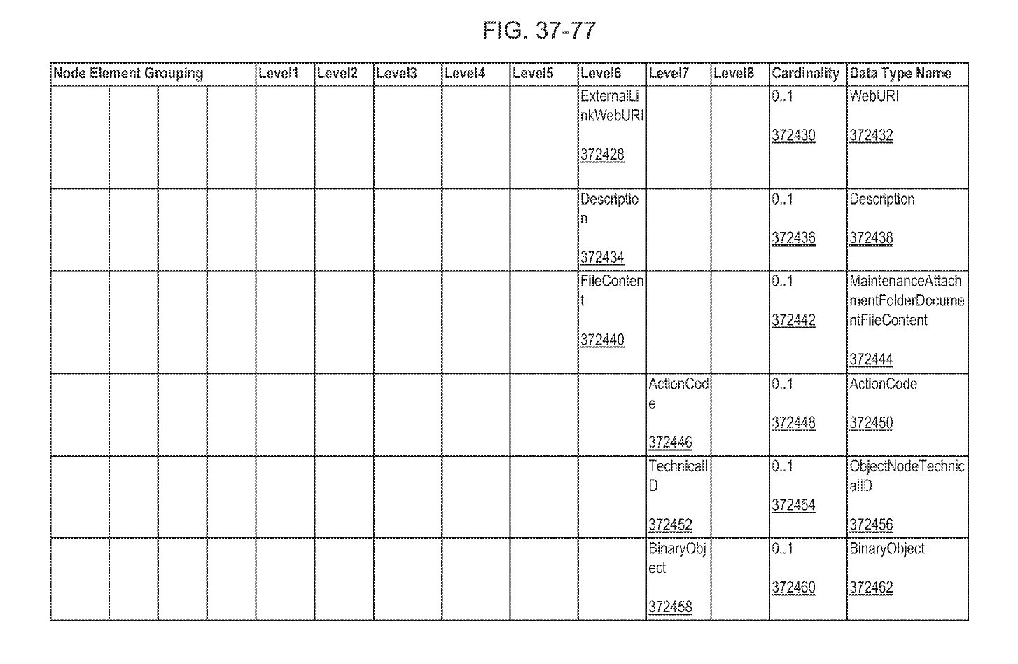

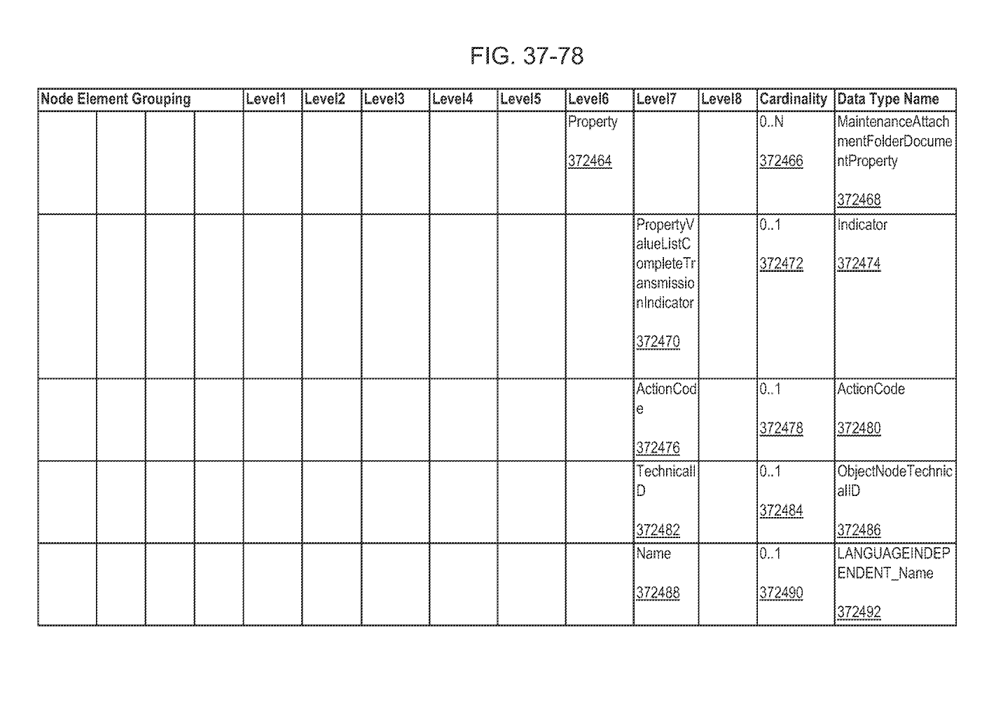

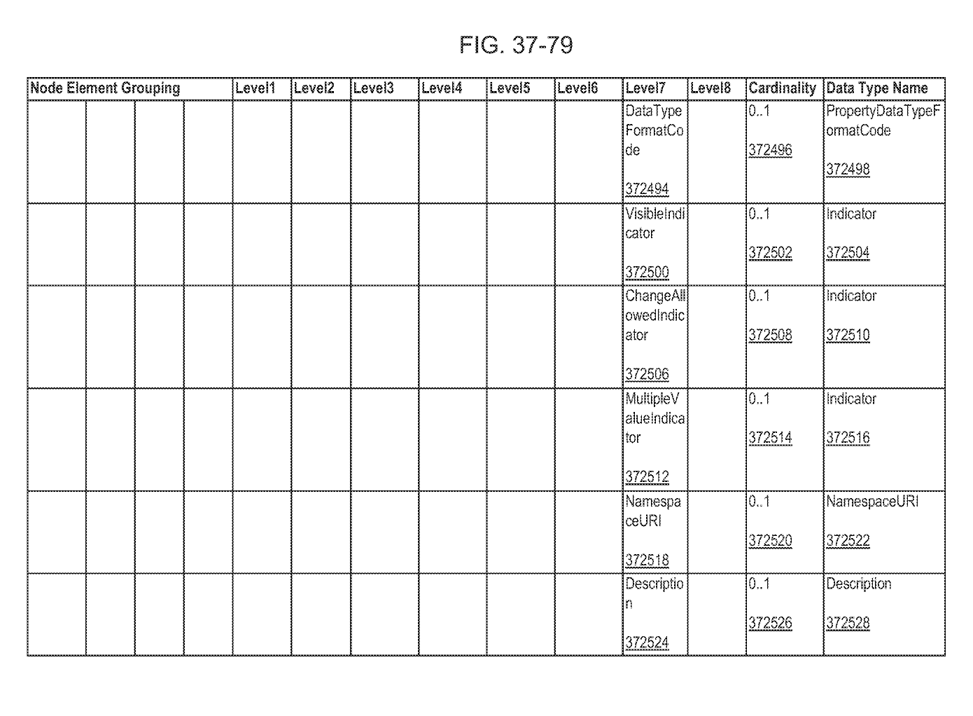

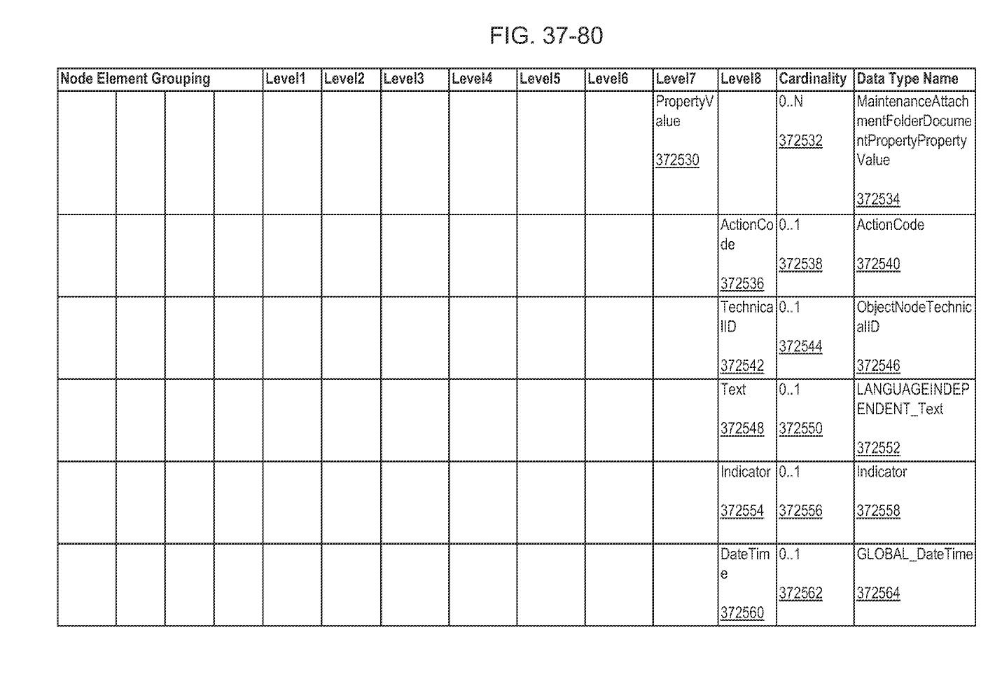

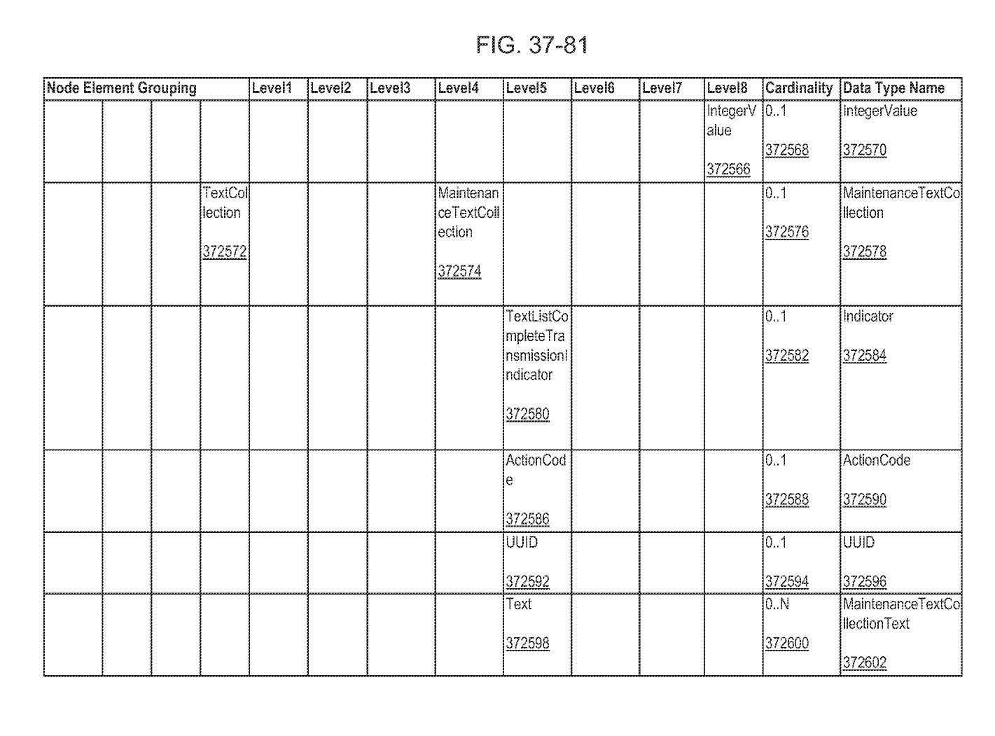

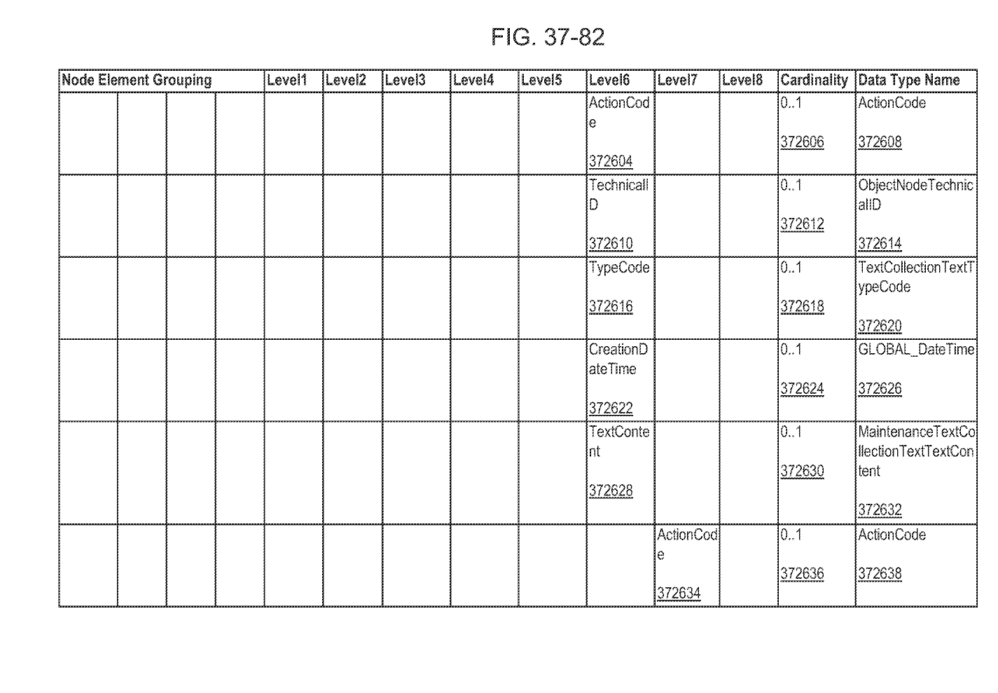

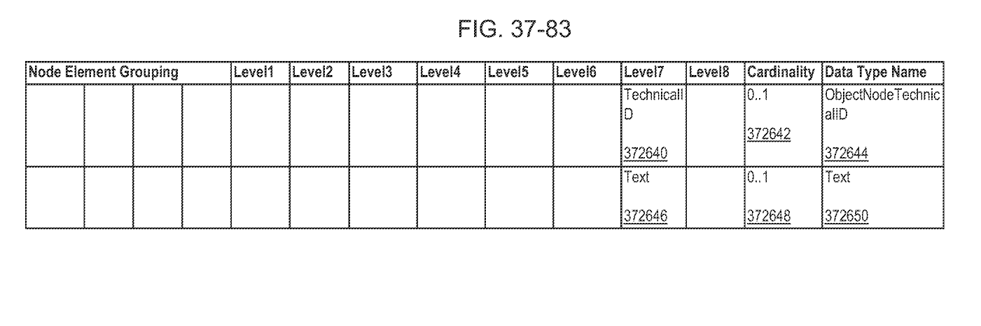

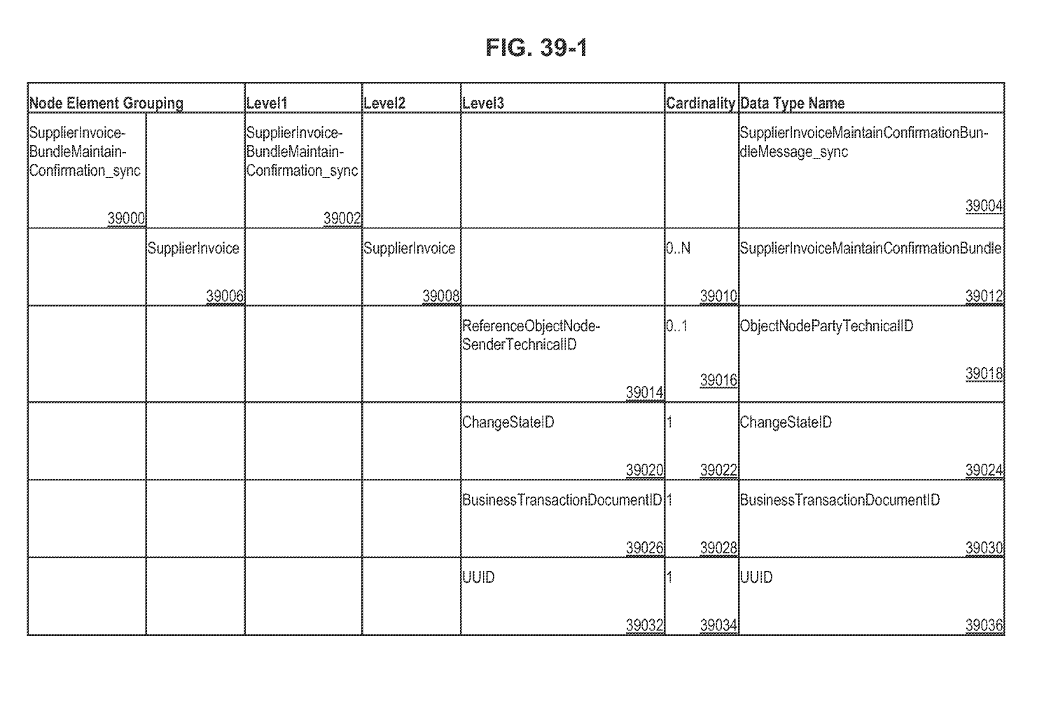

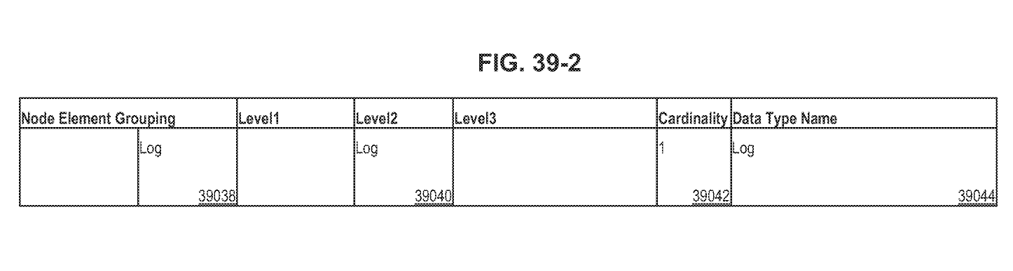

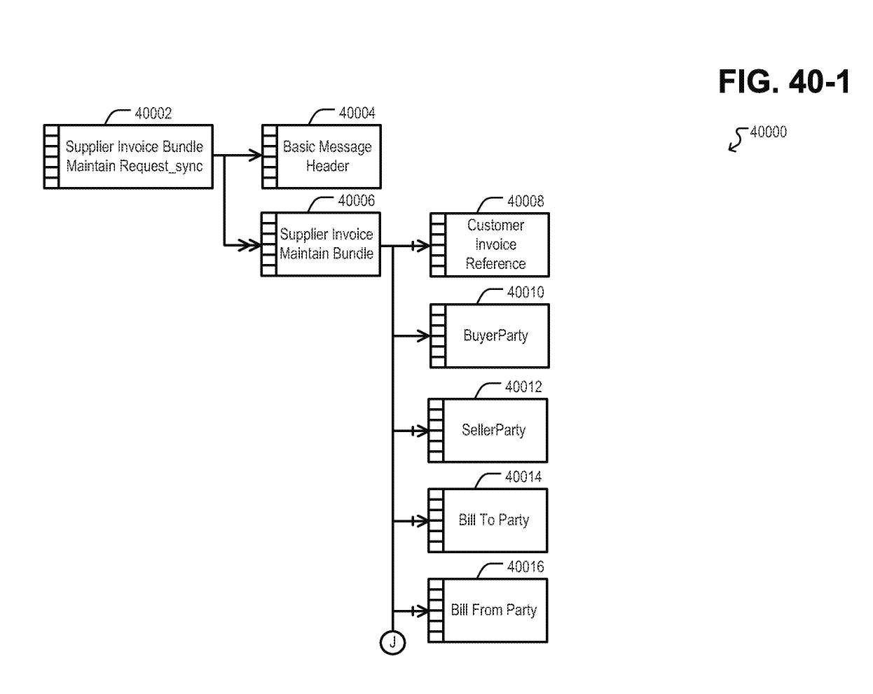

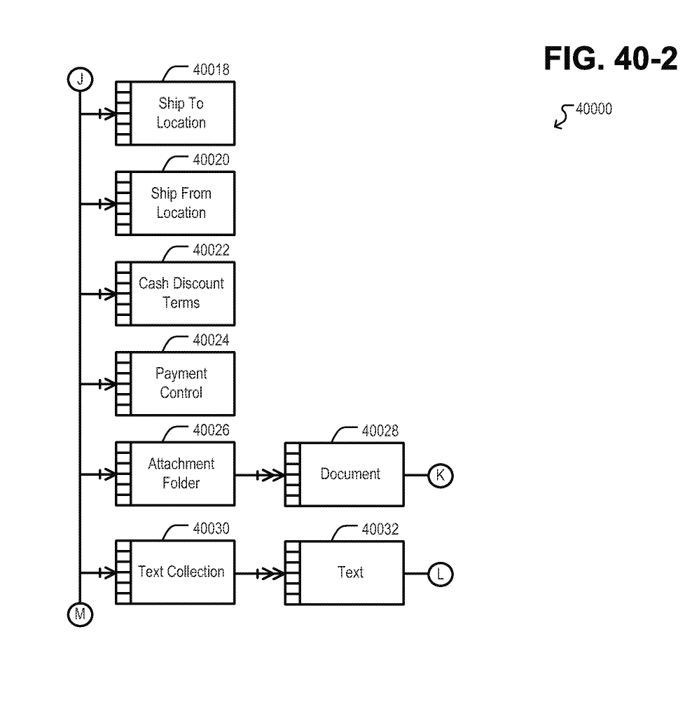

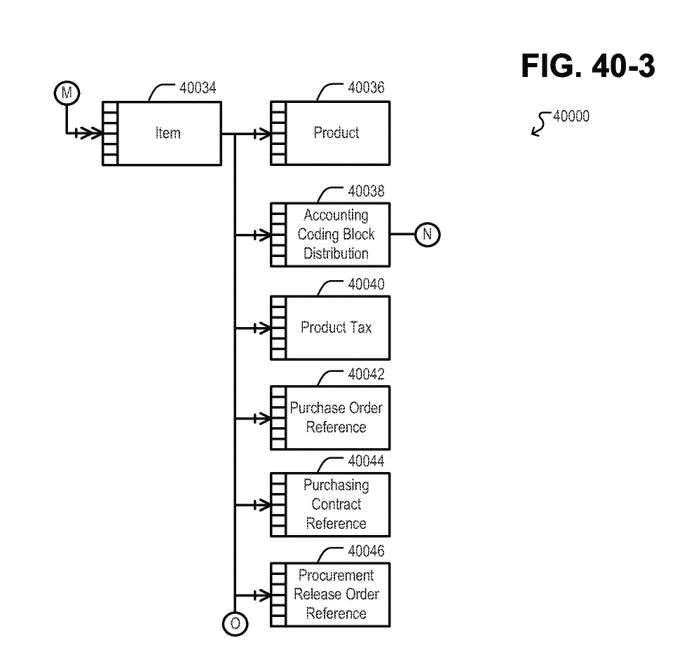

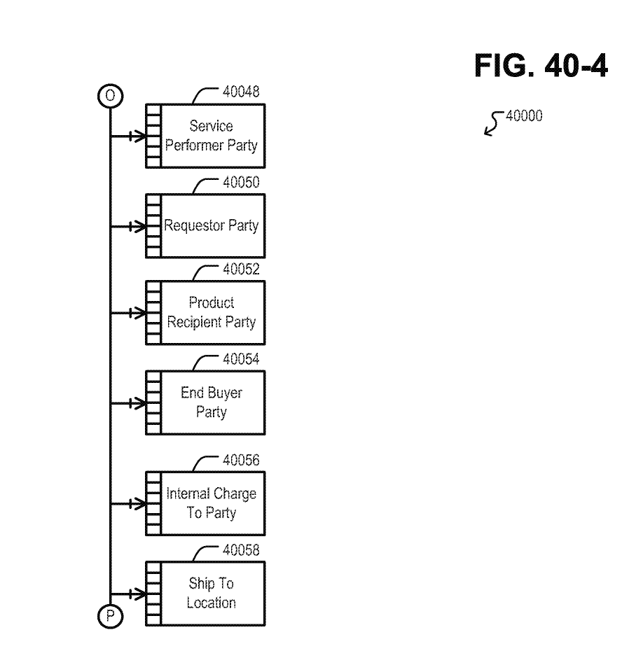

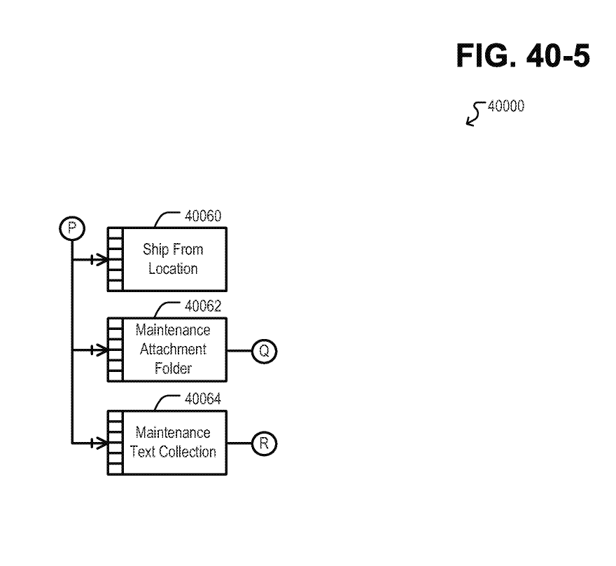

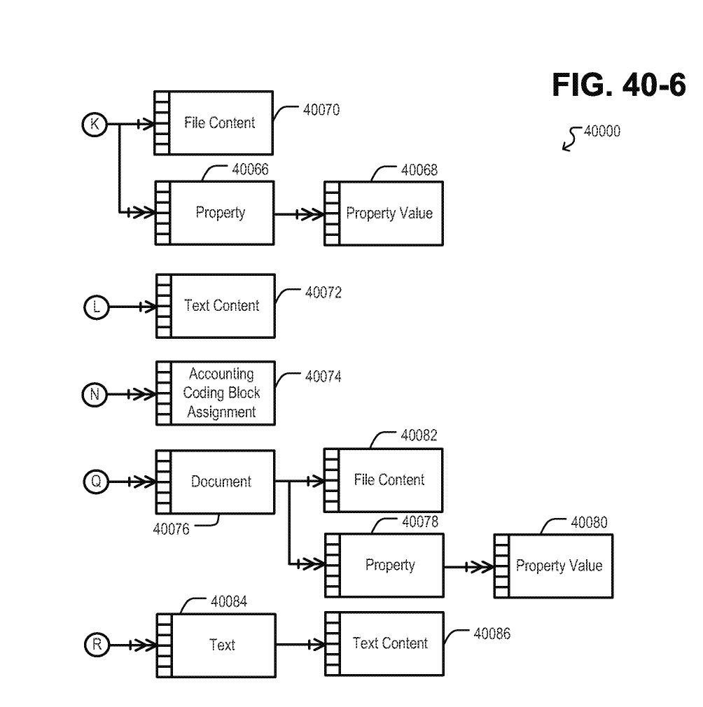

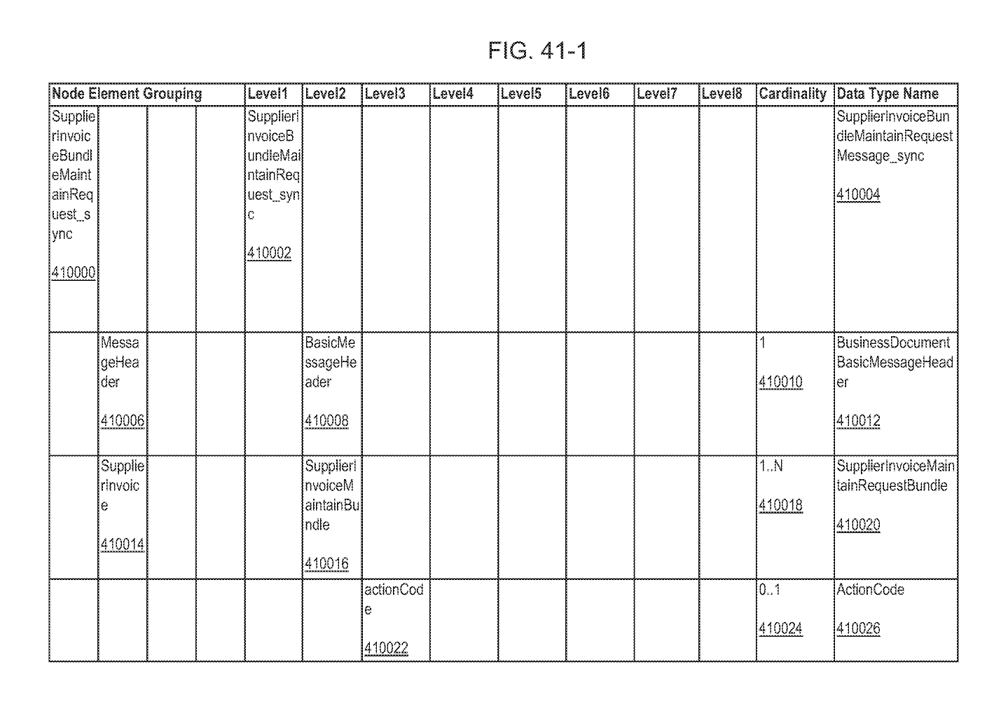

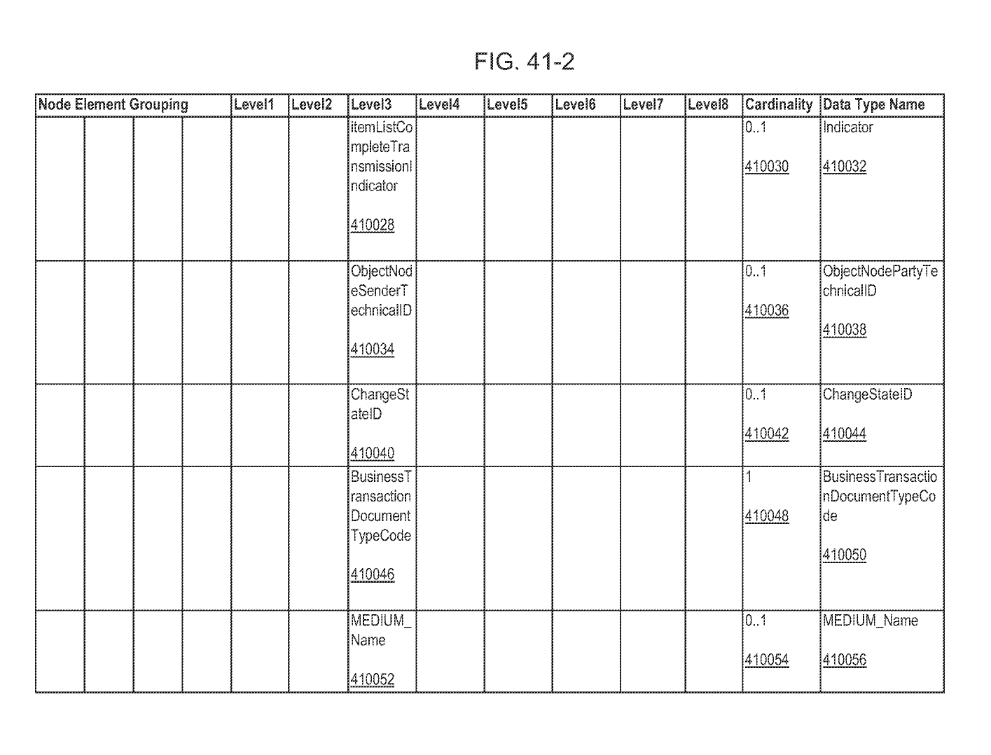

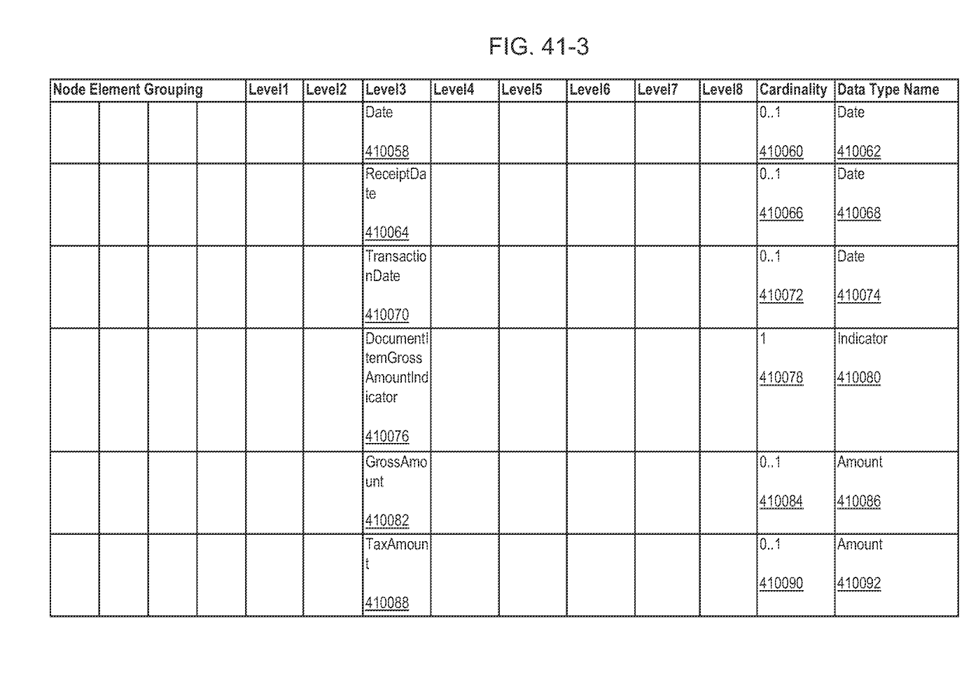

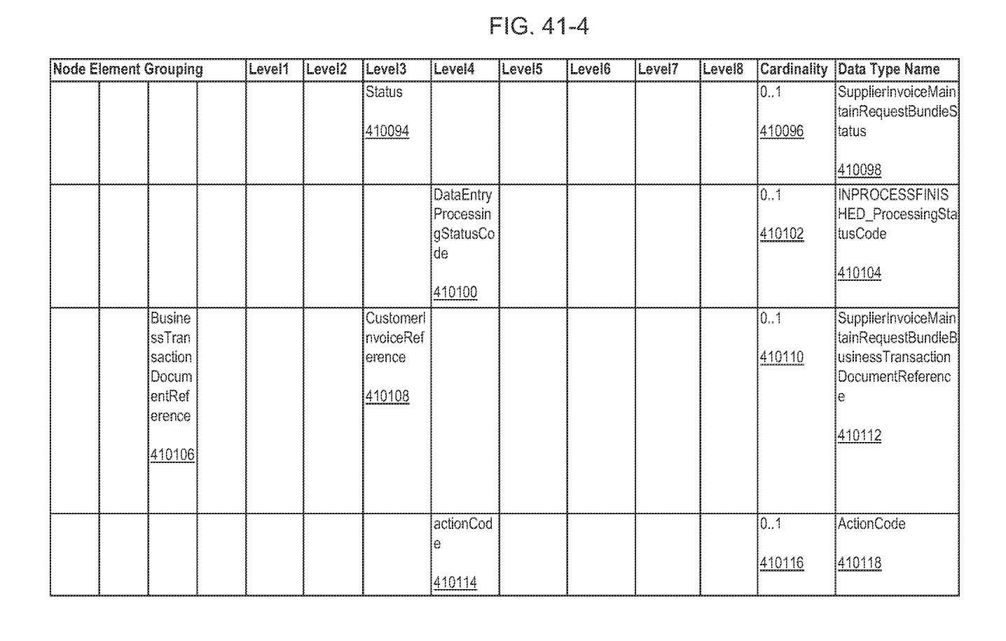

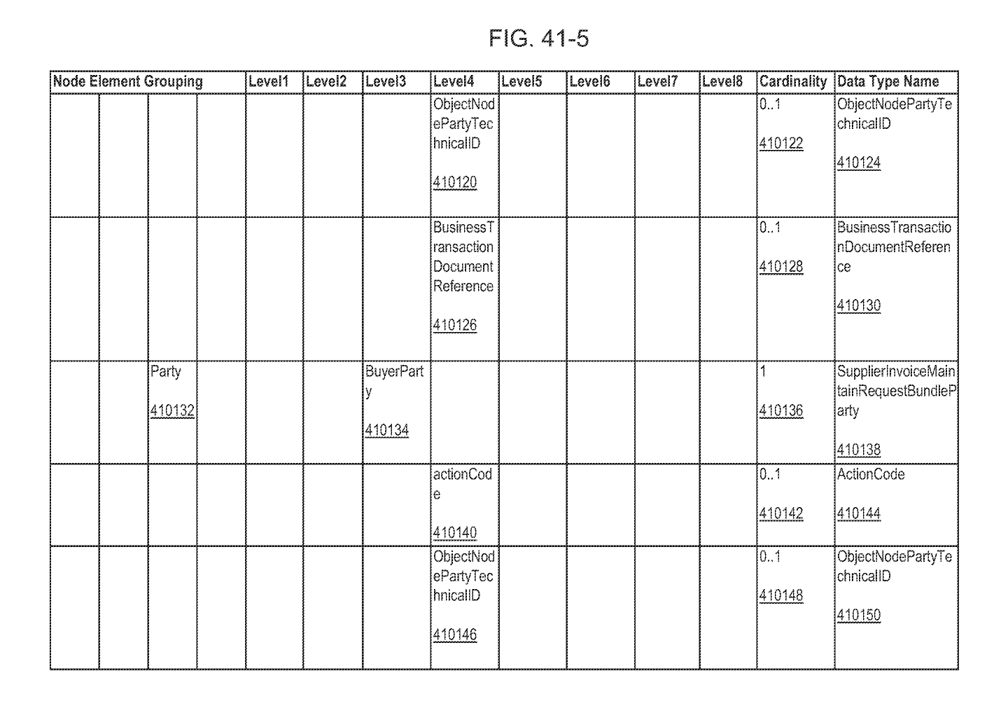

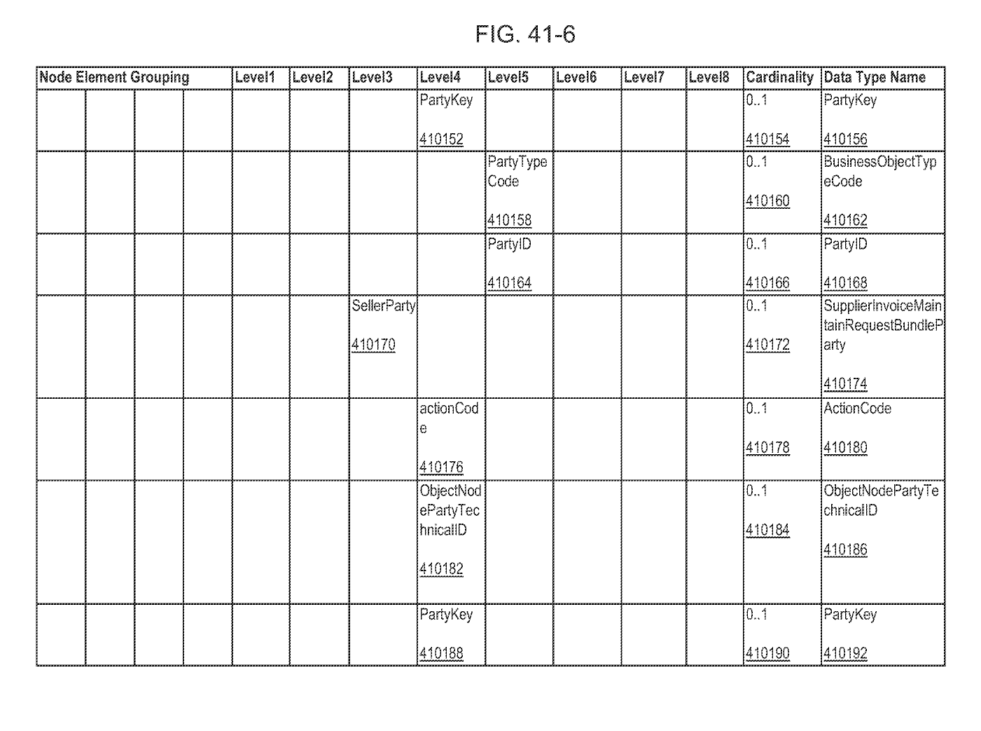

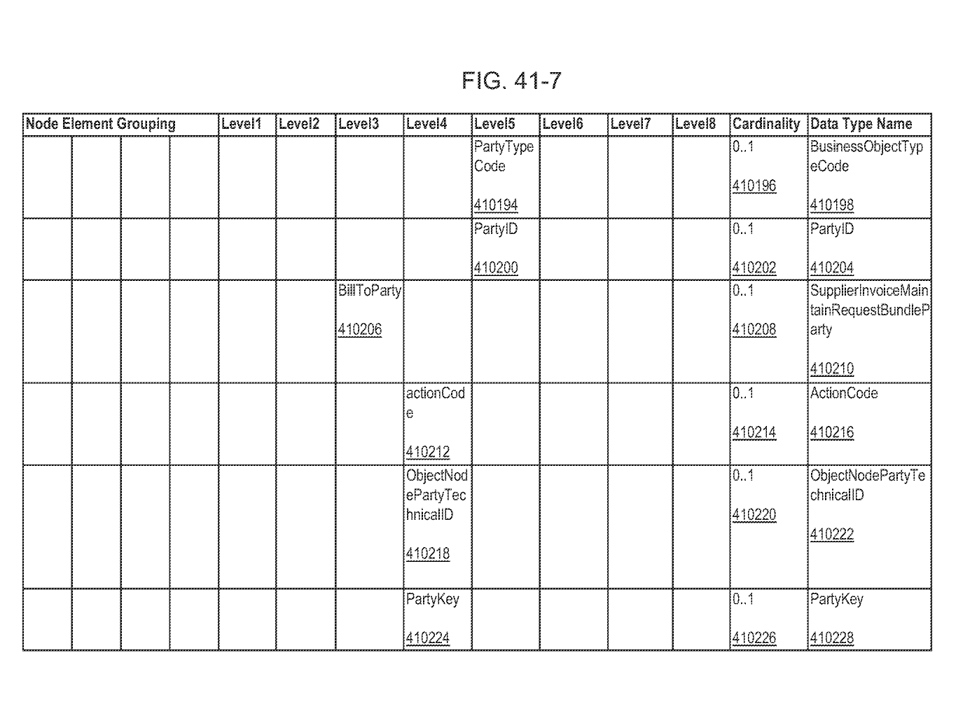

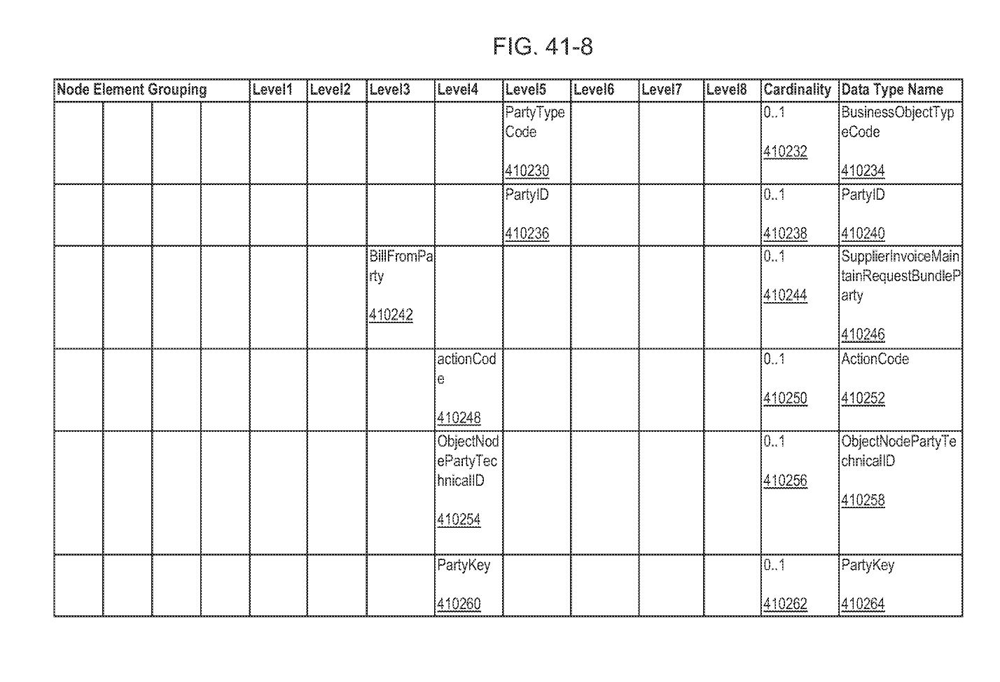

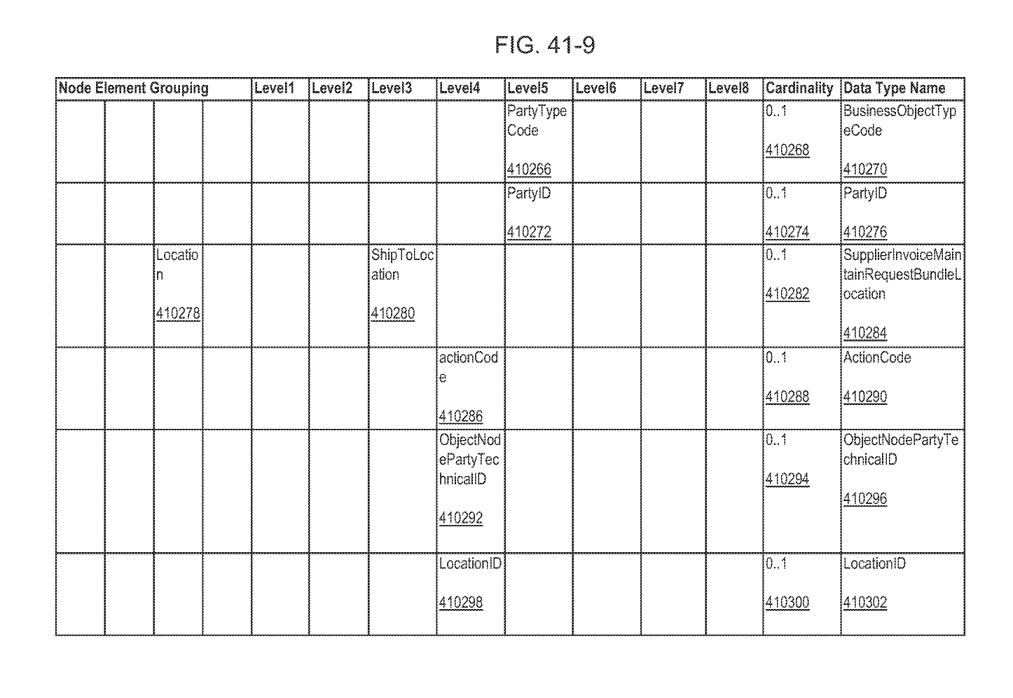

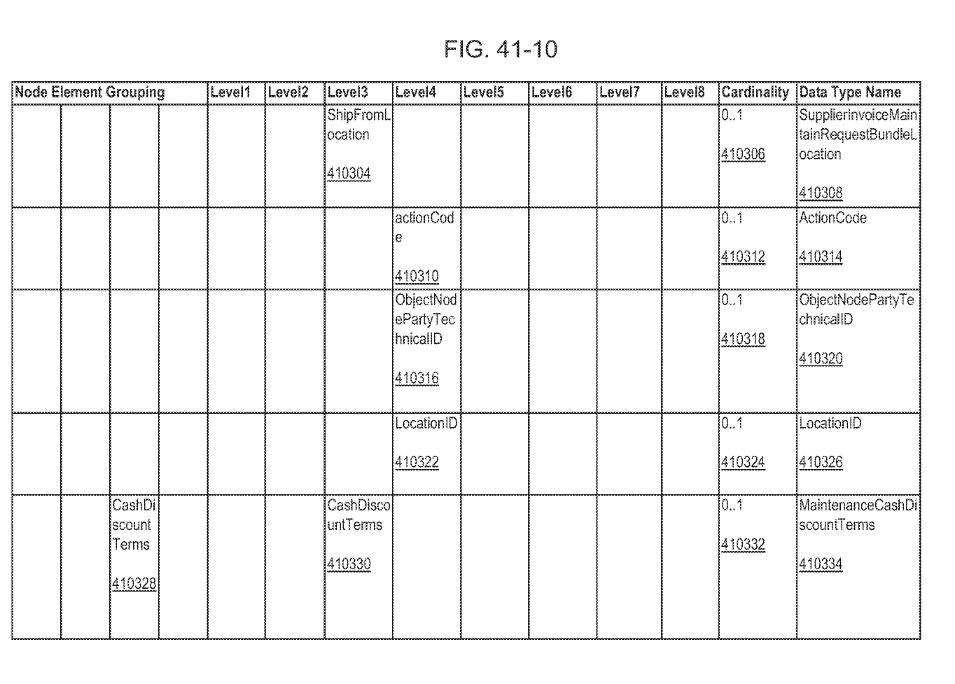

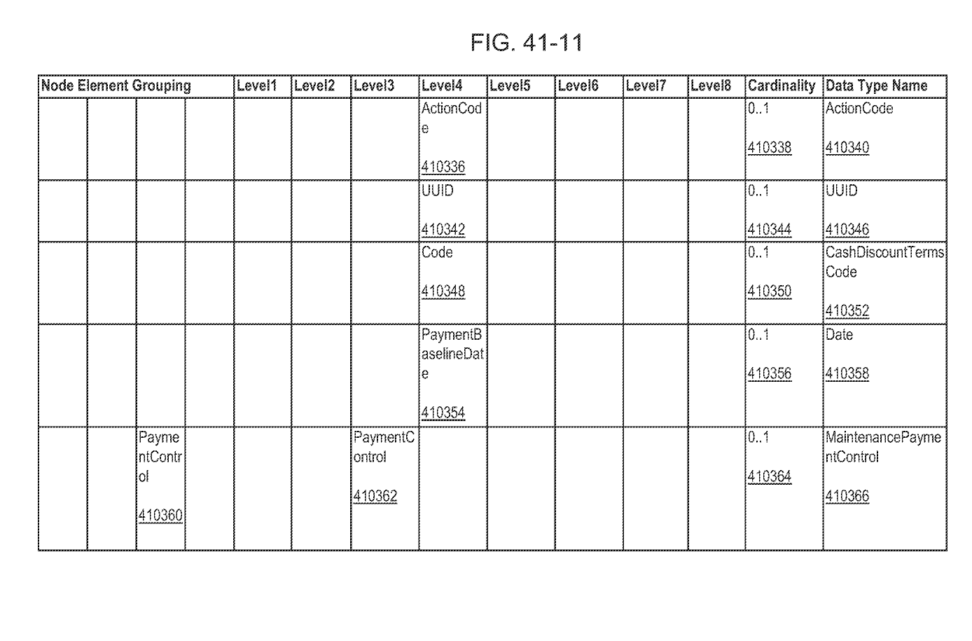

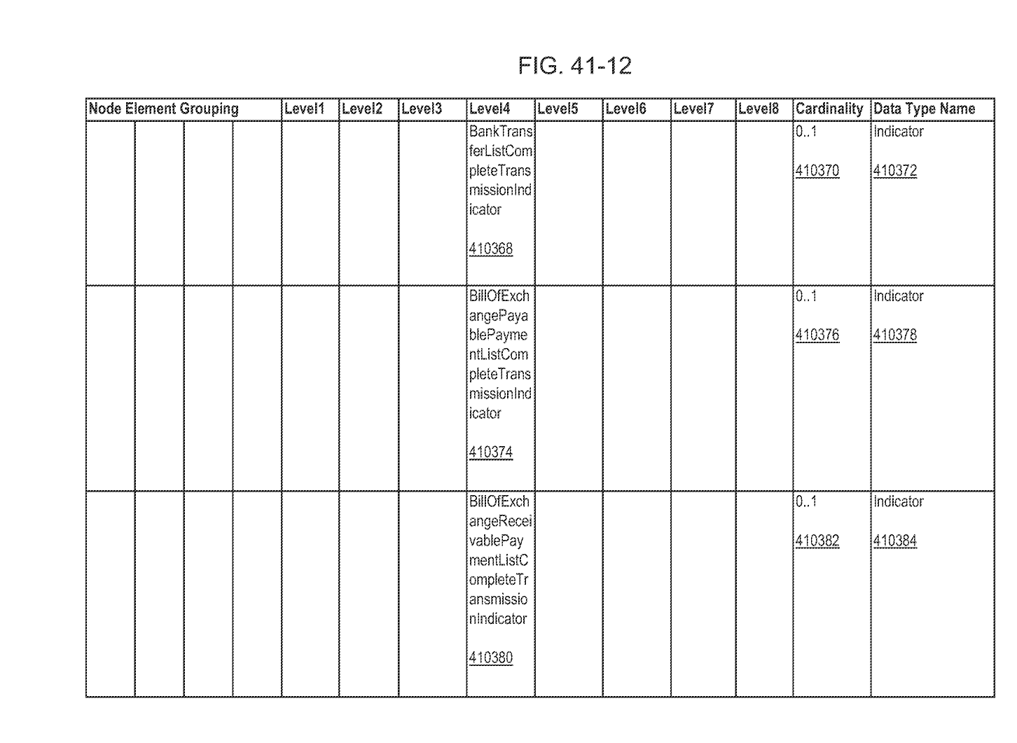

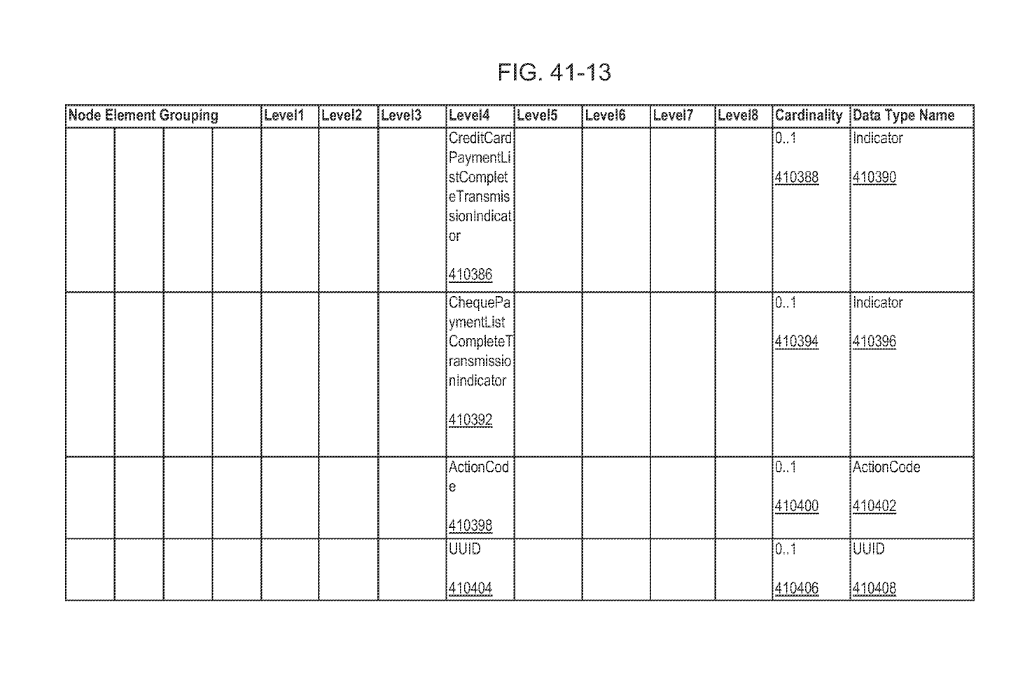

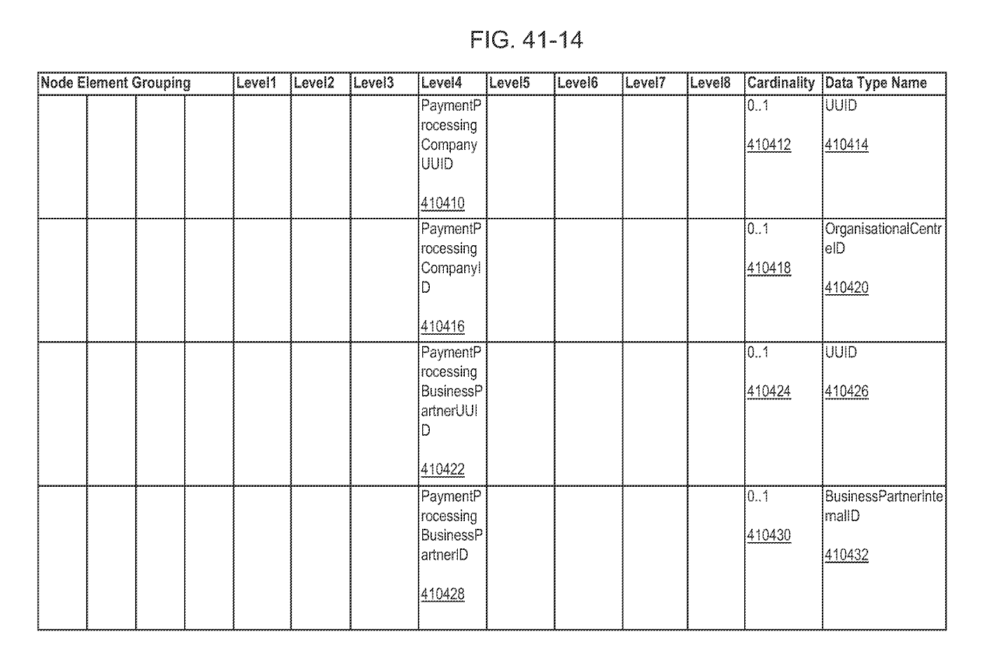

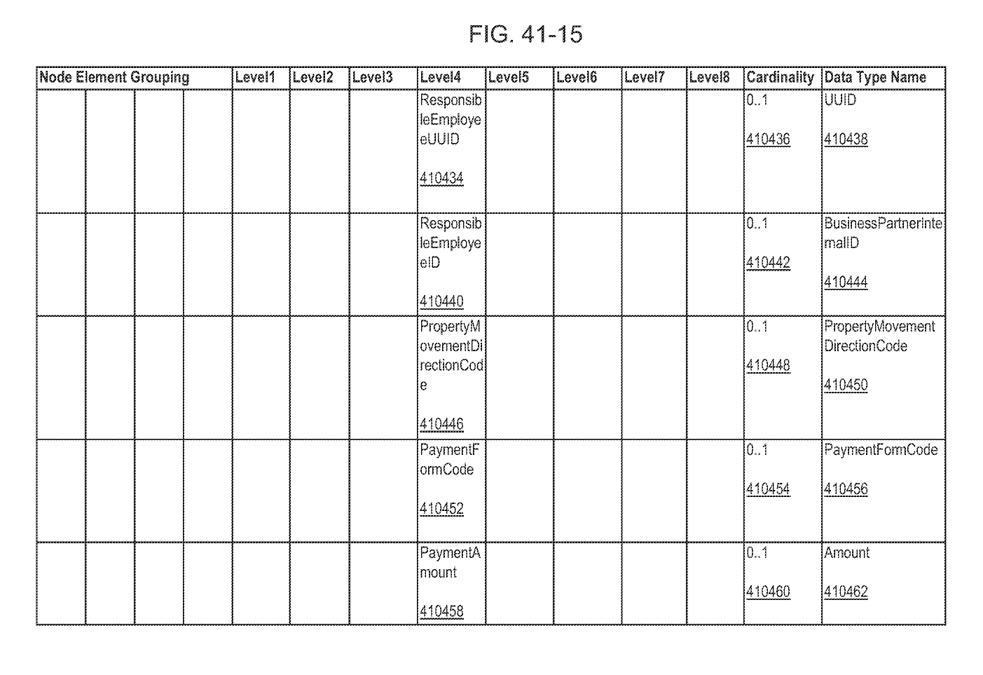

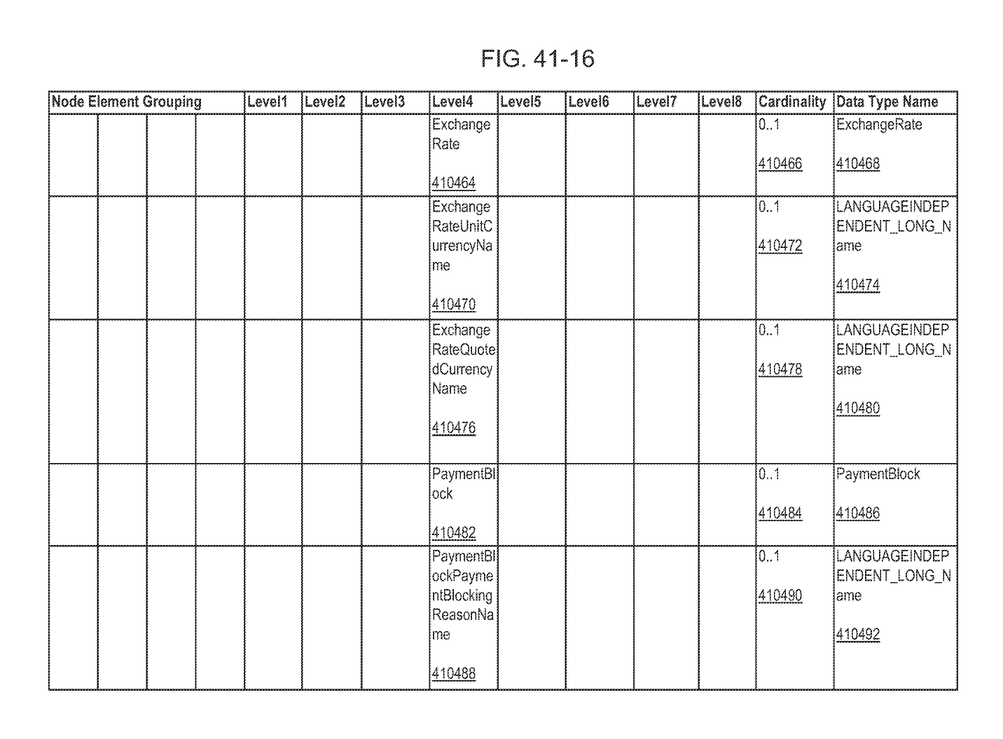

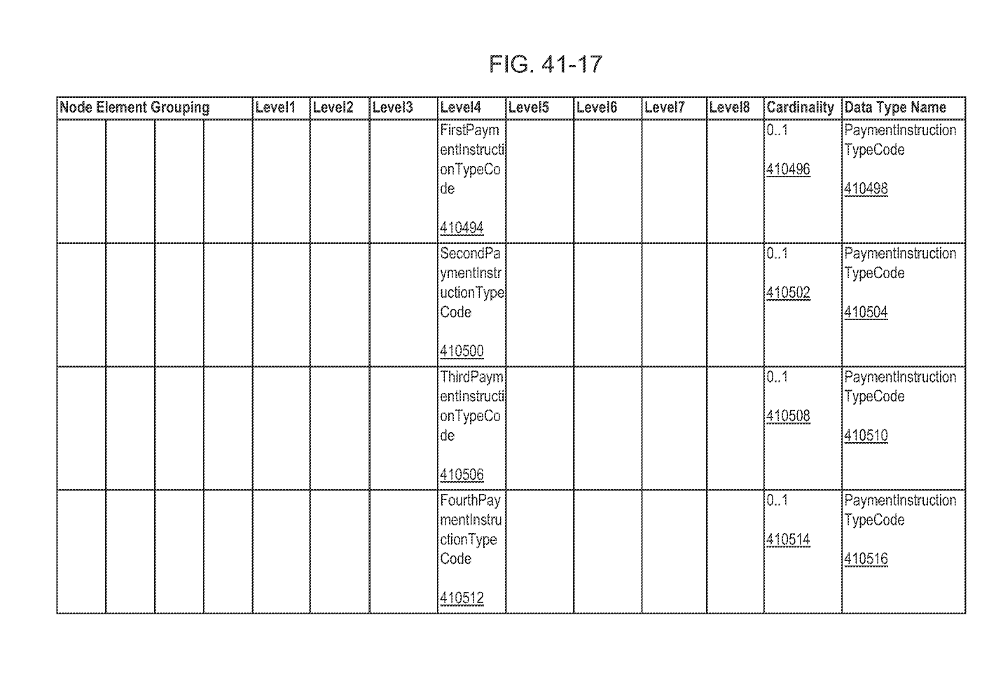

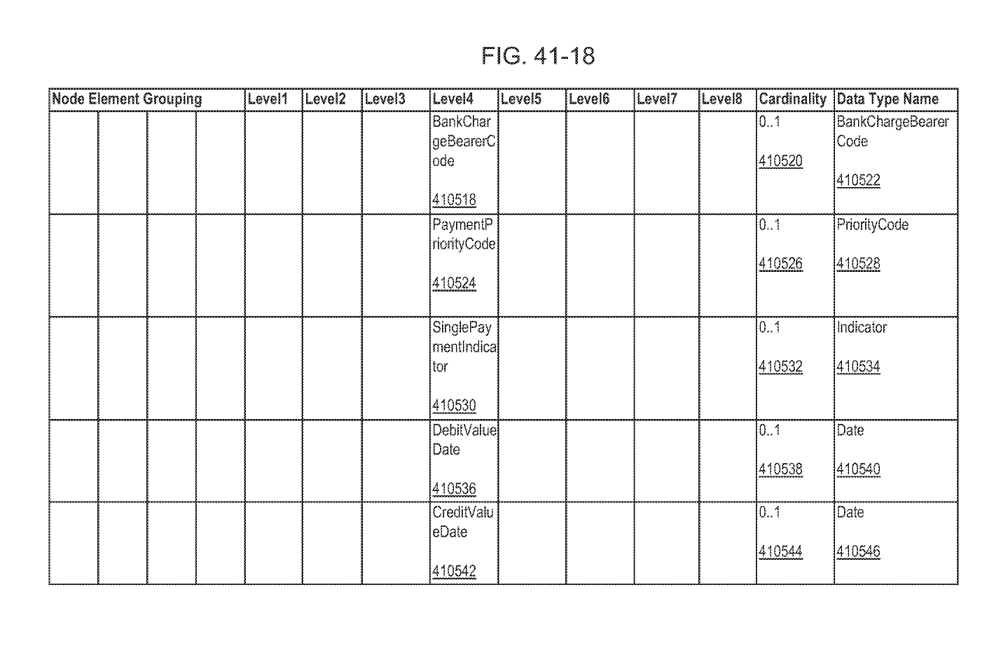

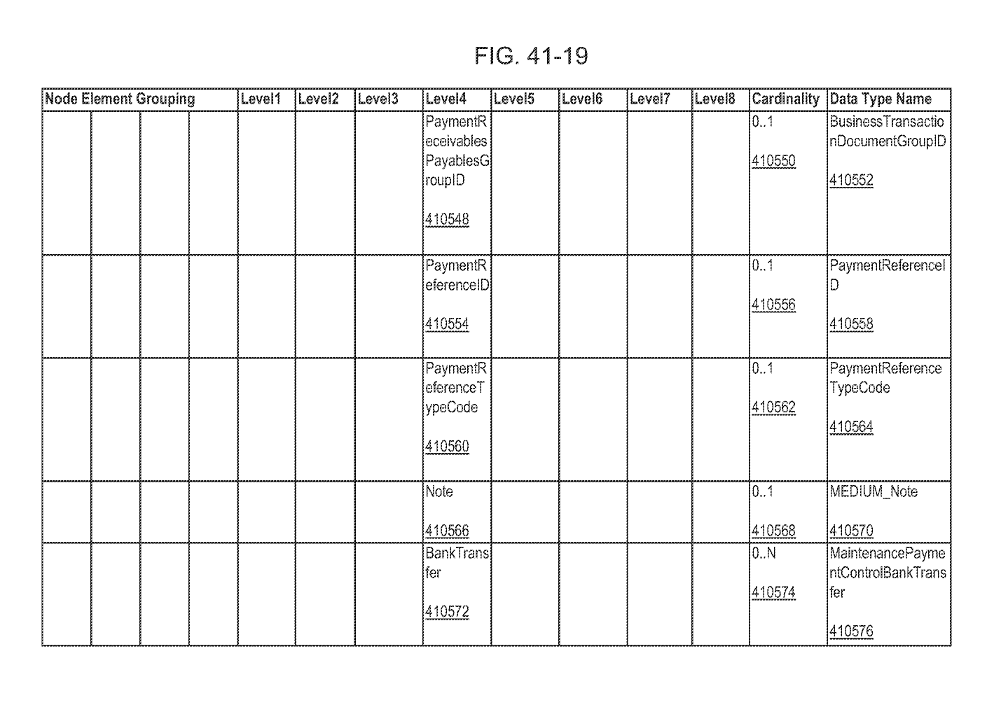

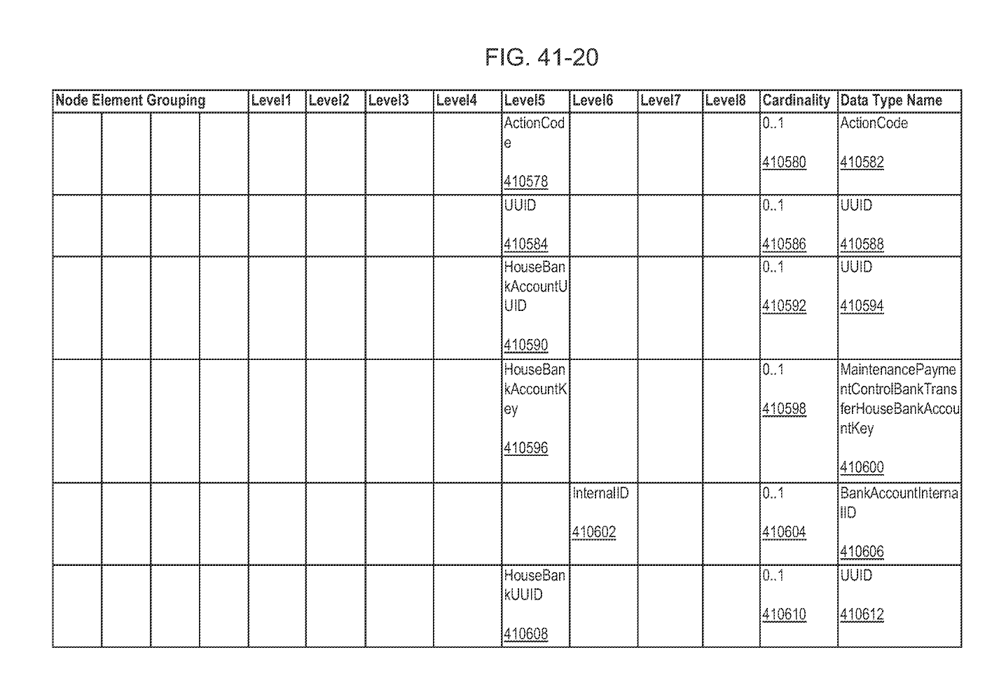

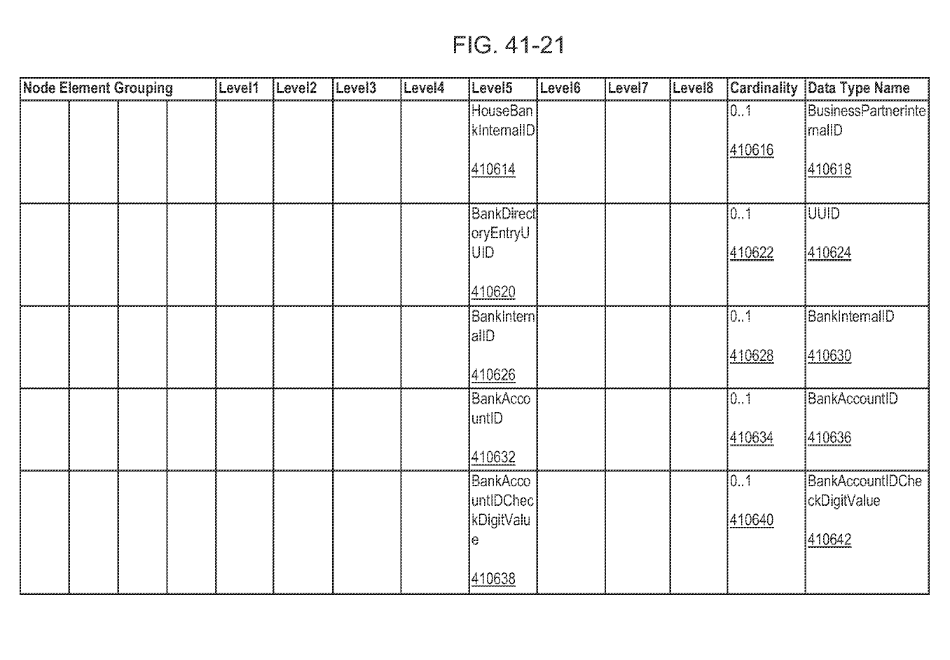

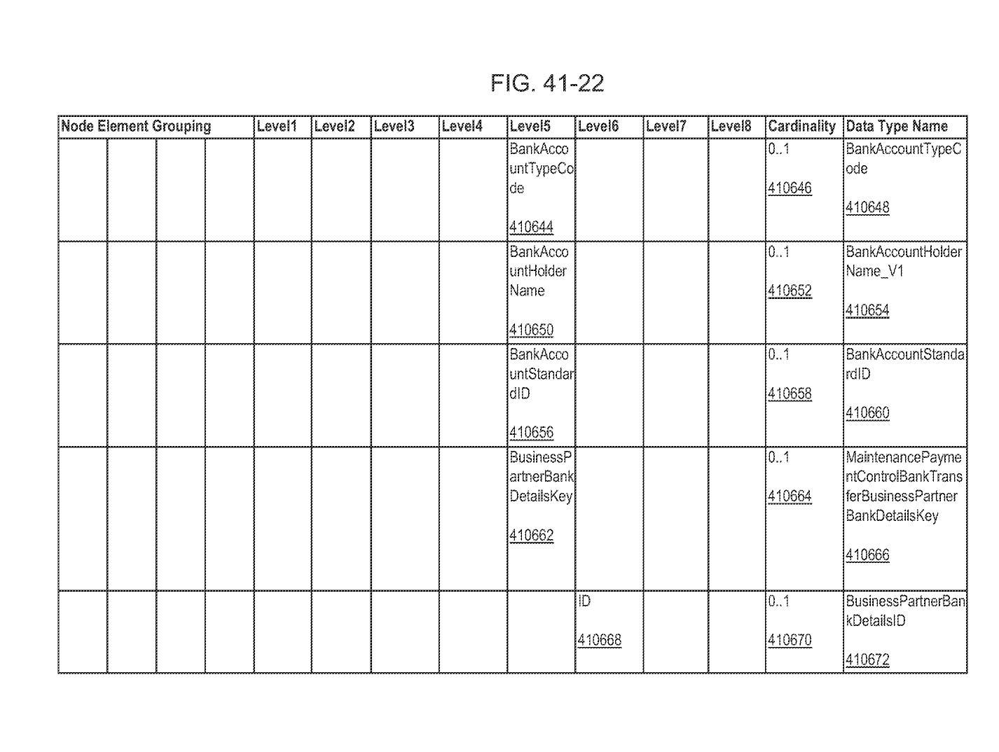

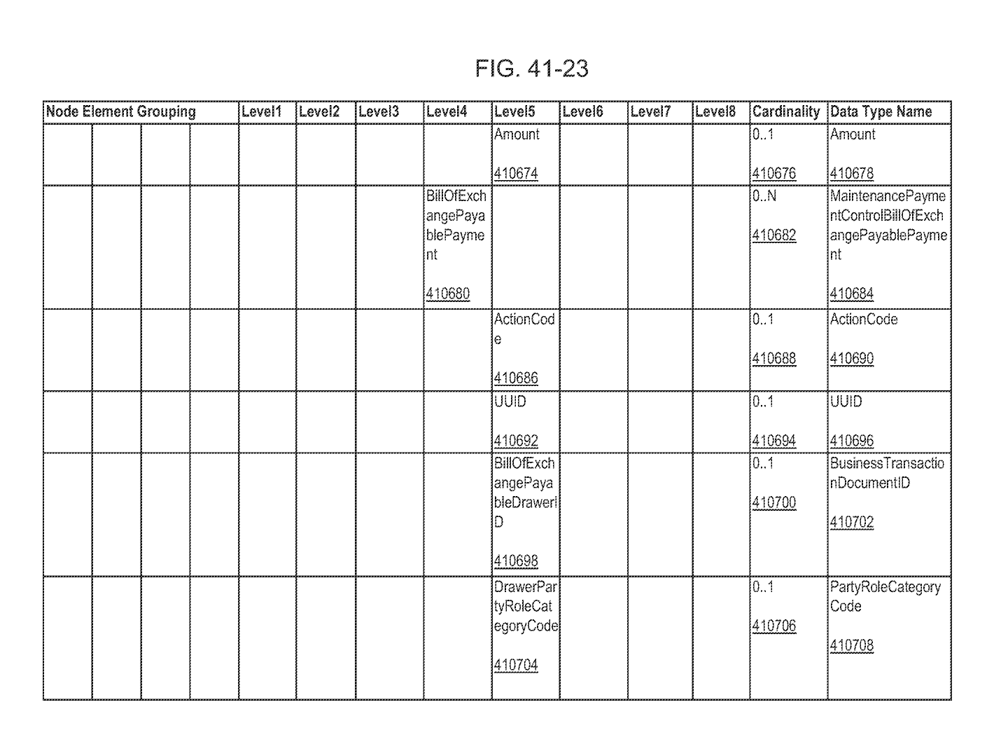

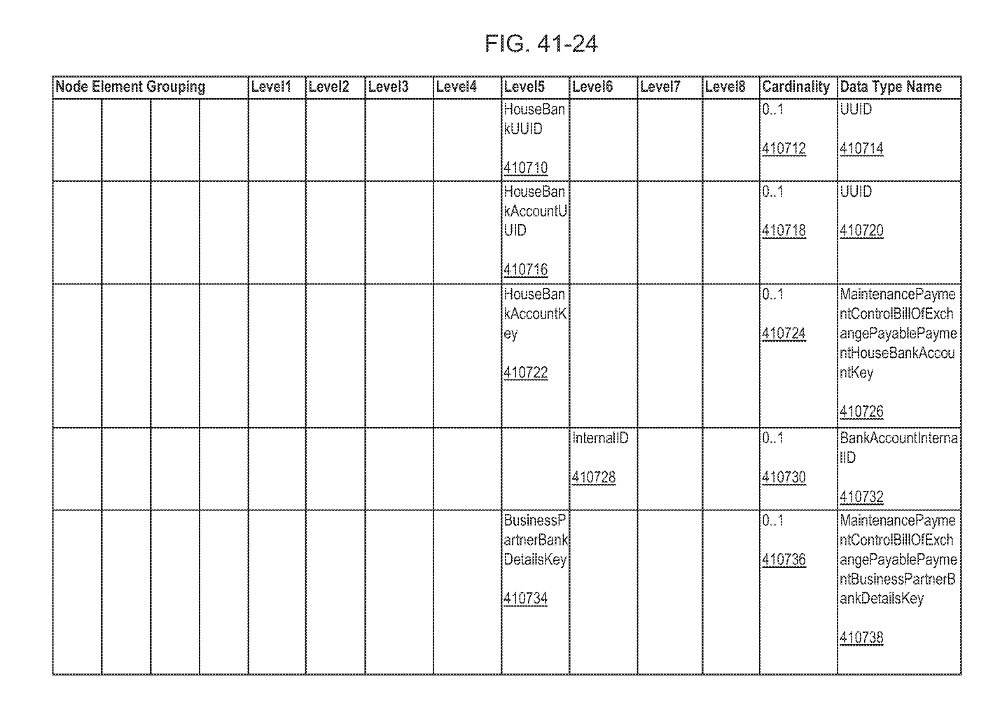

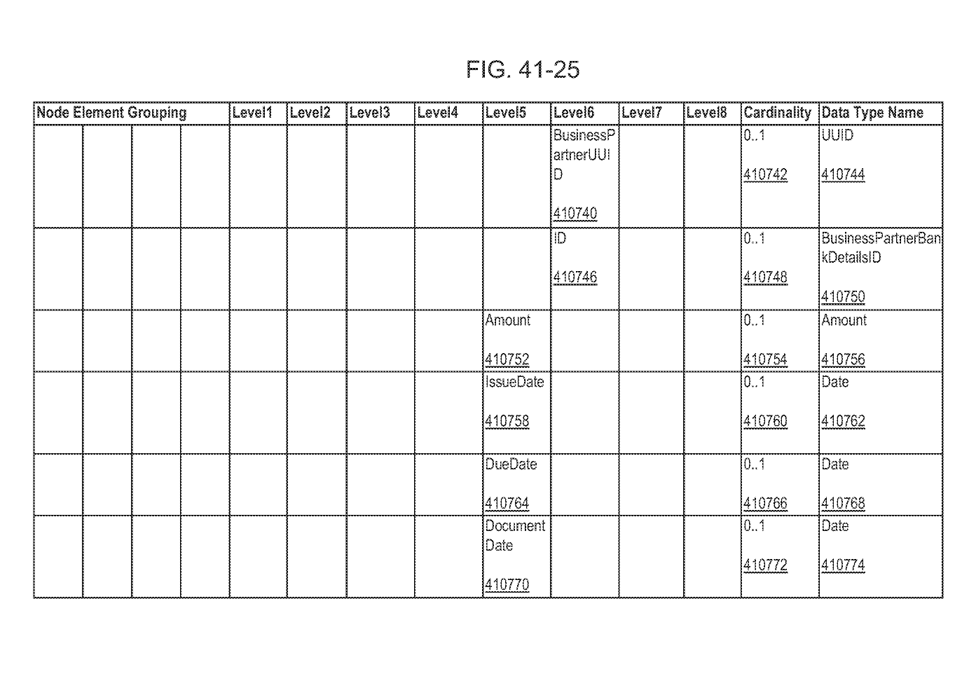

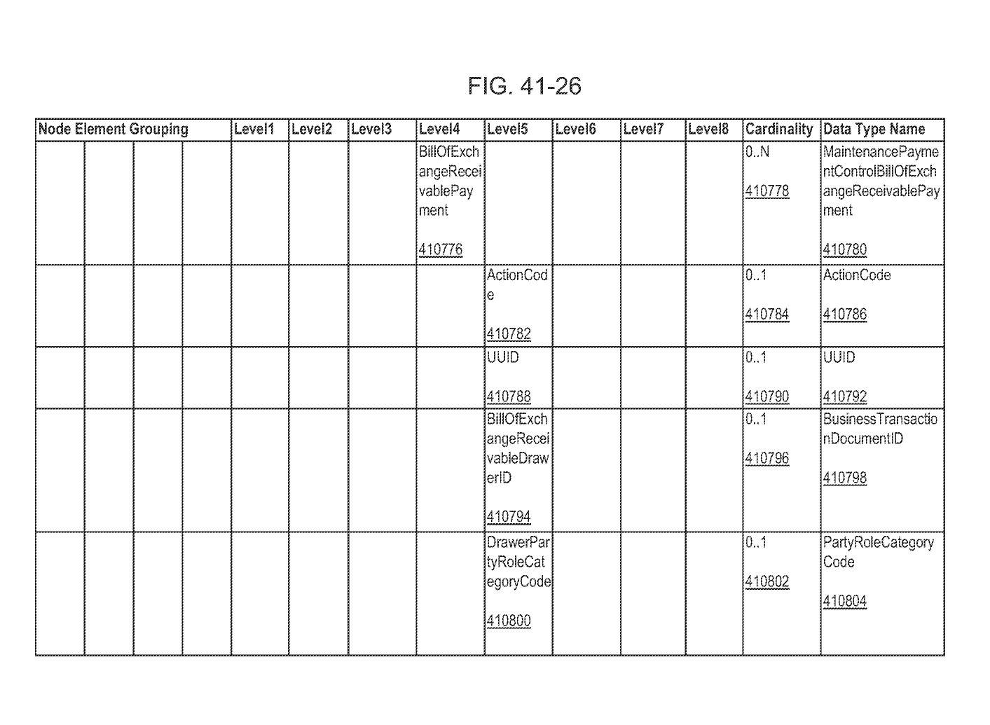

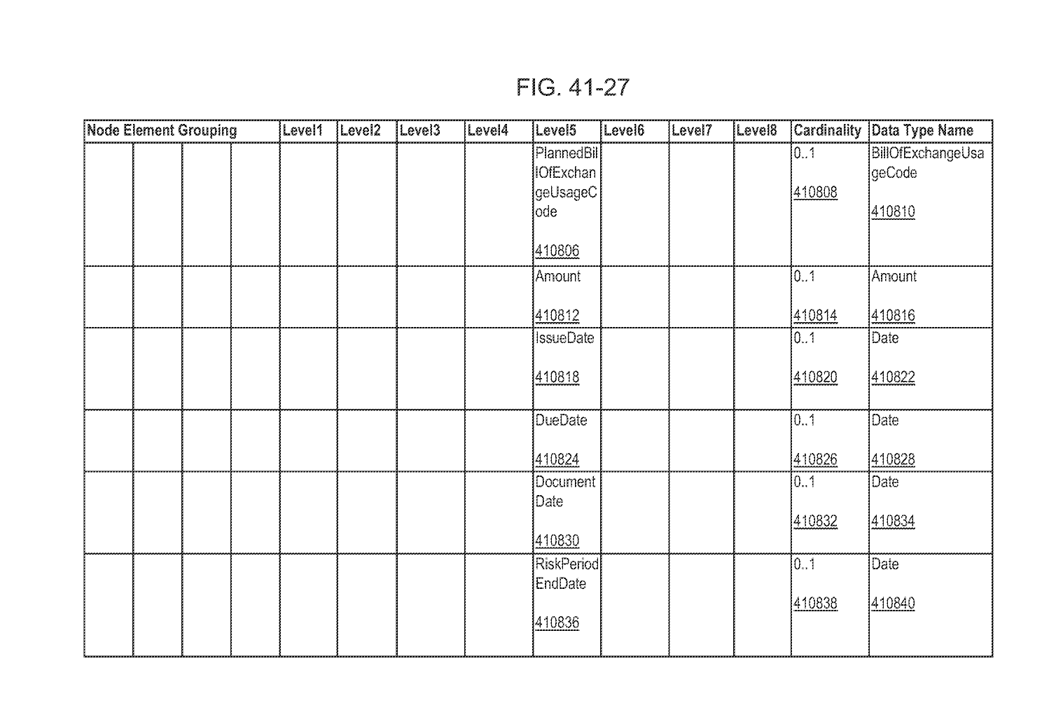

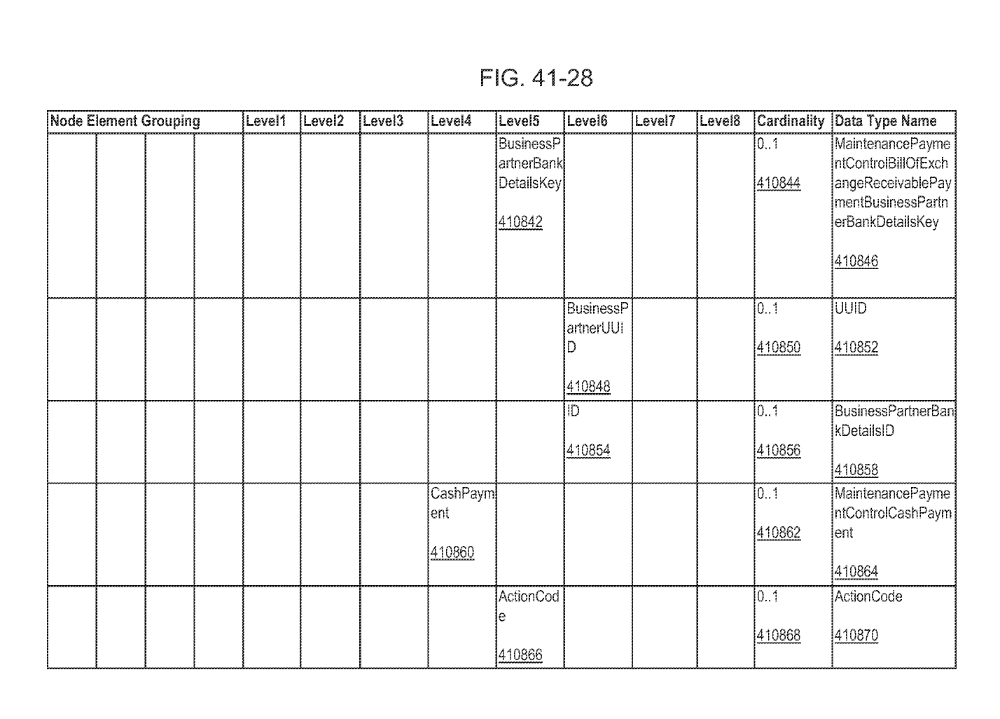

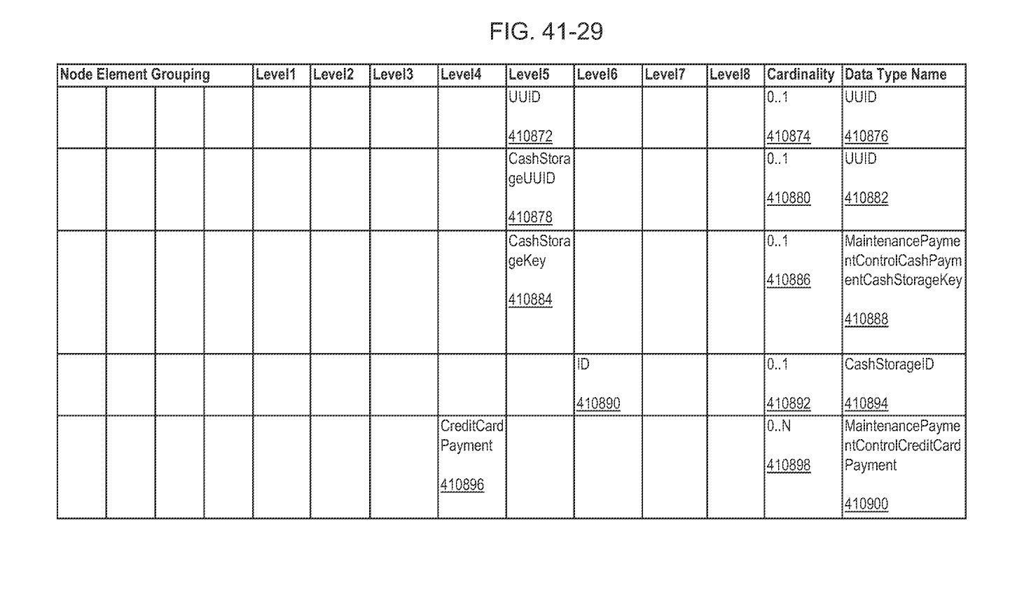

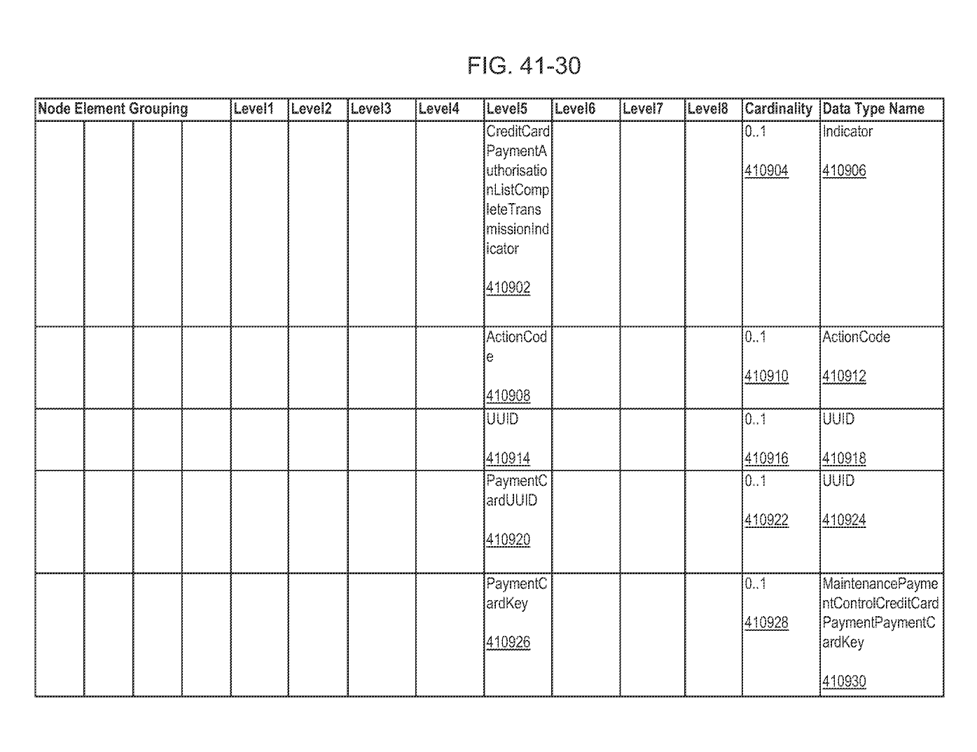

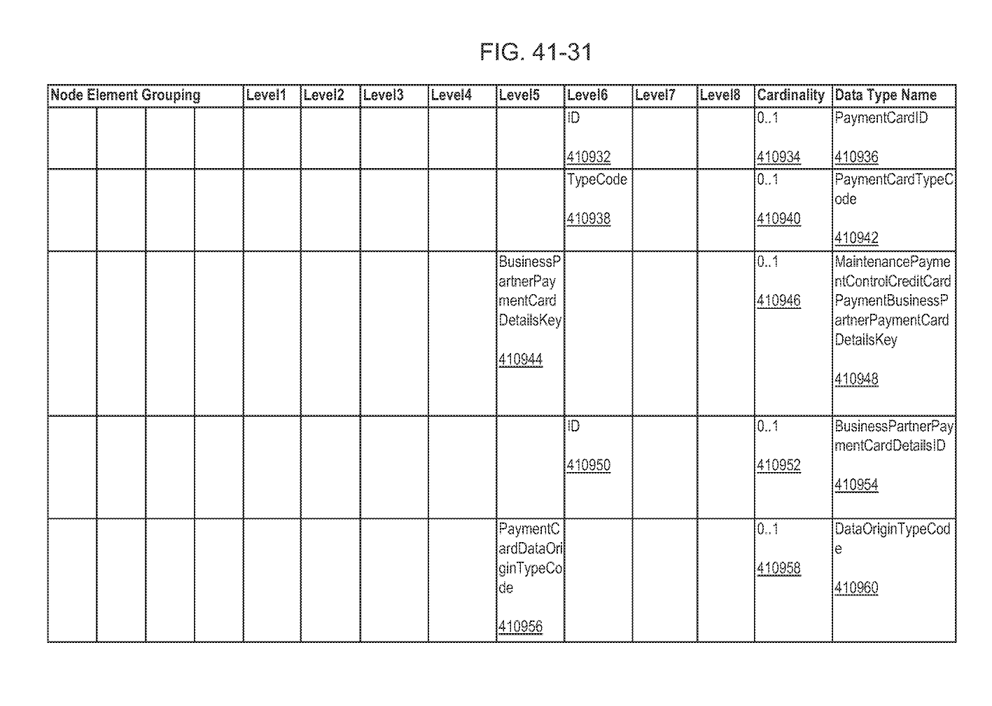

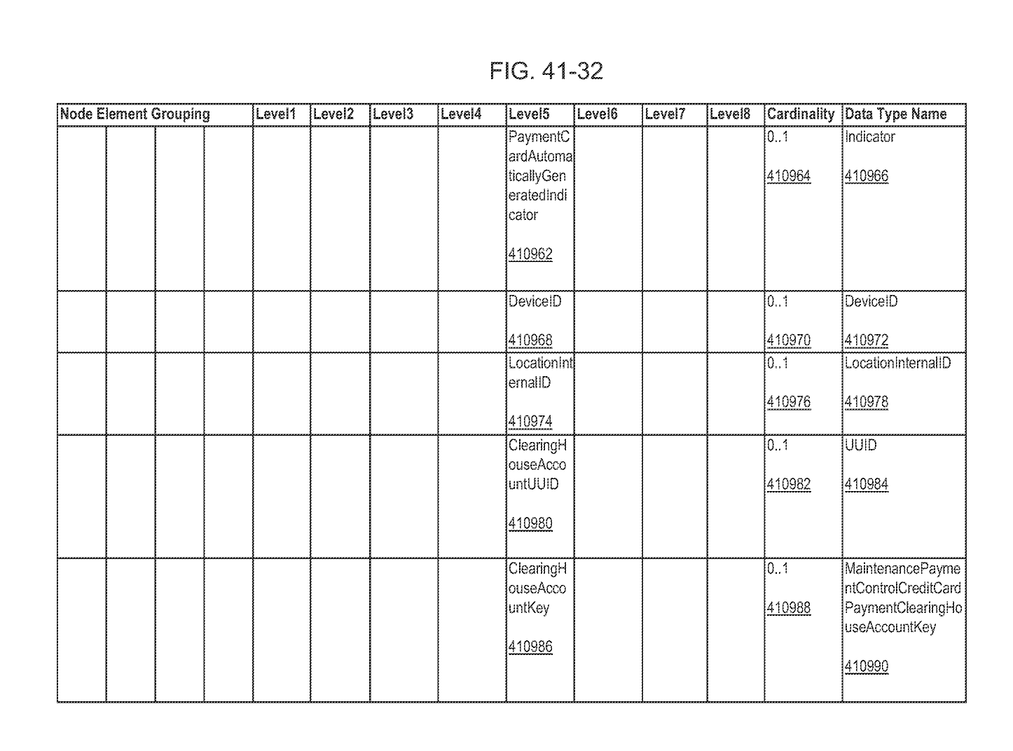

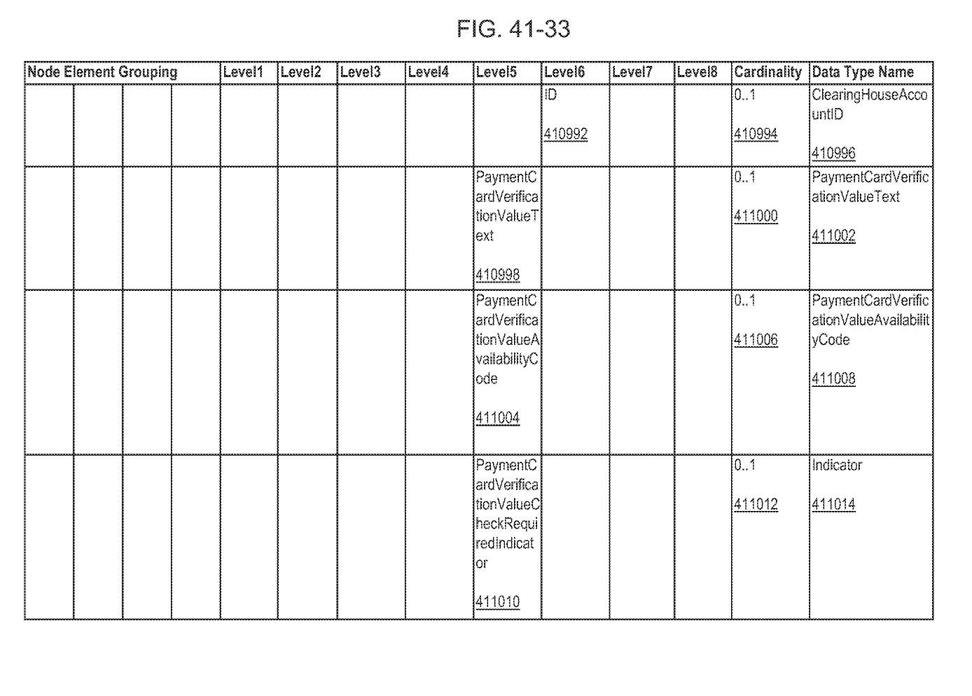

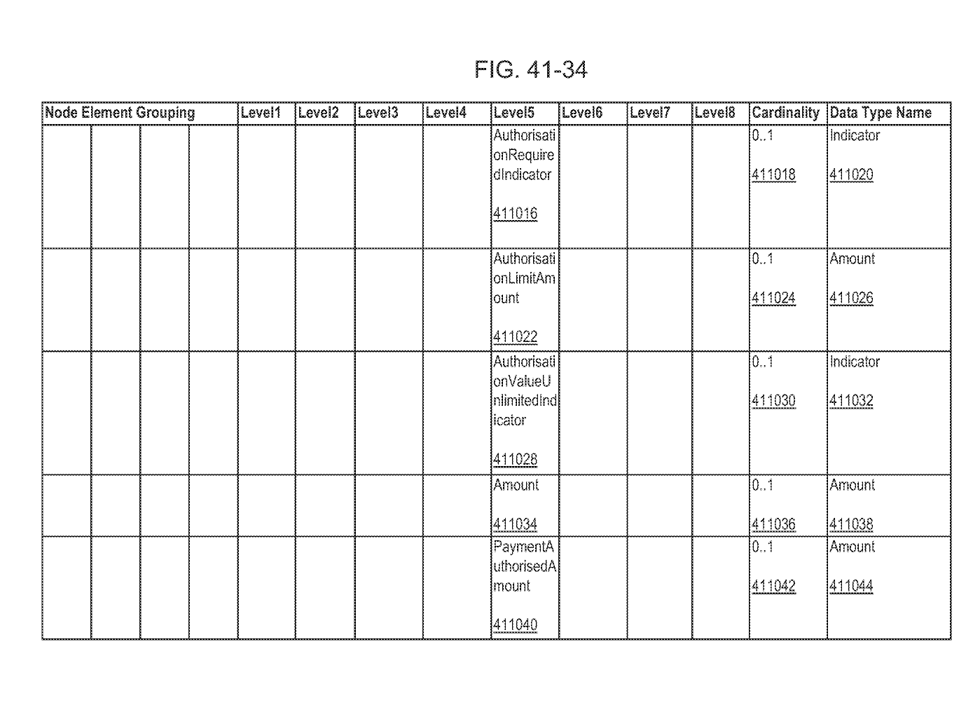

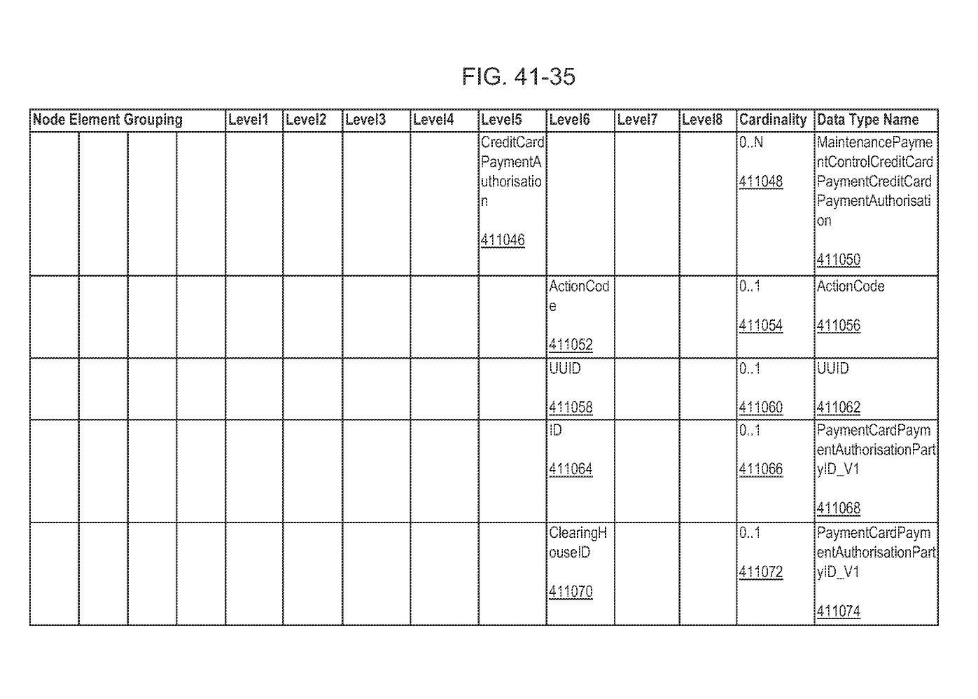

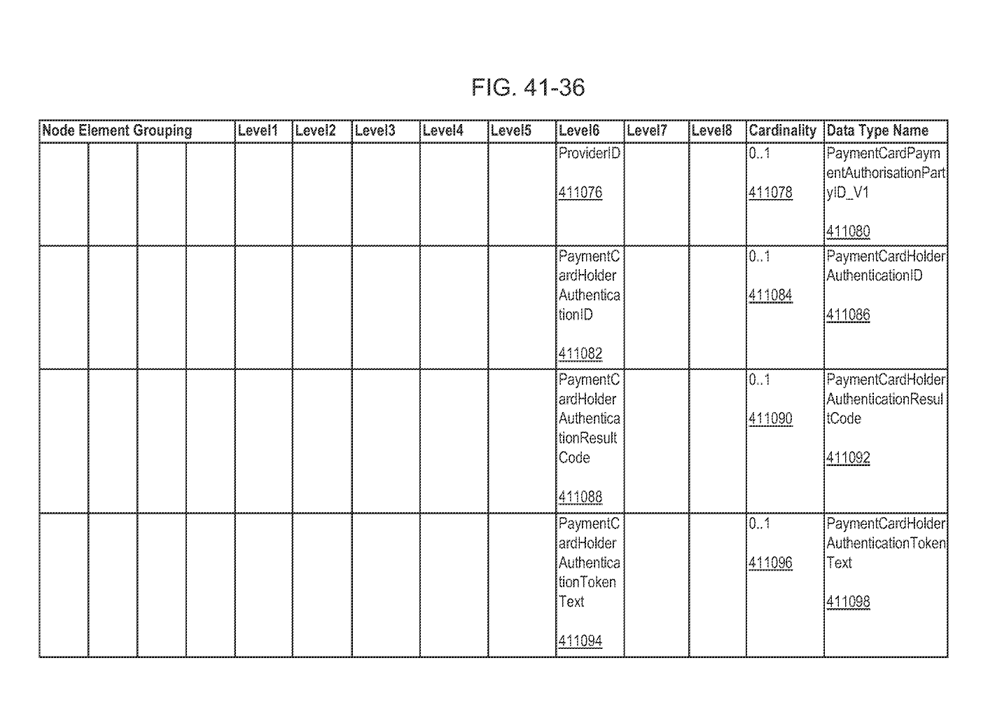

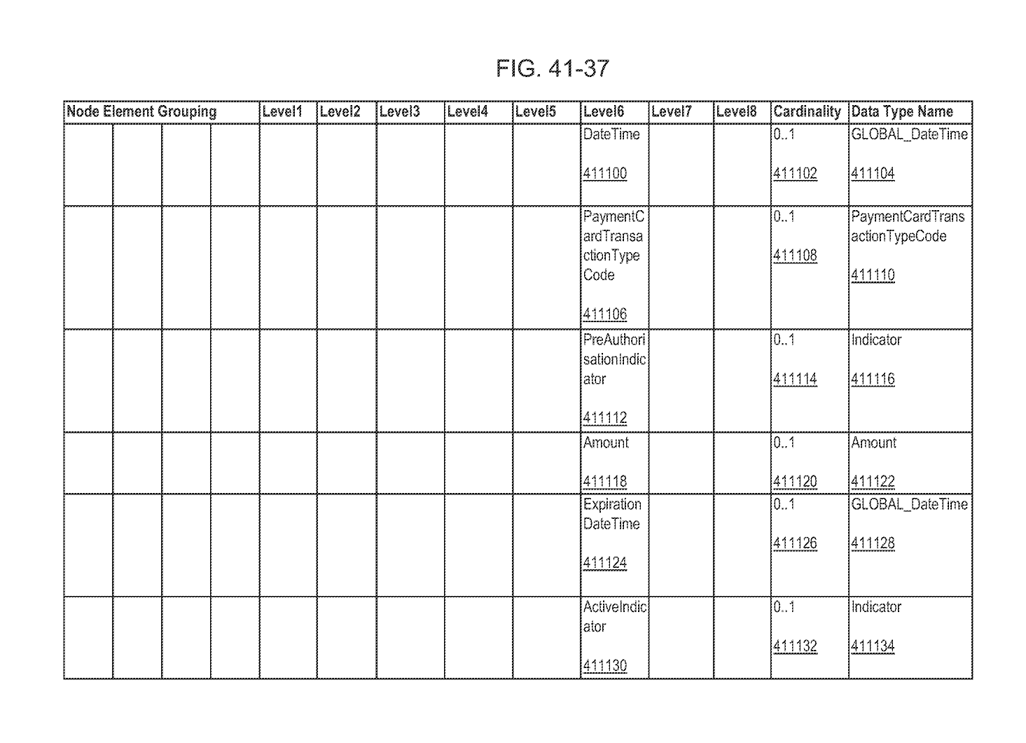

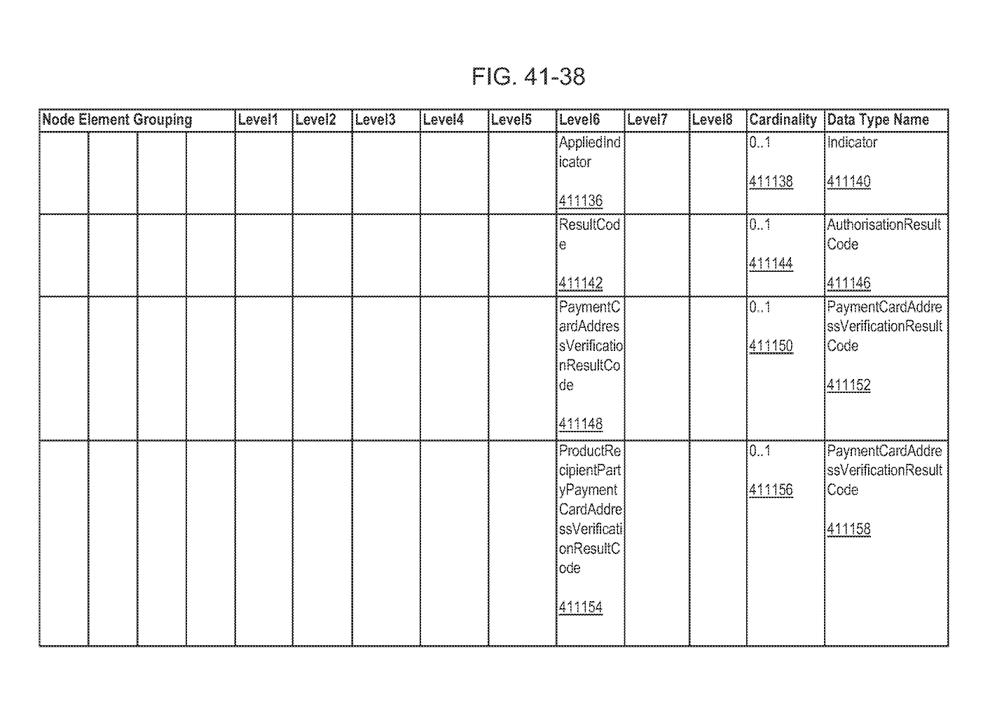

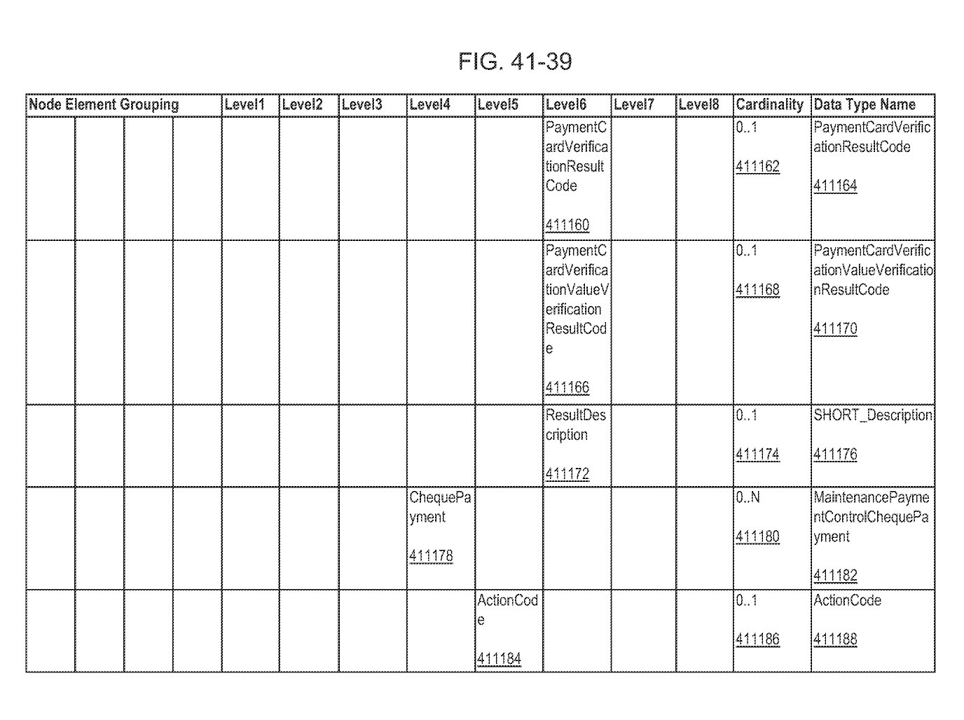

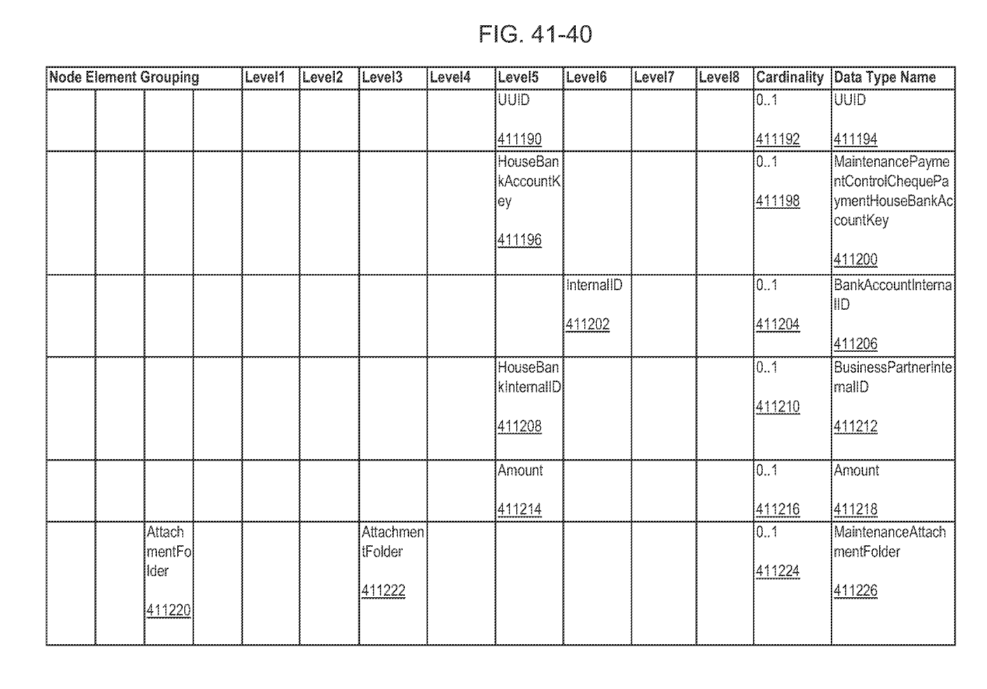

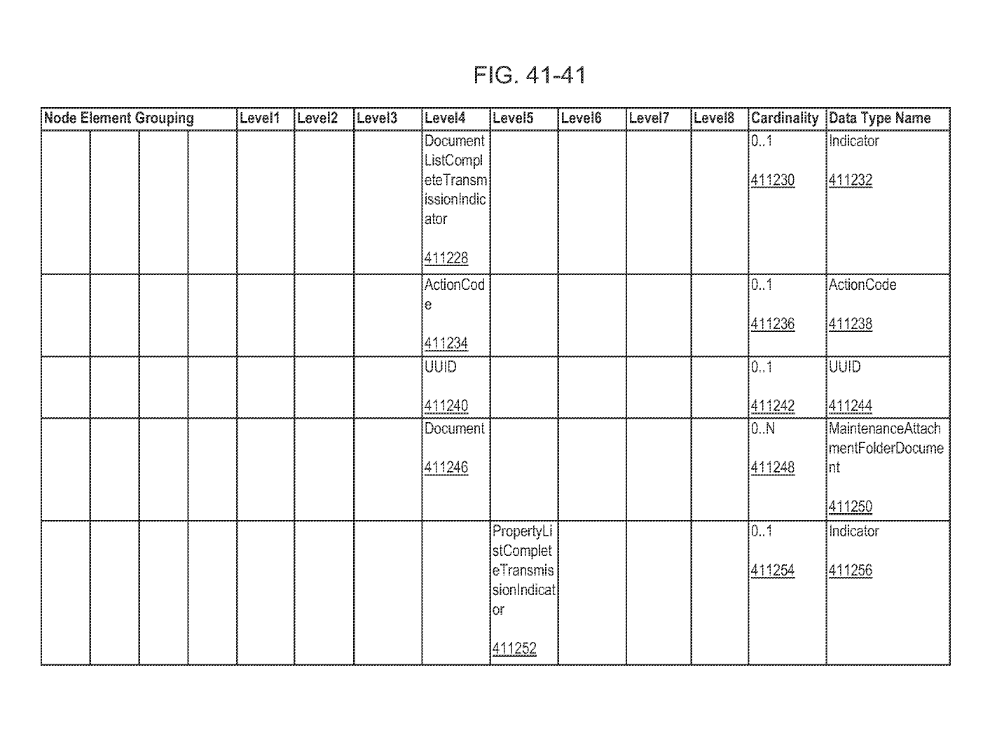

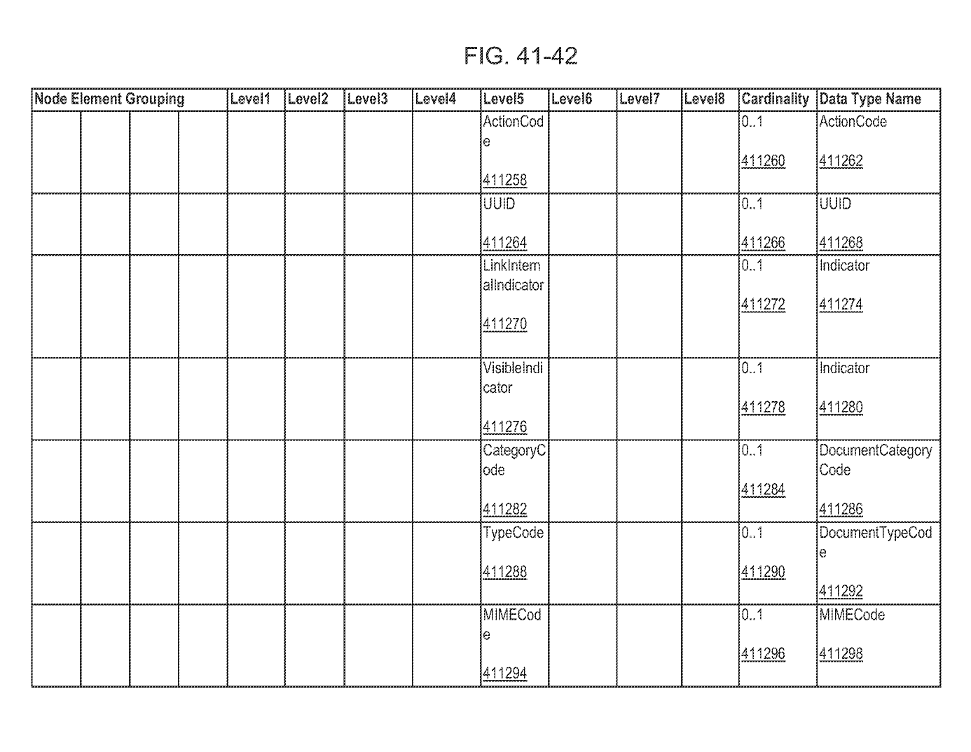

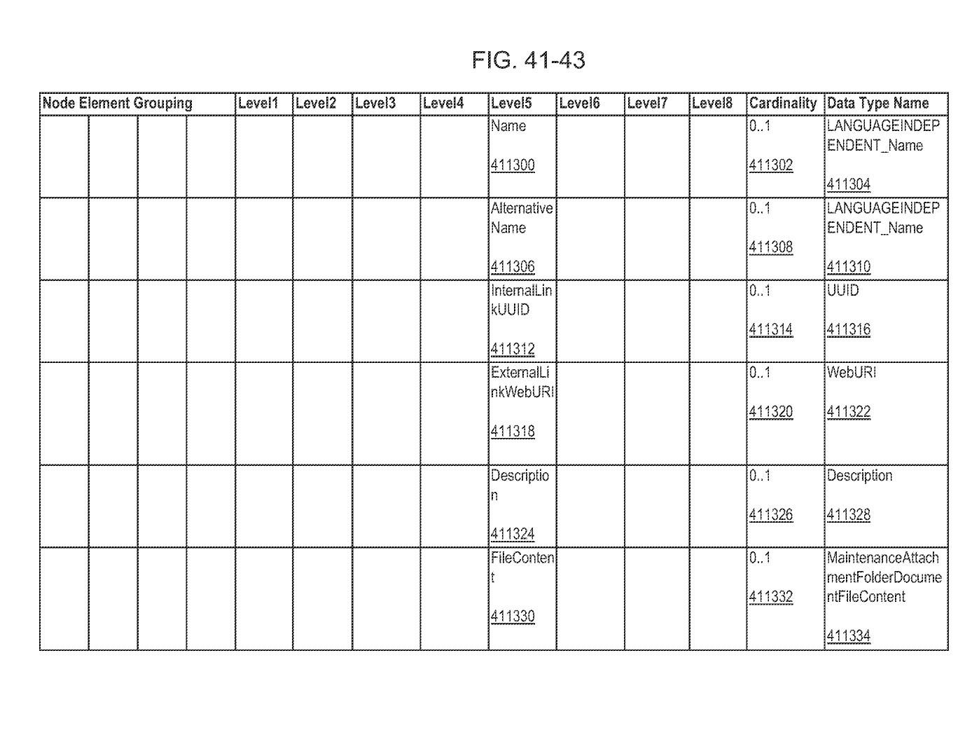

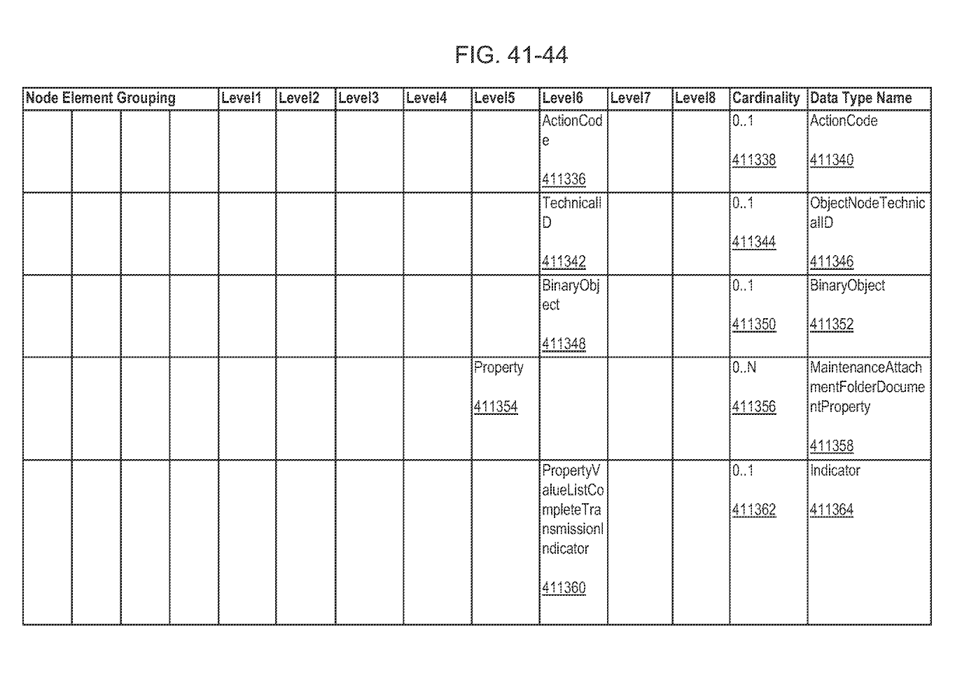

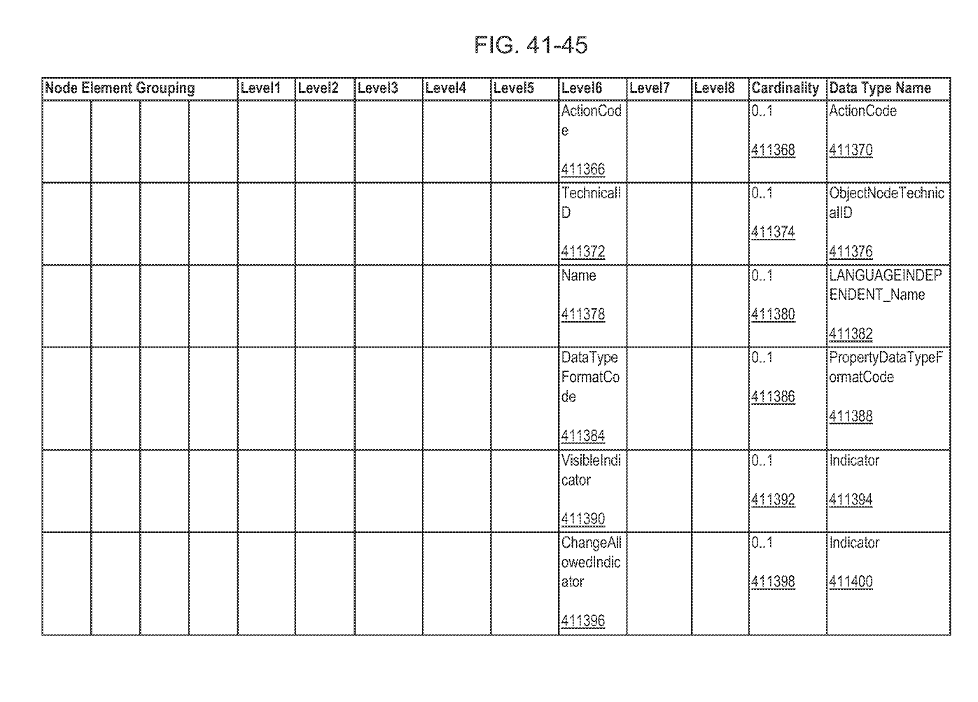

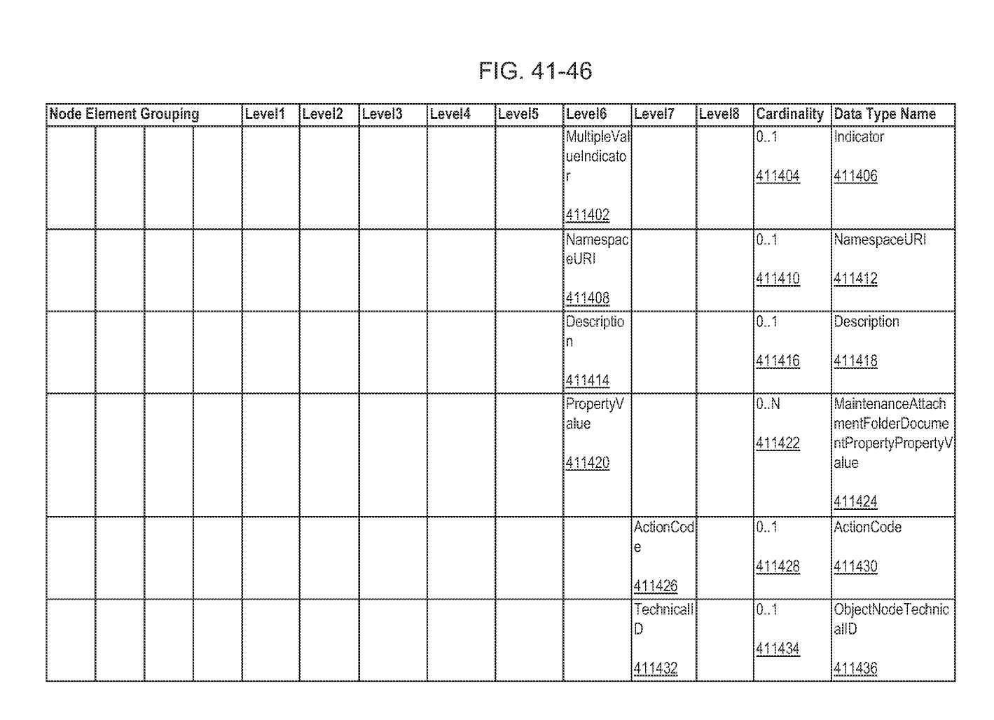

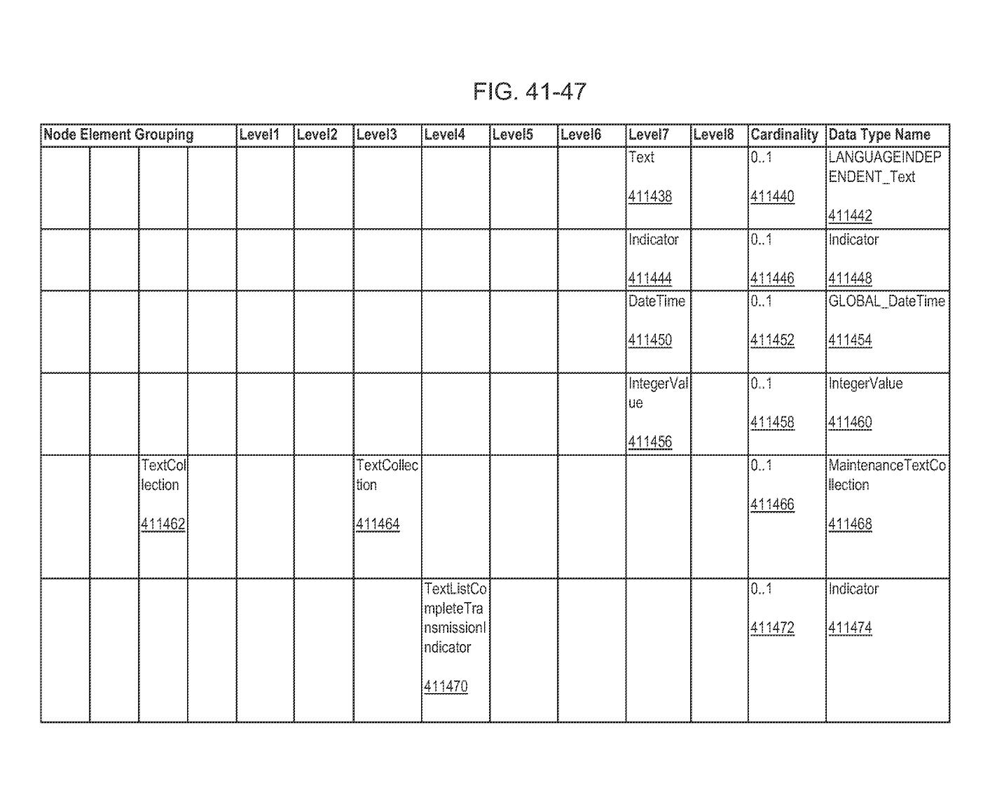

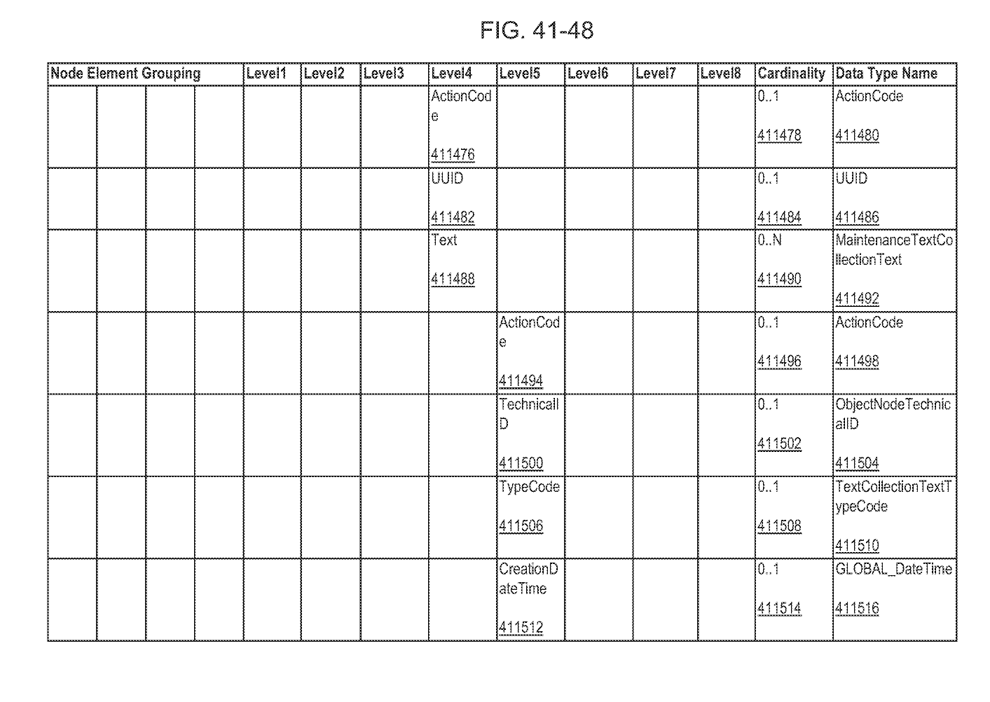

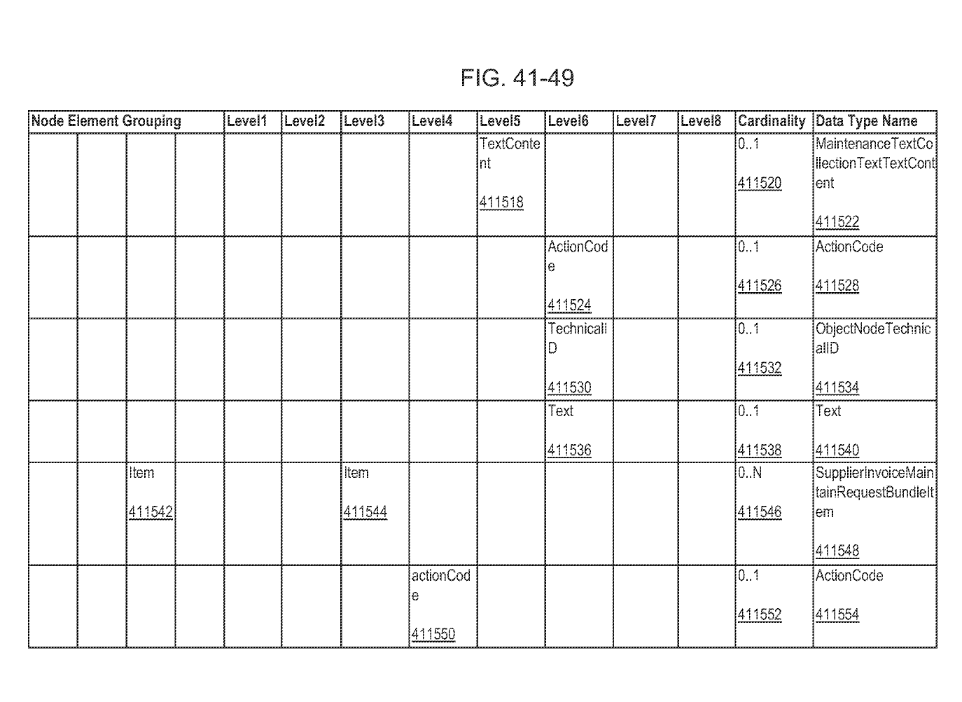

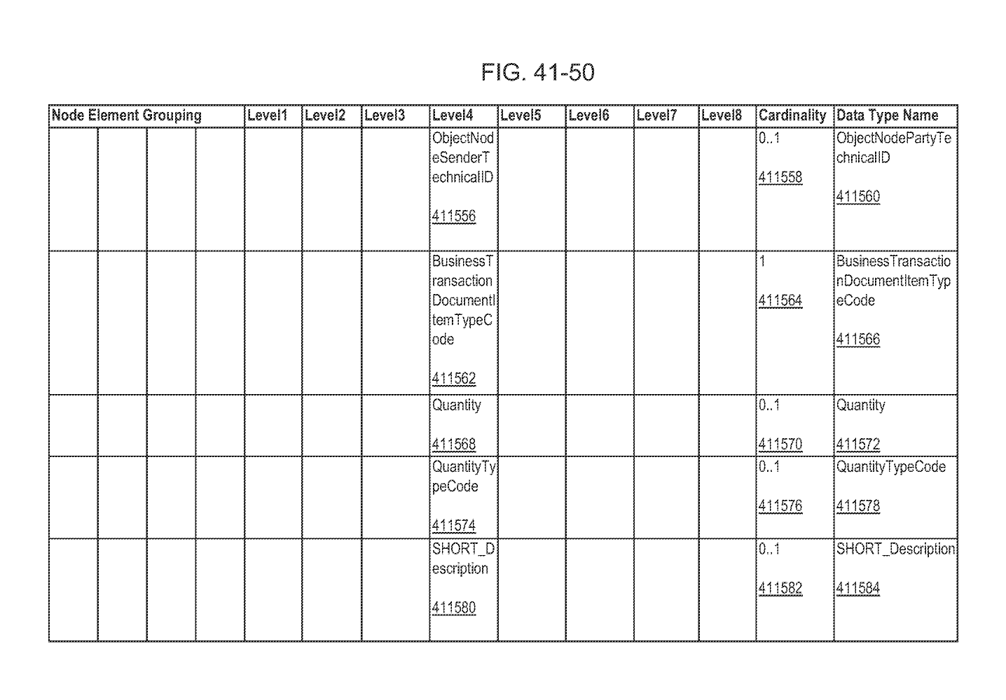

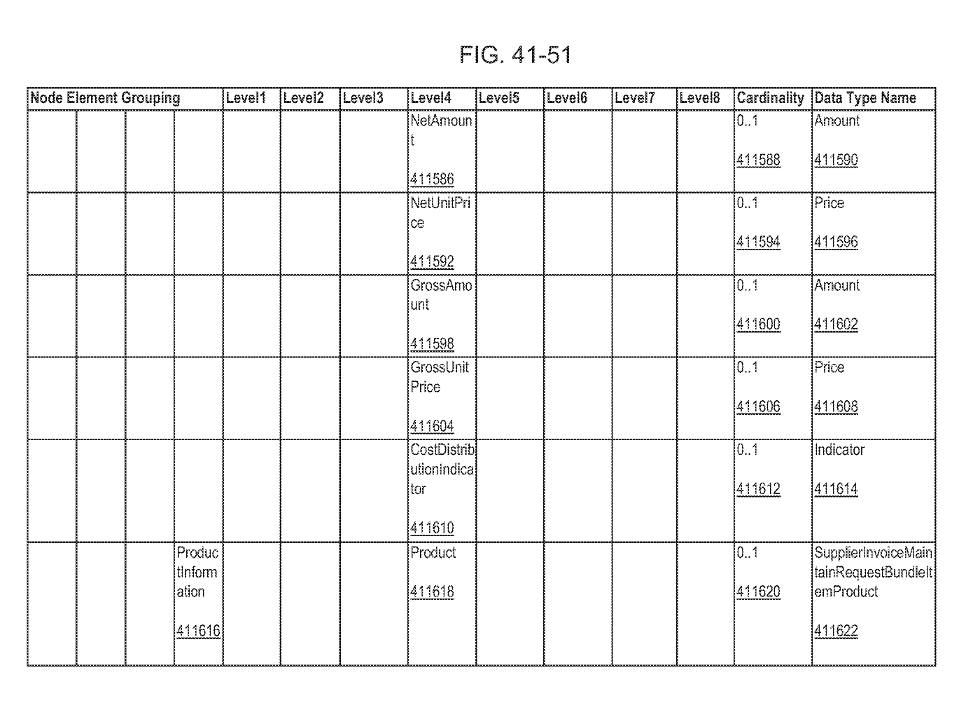

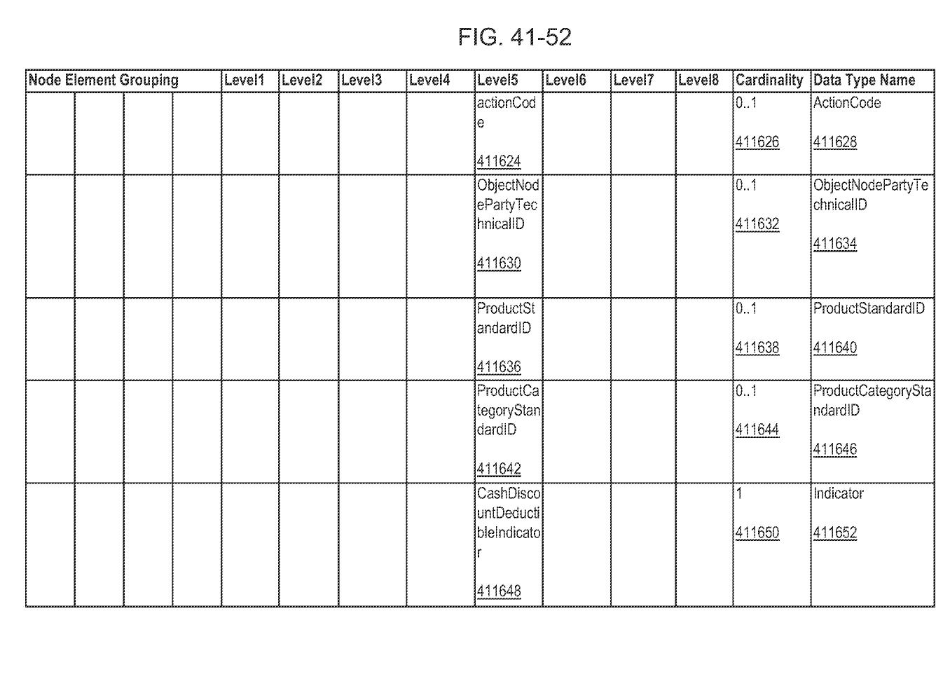

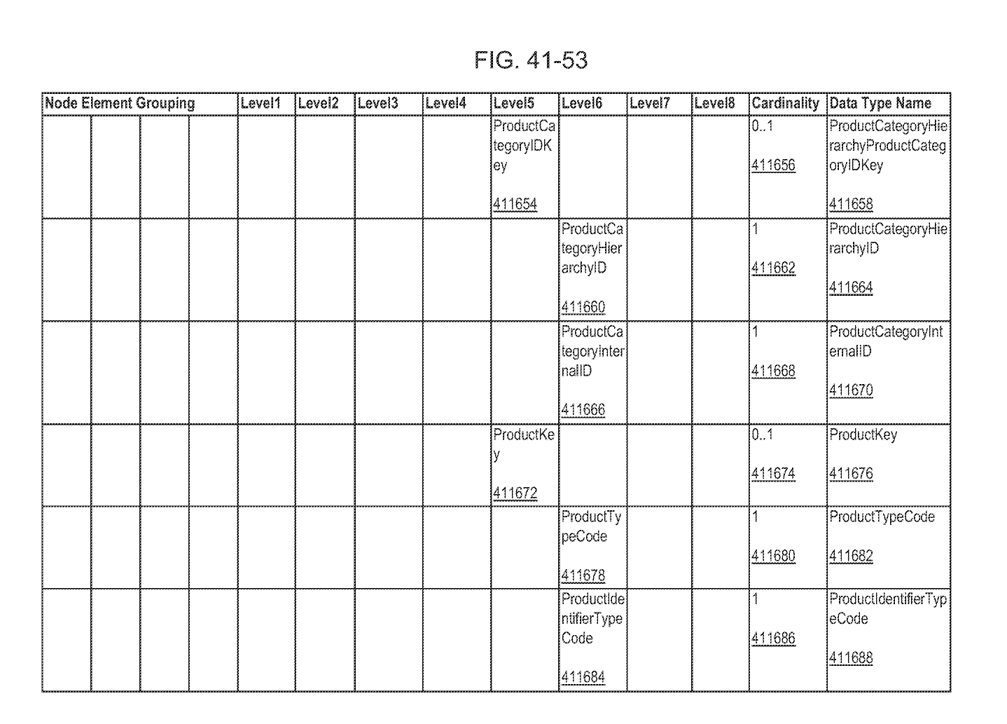

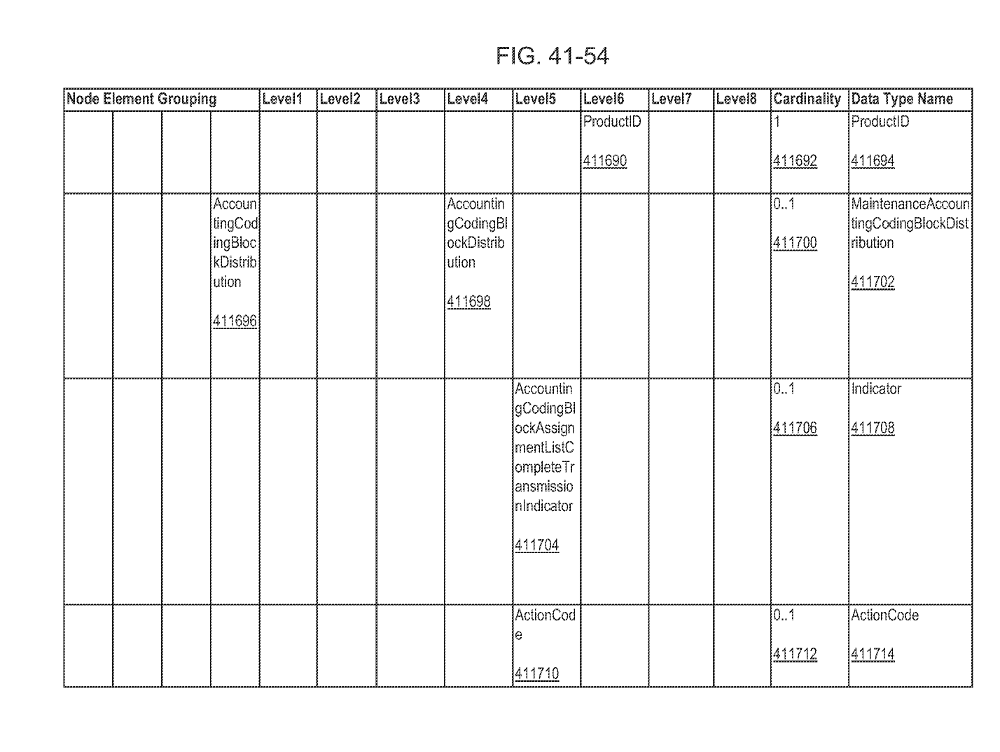

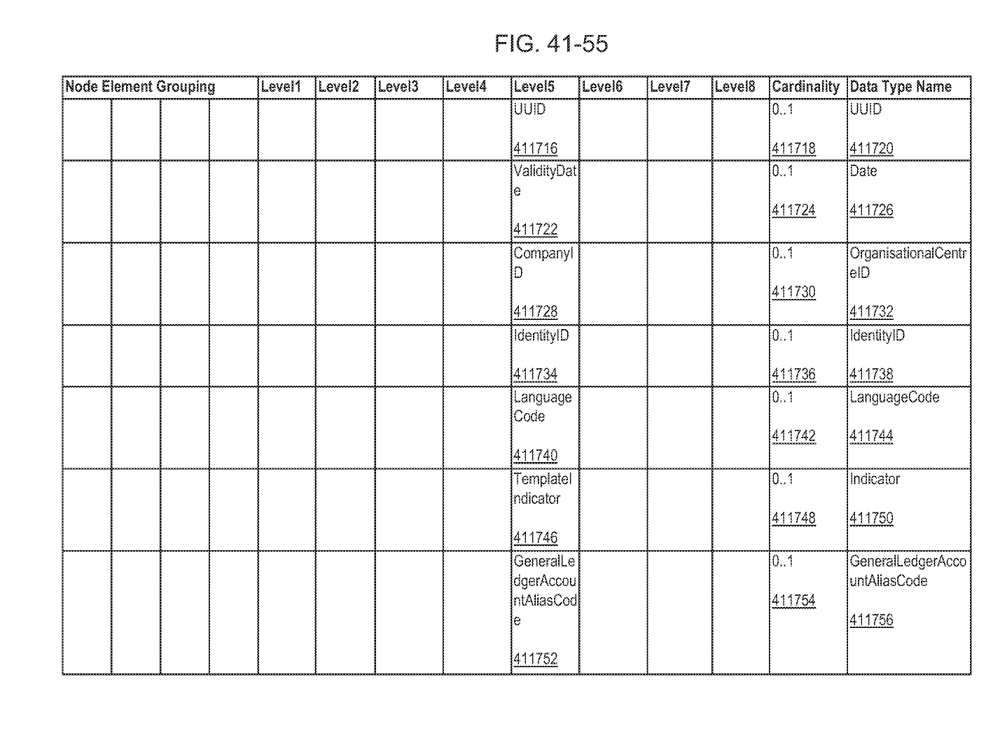

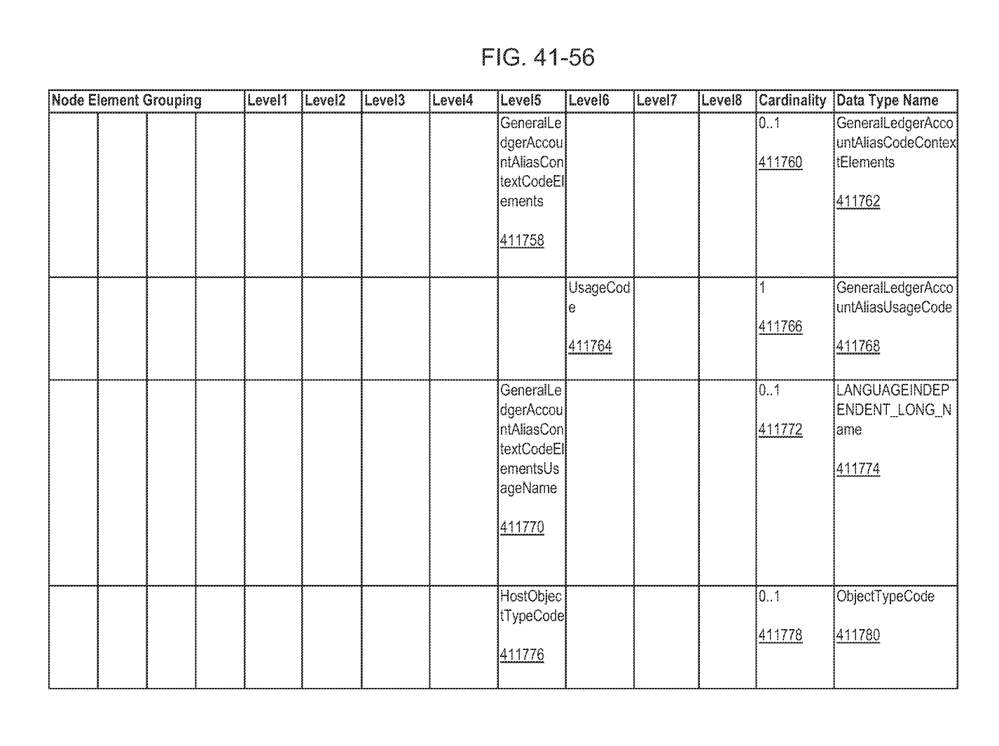

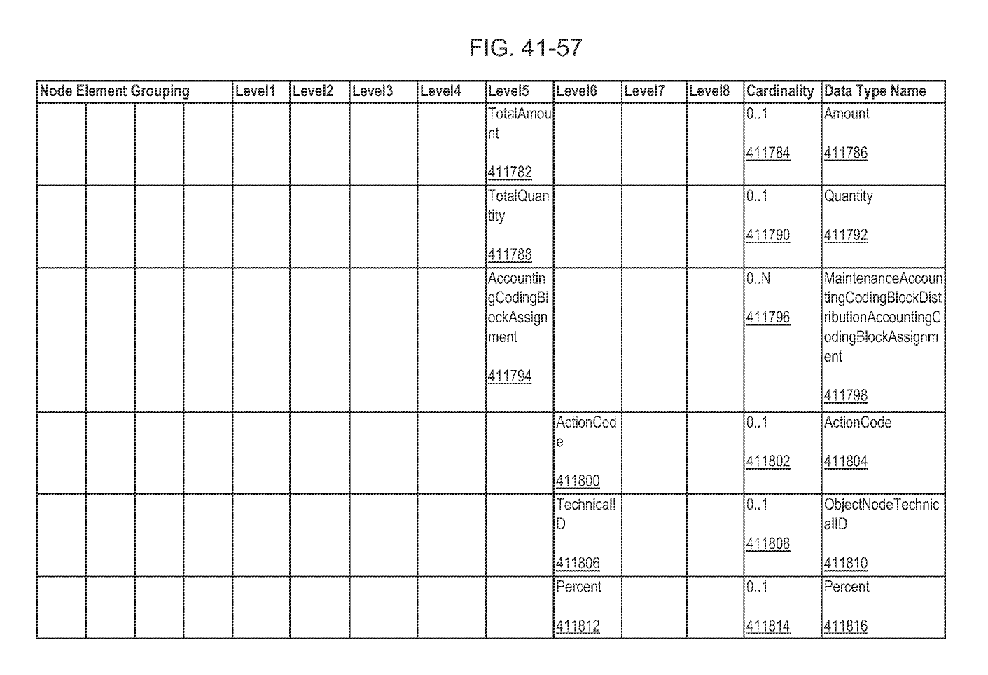

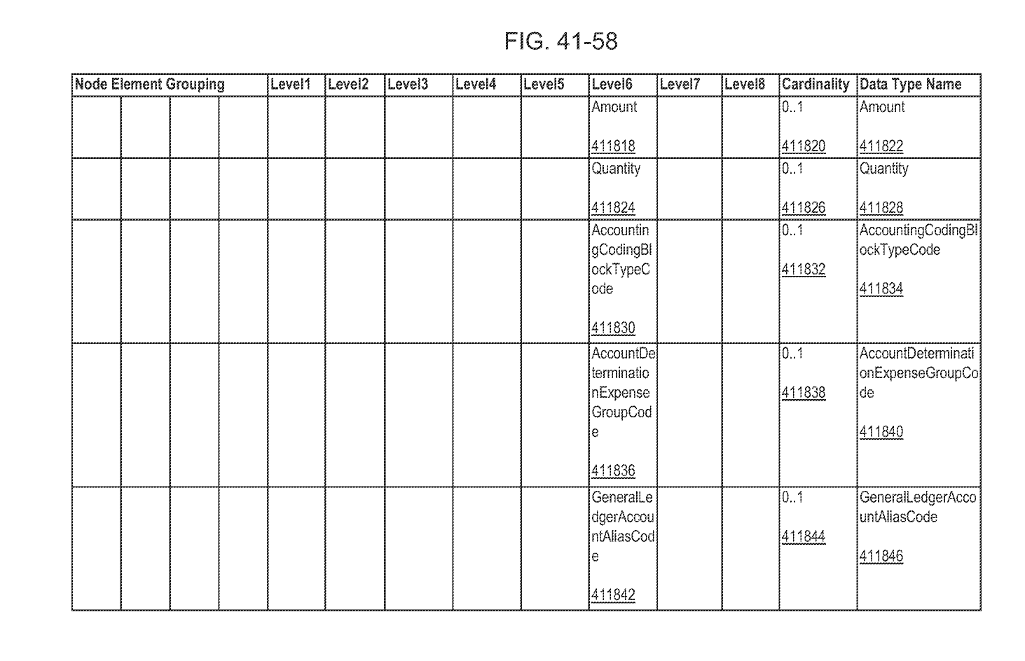

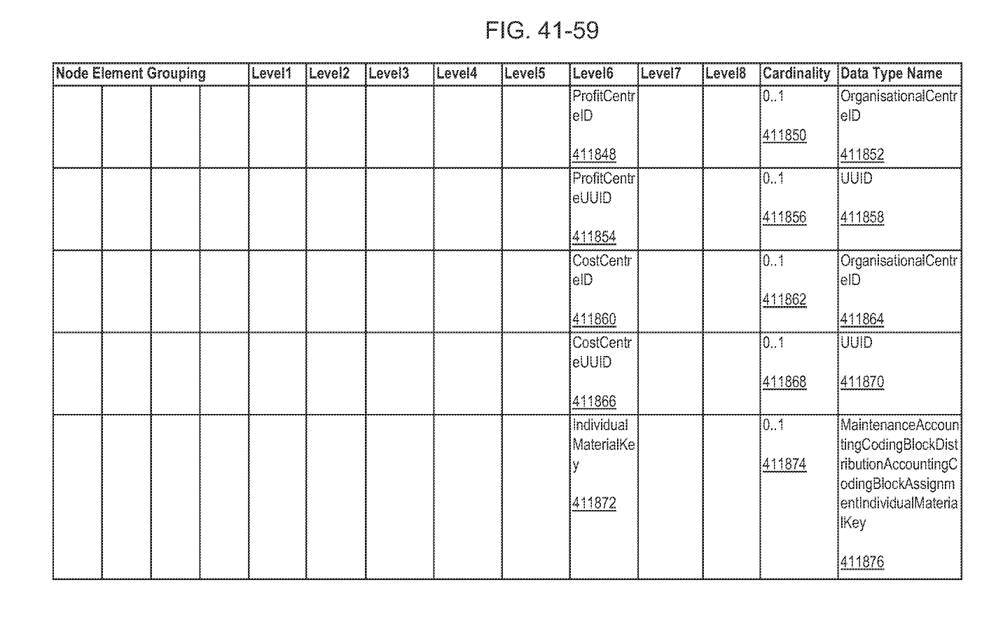

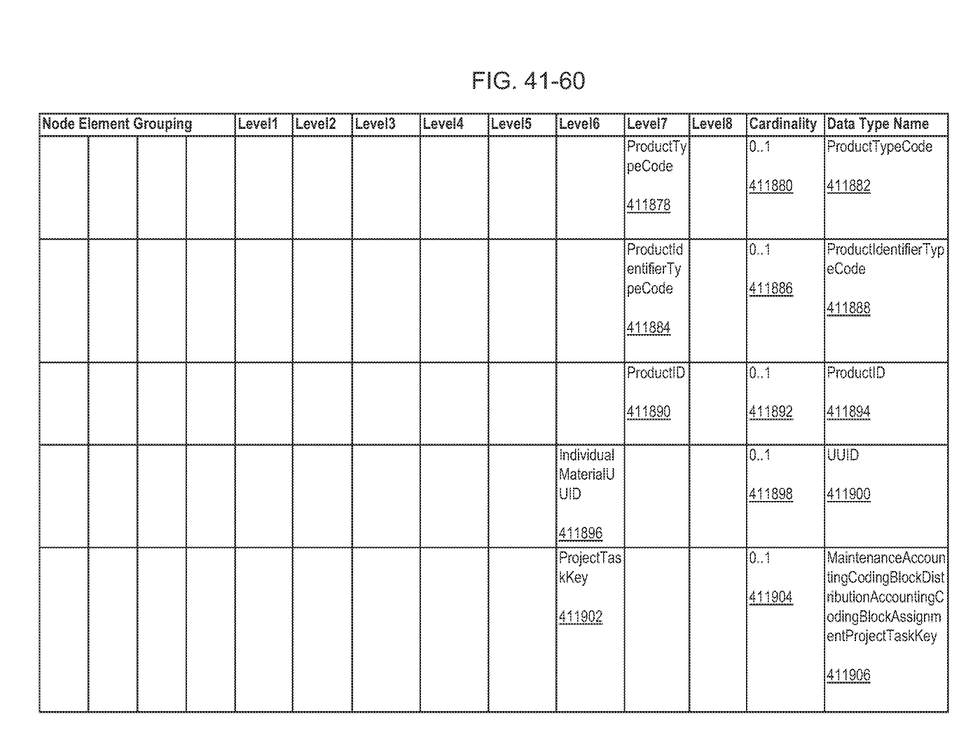

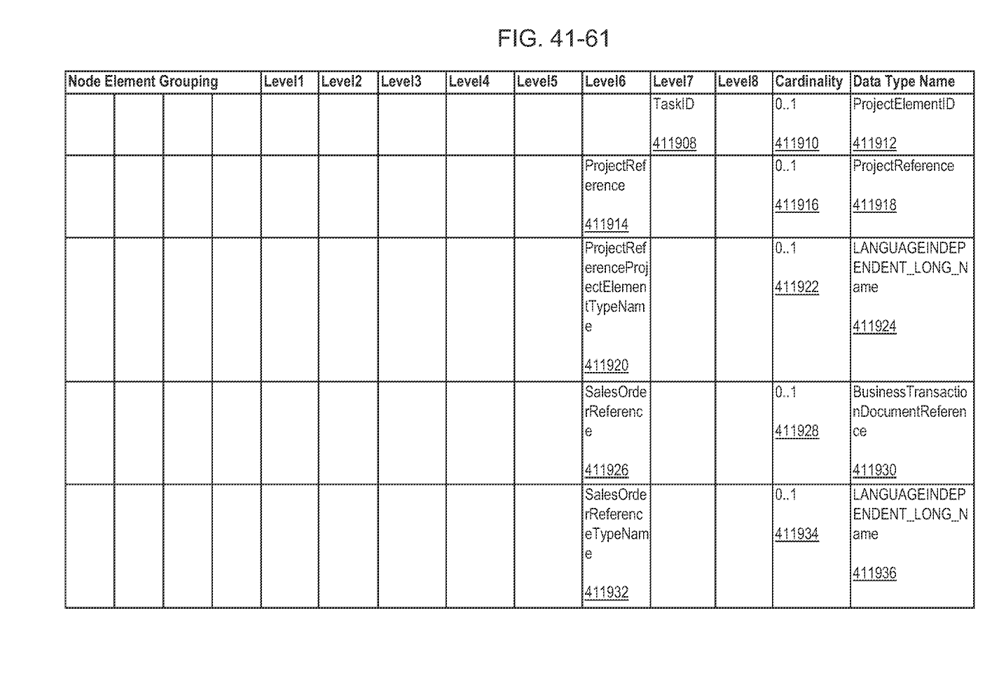

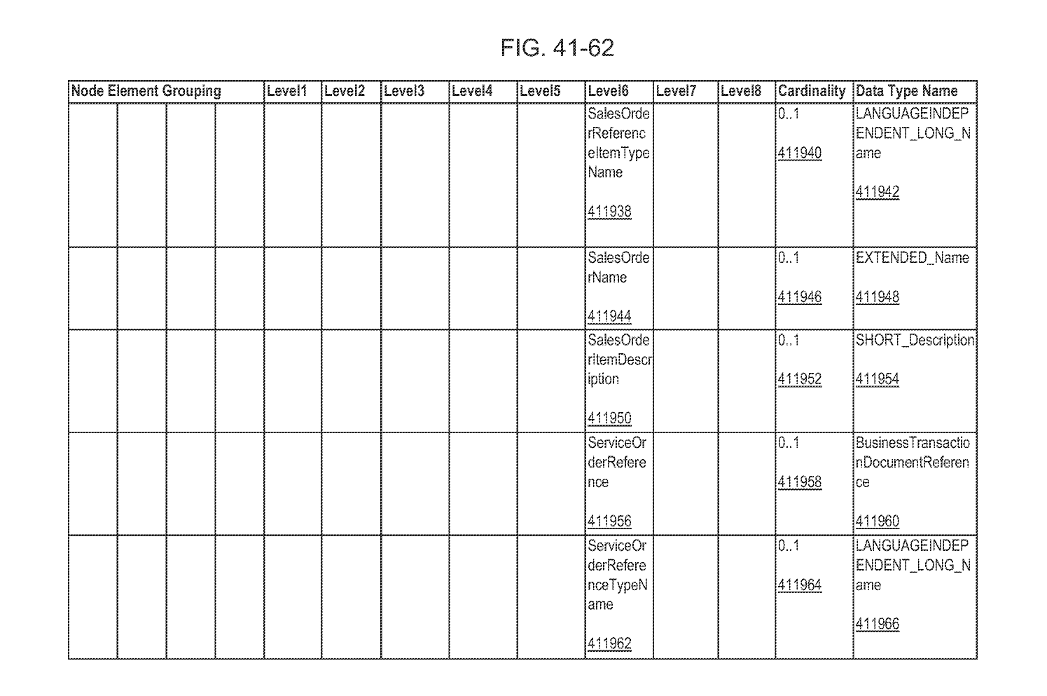

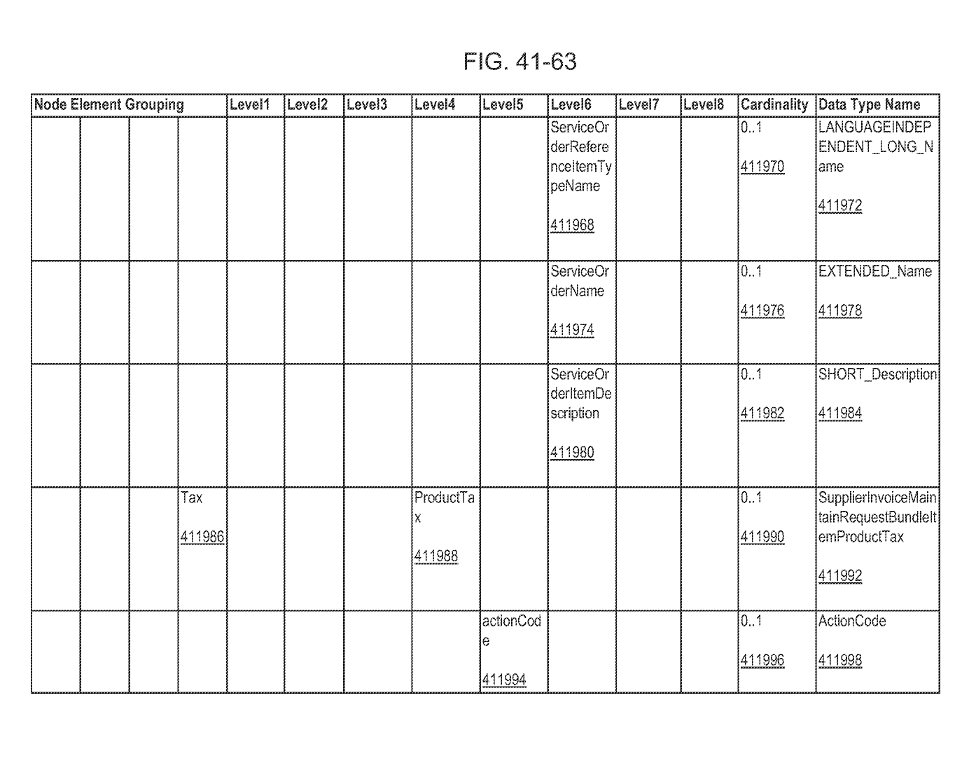

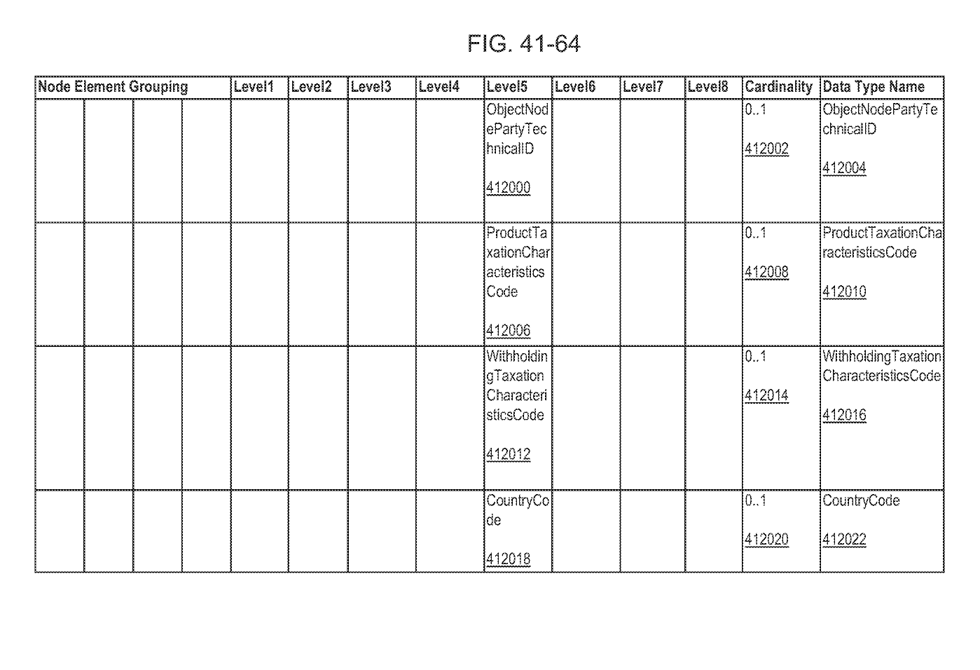

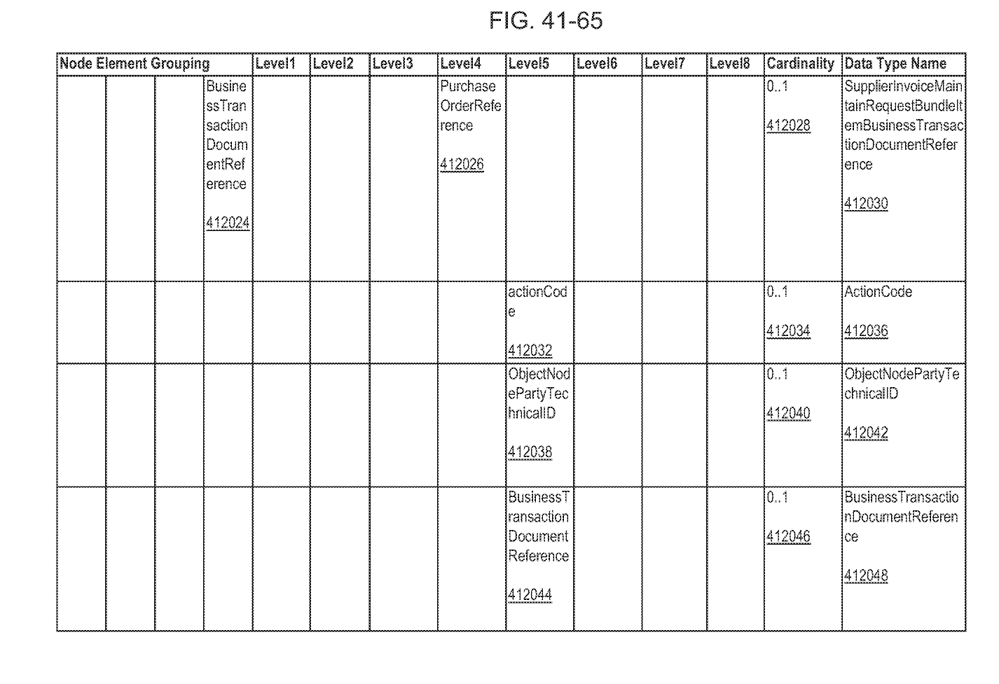

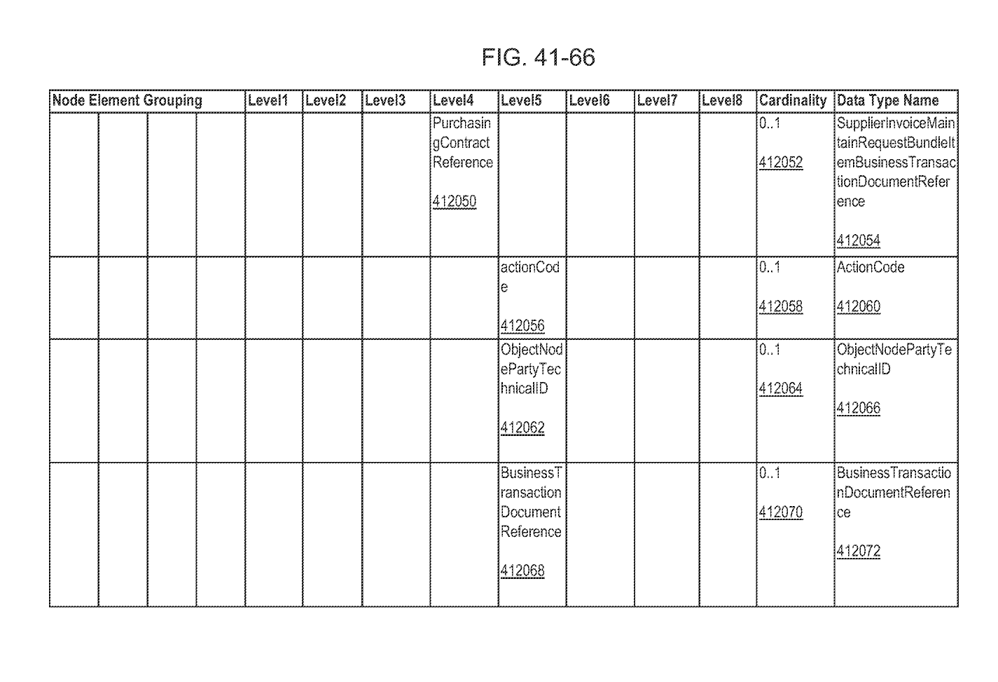

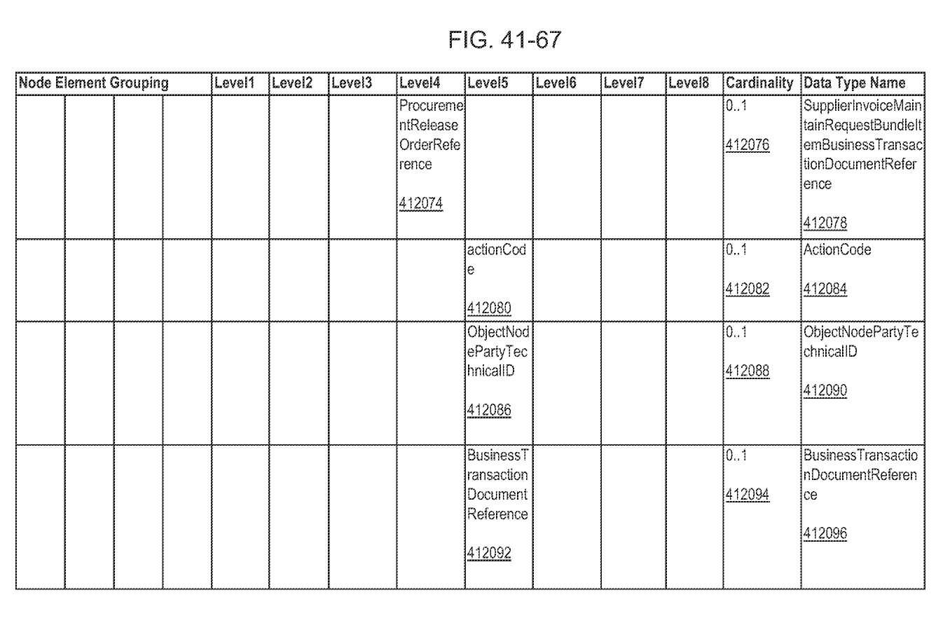

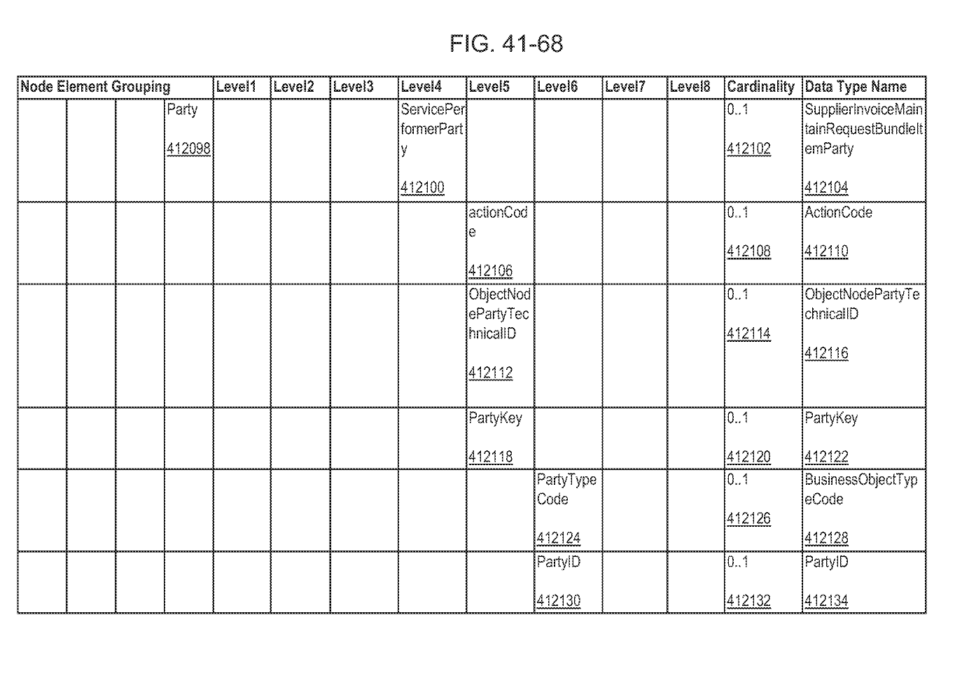

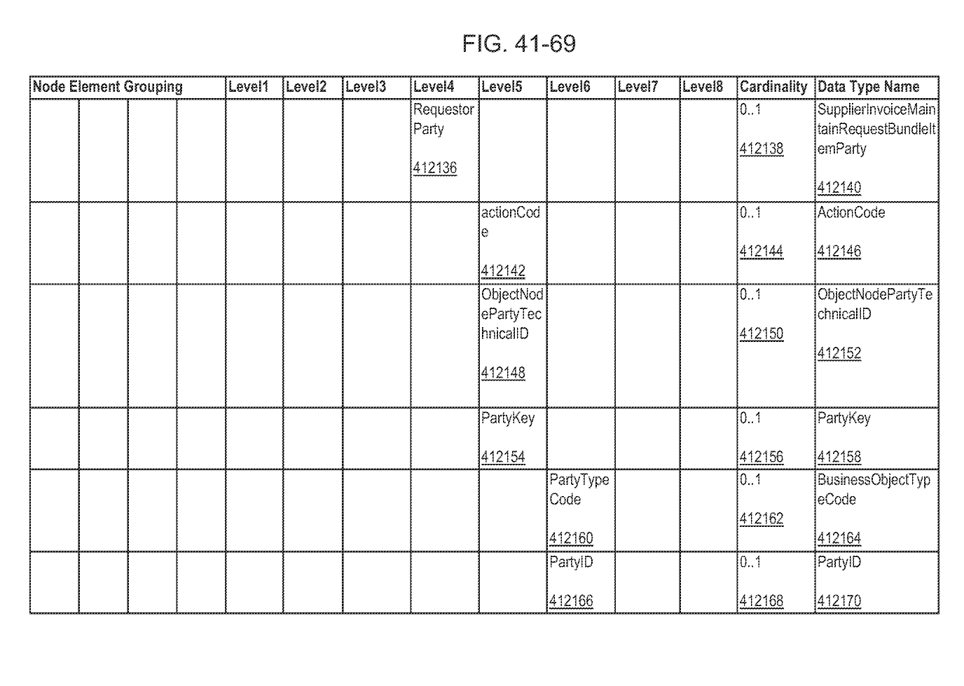

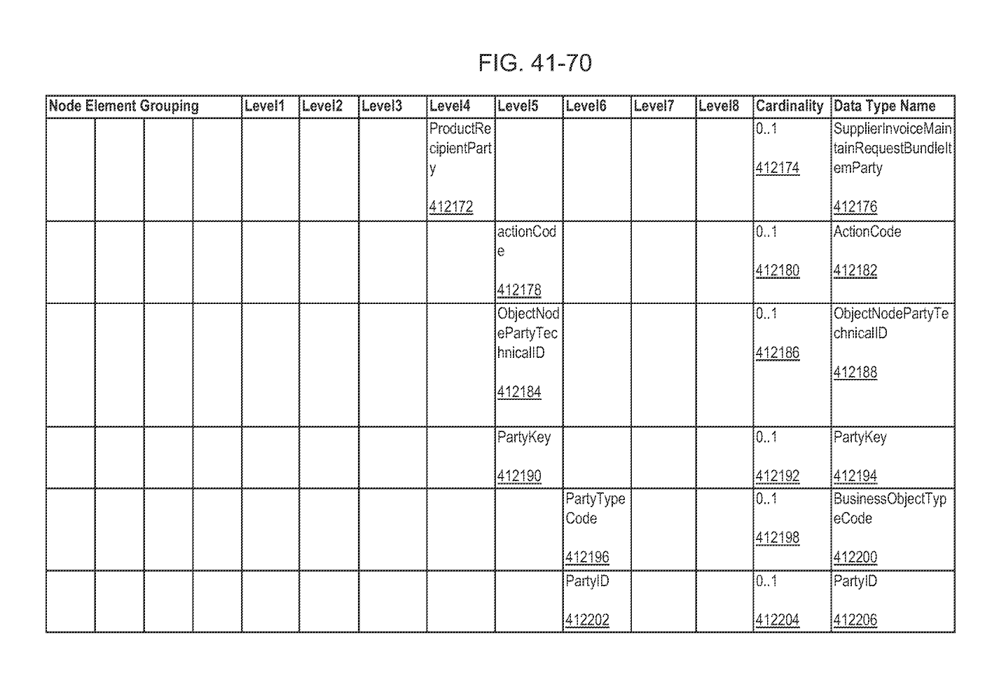

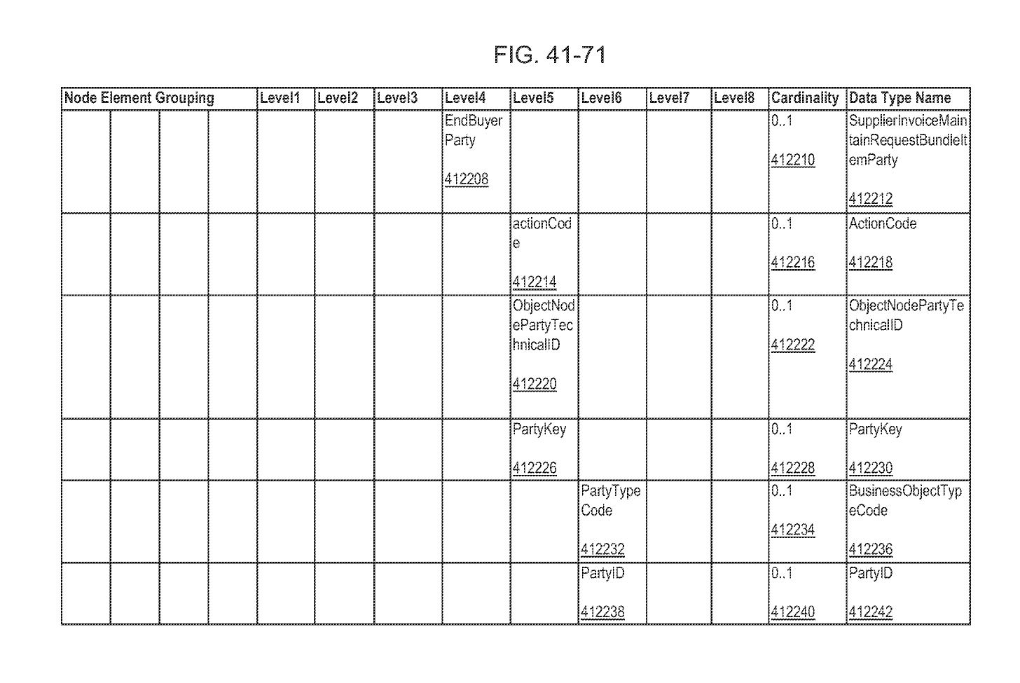

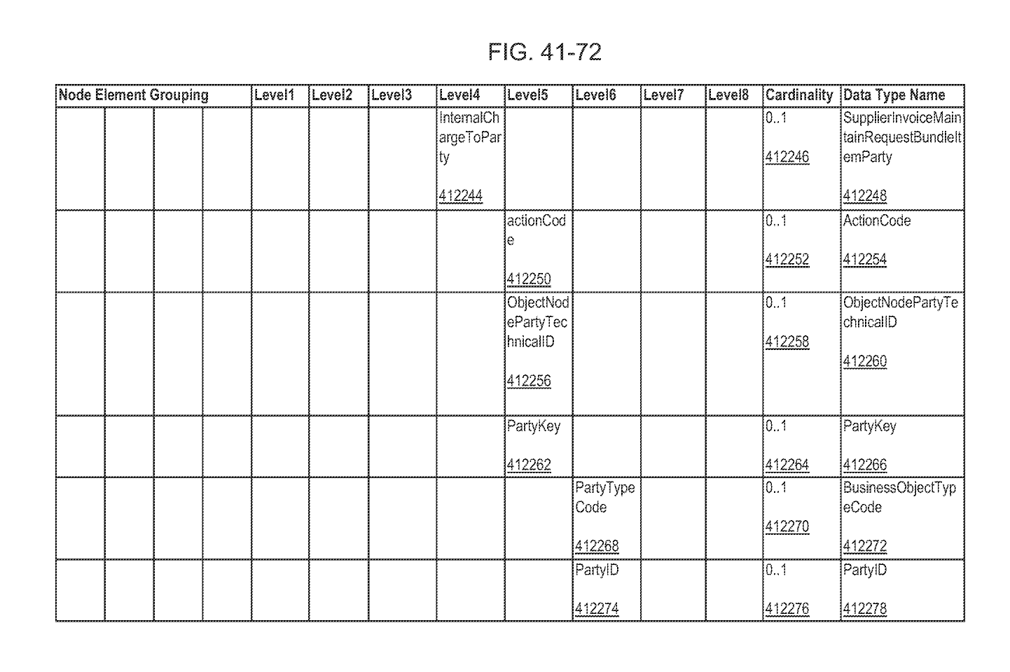

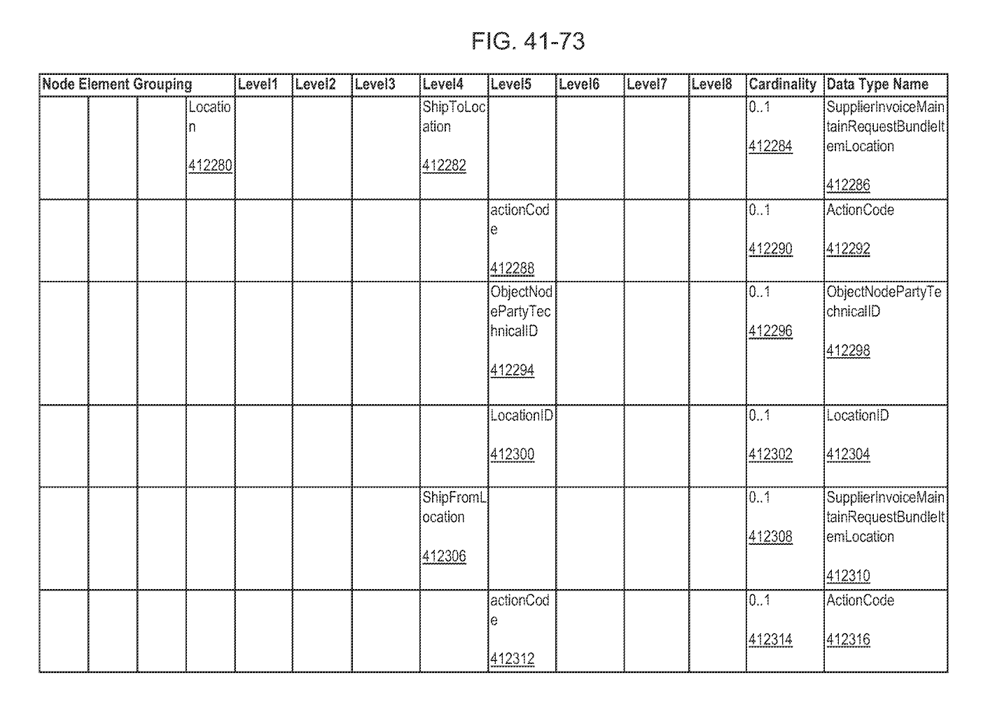

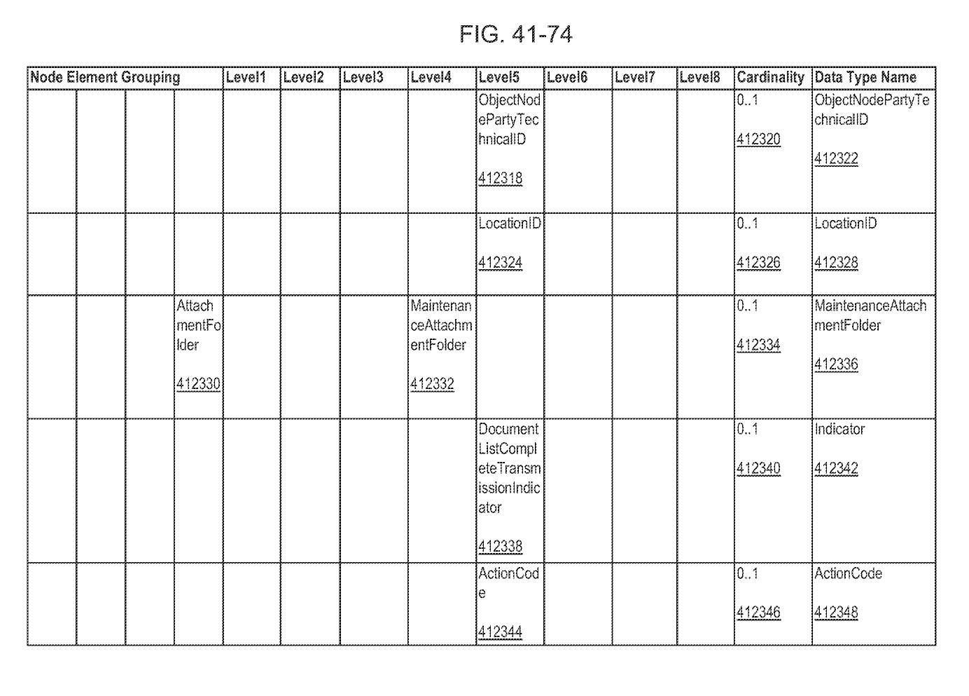

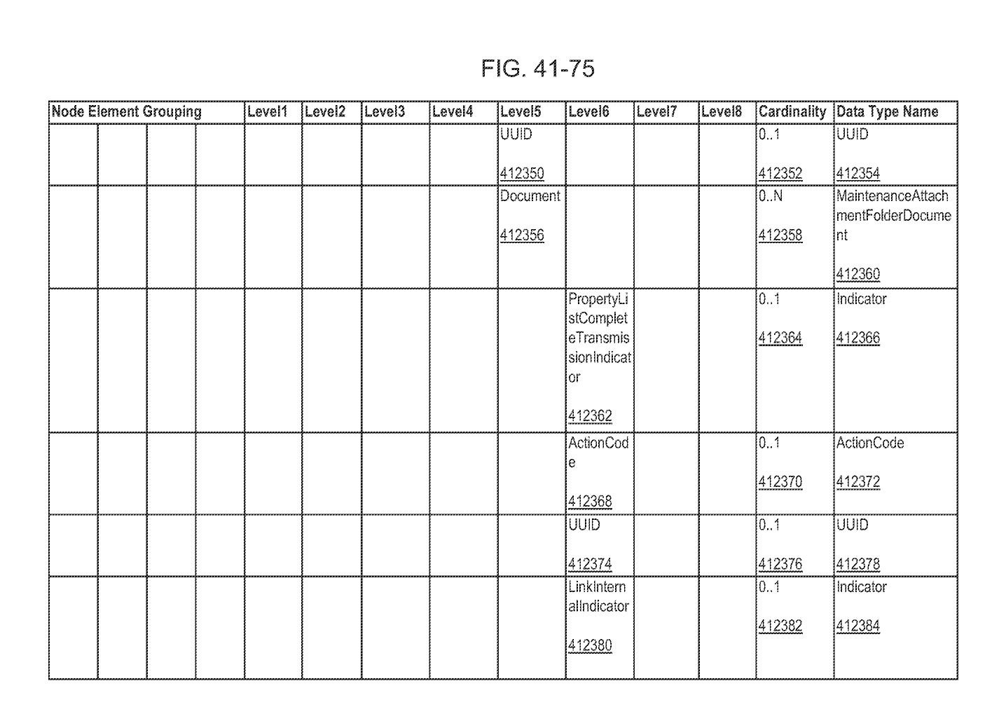

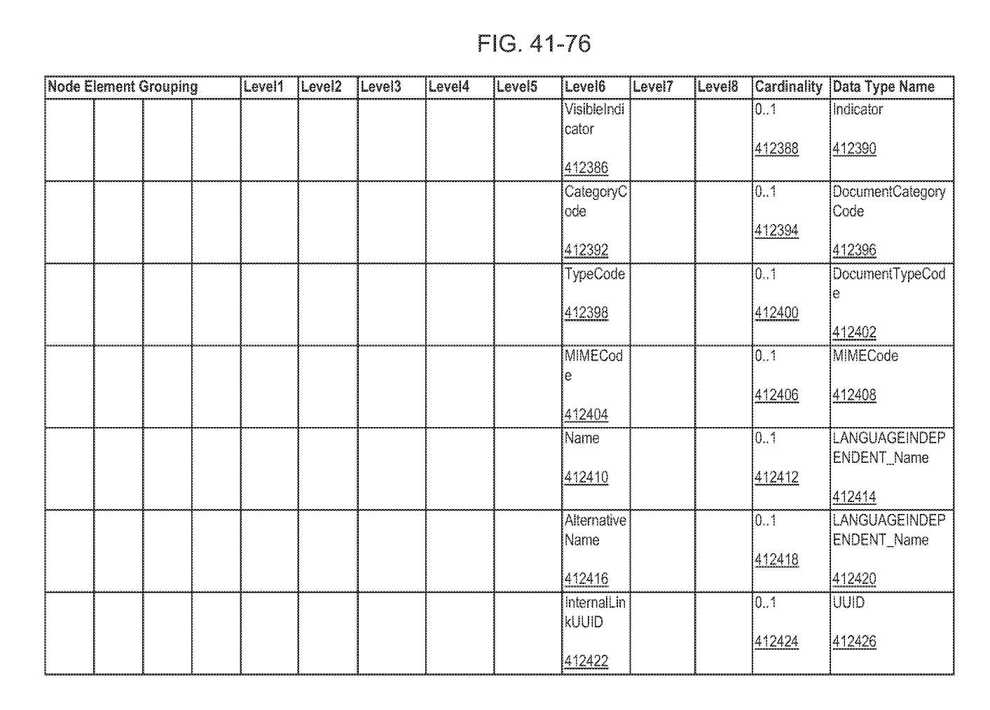

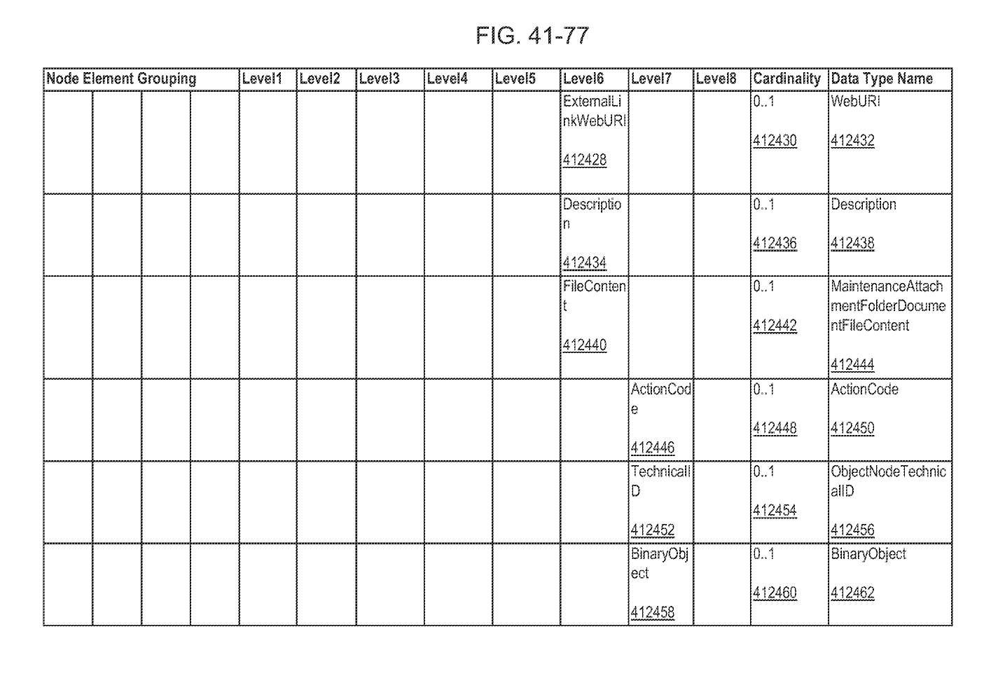

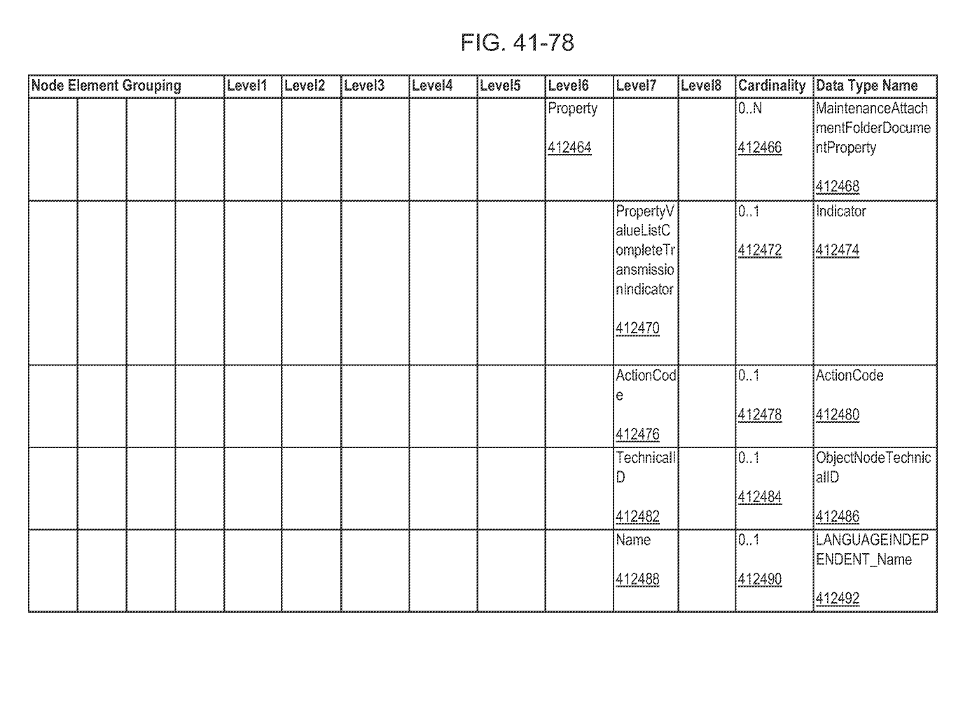

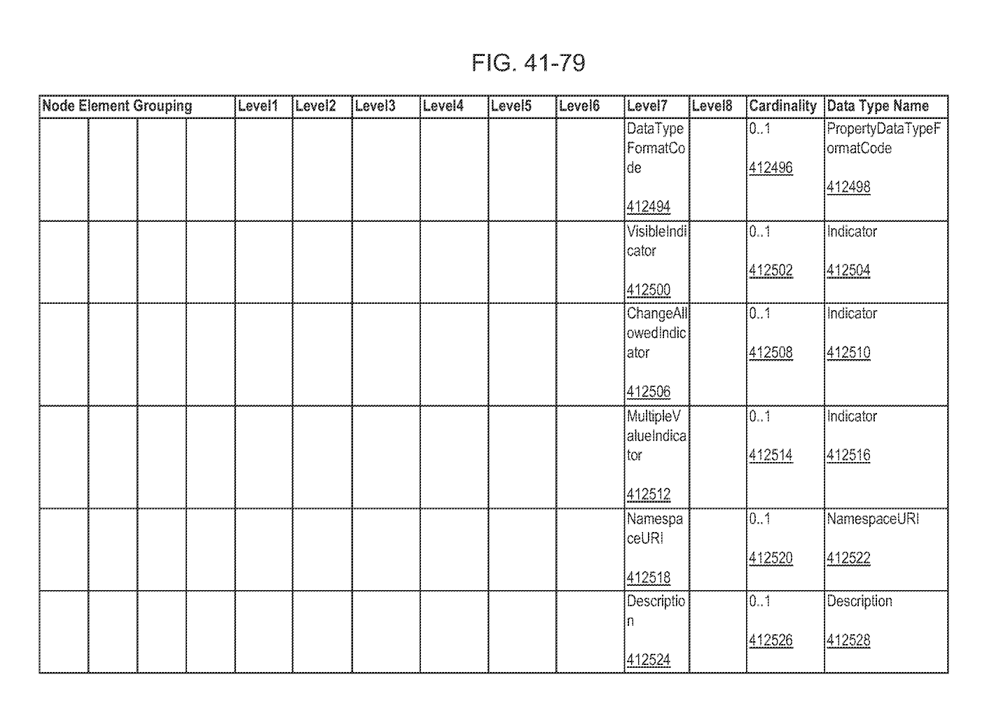

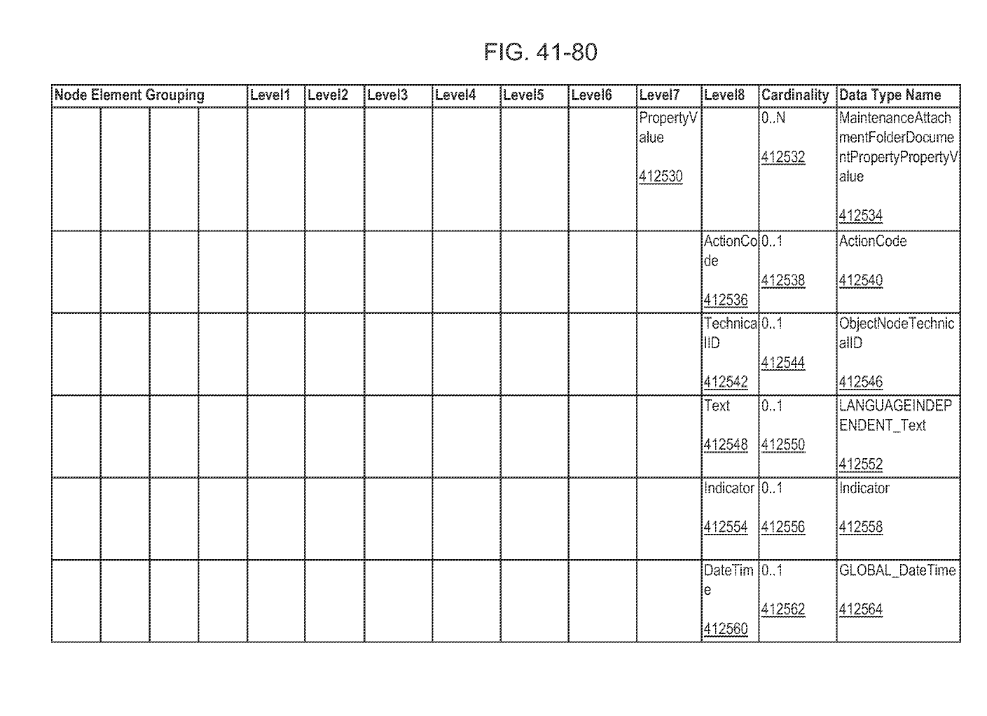

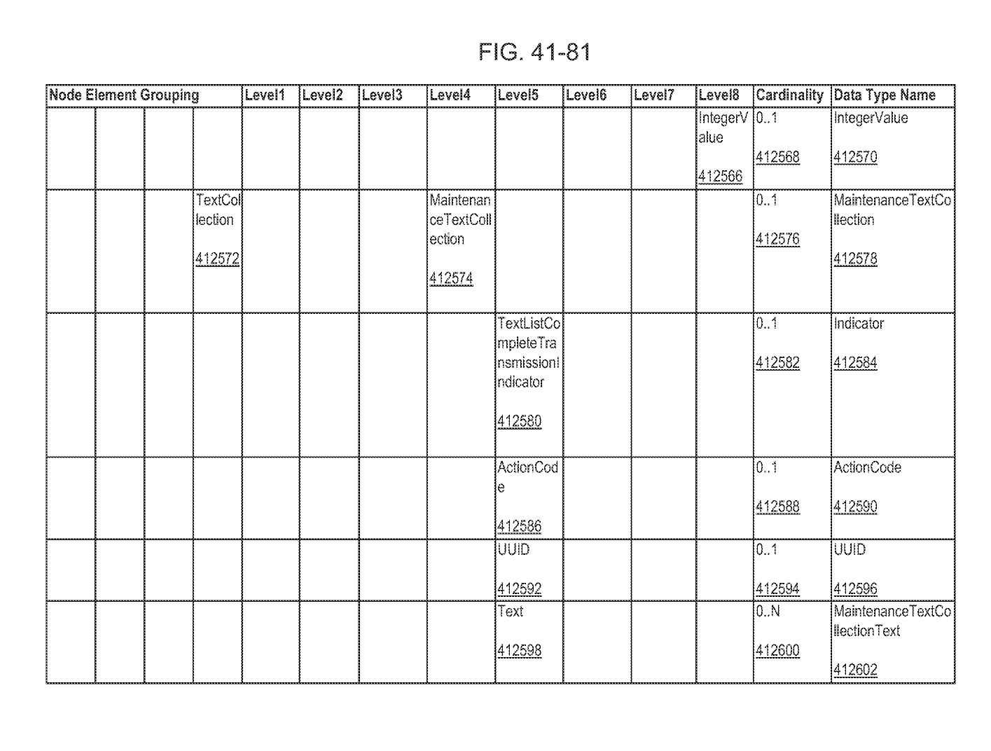

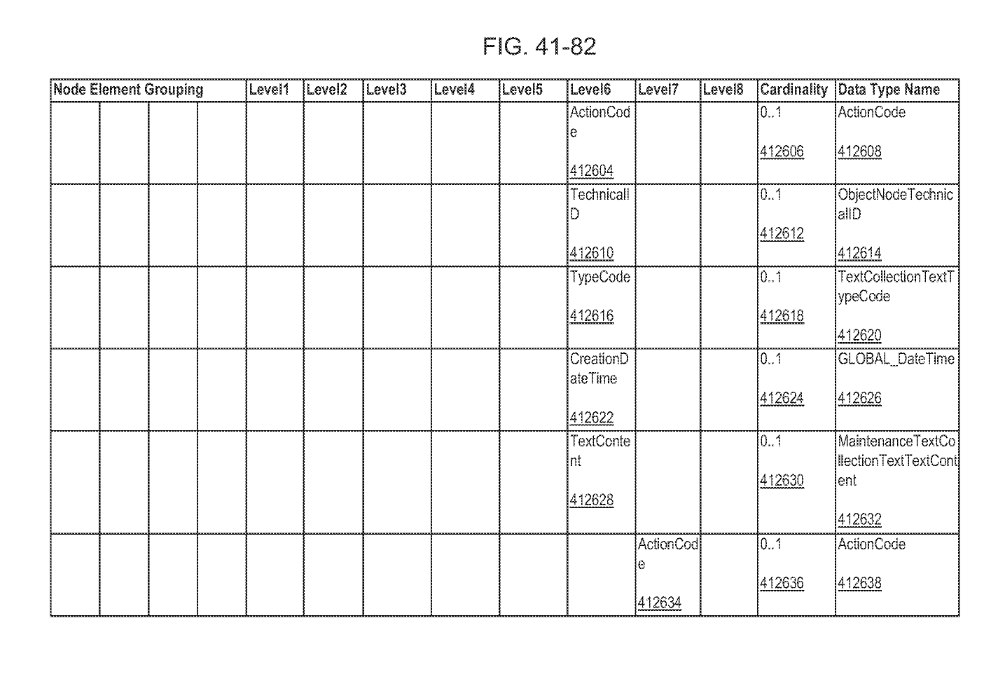

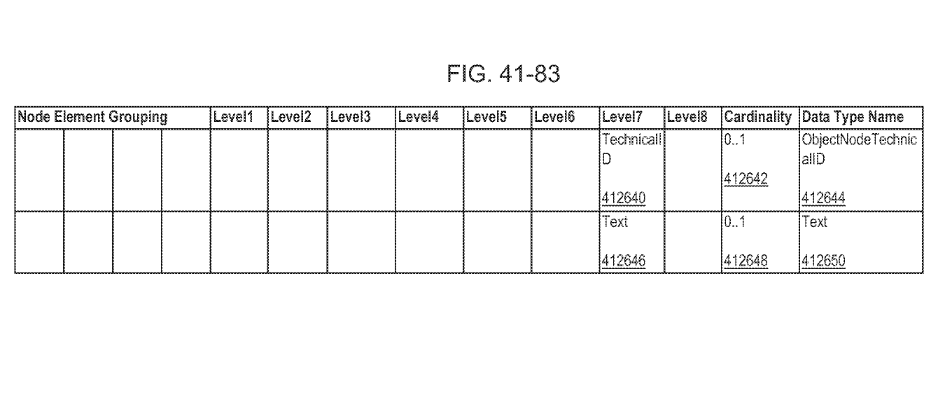

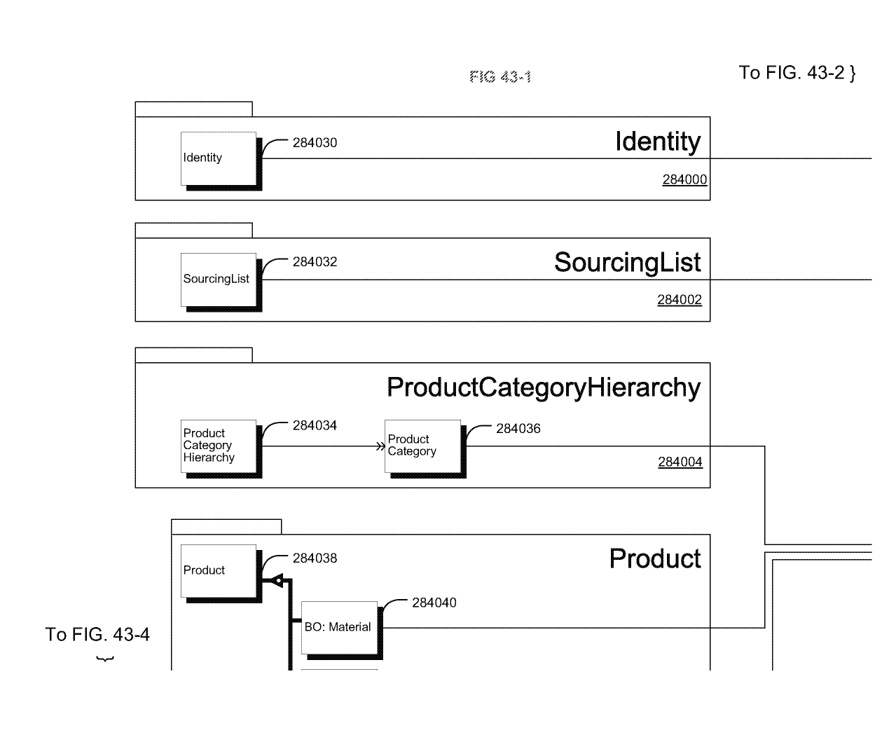

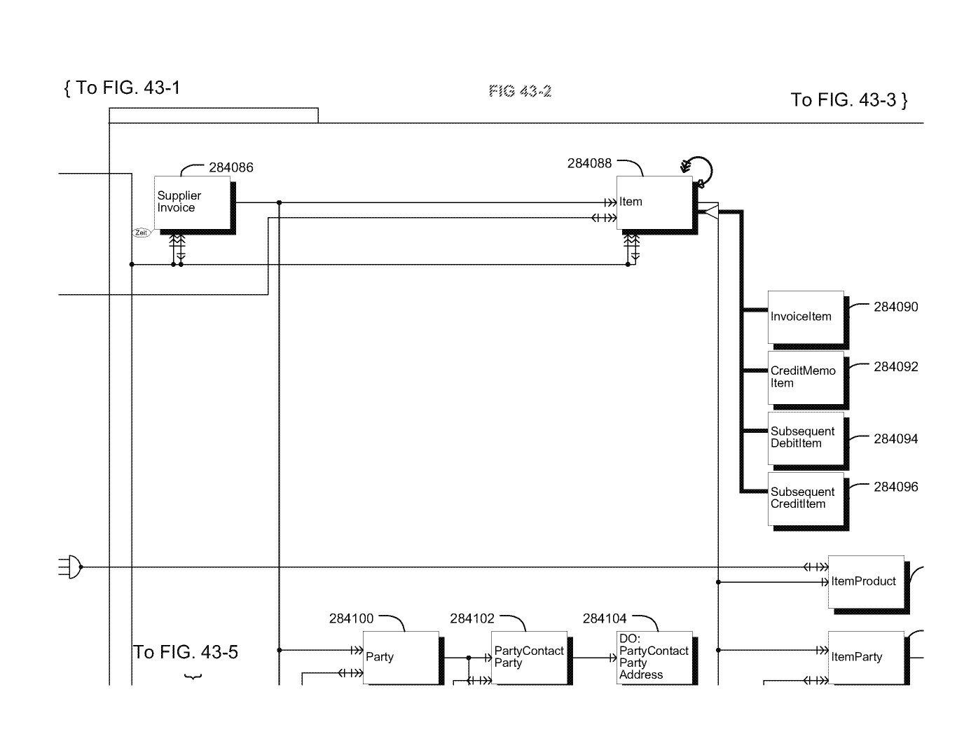

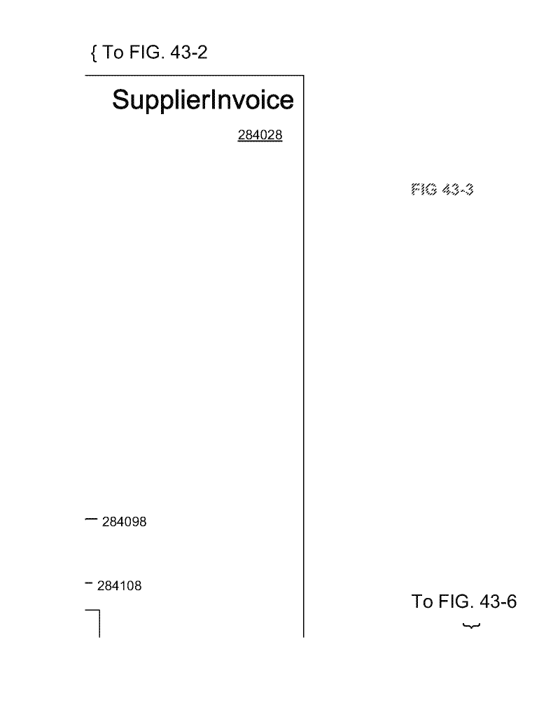

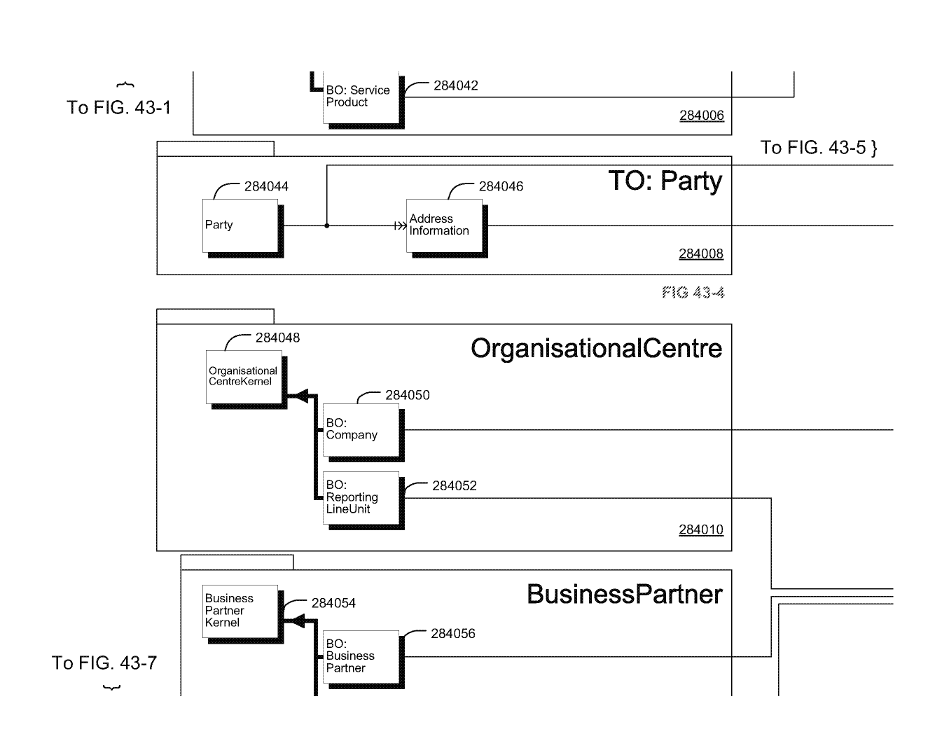

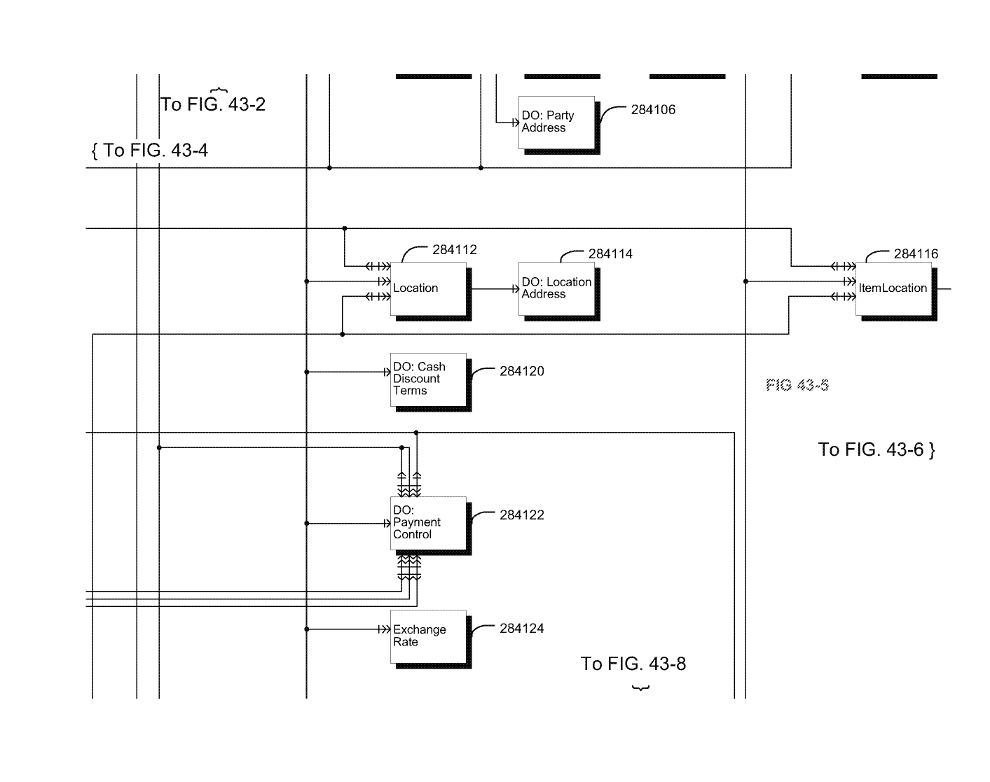

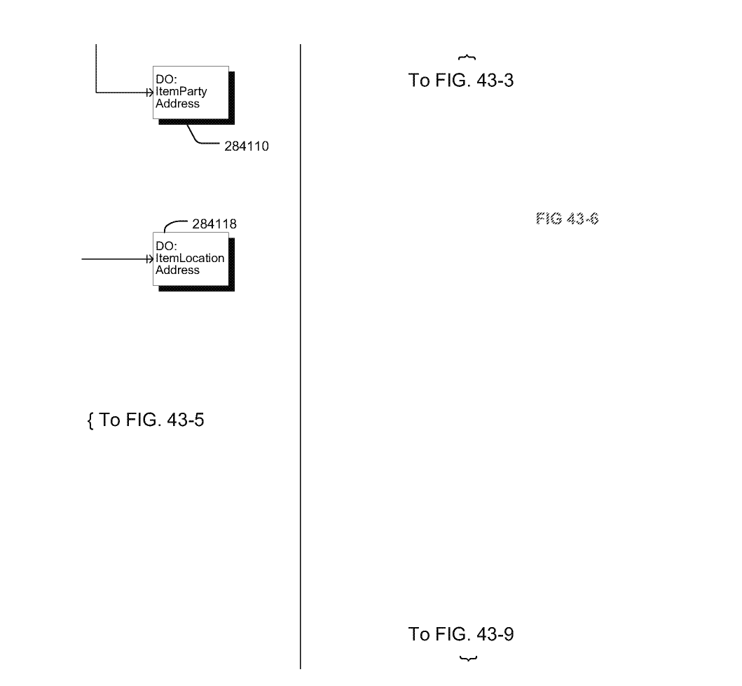

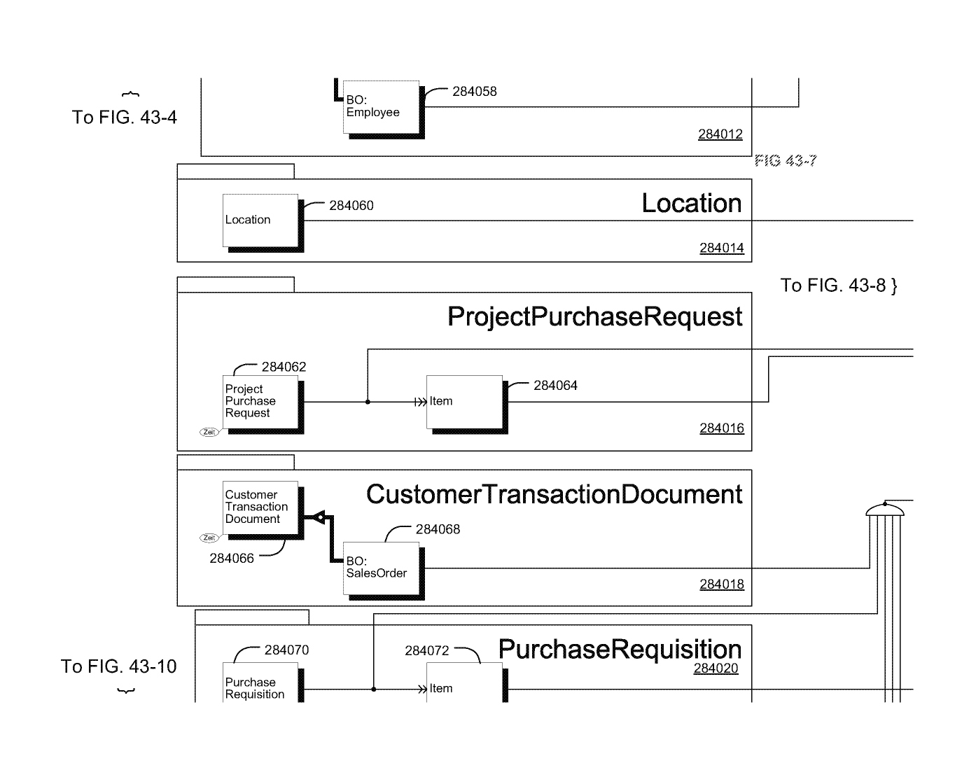

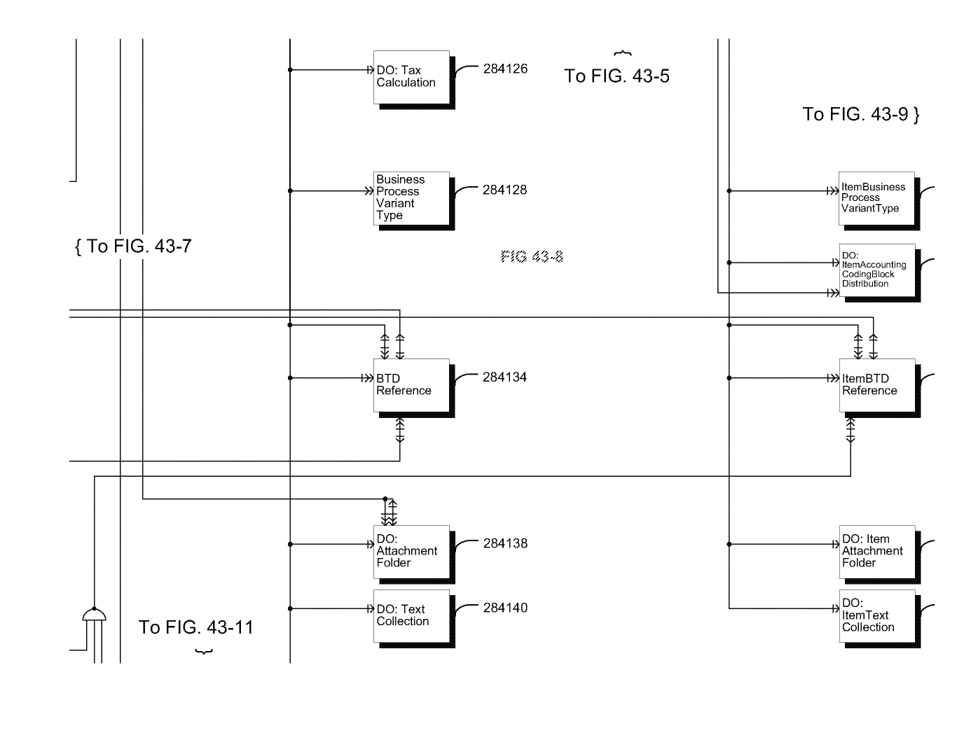

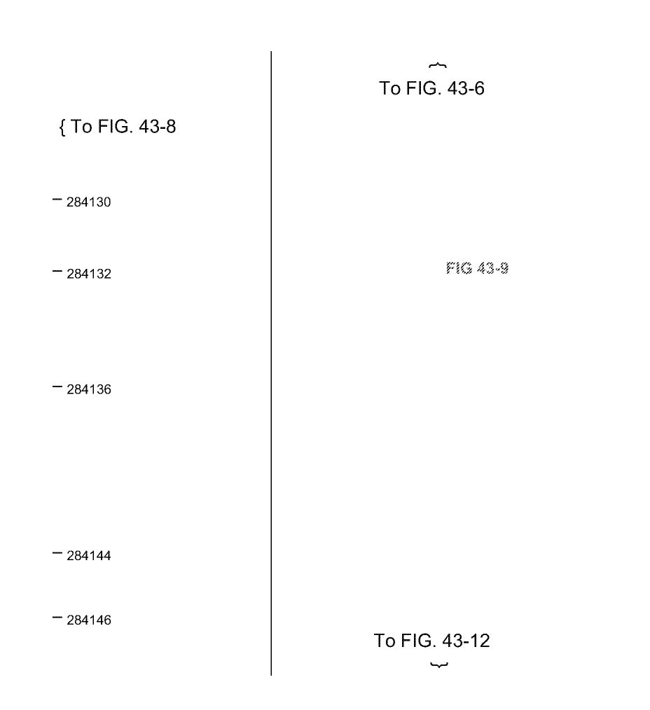

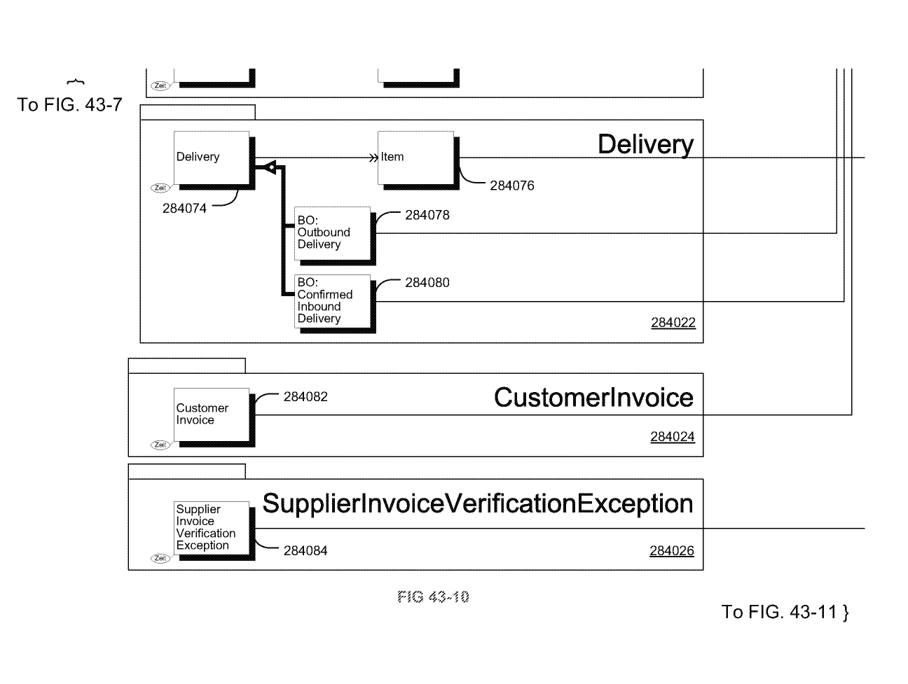

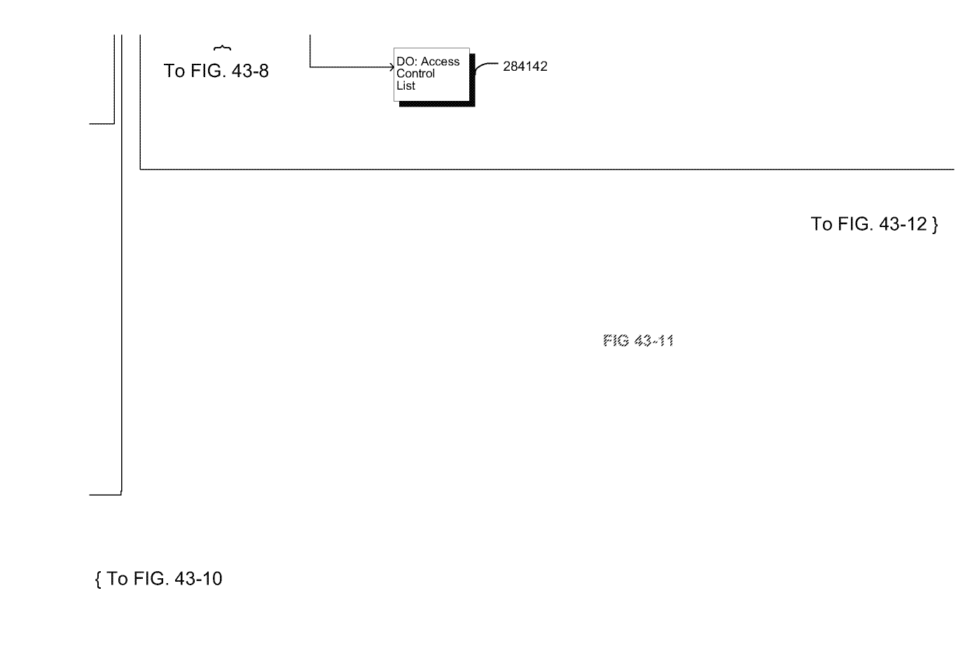

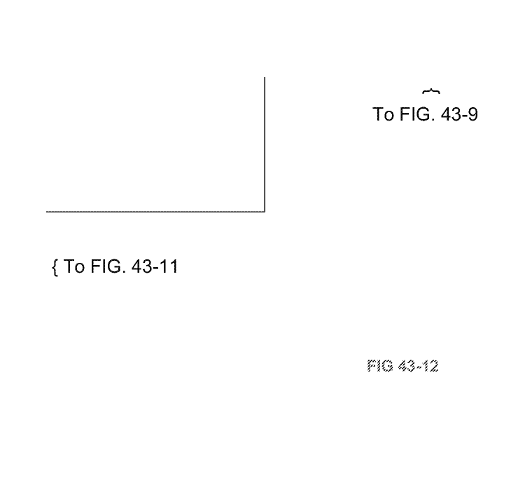

FIGS. 37-1 through 37-83 show an example configuration of an Element Structure that includes a SupplierInvoiceBundleCheckMaintainRequest_sync 370000 node element grouping. Specifically, these figures depict the arrangement and hierarchy of various components such as one or more levels of node element groupings, entities, and datatypes, shown here as 370000 through 372650. As described above, node element groupings may be used to represent hierarchy levels. Entities are discrete business elements that are used during a business transaction. Data types are used to type object entities and interfaces with a structure. For example, the SupplierInvoiceBundleCheckMaintainRequest_sync 370000 includes, among other things, a SupplierInvoiceBundleCheckMaintainRequest_sync 370002. Accordingly, heterogeneous applications may communicate using this consistent message configured as such.

The table shown in the figures presents a hierarchical representation of elements that are included in the message represented by the SupplierInvoiceBundleCheckMaintainRequest_sync 370000 node element grouping, which itself can be a package. The root level of the message is the SupplierInvoiceBundleCheckMaintainRequest_sync 370002, which is an entity. Other components of the message, which are hierarchically included by the root node, are components from the same or other packages listed in the remaining “Node Element Group” columns of the table. Sub-packages of packages are indicated by indentation, e.g., as being shown in the next column to the right in the “Node Element Group” columns. For example, the node element groupings MessageHeader 370006 and SupplierInvoice 370014 represent sub-packages to the SupplierInvoiceBundleCheckMaintainRequest_sync 370000 node element grouping.

The “Level 1” through “Level 8” columns of the table identify hierarchically lower components of the message, each hierarchically lower than the root node. In general, a component identified in the “Level 2” column is subordinate to the most recently-listed component identified in the “Level 1” column, “Level 3” components are subordinate to “Level 2” components, and so on. The components are included in the corresponding packages identified in the “Node Element Group” columns. For example, the BasicHeaderMessage entity 37008 is hierarchically lower than, or included by, the SupplierInvoiceBundleCheckMaintainRequest_sync entity 370002 and is part of the package represented by the MessageHeader node element groupings 370006. The “Level 1” through “Level 8” columns also identify attributes and elements that are subordinate to entities. For example, the ActionCode attribute 370022 is an attribute of the SupplierInvoiceMaintainBundle entity 370016.

The table includes a “Cardinality” column that identifies the number of instances that a component has or can have relative to its superordinate component. For example, the BasicMessageHeader entity 370008 has a cardinality of 1 370010 meaning that for every SupplierInvoiceBundleCheckMaintainRequest_sync entity 370002 there is one BasicMessageHeader entity 370008. In another example, the SupplierInvoiceMaintainBundle entity 370016 has a cardinality of 1 . . . N 370018 meaning that for each instance of the SupplierInvoice 370014 node element grouping, there are one or more SupplierInvoiceMaintainBundle entities 370016. In another example, the ActionCode attribute 370022 has a cardinality of 0 . . . 1 370024 meaning that for each instance of the SupplierInvoiceMaintainBundle entity 370016 entity there are zero or one ActionCode attribute 370022.

The table includes a “Data Type Name” column. For example, the column can identify the data type of the component (e.g., entity, attribute or element) that is identified on that row of the table. The full details of the example configuration of the Element Structure found in FIGS. 37-1 through 37-83 can be derived from a review of the corresponding figures. For example, first-level packages (in the second “Node Element Grouping” column) include packages 370006 through 370014, second-level packages include packages 370106 through 371542, and third-level packages include packages 371616 through 372572. Level 1 components include the entity 370002. Level 2 components include elements and attributes 370008 through 370016. Level 3 components include elements and attributes 370022 through 371544. Level 4 components include elements and attributes 370010 through 372574. Level 5 components include elements and attributes 370158 through 372598. Level 6 components include elements and attributes 370602 through 372628. Level 7 components include elements and attributes 371426 through 372646. Level 8 components include elements and attributes 372536 through 372566. Cardinality components include cardinalities 370010 through 372648. Data Type Name components include data types 370004 through 372650.

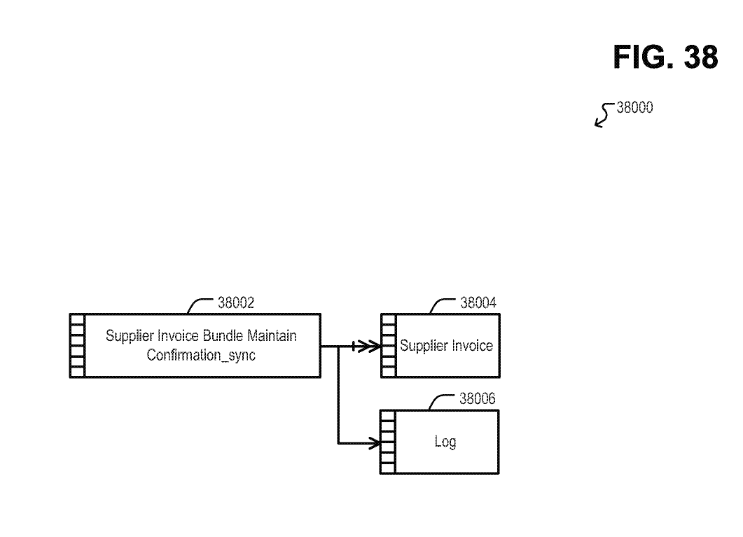

FIG. 38 illustrates one example logical configuration of a Supplier Invoice Bundle Maintain Confirmation_sync message 38000. Specifically, this figure depicts the arrangement and hierarchy of various components such as one or more levels of packages, entities, and datatypes, shown here as 38002 through 38006. As described above, packages may be used to represent hierarchy levels. Entities are discrete business elements that are used during a business transaction. Data types are used to type object entities and interfaces with a structure. For example, the Supplier Invoice Bundle Maintain Confirmation_sync message 38000 includes, among other things, Supplier Invoice entity 38004. Accordingly, heterogeneous applications may communicate using this consistent message configured as such.

The message type SupplierInvoiceBundleMaintainConfirmation_sync is derived from the business object Supplier Invoice as a leading object together with its operation signature. The message type SupplierInvoiceBundleMaintainConfirmation_sync is a positive or negative reply to a request to post and/or create one or more supplier invoices. If the creation of one or more invoices is not possible, then the invoice of the bundle might not be created. If the creation of one or more invoices is possible despite any errors or if posting is not possible, then all invoices may be created. In some cases, all errors are returned. The structure of the message type SupplierInvoiceBundleMaintainConfirmation_sync is determined by the message data type SupplierInvoiceMaintainConfirmationBundleMessage_sync. The message data type SupplierInvoiceMaintainConfirmationBundleMessage_sync includes the packages SupplierInvoice and Log. The package SupplierInvoice includes the entity SupplierInvoice.

SupplierInvoice includes the following non-node elements: ReferenceObjectNodeSenderTechnicalID, ChangeStateID, BusinessTransactionDocumentID, and UUID. ReferenceObjectNodeSenderTechnicalID may have a multiplicity of 0 . . . 1 and may be based on datatype BGDT:ObjectNodePartyTechnicalID. ChangeStateID may have a multiplicity of 1 and may be based on datatype BGDT:ChangeStateID. BusinessTransactionDocumentID may have a multiplicity of 1 and may be based on datatype BGDT:BusinessTransactionDocumentID. UUID may have a multiplicity of 1 and may be based on datatype BGDT:UUID. The package Log includes the entity Log, which is typed by datatype Log.

FIGS. 39-1 through 39-2 show an example configuration of an Element Structure that includes a SupplierInvoiceBundleMaintainConfirmation_sync 39000 node element grouping. Specifically, these figures depict the arrangement and hierarchy of various components such as one or more levels of node element groupings, entities, and datatypes, shown here as 39000 through 39044. As described above, node element groupings may be used to represent hierarchy levels. Entities are discrete business elements that are used during a business transaction. Data types are used to type object entities and interfaces with a structure. For example, the SupplierInvoiceBundleMaintainConfirmation_sync 39000 includes, among other things, a SupplierInvoiceBundleMaintainConfirmation_sync 39002. Accordingly, heterogeneous applications may communicate using this consistent message configured as such.

The table shown in the figures presents a hierarchical representation of elements that are included in the message represented by the SupplierInvoiceBundleMaintainConfirmation_sync 390000 node element grouping. The structure of the table is similar to the table structure described above with reference to FIGS. 33-1 through 33-3. The full details of the example configuration of the Element Structure found in FIGS. 39-1 through 39-2 can be derived from a review of the corresponding figures. For example, first-level packages (in the second “Node Element Grouping” column) include packages 390006 through 390038. Level 1 components include the entity 390002. Level 2 components include elements and attributes 390008 through 390040. Level 3 components include elements and attributes 390014 through 390032. Cardinality components include cardinalities 390010 through 390042. Data Type Name components include data types 390004 through 390044.

FIGS. 40-1 to 40-6 collectively illustrate one example logical configuration of a Supplier Invoice Bundle Maintain Request_sync message 40000. Specifically, these figures depict the arrangement and hierarchy of various components such as one or more levels of packages, entities, and datatypes, shown here as 40002 through 40086. As described above, packages may be used to represent hierarchy levels. Entities are discrete business elements that are used during a business transaction. Data types are used to type object entities and interfaces with a structure. For example, the Supplier Invoice Bundle Maintain Request_sync message 40000 includes, among other things, Supplier Invoice Maintain Bundle 40006. Accordingly, heterogeneous applications may communicate using this consistent message configured as such.

The message type SupplierInvoiceBundleMaintainRequest_sync is derived from the business object Supplier Invoice as a leading object together with its operation signature. The message type SupplierInvoiceBundleMaintainRequest_sync is a request to create one or more supplier invoices. The structure of the message type SupplierInvoiceBundleMaintainRequest_sync is determined by the message data type SupplierInvoiceBundleMaintainRequestMessage_sync. The message data type SupplierInvoiceBundleMaintainRequestMessage_sync includes the MessageHeader package and the SupplierInvoice package. The package MessageHeader includes the entity BasicMessageHeader. BasicMessageHeader is typed by BusinessDocumentBasicMessageHeader. The package SupplierInvoice includes the sub-packages BusinessTransactionDocumentReference, Party, Location, CashDiscountTerms, PaymentControl, AttachmentFolder, TextCollection and Item and the entity SupplierInvoiceMaintainBundle.

SupplierInvoiceMaintainBundle includes the following attributes: actionCode and itemListCompleteTransmissionIndicator. The attribute actionCode may have a multiplicity of 0 . . . 1 and may be based on datatype BGDT:ActionCode. The attribute itemListCompleteTransmissionIndicator may have a multiplicity of 0 . . . 1 and may be based on datatype CDT:Indicator. SupplierInvoiceMaintainBundle includes the non-node elements: ObjectNodeSenderTechnicalID, ChangeStateID, BusinessTransactionDocumentTypeCode, Date, ReceiptDate, TransactionDate, DocumentItemGrossAmountIndicator, GrossAmount, TaxAmount, and Status. Status may include DataEntryProcessingStatusCode. ObjectNodeSenderTechnicalID may have a multiplicity of 0 . . . 1 and may be based on datatype BGDT:ObjectNodePartyTechnicalID. ChangeStateID may have a multiplicity of 0 . . . 1 and may be based on datatype BGDT:ChangeStateID. BusinessTransactionDocumentTypeCode may have a multiplicity of 1 and may be based on datatype BGDT:BusinessTransactionDocumentTypeCode. MEDIUM_Name may have a multiplicity of 0 . . . 1 and may be based on datatype CDT:MEDIUM_Name. Date may have a multiplicity of 0 . . . 1 and may be based on datatype CDT:Date. ReceiptDate may have a multiplicity of 0 . . . 1 and may be based on datatype CDT:Date. TransactionDate may have a multiplicity of 0 . . . 1 and may be based on datatype CDT:Date. DocumentItemGrossAmountIndicator may have a multiplicity of 1 and may be based on datatype CDT:Indicator. GrossAmount may have a multiplicity of 0 . . . 1 and may be based on datatype CDT:Amount. TaxAmount may have a multiplicity of 0 . . . 1 and may be based on datatype CDT:Amount. Status may have a multiplicity of 0 . . . 1 and may be based on datatype MIDT:SupplierInvoiceMaintainRequestBundleStatus. DataEntryProcessingStatusCode may have a multiplicity of 0 . . . 1 and may be based on datatype BGDT:INPROCESSFINISHED_ProcessingStatusCode.

SupplierInvoiceMaintainBundle includes the node elements CustomerinvoiceReference in a 1:C cardinality relationship, BuyerParty in a 1:1 cardinality relationship, SellerParty in a 1:C cardinality relationship, BillToParty in a 1:C cardinality relationship, BillFromParty in a 1:C cardinality relationship, ShipToLocation in a 1:C cardinality relationship, ShipFromLocation in a 1:C cardinality relationship, CashDiscountTerms in a 1:C cardinality relationship, PaymentControl in a 1:C cardinality relationship, AttachmentFolder in a 1:C cardinality relationship, TextCollection in a 1:C cardinality relationship, and Item in a 1:CN cardinality relationship.

The package SupplierInvoiceBusinessTransactionDocumentReference includes the entity CustomerinvoiceReference. CustomerinvoiceReference includes the actionCode attribute. The attribute actionCode may have a multiplicity of 0 . . . 1 and may be based on datatype BGDT:ActionCode. SupplierInvoiceBusinessTransactionDocumentReference includes the non-node elements ObjectNodePartyTechnicalID and BusinessTransactionDocumentReference. ObjectNodePartyTechnicalID may have a multiplicity of 0 . . . 1 and may be based on datatype BGDT:ObjectNodePartyTechnicalID. BusinessTransactionDocumentReference may have a multiplicity of 0 . . . 1 and may be based on datatype AGDT:BusinessTransactionDocumentReference.

The package SupplierInvoiceParty includes the entities BuyerParty, SellerParty, BillToParty, and BillFromParty. BuyerParty includes the actionCode attribute. The attribute actionCode may have a multiplicity of 0 . . . 1 and may be based on datatype BGDT:ActionCode. SupplierInvoiceParty includes the non-node elements ObjectNodePartyTechnicalID and PartyKey. ObjectNodePartyTechnicalID may have a multiplicity of 0 . . . 1 and may be based on datatype BGDT:ObjectNodePartyTechnicalID. PartyKey may have a multiplicity of 0 . . . 1 and may be based on datatype KDT:PartyKey.

SellerParty includes the actionCode attribute. The attribute actionCode may have a multiplicity of 0 . . . 1 and may be based on datatype BGDT:ActionCode. SellerParty includes the non-node elements ObjectNodePartyTechnicalID and PartyKey. ObjectNodePartyTechnicalID may have a multiplicity of 0 . . . 1 and may be based on datatype BGDT:ObjectNodePartyTechnicalID. PartyKey may have a multiplicity of 0 . . . 1 and may be based on datatype KDT:PartyKey.

BillToParty includes the actionCode attribute. The attribute actionCode may have a multiplicity of 0 . . . 1 and may be based on datatype BGDT:ActionCode. BillToParty includes the non-node elements ObjectNodePartyTechnicalID and PartyKey. ObjectNodePartyTechnicalID may have a multiplicity of 0 . . . 1 and may be based on datatype BGDT:ObjectNodePartyTechnicalID. PartyKey may have a multiplicity of 0 . . . 1 and may be based on datatype KDT:PartyKey.

BillFromParty includes the actionCode attribute. The attribute actionCode may have a multiplicity of 0 . . . 1 and may be based on datatype BGDT:ActionCode. BillFromParty includes the non-node elements ObjectNodePartyTechnicalID and PartyKey. ObjectNodePartyTechnicalID may have a multiplicity of 0 . . . 1 and may be based on datatype BGDT:ObjectNodePartyTechnicalID. PartyKey may have a multiplicity of 0 . . . 1 and may be based on datatype KDT:PartyKey.

The package SupplierInvoiceLocation includes the entities ShipToLocation and ShipFromLocation. ShipToLocation includes the actionCode attribute. The attribute actionCode may have a multiplicity of 0 . . . 1 and may be based on datatype BGDT:ActionCode. ShipToLocation includes the non-node elements ObjectNodePartyTechnicalID and LocationID. ObjectNodePartyTechnicalID may have a multiplicity of 0 . . . 1 and may be based on datatype BGDT:ObjectNodePartyTechnicalID. LocationID may have a multiplicity of 0 . . . 1 and may be based on datatype BGDT:LocationID. ShipFromLocation includes the actionCode attribute. The attribute actionCode may have a multiplicity of 0 . . . 1 and may be based on datatype BGDT:ActionCode. ShipFromLocation includes the non-node elements ObjectNodePartyTechnicalID and LocationID. ObjectNodePartyTechnicalID may have a multiplicity of 0 . . . 1 and may be based on datatype BGDT:ObjectNodePartyTechnicalID. LocationID may have a multiplicity of 0 . . . 1 and may be based on datatype BGDT:LocationID.

The package SupplierInvoiceCashDiscountTerms includes the entity CashDiscountTerms. CashDiscountTerms includes the ActionCode attribute, which may have a multiplicity of 0 . . . 1 and may be based on datatype BGDT:ActionCode. CashDiscountTerms includes the non-node elements: UUID, Code, and PaymentBaselineDate. UUID may have a multiplicity of 0 . . . 1 and may be based on datatype BGDT:UUID. Code may have a multiplicity of 0 . . . 1 and may be based on datatype BGDT:CashDiscountTermsCode. PaymentBaselineDate may have a multiplicity of 0 . . . 1 and may be based on datatype CDT:Date.

The package SupplierInvoicePaymentControl includes the entity PaymentControl. PaymentControl includes the following attributes: BankTransferListCompleteTransmissionIndicator, BillOfExchangePayablePaymentListCompleteTransmissionIndicator, BillOfExchangeReceivablePaymentListCompleteTransmissionIndicator, CreditCardPaymentListCompleteTransmissionIndicator, ChequePaymentListCompleteTransmissionIndicator, and ActionCode. BankTransferListCompleteTransmissionIndicator may have a multiplicity of 0 . . . 1 and may be based on datatype CDT:Indicator. BillOfExchangePayablePaymentListCompleteTransmissionIndicator may have a multiplicity of 0 . . . 1 and may be based on datatype CDT:Indicator. BillOfExchangeReceivablePaymentListCompleteTransmissionIndicator may have a multiplicity of 0 . . . 1 and may be based on datatype CDT:Indicator. CreditCardPaymentListCompleteTransmissionIndicator may have a multiplicity of 0 . . . 1 and may be based on datatype CDT:Indicator. ChequePaymentListCompleteTransmissionIndicator may have a multiplicity of 0 . . . 1 and may be based on datatype CDT:Indicator. ActionCode may have a multiplicity of 0 . . . 1 and may be based on datatype BGDT:ActionCode. PaymentControl includes the non-node elements: UUID, PaymentProcessingCompanyUUID, PaymentProcessingCompanyID, PaymentProcessingBusinessPartnerUUID, PaymentProcessingBusinessPartnerID, ResponsibleEmployeeUUID, ResponsibleEmployeeID, PropertyMovementDirectionCode, PaymentFormCode, PaymentAmount, ExchangeRate, ExchangeRateUnitCurrencyName, ExchangeRateQuotedCurrencyName, PaymentBlock, PaymentBlockPaymentBlockingReasonName, FirstPaymentInstructionTypeCode, SecondPaymentInstructionTypeCode, ThirdPaymentInstructionTypeCode, FourthPaymentInstructionTypeCode, BankChargeBearerCode, PaymentPriorityCode, SinglePaymentIndicator, DebitValueDate, CreditValueDate, PaymentReceivablesPayablesGroupID, PaymentReferenceID, PaymentReferenceTypeCode, Note, BankTransfer, BillOfExchangePayablePayment, BillOfExchangeReceivablePayment, CashPayment, CreditCardPayment, and ChequePayment.

UUID may have a multiplicity of 0 . . . 1 and may be based on datatype BGDT:UUID. PaymentProcessingCompanyUUID may have a multiplicity of 0 . . . 1 and may be based on datatype BGDT:UUID. PaymentProcessingCompanyID may have a multiplicity of 0 . . . 1 and may be based on datatype BGDT:OrganisationalCentreID. PaymentProcessingBusinessPartnerUUID may have a multiplicity of 0 . . . 1 and may be based on datatype BGDT:UUID. PaymentProcessingBusinessPartnerID may have a multiplicity of 0 . . . 1 and may be based on datatype BGDT:BusinessPartnerInternalID. ResponsibleEmployeeUUID may have a multiplicity of 0 . . . 1 and may be based on datatype BGDT:UUID. ResponsibleEmployeeID may have a multiplicity of 0 . . . 1 and may be based on datatype BGDT:BusinessPartnerinternalID. PropertyMovementDirectionCode may have a multiplicity of 0 . . . 1 and may be based on datatype BGDT:PropertyMovementDirectionCode. PaymentFormCode may have a multiplicity of 0 . . . 1 and may be based on datatype BGDT:PaymentFormCode. PaymentAmount may have a multiplicity of 0 . . . 1 and may be based on datatype CDT:Amount. ExchangeRate may have a multiplicity of 0 . . . 1 and may be based on datatype AGDT:ExchangeRate. ExchangeRateUnitCurrencyName may have a multiplicity of 0 . . . 1 and may be based on datatype CDT:LANGUAGEINDEPENDENT_LONG_Name. ExchangeRateQuotedCurrencyName may have a multiplicity of 0 . . . 1 and may be based on datatype CDT:LANGUAGEINDEPENDENT_LONG_Name. PaymentBlock may have a multiplicity of 0 . . . 1 and may be based on datatype AGDT:PaymentBlock. PaymentBlockPaymentBlockingReasonName may have a multiplicity of 0 . . . 1 and may be based on datatype CDT:LANGUAGEINDEPENDENT_LONG_Name. FirstPaymentInstructionTypeCode may have a multiplicity of 0 . . . 1 and may be based on datatype BGDT:PaymentInstructionTypeCode. SecondPaymentInstructionTypeCode may have a multiplicity of 0 . . . 1 and may be based on datatype BGDT:PaymentInstructionTypeCode. ThirdPaymentInstructionTypeCode may have a multiplicity of 0 . . . 1 and may be based on datatype BGDT:PaymentInstructionTypeCode. FourthPaymentInstructionTypeCode may have a multiplicity of 0 . . . 1 and may be based on datatype BGDT:PaymentInstructionTypeCode. BankChargeBearerCode may have a multiplicity of 0 . . . 1 and may be based on datatype BGDT:BankChargeBearerCode. PaymentPriorityCode may have a multiplicity of 0 . . . 1 and may be based on datatype BGDT:PriorityCode. SinglePaymentIndicator may have a multiplicity of 0 . . . 1 and may be based on datatype CDT:Indicator. DebitValueDate may have a multiplicity of 0 . . . 1 and may be based on datatype CDT:Date. CreditValueDate may have a multiplicity of 0 . . . 1 and may be based on datatype CDT:Date. PaymentReceivablesPayablesGroupID may have a multiplicity of 0 . . . 1 and may be based on datatype BGDT:BusinessTransactionDocumentGroupID. PaymentReferenceID may have a multiplicity of 0 . . . 1 and may be based on datatype BGDT:PaymentReferenceID. PaymentReferenceTypeCode may have a multiplicity of 0 . . . 1 and may be based on datatype BGDT:PaymentReferenceTypeCode. Note may have a multiplicity of 0 . . . 1 and may be based on datatype BGDT:MEDIUM_Note. BankTransfer may have a multiplicity of 0 . . . * and may be based on datatype MIDT:MaintenancePaymentControlBankTransfer. Bank Transfer may include ActionCode, UUID, HouseBankAccountUUID, HouseBankAccountKey, HouseBankUUID, HouseBankInternalID, BankDirectoryEntryUUID, BankInternalID, BankAccountID, BankAccountIDCheckDigitValue, BankAccountTypeCode, BankAccountHolderName, BankAccountStandardID, BusinessPartnerBankDetailsKey, and Amount. ActionCode may have a multiplicity of 0 . . . 1 and may be based on datatype BGDT:ActionCode. UUID may have a multiplicity of 0 . . . 1 and may be based on datatype BGDT:UUID. HouseBankAccountUUID may have a multiplicity of 0 . . . 1 and may be based on datatype BGDT:UUID. HouseBankAccountKey may have a multiplicity of 0 . . . 1 and may be based on datatype KDT:MaintenancePaymentControlBankTransferHouseBankAccountKey. HouseBankUUID may have a multiplicity of 0 . . . 1 and may be based on datatype BGDT:UUID. HouseBankInternalID may have a multiplicity of 0 . . . 1 and may be based on datatype BGDT:BusinessPartnerinternalID. BankDirectoryEntryUUID may have a multiplicity of 0 . . . 1 and may be based on datatype BGDT:UUID. BankInternalID may have a multiplicity of 0 . . . 1 and may be based on datatype BGDT:BankInternalID. BankAccountID may have a multiplicity of 0 . . . 1 and may be based on datatype BGDT:BankAccountID. BankAccountIDCheckDigitValue may have a multiplicity of 0 . . . 1 and may be based on datatype BGDT:BankAccountIDCheckDigitValue. BankAccountTypeCode may have a multiplicity of 0 . . . 1 and may be based on datatype BGDT:BankAccountTypeCode. BankAccountHolderName may have a multiplicity of 0 . . . 1 and may be based on datatype BGDT:BankAccountHolderName_V1. BankAccountStandardID may have a multiplicity of 0 . . . 1 and may be based on datatype BGDT:BankAccountStandardID. BusinessPartnerBankDetailsKey may have a multiplicity of 0 . . . 1 and may be based on datatype KDT:MaintenancePaymentControlBankTransferBusinessPartnerBankDetailsKey. Amount may have a multiplicity of 0 . . . 1 and may be based on datatype CDT:Amount. BillOfExchangePayablePayment may have a multiplicity of 0 . . . * and may be based on datatype MIDT:MaintenancePaymentControlBillOfExchangePayablePayment. BillOfExchangePayablePayment may include ActionCode, UUID, BillOfExchangePayableDrawerID, DrawerPartyRoleCategoryCode, HouseBankUUID, HouseBankAccountUUID, HouseBankAccountKey, BusinessPartnerBankDetailsKey,

Amount, IssueDate, DueDate, and DocumentDate. ActionCode may have a multiplicity of 0 . . . 1 and may be based on datatype BGDT:ActionCode. UUID may have a multiplicity of 0 . . . 1 and may be based on datatype BGDT:UUID. BillOfExchangePayableDrawerID may have a multiplicity of 0 . . . 1 and may be based on datatype BGDT:BusinessTransactionDocumentID. DrawerPartyRoleCategoryCode may have a multiplicity of 0 . . . 1 and may be based on datatype BGDT:PartyRoleCategoryCode. HouseBankUUID may have a multiplicity of 0 . . . 1 and may be based on datatype BGDT:UUID. HouseBankAccountUUID may have a multiplicity of 0 . . . 1 and may be based on datatype BGDT:UUID. HouseBankAccountKey may have a multiplicity of 0 . . . 1 and may be based on datatype KDT:MaintenancePaymentControlBillOfExchangePayablePaymentHouseBankAccountKey.

BusinessPartnerBankDetailsKey may have a multiplicity of 0 . . . 1 and may be based on datatype KDT:MaintenancePaymentControlBillOfExchangePayablePaymentBusinessPartnerBankDeta ilsKey. Amount may have a multiplicity of 0 . . . 1 and may be based on datatype CDT:Amount. IssueDate may have a multiplicity of 0 . . . 1 and may be based on datatype CDT:Date. DueDate may have a multiplicity of 0 . . . 1 and may be based on datatype CDT:Date. DocumentDate may have a multiplicity of 0 . . . 1 and may be based on datatype CDT:Date. BillOfExchangeReceivablePayment may have a multiplicity of 0 . . . * and may be based on datatype MIDT:MaintenancePaymentControlBillOfExchangeReceivablePayment. BillOfExchangeReceivablePayment may include ActionCode, UUID, BillOfExchangeReceivableDrawerID, DrawerPartyRoleCategoryCode, PlannedBillOfExchangeUsageCode, Amount, IssueDate, DueDate, DocumentDate, RiskPeriodEndDate, and BusinessPartnerBankDetailsKey. ActionCode may have a multiplicity of 0 . . . 1 and may be based on datatype BGDT:ActionCode. UUID may have a multiplicity of 0 . . . 1 and may be based on datatype BGDT:UUID. BillOfExchangeReceivableDrawerID may have a multiplicity of 0 . . . 1 and may be based on datatype BGDT:BusinessTransactionDocumentID. DrawerPartyRoleCategoryCode may have a multiplicity of 0 . . . 1 and may be based on datatype BGDT:PartyRoleCategoryCode. PlannedBillOfExchangeUsageCode may have a multiplicity of 0 . . . 1 and may be based on datatype BGDT:BillOfExchangeUsageCode. Amount may have a multiplicity of 0 . . . 1 and may be based on datatype CDT:Amount. IssueDate may have a multiplicity of 0 . . . 1 and may be based on datatype CDT:Date. DueDate may have a multiplicity of 0 . . . 1 and may be based on datatype CDT:Date. DocumentDate may have a multiplicity of 0 . . . 1 and may be based on datatype CDT:Date. RiskPeriodEndDate may have a multiplicity of 0 . . . 1 and may be based on datatype CDT:Date. BusinessPartnerBankDetailsKey may have a multiplicity of 0 . . . 1 and may be based on datatype KDT:MaintenancePaymentControlBillOfExchangeReceivablePaymentBusinessPartnerBank DetailsKey.

CashPayment may have a multiplicity of 0 . . . 1 and may be based on datatype MIDT:MaintenancePaymentControlCashPayment. CashPayment may include ActionCode, UUID, CashStorageUUID, and CashStorageKey. ActionCode may have a multiplicity of 0 . . . 1 and may be based on datatype BGDT:ActionCode. UUID may have a multiplicity of 0 . . . 1 and may be based on datatype BGDT:UUID. CashStorageUUID may have a multiplicity of 0 . . . 1 and may be based on datatype BGDT:UUID. CashStorageKey may have a multiplicity of 0 . . . 1 and may be based on datatype KDT:MaintenancePaymentControlCashPaymentCashStorageKey.

CreditCardPayment may have a multiplicity of 0 . . . * and may be based on datatype MIDT:MaintenancePaymentControlCreditCardPayment. CreditCardPayment may include CreditCardPaymentAuthorisationListCompleteTransmissionIndicator, ActionCode, UUID, PaymentCardUUID, PaymentCardKey, BusinessPartnerPaymentCardDetailsKey, PaymentCardDataOriginTypeCode, PaymentCardAutomaticallyGeneratedIndicator, DeviceID, LocationInternalID, ClearingHouseAccountUUID, ClearingHouseAccountKey, PaymentCardVerificationValueText, PaymentCardVerificationValueAvailabilityCode, PaymentCardVerificationValueCheckRequiredIndicator, AuthorisationRequiredIndicator, AuthorisationLimitAmount, AuthorisationValueUnlimitedIndicator, Amount, PaymentAuthorisedAmount, and CreditCardPaymentAuthorisation. CreditCardPaymentAuthorisationListCompleteTransmissionIndicator may have a multiplicity of 0 . . . 1 and may be based on datatype CDT:Indicator. ActionCode may have a multiplicity of 0 . . . 1 and may be based on datatype BGDT:ActionCode. UUID may have a multiplicity of 0 . . . 1 and may be based on datatype BGDT:UUID. PaymentCardUUID may have a multiplicity of 0 . . . 1 and may be based on datatype BGDT:UUID. PaymentCardKey may have a multiplicity of 0 . . . 1 and may be based on datatype KDT:MaintenancePaymentControlCreditCardPaymentPaymentCardKey. BusinessPartnerPaymentCardDetailsKey may have a multiplicity of 0 . . . 1 and may be based on datatype KDT:MaintenancePaymentControlCreditCardPaymentBusinessPartnerPaymentCardDetailsKey. PaymentCardDataOriginTypeCode may have a multiplicity of 0 . . . 1 and may be based on datatype BGDT:DataOriginTypeCode. PaymentCardAutomaticallyGeneratedIndicator may have a multiplicity of 0 . . . 1 and may be based on datatype CDT:Indicator. DeviceID may have a multiplicity of 0 . . . 1 and may be based on datatype BGDT:DeviceID. LocationInternalID may have a multiplicity of 0 . . . 1 and may be based on datatype BGDT:LocationInternalID. ClearingHouseAccountUUID may have a multiplicity of 0 . . . 1 and may be based on datatype BGDT:UUID. ClearingHouseAccountKey may have a multiplicity of 0 . . . 1 and may be based on datatype KDT:MaintenancePaymentControlCreditCardPaymentClearingHouseAccountKey. PaymentCardVerificationValueText may have a multiplicity of 0 . . . 1 and may be based on datatype BGDT:PaymentCardVerificationValueText. PaymentCardVerificationValueAvailabilityCode may have a multiplicity of 0 . . . 1 and may be based on datatype BGDT:PaymentCardVerificationValueAvailabilityCode. PaymentCardVerificationValueCheckRequiredIndicator may have a multiplicity of 0 . . . 1 and may be based on datatype CDT:Indicator. AuthorisationRequiredIndicator may have a multiplicity of 0 . . . 1 and may be based on datatype CDT:Indicator. AuthorisationLimitAmount may have a multiplicity of 0 . . . 1 and may be based on datatype CDT:Amount. AuthorisationValueUnlimitedIndicator may have a multiplicity of 0 . . . 1 and may be based on datatype CDT:Indicator. Amount may have a multiplicity of 0 . . . 1 and may be based on datatype CDT:Amount. PaymentAuthorisedAmount may have a multiplicity of 0 . . . 1 and may be based on datatype CDT:Amount.

CreditCardPaymentAuthorisation may have a multiplicity of 0 . . . * and may be based on datatype MIDT:MaintenancePaymentControlCreditCardPaymentCreditCardPaymentAuthorisation. CreditCardPaymentAuthorisation may include ActionCode, UUID, ID, ClearingHouseID, ProviderID, PaymentCardHolderAuthenticationID, PaymentCardHolderAuthenticationResultCode, PaymentCardHolderAuthenticationTokenText, DateTime, PaymentCardTransactionTypeCode, PreAuthorisationIndicator, Amount, ExpirationDateTime, ActiveIndicator, AppliedIndicator, ResultCode, PaymentCardAddressVerificationResultCode, ProductRecipientPartyPaymentCardAddressVerificationResultCode, PaymentCardVerificationResultCode, PaymentCardVerificationValueVerificationResultCode, and ResultDescription. ActionCode may have a multiplicity of 0 . . . 1 and may be based on datatype BGDT:ActionCode. UUID may have a multiplicity of 0 . . . 1 and may be based on datatype BGDT:UUID. ID may have a multiplicity of 0 . . . 1 and may be based on datatype BGDT:PaymentCardPaymentAuthorisationPartyID_V1. ClearingHouseID may have a multiplicity of 0 . . . 1 and may be based on datatype BGDT:PaymentCardPaymentAuthorisationPartyID_V1. ProviderID may have a multiplicity of 0 . . . 1 and may be based on datatype BGDT:PaymentCardPaymentAuthorisationPartyID_V1. PaymentCardHolderAuthenticationID may have a multiplicity of 0 . . . 1 and may be based on datatype BGDT:PaymentCardHolderAuthenticationID. PaymentCardHolderAuthenticationResultCode may have a multiplicity of 0 . . . 1 and may be based on datatype BGDT:PaymentCardHolderAuthenticationResultCode. PaymentCardHolderAuthenticationTokenText may have a multiplicity of 0 . . . 1 and may be based on datatype BGDT: PaymentCardHolderAuthenticationTokenText. DateTime may have a multiplicity of 0 . . . 1 and may be based on datatype CDT:GLOBAL_DateTime. PaymentCardTransactionTypeCode may have a multiplicity of 0 . . . 1 and may be based on datatype BGDT:PaymentCardTransactionTypeCode. PreAuthorisationIndicator may have a multiplicity of 0 . . . 1 and may be based on datatype CDT:Indicator. Amount may have a multiplicity of 0 . . . 1 and may be based on datatype CDT:Amount. ExpirationDateTime may have a multiplicity of 0 . . . 1 and may be based on datatype CDT:GLOBAL_DateTime. ActiveIndicator may have a multiplicity of 0 . . . 1 and may be based on datatype CDT:Indicator. AppliedIndicator may have a multiplicity of 0 . . . 1 and may be based on datatype CDT:Indicator. ResultCode may have a multiplicity of 0 . . . 1 and may be based on datatype BGDT:AuthorisationResultCode. PaymentCardAddressVerificationResultCode may have a multiplicity of 0 . . . 1 and may be based on datatype BGDT:PaymentCardAddressVerificationResultCode. ProductRecipientPartyPaymentCardAddressVerificationResultCode may have a multiplicity of 0 . . . 1 and may be based on datatype BGDT:PaymentCardAddressVerificationResultCode. PaymentCardVerificationResultCode may have a multiplicity of 0 . . . 1 and may be based on datatype BGDT:PaymentCardVerificationResultCode. PaymentCardVerificationValueVerificationResultCode may have a multiplicity of 0 . . . 1 and may be based on datatype BGDT:PaymentCardVerificationValueVerificationResultCode. ResultDescription may have a multiplicity of 0 . . . 1 and may be based on datatype BGDT: SHORT_Description.

ChequePayment may have a multiplicity of 0 . . . * and may be based on datatype MIDT:MaintenancePaymentControlChequePayment. ChequePayment may include ActionCode, UUID, HouseBankAccountKey, HouseBankInternalID, and Amount. ActionCode may have a multiplicity of 0 . . . 1 and may be based on datatype BGDT:ActionCode. UUID may have a multiplicity of 0 . . . 1 and may be based on datatype BGDT:UUID. HouseBankAccountKey may have a multiplicity of 0 . . . 1 and may be based on datatype KDT:MaintenancePaymentControlChequePaymentHouseBankAccountKey. HouseBankInternalID may have a multiplicity of 0 . . . 1 and may be based on datatype BGDT:BusinessPartnerInternalID. Amount may have a multiplicity of 0 . . . 1 and may be based on datatype CDT:Amount.

The package SupplierInvoiceAttachmentFolder includes the entity AttachmentFolder. AttachmentFolder includes the following attributes: DocumentListCompleteTransmissionIndicator and ActionCode. DocumentListCompleteTransmissionIndicator may have a multiplicity of 0 . . . 1 and may be based on datatype CDT:Indicator. ActionCode may have a multiplicity of 0 . . . 1 and may be based on datatype BGDT:ActionCode. AttachmentFolder includes the non-node element UUID, which may have a multiplicity of 0 . . . 1 and which may be based on datatype BGDT:UUID. AttachmentFolder may include the node element Document in a 1:CN cardinality relationship.

The package SupplierInvoiceAttachmentFolder includes the entity Document. Document includes the following attributes: PropertyListCompleteTransmissionIndicator and ActionCode. PropertyListCompleteTransmissionIndicator may have a multiplicity of 0 . . . 1 and may be based on datatype CDT:Indicator. ActionCode may have a multiplicity of 0 . . . 1 and may be based on datatype BGDT:ActionCode. Document may include the non-node elements UUID, LinkInternalIndicator, VisibleIndicator, CategoryCode, TypeCode, MIMECode, Name, AlternativeName, InternalLinkUUID, ExternalLinkWebURI, and Description. UUID may have a multiplicity of 0 . . . 1 and may be based on datatype BGDT:UUID. LinkInternalIndicator may have a multiplicity of 0 . . . 1 and may be based on datatype CDT:Indicator. VisibleIndicator may have a multiplicity of 0 . . . 1 and may be based on datatype CDT:Indicator. CategoryCode may have a multiplicity of 0 . . . 1 and may be based on datatype BGDT:DocumentCategoryCode. TypeCode may have a multiplicity of 0 . . . 1 and may be based on datatype BGDT:DocumentTypeCode. MIMECode may have a multiplicity of 0 . . . 1 and may be based on datatype BGDT:MIMECode. Name may have a multiplicity of 0 . . . 1 and may be based on datatype CDT:LANGUAGEINDEPENDENT_Name. AlternativeName may have a multiplicity of 0 . . . 1 and may be based on datatype CDT:LANGUAGEINDEPENDENT_Name. InternalLinkUUID may have a multiplicity of 0 . . . 1 and may be based on datatype BGDT:UUID. ExternalLinkWebURI may have a multiplicity of 0 . . . 1 and may be based on datatype BGDT:WebURI. Description may have a multiplicity of 0 . . . 1 and may be based on datatype BGDT:Description.

Document includes the node element FileContent in a 1:C cardinality relationship and Property in a 1:CN cardinality relationship. FileContent includes the ActionCode attribute, which may have a multiplicity of 0 . . . 1 and may be based on datatype BGDT:ActionCode. FileContent includes the non-node elements: TechnicalID and BinaryObject. TechnicalID may have a multiplicity of 0 . . . 1 and may be based on datatype BGDT:ObjectNodeTechnicalID. BinaryObject may have a multiplicity of 0 . . . 1 and may be based on datatype CDT:BinaryObject.

Property includes the following attributes: PropertyValueListCompleteTransmissionIndicator and ActionCode. PropertyValueListCompleteTransmissionIndicator may have a multiplicity of 0 . . . 1 and may be based on datatype CDT:Indicator. ActionCode may have a multiplicity of 0 . . . 1 and may be based on datatype BGDT:ActionCode. Property includes the following non-node elements: TechnicalID, Name, DataTypeFormatCode, VisibleIndicator, ChangeAllowedIndicator, MultipleValueIndicator, NamespaceURI, and Description. TechnicalID may have a multiplicity of 0 . . . 1 and may be based on datatype BGDT:ObjectNodeTechnicalID. Name may have a multiplicity of 0 . . . 1 and may be based on datatype CDT:LANGUAGEINDEPENDENT_Name. DataTypeFormatCode may have a multiplicity of 0 . . . 1 and may be based on datatype BGDT:PropertyDataTypeFormatCode. VisibleIndicator may have a multiplicity of 0 . . . 1 and may be based on datatype CDT:Indicator. ChangeAllowedIndicator may have a multiplicity of 0 . . . 1 and may be based on datatype CDT:Indicator. MultipleValueIndicator may have a multiplicity of 0 . . . 1 and may be based on datatype CDT:Indicator. NamespaceURI may have a multiplicity of 0 . . . 1 and may be based on datatype BGDT:NamespaceURI. Description may have a multiplicity of 0 . . . 1 and may be based on datatype BGDT:Description. Property includes the PropertyValue node element in a 1:CN cardinality relationship.

PropertyValue includes the ActionCode attribute, which may have a multiplicity of 0 . . . 1 and which may be based on datatype BGDT:ActionCode. PropertyValue includes the following non-node elements: TechnicalID, Text, Indicator, DateTime, and IntegerValue. TechnicalID may have a multiplicity of 0 . . . 1 and may be based on datatype BGDT:ObjectNodeTechnicalID. Text may have a multiplicity of 0 . . . 1 and may be based on datatype CDT:LANGUAGEINDEPENDENT_Text. Indicator may have a multiplicity of 0 . . . 1 and may be based on datatype CDT:Indicator. DateTime may have a multiplicity of 0 . . . 1 and may be based on datatype CDT:GLOBAL_DateTime. IntegerValue may have a multiplicity of 0 . . . 1 and may be based on datatype BGDT:IntegerValue.

The package SupplierInvoiceTextCollection includes the entity TextCollection. TextCollection includes the following attributes: TextListCompleteTransmissionIndicator and ActionCode. TextListCompleteTransmissionIndicator may have a multiplicity of 0 . . . 1 and may be based on datatype CDT:Indicator. ActionCode may have a multiplicity of 0 . . . 1 and may be based on datatype BGDT:ActionCode. TextCollection includes the UUID non-node element, which may have a multiplicity of 0 . . . 1 and may be based on datatype BGDT:UUID. TextCollection includes the Text node element in a 1:CN cardinality relationship.

The package SupplierInvoiceTextCollection includes the entity Text. Text includes the ActionCode attribute, which may have a multiplicity of 0 . . . 1 and may be based on datatype BGDT:ActionCode. Text includes the following non-node elements: TechnicalID, TypeCode, and CreationDateTime. TechnicalID may have a multiplicity of 0 . . . 1 and may be based on datatype BGDT:ObjectNodeTechnicalID. TypeCode may have a multiplicity of 0 . . . 1 and may be based on datatype BGDT:TextCollectionTextTypeCode. CreationDateTime may have a multiplicity of 0 . . . 1 and may be based on datatype CDT:GLOBAL_DateTime. Text includes the node element TextContent in a 1:C cardinality relationship.

TextContent includes the ActionCode attribute, which may have a multiplicity of 0 . . . 1 and may be based on datatype BGDT:ActionCode. TextContent includes the following non-node elements: TechnicalID and Text. TechnicalID may have a multiplicity of 0 . . . 1 and may be based on datatype BGDT:ObjectNodeTechnicalID. Text may have a multiplicity of 0 . . . 1 and may be based on datatype CDT:Text.

The package SupplierInvoiceItem includes the sub-packages ProductInformation, AccountingCodingBlockDistribution, Tax, BusinessTransactionDocumentReference, Party, Location, AttachmentFolder, and TextCollection, and the entity Item. Item includes the ActionCode attribute, which may have a multiplicity of 0 . . . 1 and may be based on datatype BGDT:ActionCode. Item includes the following non-node elements: ObjectNodeSenderTechnicalID, BusinessTransactionDocumentItemTypeCode, Quantity, QuantityTypeCode, SHORT_Description, NetAmount, NetUnitPrice, GrossAmount, GrossUnitPrice, CostDistributionIndicator. ObjectNodeSenderTechnicalID may have a multiplicity of 0 . . . 1 and may be based on datatype BGDT:ObjectNodePartyTechnicalID. BusinessTransactionDocumentItemTypeCode may have a multiplicity of 1 and may be based on datatype BGDT:BusinessTransactionDocumentItemTypeCode. Quantity may have a multiplicity of 0 . . . 1 and may be based on datatype CDT:Quantity. QuantityTypeCode may have a multiplicity of 0 . . . 1 and may be based on datatype BGDT:QuantityTypeCode. SHORT_Description may have a multiplicity of 0 . . . 1 and may be based on datatype BGDT:SHORT_Description. NetAmount may have a multiplicity of 0 . . . 1 and may be based on datatype CDT:Amount. NetUnitPrice may have a multiplicity of 0 . . . 1 and may be based on datatype AGDT:Price. GrossAmount may have a multiplicity of 0 . . . 1 and may be based on datatype CDT:Amount. GrossUnitPrice may have a multiplicity of 0 . . . 1 and may be based on datatype AGDT:Price. CostDistributionIndicator may have a multiplicity of 0 . . . 1 and may be based on datatype CDT:Indicator. Item includes the following node elements: Product, in a 1:C cardinality relationship, AccountingCodingBlockDistribution, in a 1:C cardinality relationship, ProductTax, in a 1:C cardinality relationship, PurchaseOrderReference, in a 1:C cardinality relationship, PurchasingContractReference, in a 1:C cardinality relationship, ProcurementReleaseOrderReference, in a 1:C cardinality relationship, ServicePerformerParty, in a 1:C cardinality relationship, RequestorParty, in a 1:C cardinality relationship, ProductRecipientParty, in a 1:C cardinality relationship, EndBuyerParty, in a 1:C cardinality relationship, InternalChargeToParty, in a 1:C cardinality relationship, ShipToLocation, in a 1:C cardinality relationship, ShipFromLocation, in a 1:C cardinality relationship, MaintenanceAttachmentFolder, in a 1:C cardinality relationship, and MaintenanceTextCollection, in a 1:C cardinality relationship. The package SupplierInvoiceItemProductInformation includes the entity Product. Product includes the actionCode attribute, which may have a multiplicity of 0 . . . 1 and may be based on datatype BGDT:ActionCode. Product includes the following non-node elements:

ObjectNodePartyTechnicalID, ProductStandardID, ProductCategoryStandardID, CashDiscountDeductibleIndicator, ProductCategoryIDKey, and ProductKey. ObjectNodePartyTechnicalID may have a multiplicity of 0 . . . 1 and may be based on datatype BGDT:ObjectNodePartyTechnicalID. ProductStandardID may have a multiplicity of 0 . . . 1 and may be based on datatype BGDT:ProductStandardID. ProductCategoryStandardID may have a multiplicity of 0 . . . 1 and may be based on datatype BGDT:ProductCategoryStandardID. CashDiscountDeductibleIndicator may have a multiplicity of 1 and may be based on datatype CDT:Indicator. ProductCategoryIDKey may have a multiplicity of 0 . . . 1 and may be based on datatype KDT:ProductCategoryHierarchyProductCategoryIDKey. ProductKey may have a multiplicity of 0 . . . 1 and may be based on datatype KDT:ProductKey.

The package SupplierInvoiceItemAccountingCodingBlockDistribution includes the entity AccountingCodingBlockDistribution. AccountingCodingBlockDistribution includes the following attributes: AccountingCodingBlockAssignmentListCompleteTransmissionIndicator and ActionCode. AccountingCodingBlockAssignmentListCompleteTransmissionIndicator may have a multiplicity of 0 . . . 1 and may be based on datatype CDT:Indicator. ActionCode may have a multiplicity of 0 . . . 1 and may be based on datatype BGDT:ActionCode. AccountingCodingBlockDistribution includes the following non-node elements: UUID, ValidityDate, CompanyID, IdentityID, LanguageCode, TemplateIndicator, GeneralLedgerAccountAliasCode, GeneralLedgerAccountAliasContextCodeElements, GeneralLedgerAccountAliasContextCodeElementsUsageName, HostObjectTypeCode, TotalAmount, and TotalQuantity. UUID may have a multiplicity of 0 . . . 1 and may be based on datatype BGDT:UUID. ValidityDate may have a multiplicity of 0 . . . 1 and may be based on datatype CDT:Date. CompanyID may have a multiplicity of 0 . . . 1 and may be based on datatype BGDT:OrganisationalCentreID. IdentityID may have a multiplicity of 0 . . . 1 and may be based on datatype BGDT:IdentityID. LanguageCode may have a multiplicity of 0 . . . 1 and may be based on datatype BGDT:LanguageCode. TemplateIndicator may have a multiplicity of 0 . . . 1 and may be based on datatype CDT:Indicator. GeneralLedgerAccountAliasCode may have a multiplicity of 0 . . . 1 and may be based on datatype BGDT:GeneralLedgerAccountAliasCode. GeneralLedgerAccountAliasContextCodeElements may have a multiplicity of 0 . . . 1 and may be based on datatype DT:GeneralLedgerAccountAliasCodeContextElements. GeneralLedgerAccountAliasContextCodeElementsUsageName may have a multiplicity of 0 . . . 1 and may be based on datatype CDT:LANGUAGEINDEPENDENT_LONG_Name. HostObjectTypeCode may have a multiplicity of 0 . . . 1 and may be based on datatype BGDT:ObjectTypeCode. TotalAmount may have a multiplicity of 0 . . . 1 and may be based on datatype CDT:Amount. TotalQuantity may have a multiplicity of 0 . . . 1 and may be based on datatype CDT:Quantity. AccountingCodingBlockDistribution includes the node element AccountingCodingBlockAssignment in a 1:CN cardinality relationship. The package SupplierInvoiceltemAccountingCodingBlockDistribution includes the entity AccountingCodingBlockAssignment. AccountingCodingBlockAssignment includes the ActionCode attribute, which may have a multiplicity of 0 . . . 1 and may be based on datatype BGDT:ActionCode. AccountingCodingBlockDistribution includes the following non-node elements: TechnicalID, Percent, Amount, Quantity, AccountingCodingBlockTypeCode, AccountDeterminationExpenseGroupCode, GeneralLedgerAccountAliasCode, ProfitCentreID, ProfitCentreUUID, CostCentreID, CostCentreUUID, IndividualMaterialKey, IndividualMaterialUUID, ProjectTaskKey, ProjectReference, ProjectReferenceProjectElementTypeName, SalesOrderReference, SalesOrderReferenceTypeName, SalesOrderReferenceltemTypeName, SalesOrderName, SalesOrderhemDescription, ServiceOrderReference, ServiceOrderReferenceTypeName, ServiceOrderReferenceItemTypeName, ServiceOrderName, and ServiceOrderItemDescription.

TechnicalID may have a multiplicity of 0 . . . 1 and may be based on datatype BGDT:ObjectNodeTechnicalID. Percent may have a multiplicity of 0 . . . 1 and may be based on datatype CDT:Percent. Amount may have a multiplicity of 0 . . . 1 and may be based on datatype CDT:Amount. Quantity may have a multiplicity of 0 . . . 1 and may be based on datatype CDT:Quantity. AccountingCodingBlockTypeCode may have a multiplicity of 0 . . . 1 and may be based on datatype BGDT:AccountingCodingBlockTypeCode. AccountDeterminationExpenseGroupCode may have a multiplicity of 0 . . . 1 and may be based on datatype BGDT:AccountDeterminationExpenseGroupCode. GeneralLedgerAccountAliasCode may have a multiplicity of 0 . . . 1 and may be based on datatype BGDT: GeneralLedgerAccountAliasCode. ProfitCentreID may have a multiplicity of 0 . . . 1 and may be based on datatype BGDT:OrganisationalCentreID. ProfitCentreUUID may have a multiplicity of 0 . . . 1 and may be based on datatype BGDT:UUID. CostCentreID may have a multiplicity of 0 . . . 1 and may be based on datatype BGDT:OrganisationalCentreID. CostCentreUUID may have a multiplicity of 0 . . . 1 and may be based on datatype BGDT:UUID. IndividualMaterialKey may have a multiplicity of 0 . . . 1 and may be based on datatype KDT:MaintenanceAccountingCodingBlockDistributionAccountingCodingBlockAssignmentIndividualMaterialKey. IndividualMaterialUUID may have a multiplicity of 0 . . . 1 and may be based on datatype BGDT:UUID. ProjectTaskKey may have a multiplicity of 0 . . . 1 and may be based on datatype KDT:MaintenanceAccountingCodingBlockDistributionAccountingCodingBlockAssignment ProjectTaskKey. ProjectReference may have a multiplicity of 0 . . . 1 and may be based on datatype AGDT:ProjectReference. ProjectReferenceProjectElementTypeName may have a multiplicity of 0 . . . 1 and may be based on datatype CDT:LANGUAGEINDEPENDENT_LONG_Name. SalesOrderReference may have a multiplicity of 0 . . . 1 and may be based on datatype AGDT:BusinessTransactionDocumentReference. SalesOrderReferenceTypeName may have a multiplicity of 0 . . . 1 and may be based on datatype CDT:LANGUAGEINDEPENDENT_LONG_Name. SalesOrderReferenceltemTypeName may have a multiplicity of 0 . . . 1 and may be based on datatype CDT:LANGUAGEINDEPENDENT_LONG_Name. SalesOrderName may have a multiplicity of 0 . . . 1 and may be based on datatype CDT:EXTENDED_Name. SalesOrderItemDescription may have a multiplicity of 0 . . . 1 and may be based on datatype BGDT:SHORT_Description. ServiceOrderReference may have a multiplicity of 0 . . . 1 and may be based on datatype AGDT:BusinessTransactionDocumentReference. ServiceOrderReferenceTypeName may have a multiplicity of 0 . . . 1 and may be based on datatype CDT:LANGUAGEINDEPENDENT_LONG_Name. ServiceOrderReferenceItemTypeName may have a multiplicity of 0 . . . 1 and may be based on datatype CDT:LANGUAGEINDEPENDENT_LONG_Name. ServiceOrderName may have a multiplicity of 0 . . . 1 and may be based on datatype CDT:EXTENDED_Name. ServiceOrderItemDescription may have a multiplicity of 0 . . . 1 and may be based on datatype BGDT: SHORT_Description.

The package SupplierInvoiceItemTax includes the entity ProductTax. ProductTax includes the actionCode attribute, which may have a multiplicity of 0 . . . 1 and may be based on datatype BGDT:ActionCode. ProductTax includes the following non-node elements: ObjectNodePartyTechnicalID, ProductTaxationCharacteristicsCode, WithholdingTaxationCharacteristicsCode, and CountryCode. ObjectNodePartyTechnicalID may have a multiplicity of 0 . . . 1 and may be based on datatype BGDT:ObjectNodePartyTechnicalID. ProductTaxationCharacteristicsCode may have a multiplicity of 0 . . . 1 and may be based on datatype BGDT:ProductTaxationCharacteristicsCode. WithholdingTaxationCharacteristicsCode may have a multiplicity of 0 . . . 1 and may be based on datatype BGDT:WithholdingTaxationCharacteristicsCode. CountryCode may have a multiplicity of 0 . . . 1 and may be based on datatype BGDT:CountryCode.

The package SupplierInvoiceItemBusinessTransactionDocumentReference includes the entities PurchaseOrderReference, PurchasingContractReference, and ProcurementReleaseOrderReference. PurchaseOrderReference includes the actionCode attribute, which may have a multiplicity of 0 . . . 1 and may be based on datatype BGDT:ActionCode. PurchaseOrderReference includes the following non-node elements: ObjectNodePartyTechnicalID and BusinessTransactionDocumentReference. ObjectNodePartyTechnicalID may have a multiplicity of 0 . . . 1 and may be based on datatype BGDT:ObjectNodePartyTechnicalID. BusinessTransactionDocumentReference may have a multiplicity of 0 . . . 1 and may be based on datatype AGDT:BusinessTransactionDocumentReference.

PurchasingContractReference includes the actionCode attribute, which may have a multiplicity of 0 . . . 1 and may be based on datatype BGDT:ActionCode. PurchasingContractReference includes the following non-node elements: ObjectNodePartyTechnicalID and BusinessTransactionDocumentReference. ObjectNodePartyTechnicalID may have a multiplicity of 0 . . . 1 and may be based on datatype BGDT:ObjectNodePartyTechnicalID. BusinessTransactionDocumentReference may have a multiplicity of 0 . . . 1 and may be based on datatype AGDT:BusinessTransactionDocumentReference.

ProcurementReleaseOrderReference includes the actionCode attribute, which may have a multiplicity of 0 . . . 1 and may be based on datatype BGDT:ActionCode. ProcurementReleaseOrderReference includes the following non-node elements: ObjectNodePartyTechnicalID and BusinessTransactionDocumentReference. ObjectNodePartyTechnicalID may have a multiplicity of 0 . . . 1 and may be based on datatype BGDT:ObjectNodePartyTechnicalID. BusinessTransactionDocumentReference may have a multiplicity of 0 . . . 1 and may be based on datatype AGDT:BusinessTransactionDocumentReference.

The package SupplierInvoiceItemParty includes the entities ServicePerformerParty, RequestorParty, ProductRecipientParty, EndBuyerParty and InternalChargeToParty. ServicePerformerParty includes the actionCode attribute, which may have a multiplicity of 0 . . . 1 and may be based on datatype BGDT:ActionCode. ServicePerformerParty includes the following non-node elements: ObjectNodePartyTechnicalID and PartyKey. ObjectNodePartyTechnicalID may have a multiplicity of 0 . . . 1 and may be based on datatype BGDT:ObjectNodePartyTechnicalID. PartyKey may have a multiplicity of 0 . . . 1 and may be based on datatype KDT:PartyKey.

RequestorParty includes the actionCode attribute, which may have a multiplicity of 0 . . . 1 and may be based on datatype BGDT:ActionCode. RequestorParty includes the following non-node elements: ObjectNodePartyTechnicalID and PartyKey. ObjectNodePartyTechnicalID may have a multiplicity of 0 . . . 1 and may be based on datatype BGDT:ObjectNodePartyTechnicalID. PartyKey may have a multiplicity of 0 . . . 1 and may be based on datatype KDT:PartyKey.

ProductRecipientParty includes the actionCode attribute, which may have a multiplicity of 0 . . . 1 and may be based on datatype BGDT:ActionCode. ProductRecipientParty includes the following non-node elements: ObjectNodePartyTechnicalID and PartyKey. ObjectNodePartyTechnicalID may have a multiplicity of 0 . . . 1 and may be based on datatype BGDT:ObjectNodePartyTechnicalID. PartyKey may have a multiplicity of 0 . . . 1 and may be based on datatype KDT:PartyKey.

EndBuyerParty includes the actionCode attribute, which may have a multiplicity of 0 . . . 1 and may be based on datatype BGDT:ActionCode. EndBuyerParty includes the following non-node elements: ObjectNodePartyTechnicalID and PartyKey. ObjectNodePartyTechnicalID may have a multiplicity of 0 . . . 1 and may be based on datatype BGDT:ObjectNodePartyTechnicalID. PartyKey may have a multiplicity of 0 . . . 1 and may be based on datatype KDT:PartyKey.

InternalChargeToParty includes the actionCode attribute, which may have a multiplicity of 0 . . . 1 and may be based on datatype BGDT:ActionCode. InternalChargeToParty includes the following non-node elements: ObjectNodePartyTechnicalID and PartyKey. ObjectNodePartyTechnicalID may have a multiplicity of 0 . . . 1 and may be based on datatype BGDT:ObjectNodePartyTechnicalID. PartyKey may have a multiplicity of 0 . . . 1 and may be based on datatype KDT:PartyKey.

The package SupplierInvoiceItemLocation includes the entities ShipToLocation and ShipFromLocation. ShipToLocation includes the actionCode attribute, which may have a multiplicity of 0 . . . 1 and may be based on datatype BGDT:ActionCode. ShipToLocation includes the following non-node elements: ObjectNodePartyTechnicalID and LocationID. ObjectNodePartyTechnicalID may have a multiplicity of 0 . . . 1 and may be based on datatype BGDT:ObjectNodePartyTechnicalID. LocationID may have a multiplicity of 0 . . . 1 and may be based on datatype BGDT:LocationID.

ShipFromLocation includes the actionCode attribute, which may have a multiplicity of 0 . . . 1 and may be based on datatype BGDT:ActionCode. ShipFromLocation includes the following non-node elements: ObjectNodePartyTechnicalID and LocationID. ObjectNodePartyTechnicalID may have a multiplicity of 0 . . . 1 and may be based on datatype BGDT:ObjectNodePartyTechnicalID. LocationID may have a multiplicity of 0 . . . 1 and may be based on datatype BGDT:LocationID.

The package SupplierInvoiceltemAttachmentFolder includes the entity MaintenanceAttachmentFolder. MaintenanceAttachmentFolder includes the following attributes: DocumentListCompleteTransmissionIndicator, and ActionCode. DocumentListCompleteTransmissionIndicator may have a multiplicity of 0 . . . 1 and may be based on datatype CDT:Indicator. ActionCode may have a multiplicity of 0 . . . 1 and may be based on datatype BGDT:ActionCode. MaintenanceAttachmentFolder includes the UUID non-node element, which may have a multiplicity of 0 . . . 1 and may be based on datatype BGDT:UUID. MaintenanceAttachmentFolder includes the Document node element in a 1:CN cardinality relationship.

The package SupplierInvoiceltemAttachmentFolder includes the entity Document. Document includes the following attributes: PropertyListCompleteTransmissionIndicator and ActionCode. PropertyListCompleteTransmissionIndicator may have a multiplicity of 0 . . . 1 and may be based on datatype CDT:Indicator. ActionCode may have a multiplicity of 0 . . . 1 and may be based on datatype BGDT:ActionCode. Document includes the following non-node elements: UUID, LinkInternalIndicator, VisibleIndicator, CategoryCode, TypeCode, MIMECode, Name, AlternativeName, InternalLinkUUID, ExternalLinkWebURI, and Description. UUID may have a multiplicity of 0 . . . 1 and may be based on datatype BGDT:UUID. LinkInternalIndicator may have a multiplicity of 0 . . . 1 and may be based on datatype CDT:Indicator. VisibleIndicator may have a multiplicity of 0 . . . 1 and may be based on datatype CDT:Indicator. CategoryCode may have a multiplicity of 0 . . . 1 and may be based on datatype BGDT:DocumentCategoryCode. TypeCode may have a multiplicity of 0 . . . 1 and may be based on datatype BGDT:DocumentTypeCode. MIMECode may have a multiplicity of 0 . . . 1 and may be based on datatype BGDT:MIMECode. Name may have a multiplicity of 0 . . . 1 and may be based on datatype CDT:LANGUAGEINDEPENDENT_Name. AlternativeName may have a multiplicity of 0 . . . 1 and may be based on datatype CDT:LANGUAGEINDEPENDENT_Name. InternalLinkUUID may have a multiplicity of 0 . . . 1 and may be based on datatype BGDT:UUID. ExternalLinkWebURI may have a multiplicity of 0 . . . 1 and may be based on datatype BGDT:WebURI. Description may have a multiplicity of 0 . . . 1 and may be based on datatype BGDT:Description. Document includes the following node elements: FileContent, in a 1:C cardinality relationship, and Property, in a 1:CN cardinality relationship.

FileContent includes the ActionCode attribute, which may have a multiplicity of 0 . . . 1 and may be based on datatype BGDT:ActionCode. FileContent includes the following non-node elements: TechnicalID and BinaryObject. TechnicalID may have a multiplicity of 0 . . . 1 and may be based on datatype BGDT:ObjectNodeTechnicalID. BinaryObject may have a multiplicity of 0 . . . 1 and may be based on datatype CDT:BinaryObject.

Property includes the following attributes: PropertyValueListCompleteTransmissionIndicator and ActionCode. PropertyValueListCompleteTransmissionIndicator may have a multiplicity of 0 . . . 1 and may be based on datatype CDT:Indicator. ActionCode may have a multiplicity of 0 . . . 1 and may be based on datatype BGDT:ActionCode. Property includes the following non-node elements: TechnicalID, Name, DataTypeFormatCode, VisibleIndicator, ChangeAllowedIndicator, MultipleValueIndicator, NamespaceURI, and Description. TechnicalID may have a multiplicity of 0 . . . 1 and may be based on datatype BGDT:ObjectNodeTechnicalID. Name may have a multiplicity of 0 . . . 1 and may be based on datatype CDT:LANGUAGEINDEPENDENT_Name. DataTypeFormatCode may have a multiplicity of 0 . . . 1 and may be based on datatype BGDT:PropertyDataTypeFormatCode. VisibleIndicator may have a multiplicity of 0 . . . 1 and may be based on datatype CDT:Indicator. ChangeAllowedIndicator may have a multiplicity of 0 . . . 1 and may be based on datatype CDT:Indicator. MultipleValueIndicator may have a multiplicity of 0 . . . 1 and may be based on datatype CDT:Indicator. NamespaceURI may have a multiplicity of 0 . . . 1 and may be based on datatype BGDT:NamespaceURI. Description may have a multiplicity of 0 . . . 1 and may be based on datatype BGDT:Description. Property includes the node element PropertyValue in a 1:CN cardinality relationship.

PropertyValue includes the ActionCode attribute, which may have a multiplicity of 0 . . . 1 and may be based on datatype BGDT:ActionCode. PropertyValue includes the following non-node elements: TechnicalID, Text, Indicator, DateTime, and IntegerValue. TechnicalID may have a multiplicity of 0 . . . 1 and may be based on datatype BGDT:ObjectNodeTechnicalID. Text may have a multiplicity of 0 . . . 1 and may be based on datatype CDT:LANGUAGEINDEPENDENT_Text. Indicator may have a multiplicity of 0 . . . 1 and may be based on datatype CDT:Indicator. DateTime may have a multiplicity of 0 . . . 1 and may be based on datatype CDT:GLOBAL_DateTime. IntegerValue may have a multiplicity of 0 . . . 1 and may be based on datatype BGDT:IntegerValue.

The package SupplierInvoiceItemTextCollection includes the entity MaintenanceTextCollection. MaintenanceTextCollection includes the following attributes: TextListCompleteTransmissionIndicator and ActionCode. TextListCompleteTransmissionIndicator may have a multiplicity of 0 . . . 1 and may be based on datatype CDT:Indicator. ActionCode may have a multiplicity of 0 . . . 1 and may be based on datatype BGDT:ActionCode. MaintenanceTextCollection includes the UUID non-node element, which may have a multiplicity of 0 . . . 1 and may be based on datatype BGDT:UUID.

MaintenanceTextCollection includes the node element Text in a 1:CN cardinality relationship. The package SupplierInvoiceItemTextCollection includes the entity Text.

Text includes the ActionCode attribute, which may have a multiplicity of 0 . . . 1 and may be based on datatype BGDT:ActionCode. Text includes the following non-node elements: TechnicalID, TypeCode, and CreationDateTime. TechnicalID may have a multiplicity of 0 . . . 1 and may be based on datatype BGDT:ObjectNodeTechnicalID. TypeCode may have a multiplicity of 0 . . . 1 and may be based on datatype BGDT:TextCollectionTextTypeCode. CreationDateTime may have a multiplicity of 0 . . . 1 and may be based on datatype CDT:GLOBAL_DateTime. Text includes the node element TextContent in a 1:C cardinality relationship.

TextContent includes the ActionCode attribute, which may have a multiplicity of 0 . . . 1 and may be based on datatype BGDT:ActionCode. TextContent includes the following non-node elements: TechnicalID and Text. TechnicalID may have a multiplicity of 0 . . . 1 and may be based on datatype BGDT:ObjectNodeTechnicalID. Text may have a multiplicity of 0 . . . 1 and may be based on datatype CDT:Text.

FIGS. 41-1 through 41-83 show an example configuration of an Element Structure that includes a SupplierInvoiceBundleMaintainRequest_sync 410000 node element grouping. Specifically, these figures depict the arrangement and hierarchy of various components such as one or more levels of node element groupings, entities, and datatypes, shown here as 410000 through 412650. As described above, node element groupings may be used to represent hierarchy levels. Entities are discrete business elements that are used during a business transaction. Data types are used to type object entities and interfaces with a structure. For example, the SupplierInvoiceBundleMaintainRequest_sync 410000 includes, among other things, a SupplierInvoiceBundleMaintainRequest_sync 410002. Accordingly, heterogeneous applications may communicate using this consistent message configured as such.

The table shown in the figures presents a hierarchical representation of elements that are included in the message represented by the SupplierInvoiceBundleMaintainRequest_sync 410000 node element grouping. The structure of the table is similar to the table structure described above with reference to FIGS. 33-1 through 33-3. The full details of the example configuration of the Element Structure found in FIGS. 41-1 through 41-83 can be derived from a review of the corresponding figures. For example, first-level packages (in the second “Node Element Grouping” column) include packages 410006 through 410014, second-level packages include packages 410106 through 411542, and third-level packages include packages 411616 through 412572. Level 1 components include the entity 410002. Level 2 components include elements and attributes 410008 through 410016. Level 3 components include elements and attributes 410022 through 411544. Level 4 components include elements and attributes 410010 through 412574. Level 5 components include elements and attributes 410158 through 412598. Level 6 components include elements and attributes 410602 through 412628. Level 7 components include elements and attributes 411426 through 412646. Level 8 components include elements and attributes 412536 through 412566. Cardinality components include cardinalities 410010 through 412648. Data Type Name components include data types 410004 through 412650.

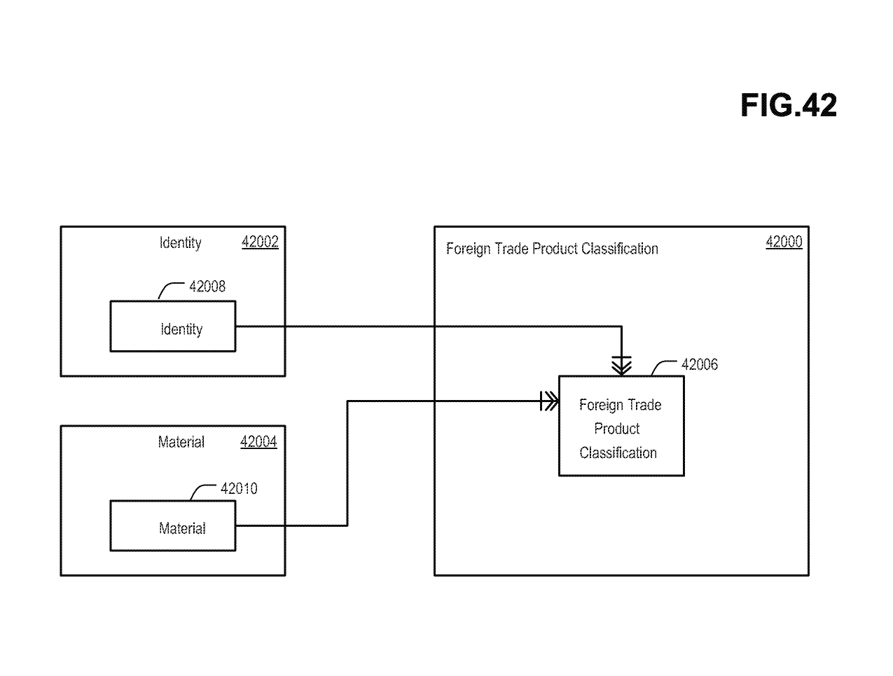

FIG. 42 illustrates an example object model for a Foreign Trade Product Classification business object 42000. Some details of the business object are described in detail on pages 68-94 in previously-filed U.S. patent application Ser. No. 12/815,911, entitled “Managing Consistent Interfaces for Foreign Trade Commodity Catalog and Foreign Trade Product Classification Business Objects across Heterogeneous Systems”, filed on Jun. 15, 2010, and is hereby incorporated by reference. Referring to FIG. 42, the object model depicts interactions among various components of the Foreign Trade Product Classification business object 42000, as well as external components that interact with the Foreign Trade Product Classification business object 42000 (shown here as 42002 through 42004 and 42008 through 42010). The Foreign Trade Product Classification business object 42000 includes entity 42006. Entity 42006 can correspond to packages and/or entities in the message data types described below.

The business object Foreign Trade Product Classification is a classification of products for foreign trade purposes and may include codes used by authorities which are assigned to a product for identifying goods traded by a company. Products that are not relevant for classification may also be included, but are marked as such. The business object Foreign Trade Product Classification belongs to the process component Foreign Trade Product Classification. Codes may be provided by authorities and each code may represent a specific group of goods. In declarations for foreign trade processes or in Intrastat declarations, these codes may be used to categorize available goods in a market and make information about the goods comparable. In some implementations, if RelevanceIndicator is not set, no classification is necessary. The Foreign Trade Product Classification includes the a main Root component, a unique identifier, a product key of a product, and a Commodity Code that the product is assigned to. The business object Foreign Trade Product Classification represents an assignment of required codes to trade products. Any product which is included in a foreign trade declaration, Intrastat declaration, or import declaration and which is transmitted to an authority may be classified using a relevant commodity or tariff code.

The elements located directly at the node Foreign Trade Product Classification are defined by the datatype ForeignTradeProductClassificationElements. These elements include: UUID, ProductUUID, ProductKey, ProductTypeCode, ProductIdentifierTypeCode, ProductID, CommodityCatalogueTypeCode, ValidityStartDate, CustomsCommodityClassificationCode, ClassificationRelevanceIndicator, and SystemAdministrativeData. UUID may be an alternative key, is an internally assigned universally unique identifier of a Foreign Trade Product Classification, and may be based on datatype GDT: UUID. ProductUUID is a universally unique identifier of a product that is assigned to a certain Customs Commodity Classification Code, and may be based on datatype GDT: UUID. ProductKey is a key of a product that is assigned to a certain Customs Commodity Classification Code, and may be based on datatype KDT: ProductKey. ProductTypeCode is a coded representation of a product type, such as a material or service, and may be based on datatype GDT: ProductTypeCode. ProductIdentifierTypeCode is a coded representation of a product identifier type, and may be based on datatype GDT: ProductIdentifierTypeCode. ProductID is an identifier for a product, and may be based on datatype GDT: ProductID. CommodityCatalogueTypeCode is a type of catalogue as defined by an authority or a standardization organisation, and may be based on datatype GDT: CommodityCatalogueTypeCode. ValidityStartDate is a date onward from which a product classification is valid, and may be based on datatype GDT: Date. CustomsCommodityClassificationCode may be optional, is a commodity code as defined by an authority or a standardization organisation, and may be based on datatype GDT: CustomsCommodityClassificationCode. ClassificationRelevanceIndicator may be optional, indicates whether a Product needs to be classified assigned to a CommodityCode, and may be based on datatype GDT: Indicator, with a qualifier of Relevance. SystemAdministrativeData includes administrative data recorded by a system, such as system user and change times, and may be based on datatype GDT: SystemAdministrativeData. A Material inbound aggregation relationship from the business object Material/node Material may exist, with a cardinality of 1:CN, which specifies a material identification product number. A Last Change Identity inbound association relationship may exist from the business object Identity/node Identity, with a cardinality of 1:CN, which specifies an identity of the user who did a last change of a Foreign Trade Product Classification. A Creation Identity inbound association relationship may exist from the business object Identity/node Identity, with a cardinality of 1:CN, which specifies an identity of the user who has created a Foreign Trade Product Classification. A CommodityCatalogueItem specialization association for navigation may exist to business object ForeignTradeCommodityCatalogue/Node Item. In some implementations, when taking the CatalogueType and the ValidityStartDate from the business object ForeignTradeProductClassification, the business object ForeignTradeCommodityCatalogueUsageSpecification is read, such as to retrieve the UUID of a catalogue that was valid at a time of the ValidityStartDate of a Classification. Then, the business object ForeignTradeCommodityCatalouge may be read, an item may be navigated to using the CustomsCommodityClassificationCode used in the business object ForeignTradeProductClassification to retrieve additional information such as the MeasureUnitForAuthorityCode and text-collection elements, assigned to the item.

The business object Foreign Trade Product Classification may be associated with a Select All query and with a Query by Elements query. The Select All query provides the to NodeIDs of all instances of a node and may be used to enable an initial load of data for a Fast Search Infrastructure. The Query by Elements query provides a list of classified products that correspond to search criteria a user has specified. The query elements for the Query by Elements query are defined by the datatype ForeignTradeProductClassificationElementsQueryElements. These elements include: UUID, ProductUUID, ProductKey, ProductTypeCode, ProductIdentifierTypeCode, ProductID, CommodityCatalogueTypeCode, ValidityStartDate, CustomsCommodityClassificationCode, RelevanceIndicator, SystemAdministrativeData, CreationDateTime, CreationIdentityUUID, CreationIdentityID, CreationIdentityBusinessPartnerinternalID, CreationIdentityBusinessPartnerPersonFamilyName, CreationIdentityBusinessPartnerPersonGivenName, CreationIdentityEmployeeID, LastChangeDateTime, LastChangeIdentityUUID, LastChangeIdentityID, LastChangeIdentityBusinessPartnerInternalID, LastChangeIdentityBusinessPartnerPersonFamilyName, LastChangeIdentityBusinessPartnerPersonGivenName, and LastChangeIdentityEmployeeID. UUID may be optional, and may be based on datatype GDT: UUID. ProductUUID may be optional, and may be based on datatype GDT: UUID. ProductKey may be optional, and may be based on datatype KDT: ProductKey. ProductTypeCode is a coded representation of a product type such as a material or service, and may be based on datatype GDT: ProductTypeCode. ProductIdentifierTypeCode is a coded representation of a product identifier type, and may be based on datatype GDT: ProductIdentifierTypeCode. ProductID is an identifier for a product, and may be based on datatype GDT: ProductID. CommodityCatalogueTypeCode may be optional, and may be based on datatype GDT: CommodityCatalogueTypeCode. ValidityStartDate may be optional, and may be based on datatype GDT: Date, with a qualifier of ValidityStart. CustomsCommodityClassificationCode may be optional, and may be based on datatype GDT: CustomsCommodityClassificationCode. RelevanceIndicator may be optional, and may be based on datatype GDT: Indicator, with a qualifier of Relevance. SystemAdministrativeData may be optional, and may be based on datatype QueryIDT: QueryElementSystemAdministrativeData. CreationDateTime may be optional, is a point in time that a goods tag is created, and may be based on datatype GDT: GLOBAL_DateTime. CreationIdentityUUID may be optional, is a globally unique identifier for a person who performed a creation, and may be based on datatype GDT: UUID. CreationIdentityID may be optional, is an identifier for a person who performed a creation, and may be based on datatype GDT: IdentityID. CreationIdentityBusinessPartnerinternalID may be optional, is a proprietary identifier for a business partner that is attributed to a creation identity and that can be reached following the relationships of the creation identity, and may be based on datatype GDT: BusinessPartnerInternalID. CreationIdentityBusinessPartnerPersonFamilyName may be optional, is a family name of a business partner of a category person that is attributed to a creation identity and that can be reached following the relationships of the creation identity, and may be based on datatype GDT: LANGUAGEINDEPENDENT_MEDIUM_Name. CreationIdentityBusinessPartnerPersonGivenName may be optional, is a given name of a business partner of a category person that is attributed to a creation identity and that can be reached following the relationships of the creation identity, and may be based on datatype GDT: LANGUAGEINDEPENDENT_MEDIUM_Name. CreationIdentityEmployeeID may be optional, is an identifier for an employee that is attributed to a creation identity and that can be reached following the relationships of the creation identity, and may be based on datatype GDT: EmployeeID. LastChangeDateTime may be optional, is a point in time date and time stamp of a last change, and may be based on datatype GDT: GLOBAL_DateTime. LastChangeIdentityUUID may be optional, is a globally unique identifier for an identity who made last changes, and may be based on datatype GDT: UUID. LastChangeIdentityID may be optional, is an identifier for an identity who made last changes, and may be based on datatype GDT: IdentityID. LastChangeIdentityBusinessPartnerinternalID may be optional, is a proprietary identifier for a business partner that is attributed to a last change identity and that can be reached following the relationships of the last change identity, and may be based on datatype GDT: BusinessPartnerInternalID. LastChangeIdentityBusinessPartnerPersonFamilyName may be optional, is a family name of a business partner of a category person that is attributed to a last change identity and that can be reached following the relationships of the last change identity, and may be based on datatype GDT: LANGUAGEINDEPENDENT_MEDIUM_Name. LastChangeIdentityBusinessPartnerPersonGivenName may be optional, is a given name of a business partner of a category person that is attributed to a last change identity and that can be reached following the relationships of the last change identity, and may be based on datatype GDT: LANGUAGEINDEPENDENT_MEDIUM_Name. LastChangeIdentityEmployeeID may be optional, is an identifier for an employee that is attributed to a last change identity and that can be reached following the relationships of the last change identity, and may be based on datatype GDT: EmployeeID.

FIGS. 43-1 through 43-12 collectively illustrate an example object model for a Supplier Invoice business object 284028. Some details of the business object are described in detail on pages 4204-4259 in previously-filed U.S. patent application Ser. No. 11/803,178, entitled “Consistent Set of Interfaces Derived From a Business Object Model”, filed on May 11, 2007, and is hereby incorporated by reference. The object model depicts interactions among various components of the Supplier Invoice business object 284028, as well as external components that interact with the Supplier Invoice business object 284028 (shown here as 284000 through 284026 and 284030 through 284084). The Supplier Invoice business object 284028 includes elements 284086 through 284146. The elements 284086 through 284146 can be hierarchical, as depicted. For example, the item entity 284088 hierarchically includes entities 284092 through 284096. Some or all of the entities 284086 through 284146 can correspond to packages and/or entities in the message data types described below.

Business Object SupplierInvoice can be a recipient's (usually purchaser's) obligation to pay a supplier for goods received or services rendered. An invoice may be created after goods and service acknowledgment has been confirmed. A business object SupplierInvoice may be derived from a Procurement Document Template. A Business Object SupplierInvoice can be part of a Process Component Supplier Invoice Processing and a Deployable Unit Supplier Invoicing. A Business Object SupplierInvoice may be represented by root node SupplierInvoice and its associations.

A Business Object may be involved in the following Process Integration Models: Internal Request Processing_Supplier Invoice Processing, Customer Invoice Processing at Supplier_Supplier Invoice Processing, Document Inbound Service_Supplier Invoice Processing, Supplier Invoice Processing_Accounting, Supplier Invoice Processing_Due Item Processing, Supplier Invoice Processing_Customer Invoice Processing, and/or Supplier Invoice Processing_Purchasing Contract Processing. Service Interface Invoicing In (B2B) can also be referred to as SupplierInvoiceProcessingInvoicingIn. Service Interface Invoicing In Interface may be part of Process Integration Model Customer Invoice Processing at Supplier_Supplier Invoice Processing. Invoicing in Interface can be a grouping of operations, which may create a Supplier Invoice out of legally binding requests of payables or receivables for delivered goods and rendered services—usually, a payment request for se goods and services.

Create Invoice can be also be referred to as SupplierInvoiceProcessingInvoicingIn. Create Invoice can create a SupplierInvoice according to legally binding claims or liabilities for delivered goods and rendered services. This operation may be based on message type InvoiceRequest and may be derived from Business Object SupplierInvoice. A message type InvoiceRequest can be sent from invoicing party to an invoice recipient, and can be used to start a new invoicing process. In some implementations, it transfers invoices such as specific invoice, and/or credit memo.

Service Interface Image Recognition Invoicing In (B2B) can also be referred to as SupplierInvoiceProcessinglmageRecognitionInvoicingIn. In some implementations, Service Interface Image Recognition Invoicing In Interface can be part of Process Integration Model Document Inbound Service_Supplier Invoice Processing. Image Recognition Invoicing In

Interface can be a grouping of operations, which creates a Supplier Invoice out of legally binding invoice image.

Create Invoice based on Attachment can also be referred to as SupplierInvoiceProcessingImageRecognitionInvoicingIn. An operation Create Invoice based on Attachment may create an empty SupplierInvoice with an attachment of an invoice image according to legally binding claims or liabilities for delivered goods and rendered services. This operation can be based on message type BusinessTransactionDocumentImageRecognitionRequest. A message type BusinessTransactionDocumentImageRecognitionRequest can be sent from a Document Inbound Service, can be used to start a new invoicing process and may transfer an image of an invoice. This may include an invoice, and/or a credit memo. Service Interface Internal Invoicing In (A2A) can also be referred to as SupplierInvoiceProcessingInternalInvoicingIn. Service Interface Internal Invoicing In Interface can be part of Process Integration Model Internal Request Processing_Supplier Invoice Processing. Internal Invoicing In Interface can be a grouping of operations, which creates a Supplier Invoice out of legally binding requests of payables or receivables for delivered goods and rendered services (e.g., a payment request for goods and services). This operation may be used by trusted process components, which may not require checks for factual correct-ness. It may be used if a settlement with an invoicing party/service provider exists, which enables an in-voice recipient/service consumer to issue an invoice himself.

In some implementations, Create Invoice can also be referred to as SupplierInvoiceProcessingInternalInvoicingIn. An operation Create Invoice may create a SupplierInvoice according to delivered goods and rendered services. Create Invoice can be based on message type SupplierInvoiceRequestand and may be derived from business object SupplierInvoice. In some implementations, a “one-click process” message type SupplierInvoiceRequest may be sent from requestor party to invoice recipient for invoice verification purposes. This may create automatically a SupplierInvoice without manual interaction and helps to streamline organisational processes.

In some implementations, Service Interface Request Invoicing Out (A2A) can also be referred to as SupplierInvoiceProcessingRequestInvoicingOut. Service Interface Request Invoicing Out Interface can be part of Process Integration Model Supplier Invoice Processing_Customer Invoice Processing. Request Invoicing Out Interface can be a grouping of operations which request a Customer Invoice from Customer Invoice Processing in third party direct ship scenario. Request Invoicing can also be referred to as SupplierInvoiceProcessingRequestInvoicingOut.

In some implementations, operation Request Invoicing requests a customer invoice. This operation may be based on message type CustomerInvoiceRequestRequest and derived from Business Object CustomerInvoiceRequest. Service Interface Invoice Accounting Notification Out (A2A) can also be referred to as SupplierInvoiceProcessingInvoiceAccountingNotificationOut. Service Interface Invoice Accounting Notification Out Interface can be part of Process Integration Model Supplier Invoice Processing_Accounting.

Invoice Accounting Notification Out Interface can be a grouping of operations which notifies financial accounting about a Supplier Invoice. Notify of Invoice can also referred to as SupplierInvoiceProcessingInvoiceAccountingNotificationOut. The operation Notify of SupplierInvoice may notify financial accounting about accounting relevant SupplierInvoice information. This operation may be based on message type InvoiceAccountingNotification and be derived from Business Object AccountingNotification. It may contain information about accounting objects to be charged. This message may be sent whenever a Supplier Invoice may be posted.

Notify of Invoice Cancellation can also be referred to as SupplierInvoiceProcessingInvoiceAccountingNotificationOut. An operation Notify of Invoice Cancellation notifies about cancellation of a Supplier Invoice. This operation may be based on message type InvoiceCancellationAccountingNotification and may be derived from Business Object AccountingNotification. It may include a Supplier Invoice reference to be cancelled. This message may be sent whenever a previously posted Supplier Invoice may be cancelled.

Service Interface Receivables Payables Out (A2A) can also be referred to as SupplierInvoiceProcessingReceivablesPayablesOut. Service Interface Receivables Payables Out Interface may be part of Process Integration Model Supplier Invoice Processing_Due Item Processing. Receivables Payables Out Interface can be a grouping of operations which notifies Due Item Processing about a Supplier Invoice.

Notify of Invoice can also be referred to as upplierinvoiceProcessingReceivablesPayablesOut. This operation Notify of Invoice may notify financial operations about payments due and tax due and may be based on message type ReceiveablesPayablesNotification and be derived from Business Ojects Trade-ReceiveablesPayablesRegister and TaxReceiveablesPayablesRegister.

Notify of Invoice Cancellation can also be referred to as SupplierInvoiceProcessingReceivablesPayablesOut. An operation Notify of Invoice Cancellation notifies Due Item Processing about previously sent ReceiveablesPayablesNotification that may no longer be valid and may need to be cancelled.

This operation can be based on message type ReceivablesPayablesCancellationNotification and may be derived from Business Ojects TradeReceiveablesPayablesRegister and TaxReceiveablesPayablesRegister.

Service Interface Invoicing Out (B2B) can also be referred to as SupplierInvoiceProcessinglnvoicingOut. Service Interface Invoicing Out Interface can be part of Process Integration Model Customer Invoice Processing at Supplier_Supplier Invoice Processing. An Invoicing Out Interface can be a grouping of operations which informs to invoicing party about acceptance of a Supplier Invoice.

Confirm Invoice can also be referred to as SupplierInvoiceProcessinglnvoicingOut. Confirm Invoice can be a response sent by a recipient to an invoicing party confirming or rejecting an entire invoice received or stating that, for example, it has been assigned temporarily status “pending”. This operation may be based on message type InvoiceConfirmation and be derived from Business Object SupplierInvoice.

Service Interface Evaluated Receipt Settlement Invoicing Out (B2B) can also be referred to as Service Interface Evaluated Receipt Settlement Invoicing Out Interface and can be part of Process Integration Model Customer Invoice Processing at Supplier_Supplier Invoice Processing.

In some implementations, Evaluated Receipt Settlement Invoicing Out Interface can be a grouping of operations which informs SellerParty about a Supplier Invoice. Request Evaluated Receipt Settlement Invoice can also be referred to as SupplierInvoiceProcessingERSInvoicingOut. This operation Request EvaluatedReceiptSettlement Invoice informs SellerParty about a SupplierInvoice created by BuyerParty using, for example, a credit memo procedure. This operation may be based on message type InvoiceRequest and derived from Business Object SupplierInvoice.

Service Interface Contract Release Out (A2A) can also be referred to as SupplierInvoiceProcessingContractReleaseOut. Service Interface Contract Release Out can be part of Process Integration Model Supplier Invoice Processing_Purchasing Contract Processing. Contract Release Out Interface can be a grouping of operations which notifies PurchasingContract about Invoices amounts and values in a SupplierInvoice.

Notify of Contract Release can also be referred to as SupplierInvoiceProcessingContractReleaseOut. An operation Notify of Contract Release may notify PurchasingContract about a contract release by a Supplier Invoice. This operation may be based on message type PurchasingContractReleaseNotification.

In some embodiments, SupplierInvoice 284086 may include detail information about claims or liabilities for delivered goods and rendered services between a BillFromParty and a BillToParty. Elements located at node SupplierInvoice may defined by data type ProcurementDocumentElements. Exemplary element SystemAdminstrativeData may be used in a SupplierInvoice. SystemAdminstrativeData (Administrative data stored within system) may contain system users and time of change. Additional exemplary elements that may be used in SupplierInvoice include: UUID, ID, TypeCode, ProcessingTypeCode, DataOriginTypeCode, Date, TransactionDate, ReceiptDate, CancellationDocumentIndicator, Name, TotalGrossAmount, GrossAmount, TotalNetAmount, TotalTaxAmount, TaxAmount, BalanceAmount, Status, IDT, SupplierInvoiceLifecycleStatusCode, ConsistencyStatusCode, BlockingStatusCode, DataEntryProcessingStatusCode, PostingStatusCode, CancellationStatusCode, and/or ApprovalStatusCode. SystemAdministrativeData may be a GDT of type SystemAdministrativeData. UUID may be a GDT of type UUID. In some implementations UUID may have an Alternative Key. UUID can be a universal unique alternative identifier of SupplierInvoice for referencing purposes. ID may be a GDT of type BusinessTransactionDocumentID. In some implementations ID may have an Alternative Key. ID can be a Identifier for SupplierInvoice assigned by BillToParty. TypeCode may be a GDT of type BusinessTransactionDocumentTypeCode. TypeCode can be a coded representation of SupplierInvoice type (e.g. invoice or credit memo). ProcessingTypeCode may be a GDT of type BusinessTransactionDocumentProcessingTypeCode. ProcessingTypeCode can be a coded representation for processing type of Supplier Invoice. DataOriginTypeCode may be a GDT of type ProcurementDocumentDataOriginTypeCode. DataOriginTypeCode can be way SupplierInvoice may be created (e.g. by ERS, XML, manually, or like). Date may be a GDT of type Date and may be optional. Date can be a point in time for posting of invoice by BillFromParty. TransactionDate may be a GDT of type Date and may be optional. TransactionDate can be point in time goods have been delivered or services have been rendered (e.g., point in time liability may be created). This date may be used to determine posting period for FI posting. ReceiptDate may be a GDT of type Date and may be optional. In some implementations, ReceiptDate may have a qualifier of Receipt. ReceiptDate can be a point in time SupplierInvoice may have been received by BillToParty or may have been created by EvaluatedReceiptSettlementRun. CancellationDocumentIndicator may be a GDT of type CancellationDocumentIndicator and may be optional. CancellationDocumentIndicator can indicate whether SupplierInvoice may be a cancellation invoice or not. Name may be a GDT of type MEDIUM_Name and may be optional. Name can be a designation or title of SupplierInvoice. TotalGrossAmount may be a GDT of type Amount and may be optional. In some implementations TotalGrossAmount may have a qualifier of TotalGross. TotalGrossAmount can be total gross amount of SupplierInvoice (net amount plus tax amount). Calculated by summation of item amounts. GrossAmount may be a GDT of type Amount and may be optional. In some implementations GrossAmount may have a qualifier of Gross. GrossAmount can be a gross amount of SupplierInvoice (net amount plus tax amount). TotalNetAmount may be a GDT of type Amount and may be optional. In some implementations TotalNetAmount may have a qualifier of TotalNet. TotalNetAmount can be a total net amount of SupplierInvoice. Calculated by summation of item net amounts. TotalTaxAmount may be a GDT of type Amount and may be optional. In some implementations TotalTaxAmount may have a qualifier of TotalNet. TotalTaxAmount can be a total tax amount of SupplierInvoice. Calculated by summation of tax amounts (DO Tax). Tax amount may be a GDT of type Amount and may be optional. In some implementations TaxAmount may have a qualifier of Tax. TaxAmount can be tax amount of SupplierInvoice. BalanceAmount may be a GDT of type Amount and may be optional. In some implementations, BalanceAmount may have a qualifier of Balance. BalanceAmount can be balance of SupplierInvoice. While posting a SupplierInvoice balance amount may be required to equal zero. This should support a value based check between amount of all items (within taxes) and total amount of SupplierInvoice. Status may be a IDT of type ProcurementDocumentStatus. Status can be an element Status containing all individual status variables that are relevant for and describe current state in life cycle of a SupplierInvoice. In some implementations, elements described subsequently can be used in a SupplierInvoice. SupplierInvoiceLifecycleStatusCode may be a GDT of type SupplierInvoiceLifecycleStatusCode. SupplierInvoiceLifecycleStatusCode can be status information of overall SupplierInvoice processing (e.g. Posted). ConsistencyStatusCode may be GDT of type ConsistencyStatusCode. ConsistencyStatusCode can be Check status information of SupplierInvoice. BlockingStatusCode may be GDT of type BlockingStatusCode. BlockingStatusCode can be a status information of SupplierInvoice blocking. DataEntryProcessingStatusCode may be a GDT of type ProcessingStatusCode. In some implementations, DataEntryProcessingStatusCode may have a qualifier of DataEntry. DataEntryProcessingStatusCode can be a status information of SupplierInvoice entry process. PostingStatusCode may be a GDT of type PostingStatusCode. PostingStatusCode can be a status information of SupplierInvoice payment, (e.g. SupplierInvoice may have been paid or payment may have been revoked). CancellationStatusCode may be a GDT of type CancellationStatusCode. CancellationStatusCode can be a status information of SupplierInvoice cancellation. ApprovalStatusCode may be a GDT of type ApprovalStatusCode. ApprovalStatusCode can be a status information of SupplierInvoice approval. In some implementations a complete SupplierInvoice may contain a CustomerInvoice reference and a BillFromParty. In some business scenarios, (e.g. dispute management with duplicate check), it may be necessary to keep an incomplete SupplierInvoice with minimum information only. A relation to a supplier can be represented by node SupplierInvoiceParty and subtype association SellerParty.

Composition relationships to subordinate nodes may exist, examples of which (with indicated cardinality relationships) may include: Item 284088 having a cardinality of 1:cn, Party 284100 having a cardinality of 1:cn, Location 284112 having a cardinality of 1:cn, CashDiscountTerms (DO) 284120 having cardinality of 1:c, PaymentControl (DO) 284122 having a cardinality of 1:c, ExchangeRate 284124 having a cardinality of 1:cn, PriceCalculation (DO) having a cardinality of 1:c, TaxCalculation (DO) 284126 having a cardinality of 1:c, BusinessTransactionDocumentReference 284134 having a cardinality of 1:cn, AttachmentFolder (DO) 284138 having a cardinality of 1:c, TextCollection (DO) 284140 having a cardinality of 1:c, BusinesssProcessVariantType 284128 having a cardinality of 1:n, and/or AccessControlList (DO) 284142 having a cardinality of 1:1.

In some implementations, inbound Aggregation Relationships may exist from business object Identity/node Root, examples of which (with associated cardinality relationships) follow. CreationIdentity may have a cardinality of 1:cn and may be an identity that created procurement document. LastChangeIdentity may have a cardinality of c:cn and may be an identity that changed procurement document in last time.

In some implementations, associations for Navigation may exist, examples of which (with possible cardnality relationships) follow. BusinessDocumentFlow may have a cardinality of c:c and can be an association to a BusinessDocumentFlow which may be a view on a set of all preceding and succeeding business (transaction) documents for current procurement document. InvoicedItem may have a cardinality of c:cn and can be an association to an item which appears within an Invoicedtem specialisation. AssignedItem may have a cardinality of c:cn and can be an association to an item which appears within an AssignedItem specialisation. BillToParty may have a cardinality of c:c and can be association to a party which appears within BillToParty specialisation. BillFromParty may have a cardinality of c:c and can be an association to a party which appears within BillFromParty specialisation. BuyerParty may have a cardinality of c:c and can be an association to a party which appears within BuyerParty specialisation. SellerParty may have a cardinality of c:c and can be an association to a party which appears within SellerParty specialisation. PayerParty may have a cardinality of c:c and can be an association to a party which appears within PayerParty specialization. PayeeParty may have a cardinality of c:c and can be an association to a party which appears within PayeeParty specialisation. EmployeeResponsibleParty may have a cardinality of c:c and can be an association to a party which appears within EmployeeResponsibleParty specialisation. ProductRecipientParty may have a cardinality of c:c and can be an association to a party which appears within ProductRecipientParty specialisation. ServicePerformerParty may have a cardinality of c:c and can be an association to a party which appears within ServicePerformerParty specialisation. RequestorParty may have a cardinality of c:c and can be an association to a party which appears within a RequestorParty specialisation. ResponsibleSupplierinvoicingUnitParty may have a cardinality of c:c and can be an association to a party which appears within ResponsibleSupplierinvoicingUnitParty. ShipToLocation may have a cardinality of c:c and can be an association to a location which appears within a ShipToLocation specialisation. ShipFromLocation may have a cardinality of c:c and can be an association to a location which appears within ShipFromLocation specialisation. PurchasingContractReference may have a cardinality of c:cn and can be an association to a business transaction document reference which appears within a PurchasingContract specialisation. PurchaseOrderReference may have a cardinality of c:cn and can be an association to a business transaction document reference which appears within a PurchaseOrder specialisation. ConfirmedInboundDeliveryReference may have a cardinality of c:cn and can be an association to a business transaction document reference which appears within a ConfirmedInboundDelivery specialisation. OutboundDeliveryReference may have a cardinality of c:cn and can be an association to a business transaction document reference which appears within an OutboundDelivery specialisation. GoodsAndServiceAcknowledgementReference may have a cardainlity of c:cn and be an association to a business transaction document reference which appears within a GoodsAndServiceAcknowledgement specialisation. CustomerInvoiceReference may have a cardinality of c:c and can be an association to a business transaction document reference which appears within a CustomerInvoice specialisation. CustomsDutyInvoiceReference may have a cardinality of c:cn and can be an association to a business transaction document reference which appears within a CustomsDutyInvoiceReference specialisation. PurchaseOrderBasedSupplierInvoiceRequestReference may have a cardinality of c:cn and can be an association to a business transaction document reference which appears within a PurchaseOrderBasedSupplierInvoiceRequest specialisation. ConfirmedInboundDeliveryBasedSupplierInvoiceRequestReference may have a cardinality of c:cn and can be an association to a business transaction document reference which appears within a ConfirmedInboundDeliveryBasedSupplierInvoiceRequest specialisation. GoodsAndServiceAcknowledgementBasedSupplierInvoiceRequestReference may have a cardinality of c:cn and can be an association to a business transaction document reference which appears within a GoodsAndServiceAcknowledgementSupplierInvoiceRequest specialisation. PurchasingContractBasedSupplierInvoiceRequestReference may have a cardinality of c:cn and can be an association to a business transaction document reference which appears within a PurchasingContractBasedSupplierInvoiceRequest specialisation. OriginSupplierInvoiceReference may have a cardinality of c:cn and can be an association to a business transaction document reference which appears within a OriginSupplierInvoice specialisation. SupplierInvoiceVerificationExceptionReference may have a cardinality of c:cn and can be an association to a business transaction document reference which appears within a SupplierInvoiceVerificationException specialisation. DeliveryBasedSupplierInvoiceRequestReference may have a cardinality of c:cn and can be an association to a business transaction document reference which appears within a DeliveryBasedSupplierInvoiceRequest specialisation. The previous are exemplary associations for Navigation which may exist.

CalculateGrossAmount may Calculate gross amount of a SupplierInvoice. In some implementations, element TotalGrossAmount can be filled from CalculatedTotalGrossAmount. CalculateTaxAmount can Calculate tax amount of a SupplierInvoice. Element TotalTaxAmount can be filled from CalculatedTotalTaxAmount. FinishDataEntryProcessing can be action declares end of data entry process of SupplierInvoice (in case verification is done by a different user). Block may be an S&AM action and may be set externally for SupplierInvoice. In some implementations, this can be removed externally, not internally by BO. Unblock may be an S&AM action and may release an external block for SupplierInvoice. SubmitForApproval may be an S&AM action and may determine whether an approval may be required and start approval of SupplierInvoice if required. Reject may be an S&AM action and may reject a SupplierInvoice which may be in approval. Approve may be an S&AM action and may approve a SupplierInvoice which may be in approval. SendBackForRevision may be an S&AM action and may be an action that can be triggered when a caller decides that this BO needs to be revised. In some implementations, the BO can be processed afterwards. WithdrawFromApproval may be an S&AM action and may withdraw approval of a SupplierInvoice. Void may be an S&AM action and may void SupplierInvoice for all changes. Post may be an S&AM action and may check whether SupplierInvoice can be posted, and if so, may change the status to “posted” and “instructions to pay issued”. This may trigger posting in financial accounting and triggers payment. SubmitForCancellation may be an S&AM action and may submit a SupplierInvoice for cancellation and triggers creation of a correction SupplierInvoice. DiscardCancellation may be an S&AM action and may discard a cancellation process of SupplierInvoice. CompleteCancellation may be an S&AM action and may complete a cancellation process of SupplierInvoice.

In some implementations, ConvertCurrency may change currency of a SupplierInvoice, including a currency conversion. Parameters can be action elements that are defined by data type ProcurementDocumentRootConvertCurrencyActionElements.

Exemplary elements may include: CurrencyCode, Propose-SupplierInvoiceFromReference, SimulateSupplierInvoiceVerificationException, CreateInvoiceFromReference, CreateCreditMemoFromReference, CreateSubsequentDebitFromReference, CreateSubsequent-CreditFromReference, CheckConsistency. CurrencyCode may be a GDT of type CurrencyCode. CurrencyCode can be target currency. ProposeSupplierInvoiceFromReference can proposes SupplierInvoice data from referred business transaction documents. SimulateSupplierInvoiceVerificationException can simulate if exceptions will occur after end of data entry of SupplierInvoice. CreateInvoiceFromReference can create a SupplierInvoice with proposal (invoice items) based on supplied reference keys. CreateCreditMemoFromReference can create a SupplierInvoice with proposal (credit memo items) based on supplied reference keys. CreateSubsequentDebitFromReference can create a SupplierInvoice with proposal (subsequent debit items) based on supplied reference keys. CreateSubsequentCreditFromReference can create a SupplierInvoice with proposal (subsequent credit items) based on supplied reference keys. CheckConsistency can check whether SupplierInvoice may be consistent or inconsistent.

In some implementations, QueryByElements can provide a list of some SupplierInvoices, which satisfy selection criteria specified by query elements, combined by logical “AND”. If no selection criteria is specified, it may be checked whether query element matches to a corresponding element of Business Object. A Query interface may be defined by data type ProcurementDocumentElementsQueryElements. The following exemplary elements may be used in a SupplierInvoice: SystemAdminstrativeData, ID, TypeCode, CreationBusinessPartnerCommonPersonNameGivenName, CreationBusinessPartnerCommonPersonNameFamilyName, LastChangeBusinessPartnerCommonPersonNameGivenName, LastChangeBusinessPartnerCommonPersonNameFamilyName, CancellationDocumentIndicator, DataOriginTypeCode, Name, Date, TransactionDate, ReceiptDate, GrossAmount, CashDiscountTermsFullPaymentEndDate, PartyBillToPartyID, PartyBillFromPartyID, PartySellerPartyID, PartyEmployeeResponsiblePartyID, PartyResponsibleSupplierinvoicingUnitPartyID, PartyEmplyeeResponsiblePartyID, Supplier_CommonFormattedName, PartyBuyerPartyID, ItemPartyRequestorPartyID, ItemPartyProductRecipientPartyID, ItemPartyServicePerformerPartyID, ItemLocationShipToLocationID, ItemLocationShipFromLocationID, ItemProductProductID, ItemProductProductSellerID, ItemDescription, ItemProductProductCategoryInternalID, Business TransactionDocumentReferencePurchaseOrderID, Business TransactionDocumentReferenceGoodsAndServiceAcknowledgementID, BusinessTransactionDocumentReferenceConfirmendInboundDeliveryID, BusinessTransactionDocumentReferenceOutboundDeliveryID, BusinessTransactionDocumentReferencePurchasingContractID, BusinessTransactionDocumentReferenceCustomerInvoiceID, BusinessTransactionDocumentReferenceCustomsDutyInvoiceID, BusinessTransactionDocumentReferenceBusinessTrasnactionDocument-TypeCode, BusinessTransactionDocumentReferenceBusinessTrasnactionDocumentID, ProcurementDocumentStatus, SupplierInvoiceLifecycleStatusCode, ConsistencyStatusCode, BlockStatusCode, DataEntryProcessingStatusCode, PostingStatusCode, CancellationStatusCode, Approval Status Code, ItemAccountingCodingBlockDistributionItemCostCentreID, ItemAccountingCodingBlockDistributionItemMaterialID, ItemAccountingCodingBlockDistributionhemAccountDeterminationExpenseGroupCode, ItemAccountingCodingBlockDistributionitemProjectReference, SupplierInvoiceVerifiationException_LifeCycleStatus, SupplierInvoiceVerifiationException_ProcessingTypeCode, SupplierInvoiceVerifiationException_CreationDayNumberValue, SupplierInvoiceVerifiationException_ChangeDayNumberValue. SystemAdminstrativeData may be a GDT of type SystemAdministrativeData and may be optional. ID may be a GDT of type BusinessTransactionDocumentID and may be optional.

TypeCode may be a GDT of type BusinessTransactionDocumentTypeCode and may be optional. CreationBusinessPartnerCommonPersonNameGivenName may be a GDT of type LANGUAGEINDEPENDENT_MEDIUM_Name and may be optional. CreationBusinessPartnerCommonPersonNameFamilyName may be a GDT of typeLANGUAGEINDEPENDENT_MEDIUM_Name and may be optional. LastChangeBusinessPartnerCommonPersonNameGivenName may be a GDT of type LANGUAGEINDEPENDENT_MEDIUM_Name and may be optional. LastChangeBusinessPartnerCommonPersonNameFamilyName may be a GDT of type LANGUAGEINDEPENDENT_MEDIUM_Name and may be optional. CancellationDocumentIndicator may be a GDT of type Indicator and may be optional. In some implementations CancellationDocumentIndicator may have a qualifier of CancellationDocument. DataOriginTypeCode may be a GDT of type ProcurementDocumentDataOriginTypeCode and may be optional. Name may be a GDT of type MEDIUM_Name and may be optional. Date may be a GDT of type Date and may be optional. TransactionDate may be a GDT of type Date and may be optional. ReceiptDate may be a GDT of type Date and may be optional. GrossAmount may be a GDT of type Amount and may be optional. CashDiscountTermsFullPaymentEndDate may be a GDT of type Date and may be optional. PartyBillToPartyID may be a GDT of type PartyID and may be optional. PartyBillFromPartyID may be a GDT of type PartyID and may be optional. PartySellerPartyID may be a GDT of type PartyID and may be optional. PartyEmployeeResponsiblePartyID may be a GDT of type PartyID and may be optional. PartyResponsibleSupplierInvoicingUnitPartyID may be a GDT of type PartyID and may be optional. PartyEmplyeeResponsiblePartyID may be a GDT of type PartyID and may be optional. Supplier_CommonFormattedName may be a GDT of type LANGUAGEINDEPENDENT_LO-NG_Name and may be optional. PartyBuyerPartyID may be a GDT of type PartyID and may be optional. ItemPartyRequestorPartyID may be a GDT of type PartyID and may be optional. ItemPartyProductRecipientPartyID may be a GDT of type PartyID and may be optional. ItemPartyServicePerformerPartyID may be a GDT of type PartyPartyID and may be optional. ItemLocationShipToLocationID may be a GDT of type LocationID and may be optional. ItemLocationShipFromLocationID may be a GDT of type LocationID and may be optional. ItemProductProductID may be a GDT of type ProductID and may be optional. ItemProductProductSellerID may be a GDT of type ProductPartyID and may be optional. ItemDescription may be a GDT of type Medium_Description and may be optional. ItemProductProductCategoryInternalID may be a GDT of type ProductCategoryInternalID and may be optional. Business TransactionDocumentReferencePurchaseOrderID may be a GDT of type BusinessTransactionDocumentID and may be optional. BusinessTransactionDocumentReferenceGoodsAndServiceAcknowledge-mentID may be a GDT of type BusinessTransactionDocumentID and may be optional. BusinessTransactionDocumentReferenceConfirmendInboundDeliveryID may be a GDT of type BusinessTransactionDocumentID and may be optional. BusinessTransactionDocumentReferenceOutboundDeliveryID may be a GDT of type BusinessTransactionDocumentID and may be optional. BusinessTransactionDocumentReferencePurchasingContractID may be a GDT of type BusinessTransactionDocumentID and may be optional. BusinessTransactionDocumentReferenceCustomerInvoiceID may be a GDT of type BusinessTransactionDocumentID and may be optional. BusinessTransactionDocumentReferenceCustomsDutyInvoiceID may be a GDT of type BusinessTransactionDocumentID and may be optional. BusinessTransactionDocumentReferenceBusinessTrasnaction-DocumentTypeCode may be a GDT of type BusinessTransactionDocumentTypeCode and may be optional. BusinessTransactionDocumentReferenceBusinessTrasnactionDocumentID may be a GDT of type BusinessTransactionDocumentID and may be optional. ProcurementDocumentStatus may be a Data Type of ProcurementDocumentStatus. SupplierInvoiceLifecycleStatusCode may be a GDT of type SupplierInvoiceLifecycleStatusCode and may be optional. ConsistencyStatusCode may be a GDT of type ConsistencyStatusCode and may be optional. BlockStatusCode may be a GDT of type BlockStatusCode and may be optional. DataEntryProcessingStatusCode may be a GDT of type ProcessingStatusCode and may be optional. PostingStatusCode may be a GDT of type PostingStatusCode and may be optional. CancellationStatusCode may be a GDT of type CancellationStatusCode and may be optional. ApprovalStatusCode may be a GDT of type ApprovalStatusCode and may be optional. ItemAccountingCodingBlockDistributionItemCostCentreID may be a GDT of type OrganisationalCentreID. ItemAccountingCodingBlockDistributionItemMaterialID may be a GDT of type ProductID. ItemAccountingCodingBlockDistributionhemAccountDeterminationExpenseGroupCode may be a GDT of type AccountDeterminationExpenseGroupCode. ItemAccountingCodingBlockDistributionItemProjectReference may be a GDT of type ProjectReference. SupplierInvoiceVerifiationException_LifeCycleStatus may be a GDT of type SupplierInvoiceVerifiationExceptionLifeCycle and may be optional. SupplierInvoiceVerifiationException_ProcessingTypeCode may be a GDT of typeBusinessTransactionDocument-ProcessingTypeCode and may be optional. SupplierInvoiceVerifiationException_CreationDayNumber-Value may be a GDT of type NumberValue and may be optional. SupplierInvoiceVerifiationException_Change-DayNumberValue may be a GDT of type NumberValue and may be optional.

A Party can be a natural or legal person, organization, organizational unit, or group that may be involved in a procurement document ProcurementDocument in a party role. A

Party may reference, using inbound aggregation relationship from TO Party, a business partner or one of its specializations (e.g., customer, supplier, employee, or the like) one of following specializations of an organizational center: Company, CostCentre, ReportingLineUnit, and/or FunctionalUnit. A Party may exist without reference to a business partner or an organizational unit. This could be a Casual Party, which can be a party without reference to master data in system. external identifier and description can be contained in business document.

A Party can occur within complete and disjoint specialisations, examples of which may include: A Bill-FromParty can be a party that creates invoice for delivered materials and/or services. This could be supplier or a differing invoicing party. A Contact for a BillFromParty may be available. A BillToParty can be a party to which an invoice for materials or services may be sent. A BuyerParty can be a party that ordered materials or services. A BuyerParty may typically also invoice recipient (BillToParty). A Seller-Party can be a party that sells materials or services. A SellerParty can typically issue invoices too. A Con-tact for SellerParty may be available. A PayeeParty can be a party that receives a payment for invoiced materials and/or services. A PayerParty can be a party that pays for goods or services. A EmployeeResponsibleParty can be a party that may be responsible for invoice verification process. A ResponsibleSupplierinvoicingUnitParty can be a party that may be responsible for processing of supplier invoices. A ProductRecipientParty can be a party to which materials are delivered or for which services are provided. A

ServicePerformerParty can be a party that delivers goods or provides services. In some implementations, a RequestorParty could assist in clarifying invoicing disputes. A RequestorParty can be a party that requests procurement of materials or services.

Party may include elements defined by GDT ProcurementDocument-PartyElements that may be derived from GDT BusinessTransactionDocumentPartyElements. These elements may include UUID:SupplierInvoiceParty, PartyID, PartyUUID, PartyTypeCode, RoleCategoryCode, RoleCode, AddressReference, and/or DeterminationMethodCode. UUID:SupplierInvoiceParty may be a GDT of type UUID. PartyID may be a GDT of type PartyID (e.g., without additional components, such as sche-meAgencyID and may be optional. PartyID can be identifier of Party in this PartyRole in a business document or master data object. If a business partner or organizational units are referenced, attribute may contains this identifier. PartyUUID may be a GDT of type UUID and may be optional. PartyUUID can be a unique identifier for a business partner, organizational unit, or ir specializations. PartyType-Code may be a GDT of type PartyTypeCode and may be optional. PartyTypeCode can be type of business partner, organizational unit, or ir specializations referenced by attribute PartyUUID. RoleCategory-Code may be a GDT of type PartyRoleCategoryCode and may be optional. RoleCategoryCode can be a Party Role Category of Party in business document or master data object. RoleCode may be a GDT of type PartyRoleCode and may be optional. PartyRoleCode can be a Party Role of Party in business document or master data object. AddressReference may be a GDT of type PartyAddressReference and may be optional. AddressReference can be a reference to address of Party. DeterminationMethodCode may be a GDT of type PartyDeterminationMethodCode and may be optional. Determination-MethodCode can be a coded representation of determination method of Party. A party could be a per-son, organization, or group within or outside of company. In some embodiments, Inheritance may be used for all parties (e.g., parties that are specified at ProcurementDocument_Template level are used for some items if not otherwise specified on item level).

In some implementations, inbound Aggregation Relationships to SupplierInvoice may exist, an example of which may be from business object Party/Node Root. Party may have a cardinality of c:cn and may reference Party in Master Data. Association for Navigation may exist to transformed object UsedAddress/Node Root. UsedAddress may have a cardinality of c:c and can be a transformed object UsedAddress representing a uniform way to access a party address of an procurement document whether it's a business partner address, a organization center address or an address specified within a procurement document.

PartyContactParty 284102 can be a natural person or organizational center that can be contacted for a Party. Contact may be a contact person or, for example, a secretary's office. Usually, communication data for contact may be available. Exemplary structure elements may include UUID, PartyID, PartyUUID, PartyTypeCode, AddressReference and/or DeterminationMethodCode. UUID may be a GDT of type UUID. UUID can be a globally unique identifier for a contact. PartyID may be a GDT of type PartyID (without additional components, such as schemeAgencyID). PartyID can be an identifier of contact in this Party-Role in business document or master data object. PartyUUID may be GDT of type UUID and may be optional. PartyUUID can be a unique identifier of contact in this PartyRole in business document or master data object. PartyTypeCode may be a GDT of type ContactPartyTypeCode and may be optional. PartyTypeCode can be type of business partner, organizational unit, or it specializations referenced by attribute ContactUUID. AddressReference may be a GDT of type PartyAddressReference and may be optional. AddressReference can be a reference to address of Party. DeterminationMethodCode may be a GDT of type PartyDeterminationMethodCode and may be optional. DeterminationMethodCode can be a coded representation of determination method of contact party.

In some implementations, composition relationships to subordinate nodes may exist, an example of which is with PartyContactPartyAddress (DO) 284104 which may have a cardinality of 1:c. Inbound Aggregation Relationships, an example of which is from business object Party/Node Root. In this relationship, Party may have a cardinality of c:cn and can be a Referenced Contact Party in Master Data. Associations for Navigation may exist, an example of which is to transformed object UsedAddress/Node Root. In this association, UsedAddress may have a cardinality of c to cn and may be an address used for the Contact Party.

PartyContactPartyAddress (DO) can be a SupplierInvoice specific address of the Party. PartyAddress (DO) can be a SupplierInvoice specific address of Party. Location may be a physical place, which can be relevant for tax calculation and SupplierInvoice verification. A Location can occur within following specialisations: A ShipToLocation can be place where goods have been delivered or where a service may have been provided; A ShipFromLocation can be a place, from where goods have been delivered.

In some implementations, elements located at a node Location may be defined by data type ProcurementDocumentLocationElements that may be derived from data type BusinessTransactionDocumentLocationElements. Exemplary elements may include UUID, LocationID, LocationUUID, RoleCategoryCode, RoleCode, AddressReference, and/or DeterminationMethodCode. UUID may be GDT of type UUID. In some implementations UUID can have an Alternative Key. UUID can be a globally unique identifier of procurement document location for referencing purposes. LocationID may be a GDT of type LocationID and may be optional. LocationID can be an identifier of referenced Location. LocationUUID may be a GDT of type UUID and may be optional. LocationUUID can be a globally unique identifier of Location referenced. RoleCategoryCode may be a GDT of type LocationRoleCategoryCode. RoleCategoryCode can be a coded representation of Location role category in procurement document. RoleCode may be a GDT of type LocationRoleCode. RoleCode can be a coded representation of Location role in procurement document. AddressReference may be a GDT of type LocationAddressReference and may be optional. AddressReference can be a reference to address of Location. DeterminationMethodCode may be a GDT of type LocationDeterminationMethodCode and may be optional. DeterminationMethodCode cane be a coded representation of determination method of Location.

In some implementations, composition relationships to subordinate nodes may exist, an example of which is LocationAddress (DO) 284114 which may have a cardinality of Ito c. Inbound Aggregation Relationships may exist, an example of which is from the business object Location. In this relationship, Location may have a cardinality of c:cn and PartyAddressInformation may have a cardinality of c:cn. Associations for Navigation may exist, an example of which is UsedAddress which may have a cardinality of c:c and the trans-formed object UsedAddress may represent a uniform way to access a location address of an procurement document whether it's a business partner address, a organization center address or an address specified within a procurement document.

LocationAddress (DO) can be a SupplierInvoice specific address of Location. CashDiscountTerms (DO) can be modalities agreed on by business partners of a procurement document for payment of goods delivered or services provided. These modalities may consist of incremental payment periods and cash discounts that are allowed when payment is made within one of these periods. CashDiscountTerms can be used to define terms of payment, for example, for a purchase order or invoice issue for goods and services. PaymentControl (DO) can be an agreement between a company and a business partner on processing payments for an individual procurement document. ProcurementDocument can be used to determine instructions on payment processing, such as an individual order or invoicing for goods and services. In contrast, a PaymentAgreement may determine possible payment methods and bank ac-counts or credit cards that could be used between a company and a business partner, regardless of business transaction. Payments agreed in ProcurementDocument may be the same in characteristics payment method, execution date, payer party and payee party.

In some embodiments, ExchangeRate may be representation of an exchange rate between SupplierInvoice currency and a second currency (e.g. currency of purchase order) at a defined quotation date and time which can be different from the current exchange rate.

In some implementations, ExchangeRate may include elements that may be defined by data type: ProcurementDocumentExchangeRateElements that may be derived from data type BusinessTransactionDocumentExchangeRateElements. Exemplary elements may include: ExchangeRate, which may be the exchange rate information for SupplierInvoice and/or FixedIndicator. Exchange rate can be specified if products ordered are settled in a currency that is different from currency in purchase order. This may be the case with collective invoices, for example. Note that the leading currency may correspond to the CurrencyCode in SupplierInvoice (root node). ExchangeRate may be a GDT of type ExchangeRate. Fixed-Indicator may be a GDT of type FixedIndicator. FixedIndicator can indicates whether a specified ex-change rate is fixed for follow up business transaction documents (e.g. PaymentDue) or not. The ex-change rate may be calculated using the formula: 1 UnitCurrency=Rate*QuotedCurrency. A Supplier-Invoice was received with currency Dollar. A different currency may be used for payment. The exchange rate between invoice and payment currency should therefore be specified for Business Object Payment-Due.

TaxCalculation (DO) can be a summary of determined tax components for procurement document. ProcurementDocument. Business TransactionDocumentReference may be a unique reference to another business transaction document or an item which may be related to SupplierInvoice. A Business-TransactionDocumentReference can occur within the following specialisations: A PurchasingContractReference can be a reference to PuchasingContract that holds agreed conditions between purchaser (BuyerParty) and supplier (SellerParty), which need to be considered during SupplierInvoice verification. A PurchaseOrderReference can be a reference to PurchaseOrder that requested invoiced materials and services. An ConfirmedInboundDeliveryReference may be a reference to ConfirmedInboundDelivery that contains actual received materials. An OutboundDeliveryReference can be a reference to OutboundDelivery that contains actual delivered materials. A GoodsAndServiceAcknowledgementReference can be a reference to GoodsAndServiceAcknowledgement that contains actual received materials and services. A CustomerInvoiceReference may be reference to CustomerInvoice that can be used to charge a customer (BillToParty or BuyerParty respectively) for delivered materials and services. A Customs-DutyInvoiceReference can be a reference to CustomsDutyInvoice that states purchaser's obligation to pay customs duty and/or product tax on import to a customs authority for import of goods or services rendered. A PurchaseOrderBasedSupplierInvoiceRequestReference can be a reference to SupplierInvoiceRequest that holds all necessary PurchaseOrder information for SupplierInvoice verification. A ConfirmedInboundDeliveryBasedSupplierInvoiceRequestReference can be a reference to SupplierInvoiceRequest that holds all necessary ConfirmedInboundDelivery information for SupplierInvoice verification. A GoodsAndServiceAcknowledgementBasedSupplierInvoiceRequestReference can be a reference to SupplierInvoiceRequest that holds all necessary GoodsAndServiceAcknowledgement information for SupplierInvoice verification. A PurchasingContractBasedSupplierInvoiceRequestReference may be a reference to

SupplierInvoiceRequest that holds all necessary PurchasingContract information for SupplierInvoice verification. An OriginSupplierInvoiceReference can be a reference to SupplierInvoice that was issued in a previous process step. This reference can only be used if SupplierInvoice represents a cancellation, a credit memo, a subsequent invoice or credit. An SupplierInvoiceVerificationExceptionReference can be a reference to SupplierInvoiceVerificationException that was issued during invoice verification process. A DeliveryBasedSupplierInvoiceRequestReference can be a reference to SupplierInvoiceRequest that holds all necessary Delivery information (GoodsAndServiceAcknowledgement or ConfirmendInboundDelivery) for SupplierInvoice verification.

BusinessTransactionDocumentReference includes the following elements that are defined by GDT: ProcurementDocumentBusinessTransactionDocumentReferenceElements that can be derived from GDT BusinessTransactionDocumentReferenceElements. These include the following elements: Business-TransactionDocumentReference, BusinessTransactionDocumentRoleCode and BusinessTransactionDocumentDataProviderIndicator. BusinessTransactionDocumentReference may be a GDT of type BusinessTransactionDocumentReference. BusinessTransactionDocumentReference can be a unique reference to referred business transaction document. Furthermore, it may be possible to have a reference to a line item within business transaction document. Business TransactionDocumentRoleCode is a GDT of type Business TransactionDocumentReferenceRoleCode. BusinessTransactionDocumentRoleCode can be a coded representation of role of a BusinessTransactionDocument in this reference. BusinessTransactionDocumentDataProviderIndicator is a GDT of type Indicator. In some implementations Business-TransactionDocumentDataProviderIndicator may have a qualifier of DataProvider. BusinessTransactionDocumentDataProviderIndicator can be a coded representation of role of a BusinessTransactionDocument in this reference.

In some implementations, associations for navigation may exist, examples of which follow: from the business object PurchasingContractPurchasingContract which may have a cardinality of c:cn and can be a SupplierInvoice may refer to a PurchasingContract; from the business object PurchaseOrder which may have a cardinality of c:cn and can be a SupplierInvoice may refer to a PurchaseOrder; from the business object ConfirmedInboundDelivery which may have a cardinality of c:cn and can be a SupplierInvoice may refer to an ConfirmedInboundDelivery; from the business object OutboundDelivery which may have a cardinality of c:cn and can be a SupplierInvoice may refer to an OutboundDelivery; from the business object GoodsAndServiceAcknowledgement may have a cardinality of c:cn and can be a SupplierInvoice may refer to a GoodsAndServiceAcknowledgement; and/or from the business object CustomerInvoice which may have a cardinality of c:cn and can be a SupplierInvoice may refer to a CustomerInvoice.

In some implementations, Inbound Association Relationships may exist, examples of which are: from the business object SupplierInvoiceRequest which may have a cardinality of c:cn and can be a SupplierInvoice may refer to a SupplierInvoiceRequest; from the business object SupplierInvoice which may have a cardinality of c:cn and can be a SupplierInvoice may refer to another SupplierInvoice; and/or from the business object SupplierInvoiceVerificationException which may have a cardinality of c:cn and can be a SupplierInvoiceVerificationException which may refer to a SupplierInvoiceVerificationException.

AttachmentFolder (DO) can be a folder of some documents attached to procurement document. TextCollection (DO) can be a collection of some textual descriptions which are related to procurement document. Each text can be specified in different languages and can include formatting information. A BusinessProcessVariantType may define a character of a business process variant of procurement document. It represents a typical way of processing of a procurement document within a process component from a business point of view. In some embodiments, BusinessProcessVariantType can occur within specialisation MainBusinessProcessVariantType. A Business Process Variant can be a configuration of a Process Component. A Business Process Variant can belong to one process component. A process component can be a software package that realizes a business process and exposes its functionality as services. Exemplary functionality contains business transactions. A process component may contain one or more semantically related business objects. A business object can belong to one process component.

In some implementations, elements located at node BusinessProcessVariantType may be defined by data type ProcurementDocumentBusinessProcessVariantTypeElements. Exemplary elements may in-dude: BusinessProcessVariantTypeCode and/or MainIndicator. BusinessProcessVariantTypeCode may be a GDT of type BusinessProcessVariantTypeCode. BusinessProcessVariantTypeCode can be a BusinessProcessVariantTypeCode and may be a coded representation of a business process variant type of a procurement document business process variant type. MainIndicator may be a GDT of type Indicator. In some implementations MainIndicator may have a qualifier of Main. MainIndicator can indicate whether current business process variant type is main one or not. In some implementations, one instance of BusinessProcessVariantType may be allowed to be indicated as main. AccessControlList (DO) can be a list of access groups that have access to entire procurement document during a validity period. AccessControlList can be used to control access to procurement document instances.

In some implementations, an Item specifies invoiced or credited amounts and taxes for quantity of a product, service or free text item that may have been delivered or for a service that may have been rendered by a supplier (SellerParty or ServicePerformerParty respectively). For Item (compared to information of SupplierInvoice) deviating parties, locations, and delivery terms may be defined. Item can contain references to or business documents that are relevant for item. Notes and/or attachments can also be specified for item.

In some implementations, elements located at node Item are defined by data type: ProcurementDocumentItemElements. Elements of this data type may be used in a SupplierInvoice. Exemplary elements may include: SystemAdminstrativeData, UUID, ID, and/or TypeCode. SystemAdminstrativeData is a GDT of type SystemAdminstrativeData. SystemAdminstrativeData can be a administrative data stored within system and may contain system users and time of change. UUID is a GDT of type UUID. In some implementations UUID can have an Alternative Key. UUID can be a universal unique alternative identifier of Item for referencing purposes. ID is a GDT of type BusinessTransactionDocumentItemID. ID can be an identifier for an Item assigned by BillToParty. TypeCode is a GDT of type BusinessTransactionDocumentItemTypeCode. TypeCode can be a coded representation of Item type (e.g., invoice item 284090/credit memo item 284092/subsequent debit item 284094/subsequent credit item 284096). In some implementations, invoices that contain errors can either be canceled completely and get reissued, or adjusted using debit and credit amounts in another invoice. In this case, only the difference amount required to correct financial data are transferred and not, for example, new absolute values for a product per price unit of measure. It is also important to note that amount to be settled in a subsequent credit or debit item cannot be offset against an open purchase order or delivery quantity.

In some implementations, a HierarchyRelationship may be a relationship between a subitem and a higher-level parent item in an item hierarchy. It may include elements that are defined by GDT: ProcurementDocumentItemHierarchyRelationship. Exemplary elements may include: ParentItemUUID, Type-Code, Description, DeliveryPeriod, Quantity, QuantityTypeCode, NetAmount and/or NetUnitPrice. ParentItemUUID may be a GDT of type UUID. ParentItemUUID can be a universal unique identifier for parent SupplierInvoiceItem. TypeCode may be a GDT of type BusinessTransactionDocumentItemHierarchy-RelationshipTypeCodeContent. TypeCode can be a coded representation of type of hierarchical relationship between subitem and its higher-level parent item. Description may be a GDT of type MEDIUM_Description and may be optional. Description can be description of item. DeliveryPeriod may be a GDT of type UPPEROPEN_LOCALNORMALI-SED_DateTimePeriod and may be optional. DeliveryPeriod can be a delivery date for invoiced products or timeframe for rendered services. Quantity may be a GDT of type Quantity and may be optional. Quantity can be an invoiced quantity. QuantityTypeCode may be a GDT of type QuantityTypeCode and may be optional. QuantityTypeCode can be a coded representation of a type of quantity. NetAmount may be a GDT of type Amount and may be optional. NetAmount can be a net amount of Item. NetUnitPrice may be a GDT of type Price and may be optional. NetUnitPrice can be a net price for base quantity of a product, which may have been used for calculation for net amount.

In some implementations, composition relationships to subordinate nodes exist, examples of which (with their possible cardinality relationships) are: ItemProduct 284098, which may have a cardinality of 1:c; ItemAccountingCodingBlockDistribution (DO) 284132, which may have a cardinality of 1:c; ItemParty 284108, which may have a cardinality of 1:cn; ItemLocation 284116, which may have a cardinality of 1:cn; ItemBusinessTransactionDocumentReference 284136, which may have a cardinality of 1:cn; ItemAttachmentFolder (DO) 284144, which may have a cardinality of 1:c; ItemTextCollection (DO) 284146, which may have a cardinality of 1:c; ItemBusinessProcessVariantType 284130, which may have a cardinality of 1:cn.

In some implementations, inbound Aggregation Relationships may exist, examples of which may include: From node Item and/or from business object Identity. Exemplary relationships from node Item may include ParentItem, which may have a cardinality of c to cn and can be an association to a Item itself, which may be a relationship between a subitem and a higher-level parent item in an item hierarchy. This may enables item hierarchies to be mapped. hierarchies are mapped using elements HierarchyRelationshipTypeCode and ParentItemID Exemplary relationships from business object Identity may include: CreationIdentity, which may have a cardinality of 1:cn and can be an identity that created procurement document; and/or LastChangeIdentity, which may have a cardinality of c:cn and can be an identity that changed procurement document in last time.

In some implementations, associations for Navigation may exist, examples of which may include: To node Item, To transformed object BusinessDocumentFlow, To node TaxCalculationItem, To node ItemParty,

To node and/or ItemBusinessTransactionDocumentReference. Exemplary associations to node Item may include: ChildItem, which may have a cardinality of c:cn, may be a Child item in an item hierarchy, and may be necessary in order to create item hierarchies; BusinessDocumentFlow may have a cardinality of c:c, may be an association to a BusinessDocumentFlow which can be a view on a set of some preceding and succeeding business (transaction) documents for a current procurement document.

Exemplary associations to node TaxCalculationItem may include: TaxCalculationItem, which may have a cardinality of 1:1 and can be an association to Item within a dependent object TaxCalculation.

Exemplary associations to node ItemParty may include: ProductRecipientItemParty, which may have a cardinality of c:c and may be an association to a Party which appears within ProductRecipientParty specialisation; ServicePerformerItemParty, which may have a cardinality of c:c and may be an association to a Party which appears within ServicePerformerParty specialisation; and/or RequestorItemParty, which may have a cardinality of c:c and can be an association to a Party which appears within RequestorParty specialisation.

Exemplary associations to node ItemLocation may include: ShipToItemLocation, which may have a cardinality of c:c and can be an association to a Location which appears within ShipToLocation specialisation; and/or ShipFromItemLocation, which may have a cardinality of c:c and can be an association to a Location which appears within ShipFromLocation specialisation.

Exemplary associations to node ItemBusinessTransactionDocumentReference may include: ItemPurchasingContractItemReference, which may have a cardinality of c:c and can be an association to a BusinessTransactionDocumentReference which appears within a PurchasingContract specialisation; ItemBasePurchaseOrderItemReference, which may have a cardinality of c:c and can be an association to a BusinessTransactionDocumentReference which appears within a PurchaseOrder specialisation; ItemBaseConfirmedInboundDeliveryhemReference, which may have a cardinality of c:c and can be an association to a BusinessTransactionDocumentReference which appears within a ConfirmedInboundDelivery specialisation; ItemOutboundDeliveryItemReference, which may have a cardinality of c:c and can be an association to a BusinessTransactionDocumentReference which appears within a OutboundDelivery specialisation; ItemBaseGoodsAndServiceAcknowledgementltemReference, which may have cardinality of c:c and can be an association to a BusinessTransactionDocumentReference which appears within a GoodsAndServiceAcknowledgement specialisation; ItemCustomerInvoiceItemReference, which may have a cardinality of c:c and can be an association to a BusinessTransactionDocumentReference which appears within CustomerInvoice specialisation; ItemCustomsDutyInvoiceItemReference, which may have a cardinality of c:c and can be association to a BusinessTransactionDocumentReference which appears within a CustomsDutyInvoice specialisation; ItemPurchaseOrderBasedSupplierInvoiceRequestItemReference, which may have a cardinality of c:c and can be an association to a business transaction document reference which appears within a PurchaseOrderBasedSupplierInvoiceRequest specialisation; ItemConfirmedInboundDeliveryBasedSupplierInvoiceRequesthemReference, which may have a cardinality of c:c and can be an association to a business transaction document reference which appears within ConfirmedInboundDeliveryBasedSupplierInvoiceRequest specialisation; ItemGoodsAndSeriveAcknowledgementBasedSupplierInvoiceRequestItemReference, which may have a cardinality of c:c and can be an association to a business transaction document reference which appears within a GoodsAndServiceAcknowledgementBased SupplierInvoiceRequest specialisation. ItemPurchasingContractBasedSupplierInvoiceRequestItemReference may have a cardinality of c:c and can be an association to a business transaction document reference which appears within PurchasingContractBasedSupplierInvoiceRequest specialisation.

ItemOriginSupplierInvoiceItemReference may have a cardinality of c:c and can be an association to a BusinessTransactionDocumentReference which appears within SupplierInvoiceRequest specialisation.

ItemSupplierInvoiceVerificationExceptionReference may have a cardinality of c:c and can be an association to a BusinessTransactionDocumentReference which appears within SupplierInvoiceVerificationException specialisation; MainitemBusinessTransactionDocumentReference, which may have a cardinality of c:c and can be an association to a BusinessTransactionDocumentReference which appears within MainBusinessTransactionDocument specialisation; and/or ItemDeliveryBasedSupplierInvoiceRequetsItemReference, which may have a cardinality of c:c and can be an association to a BusinessTransactionDocumentReference which appears within DeliveryBasedSupplierInvoiceRequest specialisation.

In exemplary implementations, Copy may duplicate selected items and proposes the duplicate as additional SupplierInvoiceItems.

In some implementations, ItemProduct can be the identification, description and classification of a product within Item. ItemProduct may include the following exemplary elements that are defined by GDT: ProcurementDocumentItemProductElements that may be derived from GDT BusinessTransactionDocumentProductElements. Exemplary elements may include: ProductUUID, ProductID, ProductStandardID, ProductBillFromID, ProductTypeCode, ProductCategoryUUID, ProductCategoryInternalID, ProductCategoryStandardID, ProductCatalogueReference, and/or CashDiscountDeductibleIndicator. ProductUUID may be a GDT of type UUID and may be optional. ProductUUID can be a universal unique identifier for a product. ProductID may be a GDT of type ProductID and may be optional. ProductID can be a proprietary identifier for a product. ProductStandardID may be a GDT of type ProductStandardID and may be optional. ProductTypeCode may be a GDT of type ProductTypeCode and may be optional. ProductTypeCode can be a coded representation of type of a product and may differ from associated product type. ProductCategoryUUID may be a GDT of type GUID and may be optional. ProductCategoryUUID can be a universal unique identifier for a product category. ProductCategoryInternalID may be a GDT of type ProductCategoryInternalID and may be optional. ProductCategoryInternalID can be a Proprietary identifier for a product category. ProductCategoryStandardID may be a GDT of type ProductCategoryStandardID and may be optional. ProductCategoryStandardID can be a standardized identifier for a product category. ProductCatalogueRefernce may be a GDT of type CatalogueRefernce and may be optional. ProductCatalogueRefernce can be a unique reference to a catalogue or to an object within a catalogue. CashDiscountDeductibleIndicator may be a GDT of type Indicator and may be optional. In some implementations CashDiscountDeductibleIndicator may have a qualifier of CashDiscountDeductable. CashDiscountDeductibleIndicator can be an indicator that cash discount may be deducted for this product.

In some implementations, a product category can be a division of products according to objective criteria. A product category may be automatically derived from Material or ServiceProduct if product identification may be specified. A Material or ServiceProduct may also be specified by natural linguistic text. In this case a ProductCategory may be assigned manually.

In some implementations, inbound Association Relationships may exist, examples of which may include from the business object Material, where Material may have a cardinality of c:cn and the SupplierInvoiceItemProduct may represent the Product specialisation Material if a ProcurementDocumentItem contains a Material; from the business object ServiceProduct, where ServiceProduct may have a cardinality of c:cn and may be SupplierInvoiceItemProduct may represent Product specialisation ServiceProduct if a ProcurementDocumentItem contains a ServiceProduct; and/or from the business object ProductCategoryHierarchy node ProductCategory, where ProductCategoryHierarchyProductCategory may have a cardinality of c:cn and the SupplierInvoiceItemProduct may represent a ProductCategory that classifies invoiced Material or ServiceProduct.

In some implementations, ItemAccountingCodingBlockDistribution (DO) can be distribution of value changes from a procurement document item to coding blocks, whereby distribution may occur on basis of amounts, quantities, or percentages. A coding block can be a set of accounting objects of different types. An accounting object can be a business object to which value changes from business transactions are assigned in Accounting.

In some implementations, ItemParty can be a party, which can be involved in a SupplierInvoiceItem. A ItemParty can be a business partner in specialisation Employee. A ItemParty can occur within the following exemplary specialisations: ProductRecipientParty, ServicePerformerParty, and/or RequestorParty. A ProductRecipientParty can be a party to which materials are delivered or for which services are provided. ProductRecipientParty can be relevant for tax calculation and for clarification of invoicing disputes, because it can provide information about delivered materials or services. A ServicePerformerParty can be a party that delivers goods or provides services. A ServicePerformerParty could help to clarify invoicing disputes. A RequestorParty can be a party that requests procurement of materials or services. A RequestorParty could help to clarify invoicing disputes.

In some implementations, composition relationships to subordinate nodes may exist, an example of which is ItemPartyAddress (DO) 284110 which may have a cardinality relationship of 1 to c. Inbound Aggregation Relationships from business object Party/Node Root may exist, where Party may have a cardinality of c:cn and can be referenced Party in Master Data. Associations for Navigation may exist, an example of which is to transformed object UsedAddress/node Root where UsedAddress may have a cardinaltiy of c:c and transformed object UsedAddress may represent a uniform way to access a party address of an procurement document whether it's a business partner address, a organization center address or an ad-dress specified within a procurement document.

In some implementations, ItemPartyAddress (DO) can be a SupplierInvoice specific address of Item-Party. ItemLocation may be a physical or logical place, which may be relevant for procurement document item. Location may occur in the following complete and disjoint specialisations: ShipFromItemLocation and/or ShipToItemLocation. The elements located at node ItemLocation may be defined by data type: ProcurementDocumentItemLocationElements that can be derived from data type Business TransactionDocumentLocationElements.

In some implementations, composition relationships to subordinate nodes exist, examples of which are: LocationAddress (DO), which may have a cardinality of 1:c; and/or from the business object Location where Location may have a cardinality of c:cn and PartyAddressInformation may have a cardinality of c:cn.

Associations for Navigation may exist where UsedAddress may have a cardinality of c:c and can be transformed object UsedAddress represents a uniform way to access a location address of an procurement document whether it's a business partner address, a organization center address or an address specified within a procurement document. ItemLocationAddress (DO) 284118 can be a SupplierInvoice specific address of ItemLocation. ItemBusinessTransactionDocumentReference may be a unique reference to another business transaction document and its item which may be related to Item. An ItemBusinessTransactionDocumentReference can occur within following specialisations: A PurchasingContractReference can be a reference to PuchasingContract and its item that holds agreed conditions between purchaser (BuyerParty) and supplier (Seller-Party), which need to be considered during SupplierInvoice verification; A PurchaseOrderReference can be a reference to PurchaseOrder and its item that requested invoiced materials and services; A ConfirmedInboundDeliveryReference can be a reference to ConfirmedInboundDelivery and its item that contains actual received materials; An OutboundDeliveryReference can be a reference to OutboundDelivery and its item that contain actual delivered materials; referring to ItemBaseGoodsAndServiceAcknowledgementItemReference, a GoodsAndServiceAcknowledgementReference can be a reference to GoodsAndServiceAcknowledgement and its item that contains actual received materials and services; referring to ItemCustomerinvoiceItemReference, a CustomerInvoiceReference can be reference a to CustomerInvoice and its item that may be used to charge a customer (BillToParty or BuyerParty respectively) for delivered materials and services; A referring to ItemCustomsDutyInvoiceItemReference, a CustomsDutyInvoiceItemReference can be a reference to CustomsDutyInvoiceItem that states purchaser's obligation to pay customs duty and/or product tax on import to a customs authority for import of goods or services rendered; referring to ItemPurchaseOrderBasedSupplierInvoiceRequestItemReference, a PurchaseOrderBasedSupplierInvoiceRequestItemReference can be a reference to SupplierInvoiceRequestItem that holds all necessary PurchaseOrderItem information for SupplierInvoice verification; referring to ItemConfirmedInboundDeliveryBasedSupplierInvoiceRequestItemReference, a ConfirmedInboundDeliveryBasedSupplierInvoiceRequestItemReference can be a reference to SupplierInvoiceRequestItem that holds some necessary ConfirmedInboundDeliveryItem information for Supplier-Invoice verification; referring to ItemGoodsAndServiceAcknowledgementBasedSupplierInvoiceRequestItemReference, a GoodsAndServiceAcknowledgementBasedSupplierInvoiceRequesthem-Reference can be a reference to SupplierInvoiceRequestItem that holds some necessary GoodsAndServiceAcknowledgementItem information for SupplierInvoice verification; referring to ItemPurchasingContractBasedSupplierInvoiceRequesthemReference, a PurchasingContractBasedSupplierInvoiceRequesthemReference can be a reference to SupplierInvoiceRequestItem that holds some necessary PurchasingContractItem information for SupplierInvoice verification; referring to ItemOriginSupplierInvoiceItemReference, a OriginSupplierInvoiceItemReference can be a reference to SupplierInvoiceItem that was issued in a previous process step. This reference may be used if SupplierInvoice represents a cancellation, a credit memo, a subsequent invoice or credit; referring to ItemSupplierInvoiceVerificationExceptionReference, a SupplierInvoiceVerificationExceptionitemReference can be a reference to SupplierInvoiceVerificationException that was issued during in-voice verification process; referring to MainItemBusinessTransactionDocumentItemReference, a MainBusinessTransactionDocumentItemReference can be a Reference to a SupplierInvoiceItem that can be main reference for invoice verification process; referring to ItemDeliveryBasedSupplierInvoiceRequestItemReference, a ItemDeliveryBasedSupplierInvoiceRequestItemReference can be a Reference to SupplierInvoiceRequestItem that holds some necessary DeliveryItem (GoodsAndServiceAcknowledgementItem or ConfirmendInboundDeliveryItem) information for SupplierInvoice verification. ItemBusinessTransactionDocumentReference includes following elements that can be defined by GDT: ProcurementDocumentItemBusinessTransactionDocumentReferenceElements that can be derived from GDT BusinessTransactionDocumentReferenceElements. se elements include Business TransactionDocumentReference, BusinessTransactionDocumentRoleCode and Business TransactionDocumentDataProviderIndicator. Business TransactionDocumentReference may be a GDT of type BusinessTransactionDocumentReference. BusinessTransactionDocumentReference can be a unique reference to referred business transaction document. Furthermore, it may be possible to have a reference to a line item within business transaction document. BusinessTransactionDocumentRoleCode may be a GDT of type Business TransactionDocumentReferenceRoleCode. BusinessTransactionDocumentRoleCode can be a coded representation of role of a BusinessTransactionDocument in this reference. BusinessTransactionDocumentDataProviderIndicator may be a GDT of type Indicator. In some implementations BusinessTransactionDocumentDataProviderIndicator may have a qualifier of DataProvider. BusinessTransactionDocumentDataProviderIndicator can be a coded representation of role of a BusinessTransactionDocument in this reference.

PurchasingContractItem may have a cardinality of c:cn and can be a Item may refer to a PurchasingContractItem.

PurchaseOrderItem may have a cardinality of c:cn and can be a Item may refer to a PurchaseOrderItem.

ConfirmedInboundDeliveryItem may have a cardinality of c:cn and may be a Item may refer to an ConfirmedInboundDeliveryItem.

OutboundDeliveryItem may have a cardinality of c:cn and may be a Item may refer to an OutboundDeliveryItem.

GoodsAndServiceAcknowledgementItem may have a cardinality of c:cn and may be a Item may refer to a GoodsAndServiceAcknowledgementItem.

CustomerInvoiceItem may have a cardinality of c:cn and may be a Item may refer to an CustomerInvoiceItem.

SupplierInvoiceRequestItem may have a cardinality of c:cn and may be a Item may refer to a Supplier-InvoiceRequestItem. SupplierInvoiceItem may have a cardinality of c:cn and may be a Item may refer to a SupplierInvoiceItem. SupplierInvoiceVerificationException may have a cardinality of c:cn and may be a Item may refer to a SupplierInvoiceVerificationException.

ItemAttachmentContainer (DO) can be a folder of all documents attached to procurement document item.

ItemTextCollection (DO) can be a collection of all textual descriptions which are related to procurement document item. Each text can be specified in different languages and can include formatting information.

An ItemBusinessProcessVariantType defines character of a business process variant of procurement document item. It represents a typical way of processing of a procurement document item within a process component from a business point of view.

Elements located at node ItemBusinessProcessVariantType may be defined by data type: Procurement-DocumentItemBusinessProcessVariantTypeElements. Exemplary elements include: BusinessProcessVariantTypeCode and MainIndicator. BusinessProcessVariantTypeCode may be a GDT of type BusinessProcessVariantTypeCode. BusinessProcessVariantTypeCode can be a coded representation of a business process variant type of a procurement document business process variant type. MainIndicator may be a GDT of type Indicator. In some implementations MainIndicator may have a qualifier of Main.

MainIndicator can be an indicator that specifies whether current business process variant type may be main one or not. In some implementations there may be one instances of BusinessProcessVariantType may be allowed to be indicated as main.

The SupplierInvoice can state the recipient's, e.g. the purchaser's, obligation to pay the supplier for goods received or services rendered. The extension of SupplierInvoice can capture additional information regarding the legally required document number on an invoice which shall be sequential, chronological and without gaps. This number can be required for reporting to the authorities (e.g. tax authority). In some implementations, an invoice is typically created after the goods and service acknowledgment has been confirmed. The Business Object SupplierInvoice can be part of the Process Component Supplier Invoice Processing in the Deployment Unit Supplier Invoicing. The data type enhancements can be part of Globalisation layer.

SupplierInvoiceProcessingInvoiceAccountingNotificationOut

The Service Interface Invoice Accounting Notification Out Interface can be part of the following Process Integration Model: Supplier Invoice Processing Accounting.

The Invoice Accounting Notification Out Interface can be a grouping of operations which notifies financial accounting about a Supplier Invoice.

SupplierInvoiceProcessingInvoiceAccountingNotificationOut NotifyOfInvoice

The operation Notify of SupplierInvoice can notify financial accounting about accounting relevant SupplierInvoice information. The operation can be based on message type InvoiceAccountingNotification (Derived from Business Object AccountingNotification). InvoiceAccountingNotification can contain information about the accounting objects to be charged. This message can be sent whenever a Supplier Invoice is posted.

The extension of the operation Notify of Invoice can capture additional information which is required for legal accounting purposes in Italy, France and China. In some implementations, the legal requirement is LegallyRequiredSupplierInvoiceID should be reported in the Document Journal report. Based on this requirement, the extension to Accounting from Supplier Invoicing is done.

The elements of the Invoice Accounting Notification can be defined by the data type: InvoiceAccountingNotification. The Invoice Accounting Notification enhancement can be defined by the data type: InvoiceAccountingNotificationLegalIDExtensionElements. These elements can include: 1) LegallyRequiredSupplierInvoiceID can be optional. LegallyRequiredSupplierInvoicelD can be of GDT type BusinessTransactionDocumentID. 2) LegallyRequiredSupplierInvoiceDate can be optional. LegallyRequiredSupplierInvoiceDate can be of GDT type Date.

SupplierInvoiceProcessingReceivablesPayablesOut

The Service Interface Receiveables Payables Out Interface can be part of the following Process Integration Model: Supplier Invoice Processing Due Item Processing.

The Receivables Payables Out Interface can be a grouping of operations which notifies Due Item Processing, e.g. financial operations, about a Supplier Invoice.

SupplierInvoiceProcessingReceivablesPayablesOut.NotifyOfInvoice

The operation Notify of Invoice can notify the financial operations about payments due and tax due. The operation can be based on message type ReceiveablesPayablesNotification, for example derived from Business Ojects TradeReceiveablesPayablesRegister and TaxReceiveablesPayablesRegister.

The extension of the operation Notify of Invoice can captures additional information which is legally required for reporting to tax authorities in Italy, France and China.

The elements of the Receivables Payables Notification can be defined by the data type: ReceivablesPayablesNotificationReceivablesPayables. The Receivables Payables Notification enhancement can be defined by the data type: ReceivablesPayablesNotificationReceivablesPayablesLegalIDExtensionElements. These elements can include: 1) LegallyRequiredSupplierInvoiceID can be optional. LegallyRequiredSupplierInvoiceID can be of GDT type BusinessTransactionDocumentID. 2) LegallyRequiredSupplierInvoiceDate can be optional. LegallyRequiredSupplierInvoiceDate can be of GDT type Date.

The SupplierInvoice can include detail information about claims or liabilities for delivered goods and rendered services between a BillFromParty and a BillToParty.

The SupplierInvoice can be extended with additional elements regarding the legally required document number and date which are required in order to fulfill legal regulatory compliance of China, France and Italy.

The elements located at the node SupplierInvoice can be defined by the data type: SupplierInvoiceElements. The SupplierInvoice enhancement can be defined by the data type: SupplierInvoiceLegalIDExtensionElements. These elements can include: 1) LegallyRequiredSupplierInvoiceID can be optional. A LegallyRequiredSupplierInvoiceID can be a unique identifier for a Supplier Invoice which meets the requirements of legal authorities. In some implementations, the requirements for the procedure of generating a legal identifier depends on the country legislation. LegallyRequiredSupplierInvoiceID can be of GDT type BusinessTransactionDocumentID. The LegallyRequiredSupplierInvoiceID can contain a number that a company has to maintain because of country-specific legal requirements. This legal number is typically sequential, chronological and without gaps. Difference between SupplierInvoiceID and LegallyRequiredSupplierInvoiceID. The SupplierInvoiceID can be an identifier for the supplier invoice on the entry into the system whereas the LegallyRequiredSupplierInvoiceID can be an identifier to the Supplier Invoice which is generated when the document is posted (when the action ‘post’ is executed). The LegallyRequiredSupplierInvoiceID may not be generated when the document is parked. Additionally the LegallyRequiredSupplierInvoiceID shall be sequential, chronological and without gaps. This number can be used for reporting to the Tax authorities. 2) LegallyRequiredSupplierInvoiceDate can be optional. A LegallyRequiredSupplierInvoiceDate can be a Identifier that captures the date when the LegallyRequiredSupplierInvoiceID for a Supplier Invoice was generated. The LegallyRequiredSupplierInvoiceDate can be of GDT type Date. The LegallyRequiredSupplierInvoiceDate can be used for maintaining legal requirements (chronological, sequential).

In some implementations, all the other nodes of the Business object SupplierInvoice remain unchanged, i.e. it's no enhancement for legal identification compliance necessary.

A number of implementations have been described. Nevertheless, it will be understood that various modifications may be made without departing from the spirit and scope of the disclosure. Accordingly, other implementations are within the scope of the following claims.

What is claimed is:

1. A computer readable medium including program code for providing a message-based interface for exchanging information for foreign trade product classifications, the medium comprising:
program code for receiving via a message-based interface exposing at least one service as defined in a service registry and from a heterogeneous application executing in an environment of computer systems providing message-based services, a first message for providing a request to maintain a bundle of foreign trade product classifications that includes a message package hierarchically organized as:
a foreign trade product classification bundle maintain request message entity; and
a foreign trade product classification package comprising at least one foreign trade product classification entity, where each foreign trade product classification entity includes a product key, a validity start date, and a customs commodity classification code; and
program code for sending a second message to the heterogeneous application responsive to the first message.

2. The computer readable medium of claim 1, wherein each foreign trade product classification entity further includes at least one of the following: an action code, an object node sender technical identifier (ID), a change state ID, a universally unique identifier (UUID), a product quantity conversion quantity, and a product quantity conversion corresponding quantity.

3. A distributed system operating in a landscape of computer systems providing message-based services defined in a service registry, the system comprising:
a graphical user interface comprising computer readable instructions, embedded on tangible media, for providing a request to maintain a bundle of foreign trade product classifications using a request;
a first memory storing a user interface controller for processing the request and involving a message including a message package hierarchically organized as:
a foreign trade product classification bundle maintain request message entity; and
a foreign trade product classification package comprising at least one foreign trade product classification entity, where each foreign trade product classification entity includes a product key, a validity start date, and a customs commodity classification code; and
a second memory, remote from the graphical user interface, storing a plurality of service interfaces, where one of the service interfaces is operable to process the message via the service interface.

4. The distributed system of claim 3, wherein the first memory is remote from the graphical user interface.

5. The distributed system of claim 3, wherein the first memory is remote from the second memory.

6. A computer readable medium including program code for providing a message-based interface for exchanging information for supplier invoices, the medium comprising:
program code for receiving via a message-based interface exposing at least one service as defined in a service registry and from a heterogeneous application executing in an environment of computer systems providing message-based services, a first message for providing a request to check for issues that may occur during the creation of one or more supplier invoices by simulation their creation that includes a message package hierarchically organized as:
a supplier invoice bundle check maintain request message entity; and
a supplier invoice package comprising at least one supplier invoice maintain bundle entity and a party package, where each supplier invoice maintain bundle entity includes a business transaction document type code and a document item gross amount indicator, and where the party package comprises a buyer party entity; and
program code for sending a second message to the heterogeneous application responsive to the first message.

7. The computer readable medium of claim 6, wherein the supplier invoice package further comprises at least one of the following: a business transaction document reference package, a location package, a cash discount terms package, a payment control package, an attachment folder package, a text collection package, and an item package.

8. The computer readable medium of claim 6, wherein each supplier invoice maintain bundle entity further includes at least one of the following: an action code, an item list complete transmission indicator, an object node sender technical identifier (ID), a change state ID, a medium name, a date, a receipt date, a transaction date, a gross amount, a tax amount, and a status.

9. A distributed system operating in a landscape of computer systems providing message-based services defined in a service registry, the system comprising:
a graphical user interface comprising computer readable instructions, embedded on tangible media, for providing a request to check for issues that may occur during the creation of one or more supplier invoices by simulation their creation using a request;
a first memory storing a user interface controller for processing the request and involving a message including a message package hierarchically organized as:
a supplier invoice bundle check maintain request message entity; and
a supplier invoice package comprising at least one supplier invoice maintain bundle entity and a party package, where each supplier invoice maintain bundle entity includes a business transaction document type code and a document item gross amount indicator, and where the party package comprises a buyer party entity; and
a second memory, remote from the graphical user interface, storing a plurality of service interfaces, where one of the service interfaces is operable to process the message via the service interface.

10. The distributed system of claim 9, wherein the first memory is remote from the graphical user interface.

11. The distributed system of claim 9, wherein the first memory is remote from the second memory.
